(19) United States
(12) Patent Application Publication
(10) Pub. No.: US 2004/0078216 A1
(43) Pub. Date: Apr. 22, 2004

(54) Clinical trial process improvement method and system

(76) Inventor: Gregory Toto, San Francisco, CA (US)

Correspondence Address: WILSON SONSINI GOODRICH & ROSATI, 650 PAGE MILL ROAD, PALO ALTO, CA, 943041050

(21) Appl. No.: 10/121,967

(22) Filed: Apr. 12, 2002

Related U.S. Application Data
(60) Provisional application No. 60/353,916, filed on Feb. 1, 2002.

(51) Int. Cl. G06F 17/60

(52) U.S. Cl. 705/2; 707/100

(57) ABSTRACT

A clinical trial method provides a repository which includes a plurality of clinical trial documents from one or a plurality of document sources. At least a portion of the clinical trial documents in the repository are compared with a plurality of clinical trial documents accessed from one or the plurality of document sources. A current copy of a clinical trial document is maintained in the repository. A query interface to the repository is provided for access to at least a portion of the clinical trial documents in the repository.

### CROSS-REFERENCE TO RELATED APPLICATIONS

This application claims the benefit of priority from U.S. Provisional Patent Application No. 60/353,916 filed Jan. 31, 2002, and is related to Attorney Docket No. 28003-702, filed Apr. 12, 2002, Attorney Docket No. 28003-703, filed Apr. 12, 2002, Attorney Docket No. 28003-704, filed Apr. 12, 2002, and Attorney Docket No. 28003-705, filed Apr. 12, 2002, all of which are incorporated herein by reference in their entirety.

### BACKGROUND

1. Field of Use

This invention relates generally to clinical trial awareness, recruitment, and enrollments, and more particularly to clinical trial awareness, recruitment, and enrollments that use medical information sharing networks, services, and systems.

2. Description of Related Art

The timely completion of well-designed clinical trials is critical to the success of any new medical treatment. Biopharmaceutical and medical device companies currently face major challenges in advancing drug development pipelines; these challenges mandate significant improvements in underlying business processes. Critical shortcomings in the clinical trial process extend beyond the need for innovative applications. There is also a notable need for a comprehensive platform, adherent to high ethical standards and trusted by all players in the clinical trials process, upon which these solutions will operate.

Every year, the biopharmaceutical industry spends over $50 billion researching and developing new drugs. Approximately $30 billion of this goes into the clinical phase. Within this phase, clinical trials consume more than half of the average 15 years it takes to bring a new drug to market. The industry conducts over 16,000 clinical trials each year in the United States alone.

The average number of clinical trial subjects required for a new drug approval has tripled since the 1980s and is expected to double over the next five years. In addition, each new drug is requiring more trials for approval. And finally, the overall number of new drug therapies will increase dramatically as genomic-based drugs move out of basic research and into clinical evaluation. These factors alone will create an unprecedented demand for clinical trial subjects and will overwhelm the already-taxed clinical trial infrastructure.

Clinical trials are on the critical path of all new drug development initiatives. A delay of even a single day in a clinical trial costs a pharmaceutical company over $1 million in lost revenue. Private biotechnology companies are especially vulnerable because a delay of any kind can mean lost funding opportunities and even business failure. Yet today, the clinical trial process is routinely inefficient—over 90 percent of trials miss their scheduled completion dates.

Over the last 20 years, the industry has made efforts to improve many aspects of the new drug development process. For instance, the outsourcing of clinical trial management to clinical research organizations (CROs) and site management organizations (SMOs) has provided efficiencies at the investigative site and has improved the quality of data obtained from trials. Outsourced clinical trial management has become a $5 billion industry and represents approximately 20% of the clinical development market. These efforts have done little, however, to connect drug developers with their ultimate consumer—the patient—during the clinical trial.

In the last 10 years, patients have become increasingly educated and proactive in managing their own health. The increased availability of healthcare information through traditional media and, more recently, the Internet, as well as the rise in direct-to-consumer drug advertising, has led to heightened “consumerism” in healthcare. This has made it necessary to present healthcare information in non-technical terms.

Currently, no effective solution exists that involves patients directly in the drug development process, especially where patient involvement is needed most: in clinical trial design and recruitment.

Mechanisms do not exist that facilitate communication directly with target patients to increase drug developer knowledge and improve the drug development process. This communication and knowledge could have a dramatic, positive impact on indication selection, protocol development, investigator selection, subject recruitment, protocol compliance, subject retention, adverse event reporting, indication expansion, and long-term follow-up.

Most of the information useful to drug developers is private medical data that patients normally are reluctant to share openly. However, drug developer access to patients and information must be balanced with the patient's right to confidentiality and privacy. Worldwide, government agencies, patient advocacy organizations, and privacy groups are increasingly demanding careful protection and management of this type of information in the interest of patient privacy. These privacy concerns are a primary obstacle to a direct relationship between drug developers and patients. There is a need for an improved clinical trial processes. There is a further need for an improved method and system for clinical trial processes directed to the market performance of new drugs that utilizes a trusted, confidential, and regulation-compliant link to targeted patients early in the drug development process. There is a yet a further need for an improved method and system that provides tools and information to empower patients to make decisions about their medical care, including enrollment in clinical trials, and the appropriate dissemination of their medical information to members of the clinical trial ecosystem. There is a further need for an improved method and system that maintains comprehensive and current clinical trial information based on the requests of patients and multiple data sources. There is a yet another need for an improved method and system to improve clinical trial awareness, recruitment, and enrollments that uses medical information sharing networks, services and systems.

### SUMMARY

Accordingly, an object of the present invention is to provide improved clinical trial methods and systems.

Another object of the present invention is to provide clinical trial methods and systems that are directed to the market performance of new drugs and utilize a trusted, confidential, and regulation-compliant links to targeted patients.

A further object of the present invention is to provide clinical trial methods and systems that provides tools and information to empower patients to make decisions about their medical care, including enrollment in clinical trials, and the appropriate dissemination of their medical information to members of the clinical trial ecosystem.

Yet another object of the present invention is to provide clinical trial methods and systems that maintain comprehensive and current clinical trial information based on the requests of patients and multiple data sources.

Still another object of the present invention is to provide clinical trial methods and systems that use medical information sharing networks, services and systems.

Another object of the present invention is to provide clinical trial methods and systems that provide for the secure exchange of personal and medical information among members of the clinical trial ecosystem through permission-based regulation-compliant information sharing networks.

Yet another object of the present invention is to provide clinical trial methods and systems that provide authentication and registration of a user, and a determination of the medical role of the user, in compliance with confidentiality and privacy laws.

A further object of the present invention is to provide clinical trial methods and systems that determine a user's access privileges and sharing permissions of clinical trial information, and provides users with access or sharing of clinical trial information in compliance with confidentiality and privacy laws.

Still another object of the present invention is to provide clinical trial methods and systems that provide a user with access to at least a part of a clinical trial sponsor's clinical trial information where the extent of access depends on the permissions granted by the clinical trial sponsor and the user's medical role.

Another object of the present invention is to provide clinical trial methods and systems that authenticate users for access to the system, and grants users control over third-party users' access to the user's medical information.

A further object of the present invention is to provide clinical trial methods and systems that provides the user with access to at least a portion of the clinical trial information system's clinical trial documents in response to the user's medical role.

Still another object of the present invention is to provide clinical trial methods and systems that provides the user with access to at least a portion of the clinical trial information system's clinical trial documents in response to the user's method of access to the clinical trial information system.

A further object of the present invention is to provide clinical trial methods and systems that provides the user with access to at least a portion of the clinical trial information system's clinical trial documents in response to the user's method of access to the clinical trial information system.

A further object of the present invention is to provide clinical trial methods and systems that provide the user with access to a relevant clinical trial document while maintaining compliance with confidentiality and privacy laws.

Still a further object of the present invention is to provide clinical trial methods and systems that provide a repository for clinical trial documents, compares the clinical trial documents in the repository with clinical trial documents accessed from the document sources, maintains a current copy of clinical trial documents in the repository, and provides a query interface to the repository for access to clinical trial documents in the repository.

Another object of the present invention is to provide clinical trial methods and systems to identify users to participate in a clinical trial.

A further object of the present invention is to provide clinical trial methods and systems that contains clinical trial information about a users located within a multiple information systems, and that couples criteria suitable for identification of users eligible to participate in clinical trials with the clinical trial information about the users.

Yet another object of the present invention is to provide clinical trial methods and systems to identify investigators for clinical trials.

These and other objects of the present invention are achieved in a clinical trial method that provides a repository which includes a plurality of clinical trial documents from one or a plurality of document sources. At least a portion of the clinical trial documents in the repository are compared with a plurality of clinical trial documents accessed from one or the plurality of document sources. A current copy of a clinical trial document is maintained in the repository. A query interface to the repository is provided for access to at least a portion of the clinical trial documents in the repository.

In another embodiment of the present invention, a clinical trial information system includes a database with clinical trial information for a at least one clinical trial. A user interface includes a plurality of selectable user inputs to permit a user to access the database. At least one document server is coupled to the database and configured to provide information exchange between a user and at least one third-party user.

In another embodiment of the present invention, a clinical trial information system has at least one database with clinical trial information for a at least one clinical trial. A user interface includes a plurality of selectable user inputs to permit a user to access the database. At least one routing server is coupled to the database and is configured to provide anonymous communication between a client and at least one third-party client.

### BRIEF DESCRIPTION OF THE DRAWINGS

FIG. 1 is a schematic diagram that illustrates one embodiment of the present invention including a database and network.

FIG. 2 is a screen shot that illustrates one embodiment of a UI presented in the context of a third-party website of the present invention.

FIG. 3 is a schematic diagram that illustrates one embodiment of the present invention including three-tier server structure and UI suitable to the role of a user based on their role of the present invention.

FIG. 4 is a schematic diagram that illustrates one embodiment of a UI suitable for the device of access of the present invention.

FIG. 5 is a schematic diagram that illustrates a one embodiment of a clinical trial document repository of the present invention.

FIGS. 6 through 25 illustrate one embodiment of the database tables for a document repository of the present invention.

FIG. 26 is a schematic diagram that illustrates one embodiment of the component systems of the present invention.

FIG. 27 is a schematic diagram that illustrates one embodiment of a client, authentication server, permissions server, document server, routing server and audit server of the present invention.

FIG. 28 is a schematic diagram that illustrates one embodiment of a client and authentication server of the present invention.

FIG. 29 is a schematic diagram that illustrates one embodiment of a client and an authentication server combined with another server of the present invention.

FIG. 30 is a schematic diagram that illustrates one embodiment of a client and permissions server of the present invention.

FIG. 31 is a schematic diagram that illustrates one embodiment of a client and a permissions server combined with another server of the present invention.

FIG. 32 is a schematic diagram that illustrates one embodiment of a client and routing server of the present invention.

FIG. 33 is a schematic diagram that illustrates one embodiment of an routing server verifying user identity and permissions with an authentication server and permissions server of the present invention.

FIG. 34 is a schematic diagram that illustrates one embodiment of a client and a routing server combined with another server of the present invention.

FIG. 35 is a schematic diagram that illustrates one embodiment of a client and an audit server of the present invention.

FIG. 36 is a schematic diagram that illustrates one embodiment of a client and an audit server combined with another server of the present invention.

FIG. 37 is a schematic diagram that illustrates one embodiment of a client and a document server of the present invention exchanging information directly addressed to third-party client.

FIG. 38 is a schematic diagram that illustrates one embodiment of a client and a document server of the present invention exchanging information with a third-party client based on criteria matching.

FIG. 39 is a schematic diagram that illustrates one embodiment of a document server verifying user identity and permissions with an authentication server and permissions server of the present invention.

FIG. 40 is a schematic diagram that illustrates one embodiment of a client and a document server combined with another server of the present invention.

FIG. 41 is a schematic diagram that illustrates one embodiment of software modules of the present invention suitable to the role of a user.

FIG. 42 screen shot that illustrates one embodiment of a patron module login page of the present invention.

FIG. 43 is a screen shot that illustrates one embodiment of a partial registration patron module registration page of the present invention.

FIG. 44 is a screen shot that illustrates one embodiment of a patron module registration confirmation page of the present invention.

FIG. 45 is a screen shot that illustrates one embodiment of a patron module registration page of the present invention.

FIG. 46 is a screen shot that illustrates one embodiment of a patron module verify/update page of the present invention.

FIG. 47 is a screen shot that illustrates one embodiment of a submit confirmation page of the present invention.

FIG. 48 is a screen shot that illustrates one embodiment of a patron module account options page of the present invention.

FIG. 49 is a screen shot that illustrates one embodiment of a patron module demographics page of the present invention.

FIG. 50 is a screen shot that illustrates one embodiment of a find account page of the present invention.

FIG. 51 is a screen shot that illustrates one embodiment of a password question page of the present invention.

FIG. 52 is a screen shot that illustrates one embodiment of a password modification page of the present invention.

FIG. 53 is a screen shot that illustrates one embodiment of a change email/password page of the present invention.

FIG. 54 is a screen shot that illustrates one embodiment of a email address confirmation page of the present invention.

FIG. 55 is a screen shot that illustrates one embodiment of a contact information page of the present invention.

FIG. 56 is a screen shot that illustrates one embodiment of a trial sentinel page of the present invention.

FIG. 57 is a screen shot that illustrates one embodiment of a remove account page of the present invention.

FIG. 58 is a screen shot that illustrates one embodiment of a patron module account removed confirmation page of the present invention.

FIG. 59 is a screen shot that illustrates one embodiment of an account update confirmation page of the present invention.

FIG. 60 is a screen shot that illustrates one embodiment of a feedback page of the present invention.

FIG. 61 is a screen shot that illustrates one embodiment of a patron module main menu page of the present invention.

FIG. 62 is a screen shot that illustrates one embodiment of a browse page of the present invention.

FIG. 63 is a screen shot that illustrates one embodiment of a search/browse results page of the present invention.

FIG. 64 is a screen shot that illustrates one embodiment of an advanced search page of the present invention.

FIG. 65 is a screen shot that illustrates one embodiment of a trial locations page of the present invention.

FIG. 66 is a screen shot that illustrates one embodiment of a detailed trial information page of the present invention.

FIG. 67 is a screen shot that illustrates one embodiment of a tell a friend page of the present invention.

FIG. 68 is a schematic drawing that illustrates one embodiment of the prescreen results workflow of the present invention.

FIG. 69 is a screen shot that illustrates one embodiment of a prescreen questionnaire page of the present invention.

FIG. 70 is a screen shot that illustrates one embodiment of a prescreen results page for an incomplete prescreen of the current invention.

FIG. 71 is a screen shot that illustrates one embodiment of a take to my doctor page of the present invention.

FIG. 72 is a screen shot that illustrates one embodiment of a prescreen results page for a failed prescreen of the present invention.

FIG. 73 is a screen shot that illustrates one embodiment of a prescreen results page for a passed prescreen of the current invention.

FIG. 74 is a screen shot that illustrates one embodiment of a prescreen submitted page of the present invention.

FIG. 75 is a screen shot that illustrates one embodiment of a glossary item and definition of the present invention.

FIG. 76 is a screen shot that illustrates one embodiment of a sponsor module options page of the present invention.

FIGS. 77 and 78 are screen shots that illustrate one embodiment of a sponsor module pre-registration page of the present invention.

FIGS. 79, 80, 81, and 82 are screen shots that illustrate one embodiment of a sponsor module profile management page of the present invention.

FIGS. 83 and 84 are screen shots that illustrates one embodiment of a sponsor module profile preview page of the present invention.

FIG. 85 is a screen shot that illustrates one embodiment of a trial selection page of the present invention.

FIGS. 86, 87, 88, 89, 90, and 91 are screen shots that illustrate one embodiment of a trial management page of the present invention.

FIGS. 92 and 93 are screen shots that illustrate one embodiment of a trial preview page of the present invention.

FIG. 94 is a screen shot that illustrates one embodiment of an add keyword page of the present invention.

FIG. 95 is a screen shot that illustrates one embodiment of a trial administrator module management page of the present invention.

FIG. 96 is a screen shot that illustrates one embodiment of a trial administrator module management preview page of the present invention.

FIG. 97 is a screen shot that illustrates one embodiment of an add article citation page of the present invention.

FIG. 98 is a screen shot that illustrates one embodiment of an investigative site selection page of the present invention.

FIG. 99 is a screen shot that illustrates one embodiment of an add new investigative site page of the present invention.

FIGS. 100, 101, and 102 are screen shots that illustrate one embodiment of a trial site management page of the present invention.

FIGS. 103 and 104 are screen shots that illustrate one embodiment of a trial site management preview page of the present invention.

FIG. 105 is a screen shot that illustrates one embodiment of a trial administrator module options page of the present invention.

FIG. 106 is a screen shot that illustrates one embodiment of a delivered patron report page of the present invention.

FIG. 107 is a screen shot that illustrates one embodiment of an enrolled users report page of the present invention.

FIGS. 108 and 109 are screen shots that illustrate one embodiment of a demographic data report page of the present invention.

FIGS. 110 and 111 are screen shots that illustrate one embodiment of a partner module preregistration page of the present invention.

FIG. 112 is a screen shot that illustrates one embodiment of a partner module options page of the present invention.

FIGS. 113, 114, 115, 116, and 117 are screen shots that illustrate one embodiment of a partner module profile management page of the present invention.

FIGS. 118 and 119 are screen shots that illustrate one embodiment of a partner module page layout management page of the present invention.

FIGS. 120, 121, and 122 are screen shots that illustrate one embodiment of a partner module profile and page layout preview page of the present invention.

FIGS. 123 and 124 are screen shots that illustrate one embodiment of an investigator application page of the present invention.

FIG. 125 is a screen shot that illustrates one embodiment of an admin options page of the present invention.

FIG. 126 is a screen shot that illustrates one embodiment of a sponsor module applications list page of the present invention.

FIGS. 127, 128, 129, and 130 are screen shots that illustrate one embodiment of a sponsor module application review page of the present invention.

FIG. 131 is a screen shot that illustrates one embodiment of a partner module applications list page of the present invention.

FIGS. 132, 133, 134, 135, and 136 are screen shots that illustrate one embodiment of a partner module application review page of the present invention.

FIG. 137 is a screen shot that illustrates one embodiment of a trial submittals list page of the present invention.

FIGS. 138, 139, 140, 141, and 142 are screen shots that illustrate one embodiment of a trial submittals review page of the present invention.

FIG. 143 is a screen shot that illustrates one embodiment of a trial sentinel demand report page of the present invention.

FIGS. 144 through 172 illustrate one embodiment of the tables for a database structure of the present invention.

### DETAILED DESCRIPTION OF THE PREFERRED EMBODIMENTS

For purposes of the present invention, each of the terms set forth below shall be defined in accordance with the corresponding definition set forth below:

“Account(s)” shall mean information that provides an identification of a patron and information that does not provide an identification of a patron provided by a patron to the system or service modules during registration for a service module.

“Administrator(s)” shall mean any person able and authorized to import, export, or manage information into and out of the hardware or software necessary for the present invention.

“Advocate(s)” shall mean any person using a service module for another person or “Subject”. See also the definition for “Subject”.

“BREW” shall mean Binary Runtime Environment for Wireless.

“CFR part 11” shall mean part 11 of the Code of Federal Regulations.

“Clinical Research Organization (CRO)” shall mean any person performing clinical trial execution and supporting activities.

“Clinical trial(s)” shall mean any clinical study required to achieve regulatory approval.

“Clinical trial document(s)” shall mean any data about a clinical trial.

“Clinical trial ecosystem” shall mean any person or group of persons, any relationships, dependent or otherwise, among these entities, that are involved with the clinical trial process.

“Clinical trial process” shall mean the product research, testing and development process from the point a chemical compound or medical device is proposed for application in human beings to the point that no further product research, testing and development is performed on the chemical compound or medical device.

“CMMS” shall mean the Center for Medicare and Medicaid Services.

“Healthcare Professional(s)” or “HCP(s)” shall mean physicians, nurse practitioners, nurses, researchers, or any other person paid for medical services.

“HTML” shall mean HyperText Markup Language.

“HIPAA” shall mean the Health Insurance Portability and Accountability Act, legislation designed to promote and protect confidentiality and privacy.

“ICH” shall mean the International Conference on Harmonisation of Technical Requirements for Registration of Pharmaceuticals for Human Use.

“i-Mode” shall mean NTT DoCoMo's mobile internet access technology.

“Investigator” shall mean any organization that manages the enrollment of persons in clinical trials.

“IPSec” shall mean IP Security Protocol.

“JCAHO” shall mean the Joint Commission for Accreditations of Healthcare Organizations.

“Module access device” or “Service access device” shall mean any single or combination of hardware and software a person may use to access a service module and can include, but is not limited to, personal computers, portable computers, internet-enabled devices, information appliances, kiosks, communication devices, personal-digital assistants, and other network enabled devices.

“Partner” shall mean any person in which a service module is presented.

“Patron(s)” shall mean any person who uses the patron service module for him/herself or for others. See also “Advocate” and “Subject”.

“Payer” shall mean any person taking financial responsibility for medical care.

“Person(s)” shall mean any individual, corporation, partnership, association, unincorporated organization, or government or political subdivisions thereof.

“PKI” shall mean Public Key Infrastructure including X.509, Certificate Management Protocols (CMP), and Public Key Cryptography Standards (PKCS)

“Prescreen” shall refer to any mechanism by which a patron is evaluated against preliminary eligibility for participation in a clinical trial.

“S/MIME” shall mean Secure/Multipurpose Internet Mail Extensions.

“Service module” or “Service” shall mean any combination of persons, hardware, software, or other device used to improve the clinical trial process.

“Session” shall mean the length of time a person is interacting with a module. During a session, a person only needs to login once. A person's session terminates when a person logs out by selecting the “log out” link located in the top navigation bar or when a person's session is inactive for 20 minutes. The latter feature helps prevent unauthorized access by a different patron who may use the same module access device.

“SGML” shall mean Standard Generalized Markup Language

“Site Management Organizations (SMO)” shall mean any person who owns clinical trial locations and who conducts clinical trials in these locations at the request of another person.

“Sponsor(s)” shall mean any person managing a clinical trial.

“SSL” shall mean Secure Sockets Layer.

“Subject(s)” shall mean any person for whom an advocate is using a service module.

“System” shall mean any combination of technical infrastructure employed for purposes of this invention.

“User” shall mean any person using any invention described herein.

“UI” shall mean User Interface or any user-facing entity of the invention.

“Username” or “User ID” shall mean a means by which a person can be uniquely referenced by a user or a system, but in a manner that does not provide a personal identification of the person.

“VPN” shall mean Virtual Private Network.

“WAP” shall mean Wireless Application Protocol.

“WTLS” shall mean Wireless Transport Layer Security.

“XHTML” shall mean Extensible HyperText Markup Language.

“XML” shall mean Extensible Markup Language.

In one embodiment, methods and systems are provided that improve the clinical trial process through the use of medical information sharing networks, services, and systems. The methods and systems of the present invention provide a secure way for patients to explore their disease management options while permitting the extraction of relevant data that makes the design, set-up and management of clinical trials more efficient.

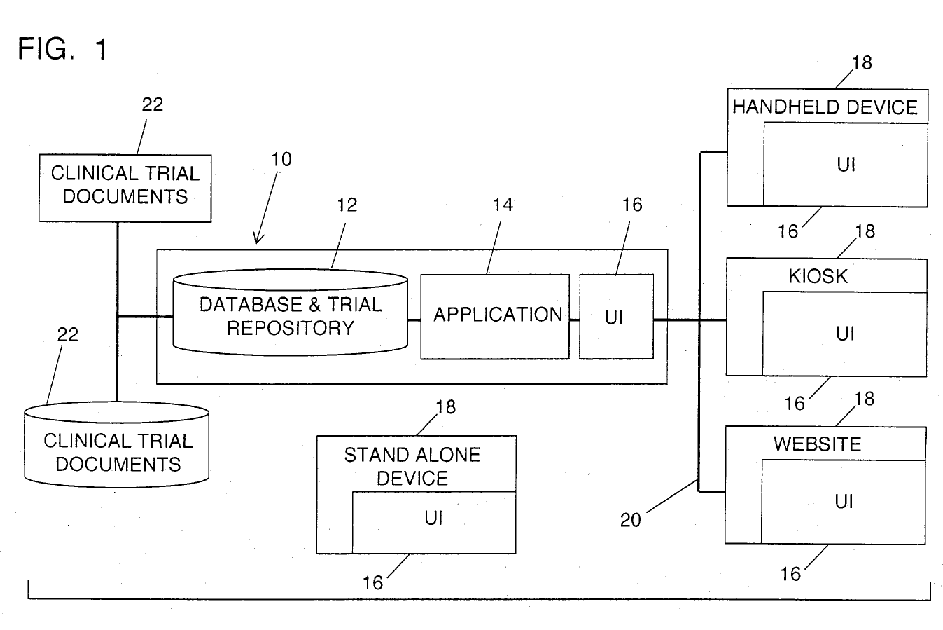

Referring now to FIG. 1, one embodiment of a medical information sharing system 10 of the present invention includes at least one database 12. Database 12 includes a document repository containing clinical trial information for at least one clinical trial. System 10 also includes software 14 that implements the functions of the medical information sharing system. A UI 16 is provided with a plurality of selectable user inputs to permit a user to access database 12. A display and input device 18 is operable by a user. Suitable display and input devices 18 include but are not limited to a personal computer, portable computer, internet-enabled device, information appliance, kiosk, communication device, personal-digital assistant, and other network enabled devices. The system 10 is coupled to display and input devices 18 by a network 20. Suitable networks 20 include but are not limited to internet, local area network, wide area network, broadband network, and wireless network.

In other embodiments of the medical information sharing system 10 of the present invention, database 12 includes but is not limited to user authentication information for the medical information sharing system, user preference and permission information, user medical information, and other user information.

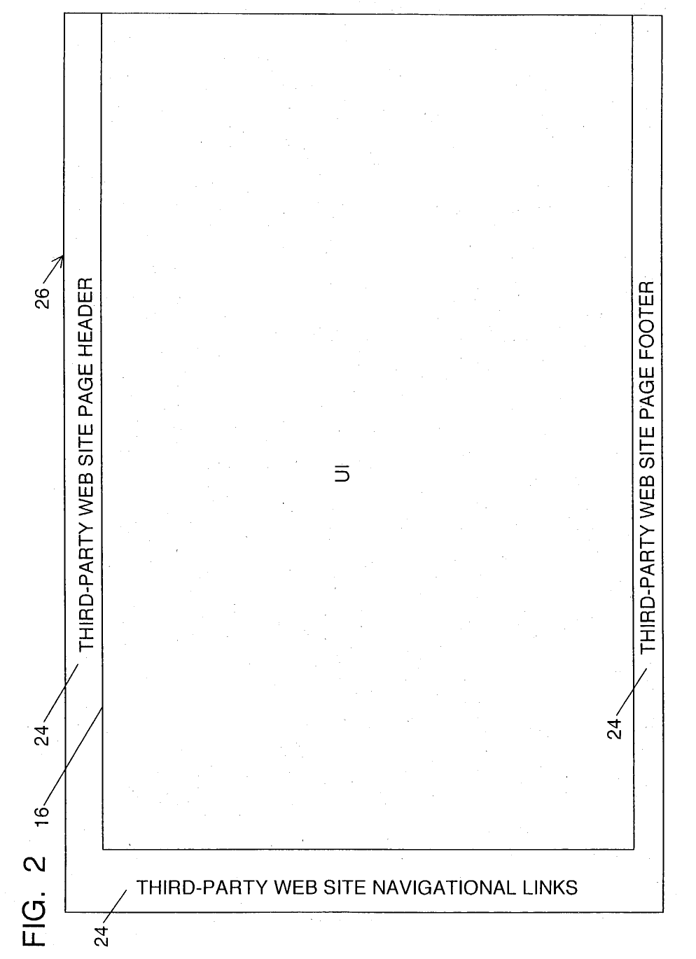

Referring now to FIG. 2, one embodiment of a medical information sharing system embeds the UI 16 of the system 10 within the context and with the design elements 24 of a third-party website 26 such that the UI 16 appears as an integral part of the third-party website 26.

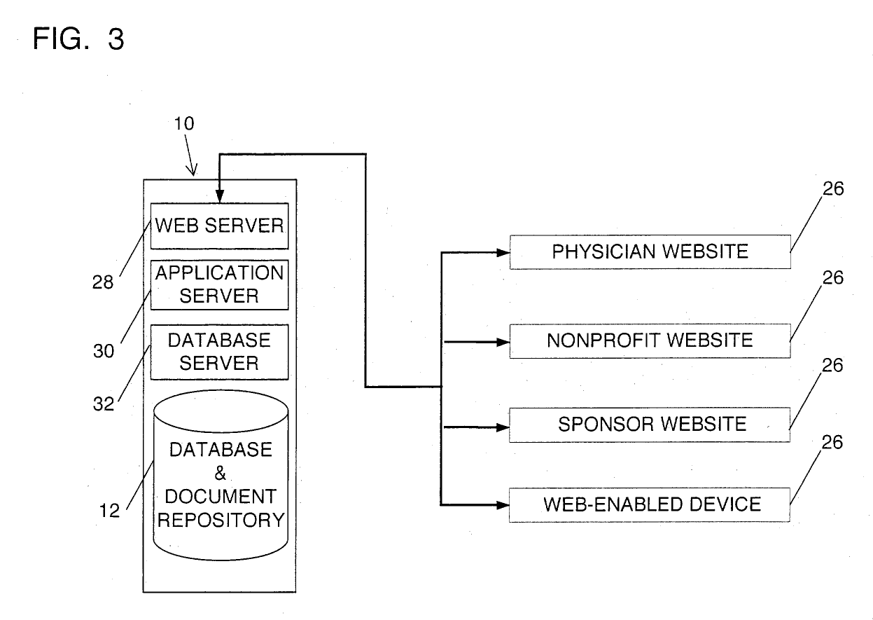

Referring now to FIG. 3, one embodiment of the system 10 is implemented in a standard 3-tier web configuration composed of a web server tier 28 implementing the UI, an application server 30 tier implementing the application and UI logic, and a database tier 32 implementing the database and clinical trials document repository 12. The 3-tier web configuration is well known in those skilled in the art.

In this embodiment, when a user clicks a UI link of the system on a third-party web site 26 the user is directed to a web page residing on the inventor's web server 28 that combined with the application server 30 dynamically includes features and functionality of the third-party site 26. Features and functionality include, but are not limited to, header information and links, navigation bar, and footer information and links (FIG. 2, 24). The user is provided with the look and feel of the partner site and the functionality of the methods and systems of the present invention.

Other embodiments may display the UI of the methods and systems of the present invention within an HTML or XHTML frame on the third-party web site.

Other embodiments may process information from the methods and systems of the present invention, parsing content information and formatting the information for display within the UI of a third-party web site. In these embodiments, the information from the methods and systems of the present invention may be encoded in XML, SGML, or another content encoding.

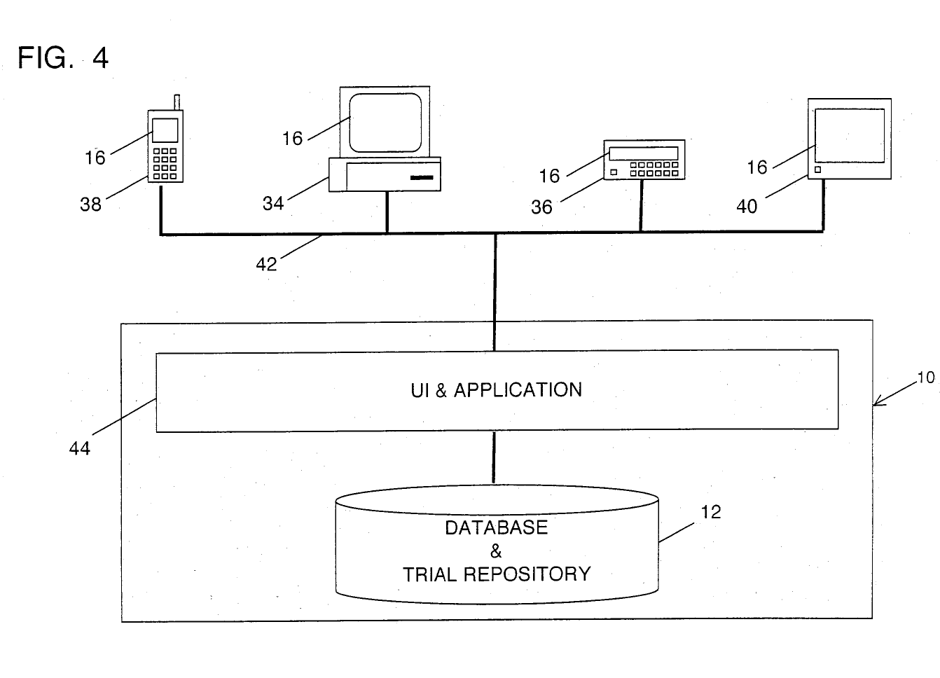

Referring now to FIG. 4, one embodiment of a medical information sharing system lo determines the method of access to the present invention and provides characteristics of a UI 16 presented to a user, one or more functions provided to a user, and a set of clinical trial documents from a document repository 12 accessible to the user in response to the method of access. The method of access may include but is not limited to desktop computer 34, portable computer device (not shown), portable display device 36, portable communication device 38, personal digital assistant 40, information access appliance (not shown), networked kiosk (not shown), and stand-alone kiosk (not shown).

Other embodiments may determine the bandwidth characteristics of the network 42 providing access to the invention and provide a UI 16 presented to a user suitable to the bandwidth available on the network. For example, graphic elements can be omitted or substituted to reduce the time required to transfer UI 16 information from the invention to a display device. Networks include but are not limited to internet, local area network, wide area network, broadband network, and wireless network,

Referring again to FIG. 3 and FIG. 4, one embodiment of a medical information sharing system 10 determines the medical role of a user and provides characteristics of a U′ 16 presented to a user, one or more functions provided to a user, and a set of clinical trial documents accessible to the user in response to the user's medical role. A user's role is determined by the authentication information the user provides to the system 10. Roles include but are not limited to patient, advocate, primary care physician, primary care physician staff, associate physician, associate physician staff, insurance staff, medical agency, medical third-party, clinical trial sponsor, clinical trial investigator, and system administrator.

In other embodiments, a user's role is deduced from the medical focus of the UI 16 through which they access the functions of the system 10.

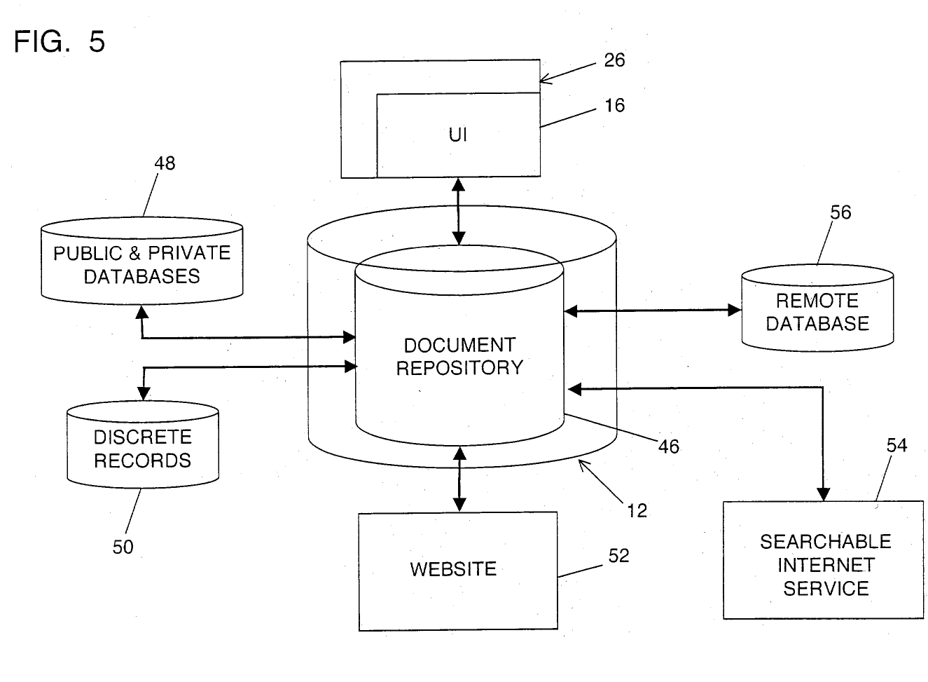

In one embodiment of a medical information sharing system 10 of the present invention, database 12 includes a repository of clinical trial documents populated from various data sources. Referring now to FIG. 5, a document repository 46 includes at least one clinical trial document gathered from at least one data source. The documents gathered are aggregated into a document repository 46 with a unified data structure and format.

In one embodiment, a document repository 46 is populated with the most current and comprehensive trial data by using algorithms that apply various criteria to the data sources and the documents that they contain. The criteria includes but is not limited to the frequency with which a query is submitted to the repository, the age of the document in the repository, the source of the trial document, the frequency of source document updates, the depth and breadth of clinical trial data. Clinical trial information is collected from periodic database imports from public and private databases 48, periodic incremental database imports 50, HTML, XHTML, XML, SGML, WAP, i-Mode, BREW, and plain text encoded sources 52 and 54, and remote databases 56. The clinical trial information is ranked and stored in the clinical trial document repository 46 using the criteria.

Similar criteria and other aging information are used to rank the data sources. Documents are imported from public and private trial databases 48, like those maintained by the National Cancer Institute. Documents are imported from discrete data sources including but not limited to pharmaceutical company clinical trial sources 48 and 50, and from data sources available via the public internet 52, 54, and 56.

One embodiment employs a web crawler that searches the internet web sites 52 for clinical trial documents. Web crawler technology is well known in those skilled in the art. Aging and source information about the documents in the repository is maintained in the repository 46 and affects the initiation of searches. When a document is retrieved from a source, the new document is automatically compared with existing documents and the documents are reconciled. The most current and comprehensive data is maintained in the repository. Documents concerning a particular trial may be aggregated from content from multiple documents and from multiple sources.

In one embodiment, clinical trial documents collected, ranked, stored, and searched for can include, but are not limited to, protocol title, rationale, eligibility criteria, treatment, protocol type, trial status, objectives, protocol entry criteria, protocol outline, special study parameters, end points, project accrual, dosage schedule, content provider, trial identification code, investigative site, and investigator name/contact information, disease condition, location of clinical trial, document lay or medical target audience, hospital affiliation of investigative site, available of pre-screen questionnaire, clinical trial contact method, availability of clinical trial help, therapeutic drug, International Classification of Disease Number, Diagnostic and Statistical Manual of Mental Disorders classification, histopathological disease classification, gene expression, investigator specialty, document source, or insurance company covering trial treatment.

Other embodiments of the present invention may use an administrator's subjective opinion to rank the clinical trial data sources and the clinical trial documents.

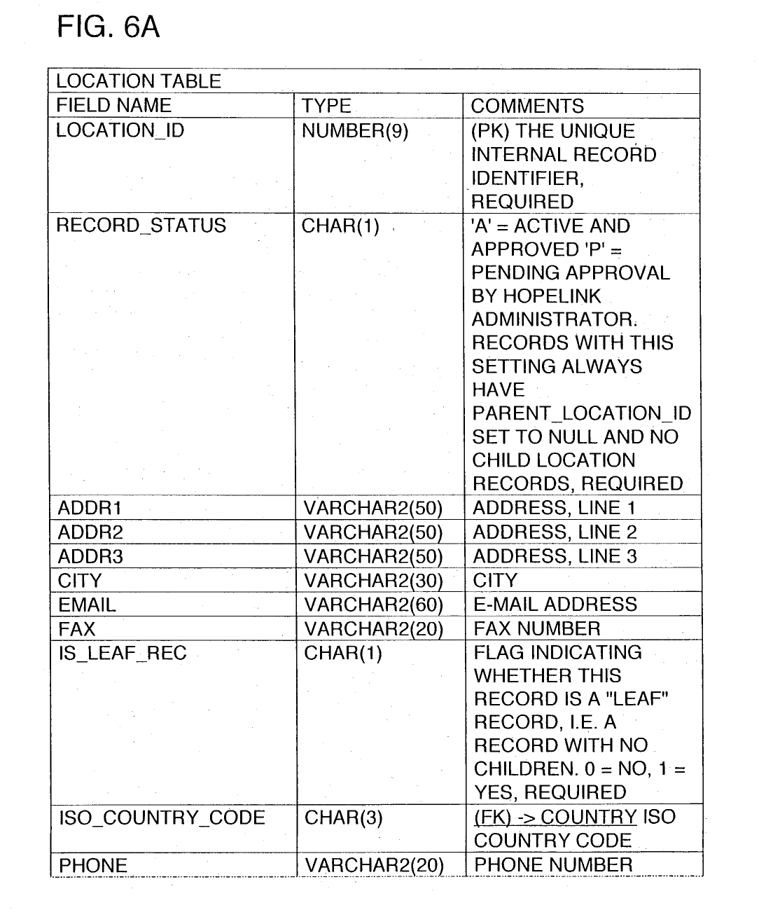

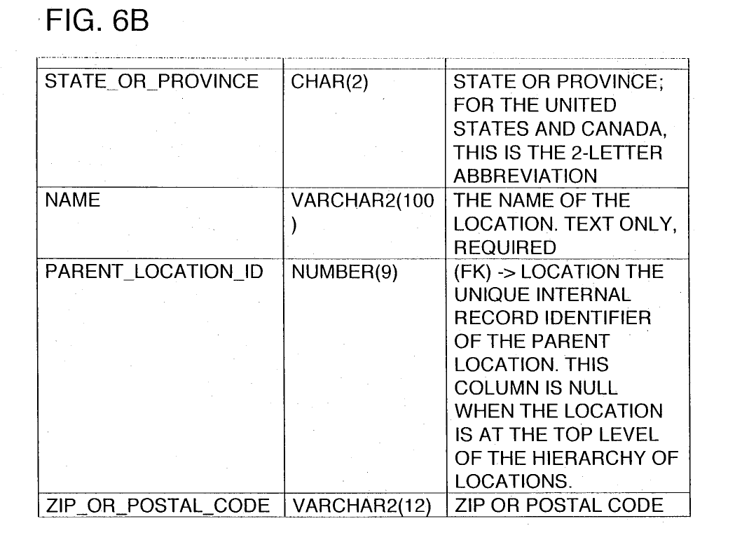

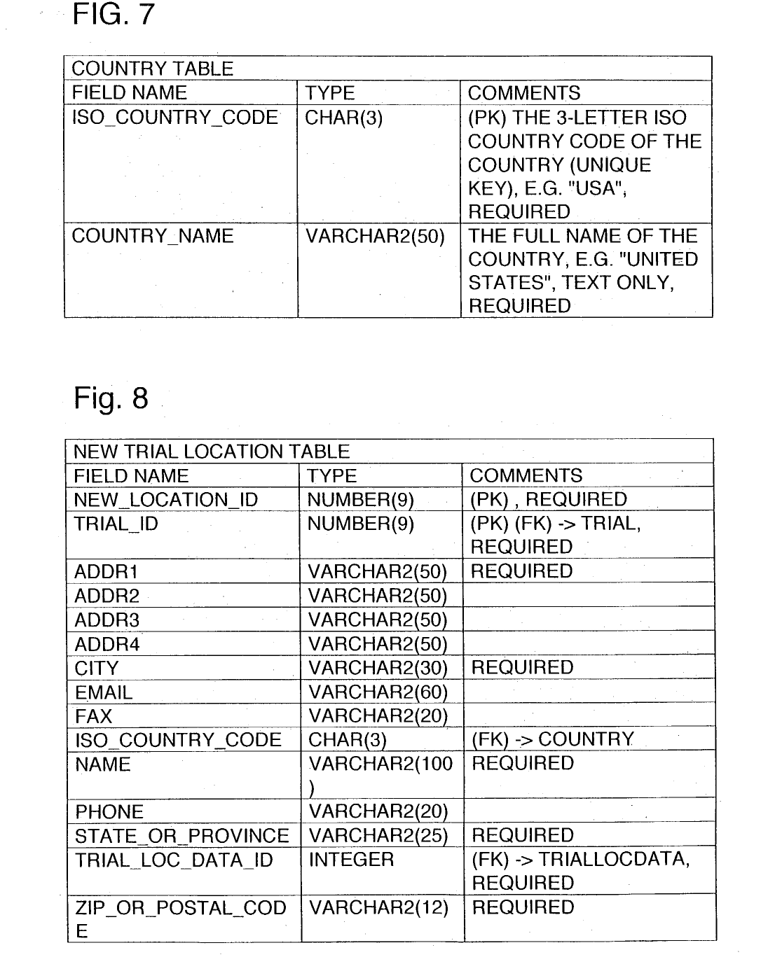

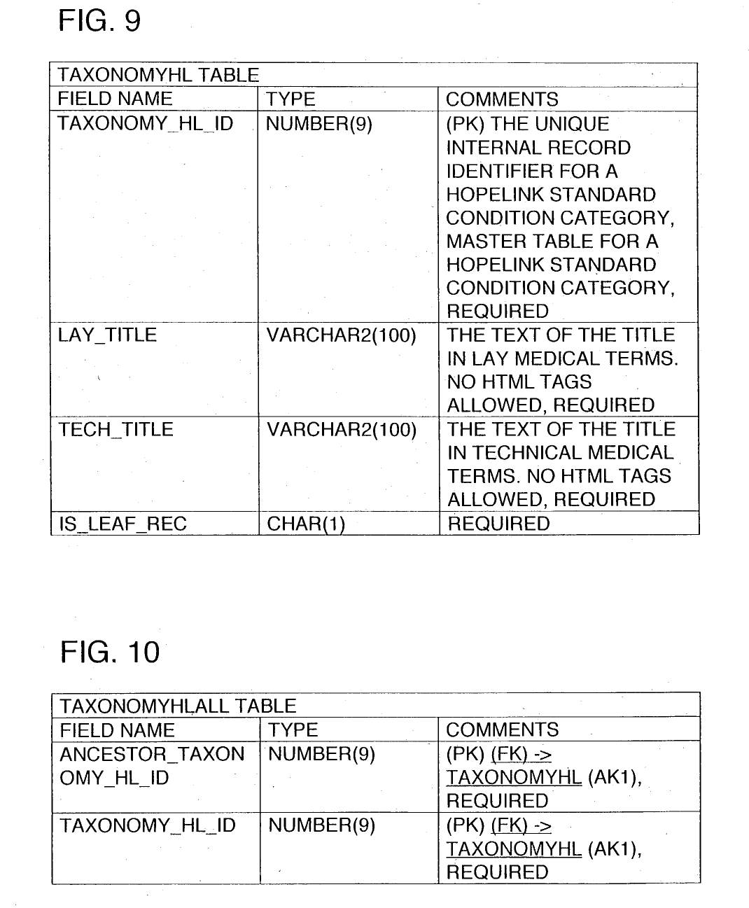

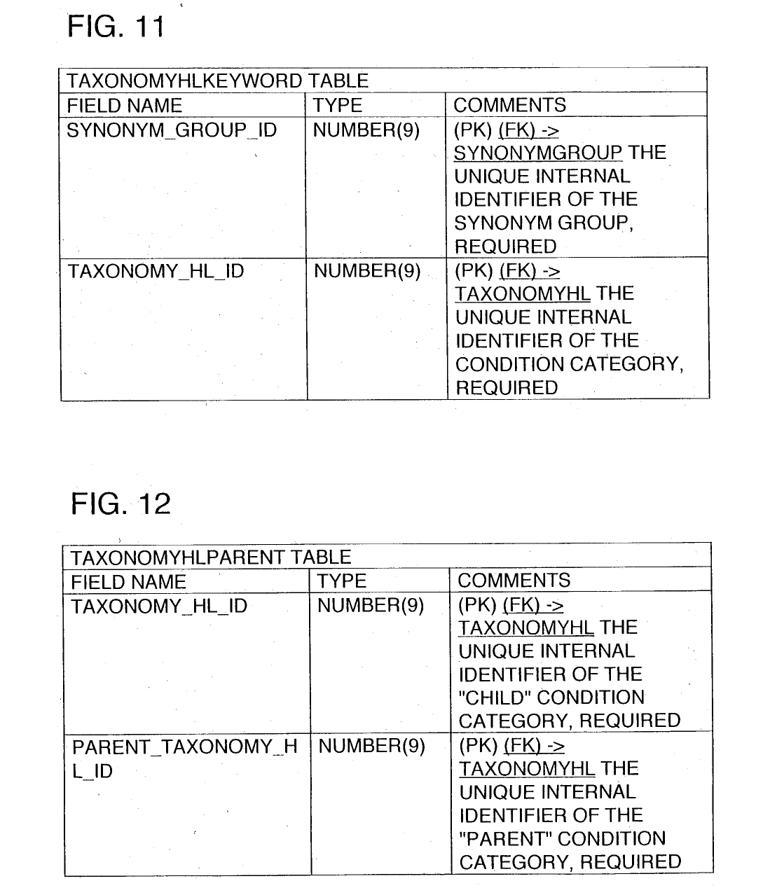

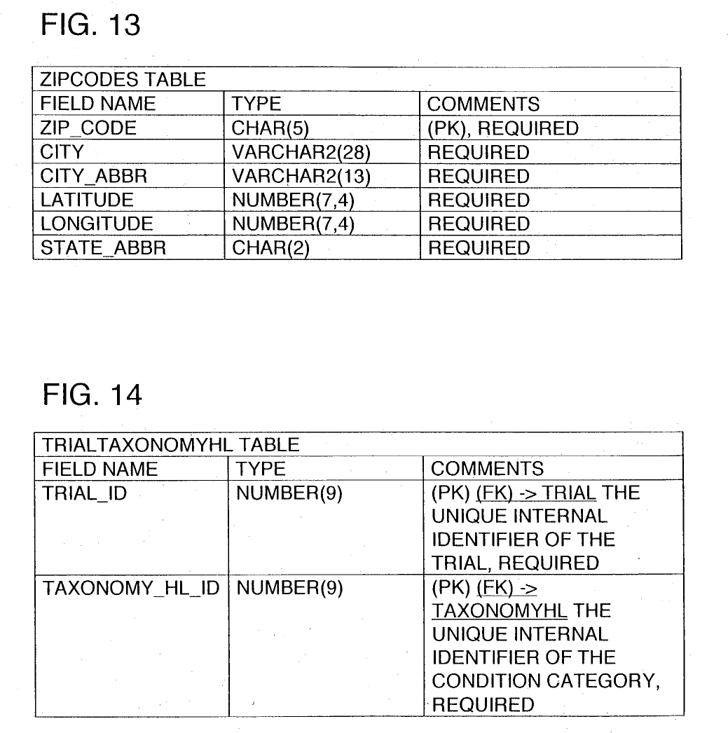

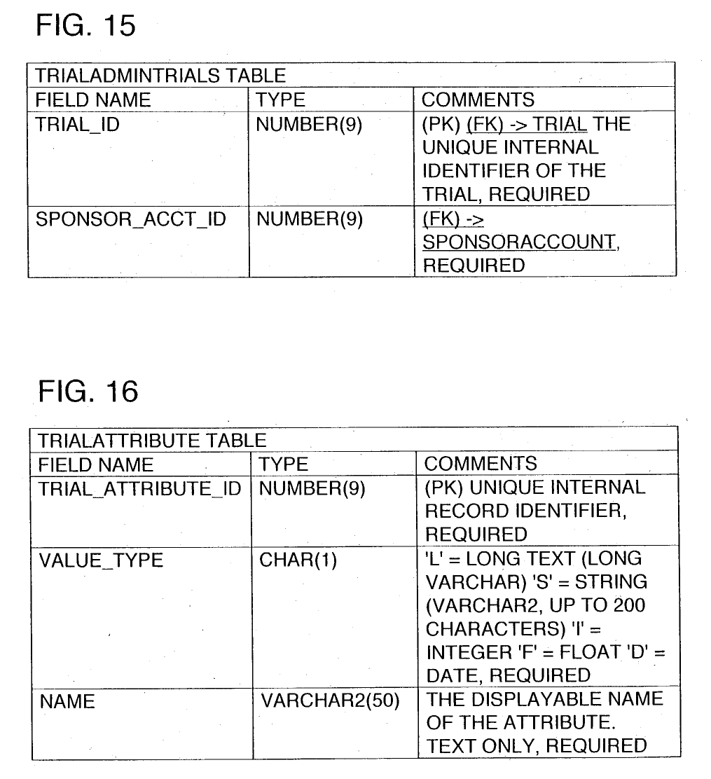

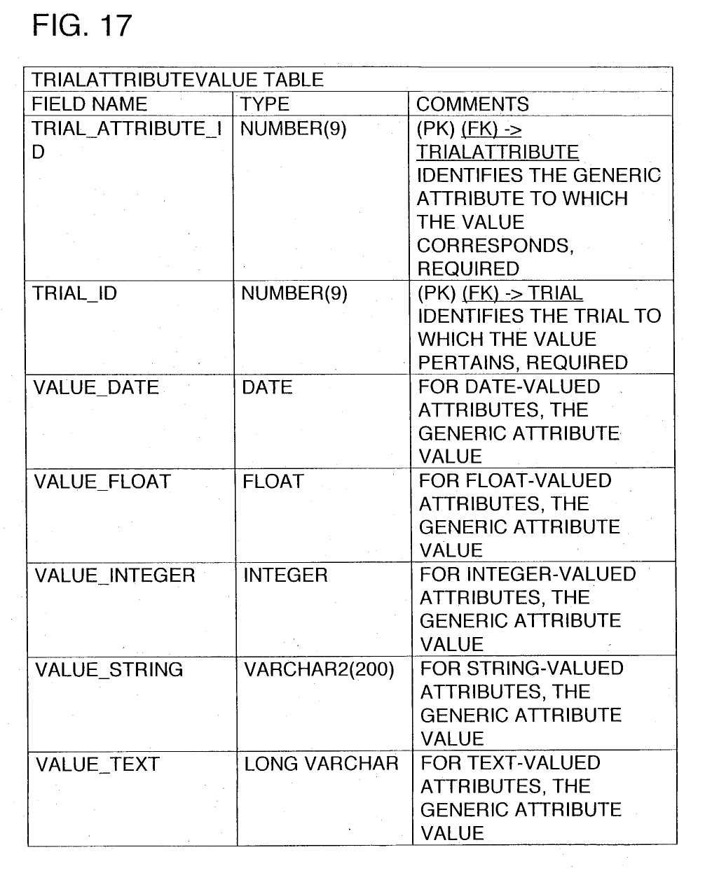

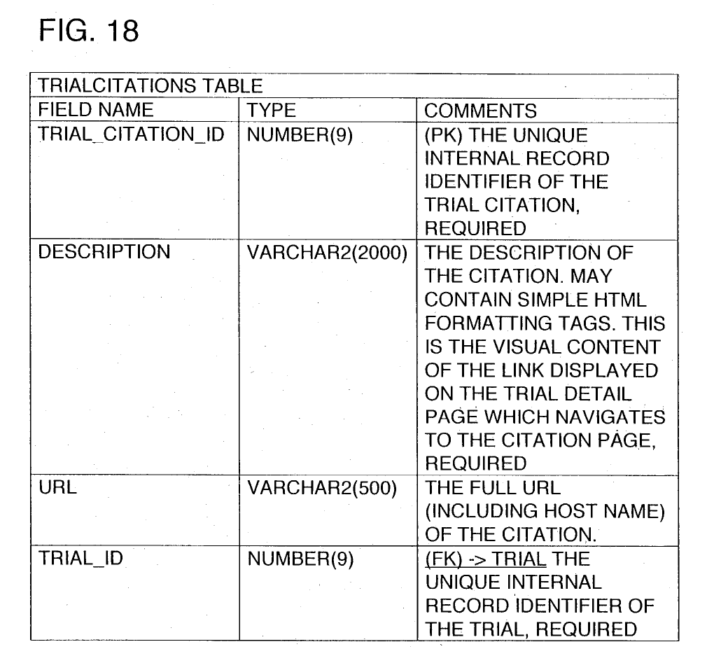

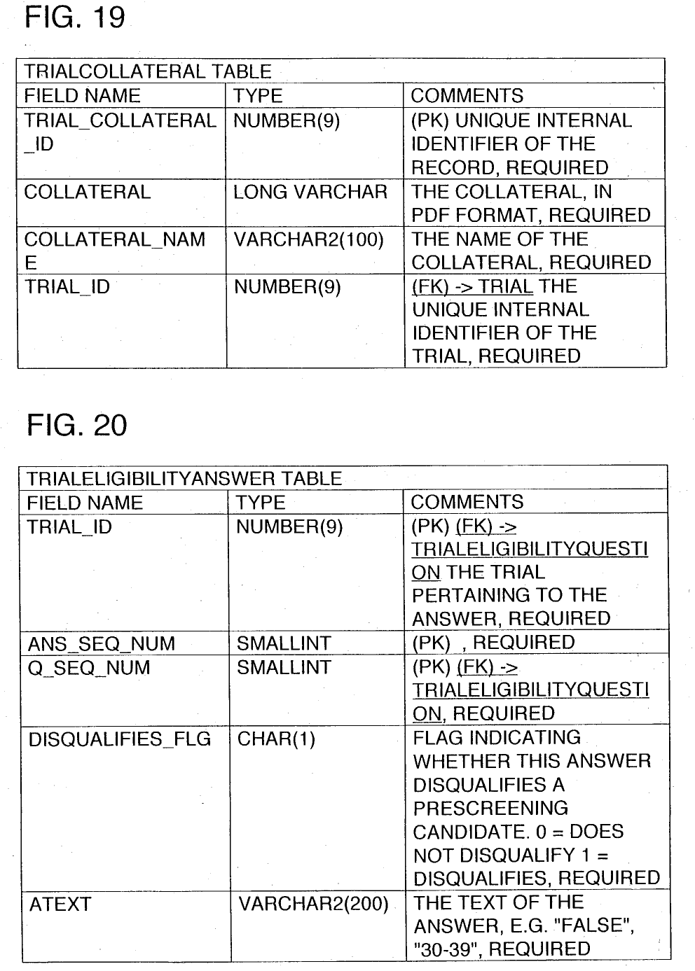

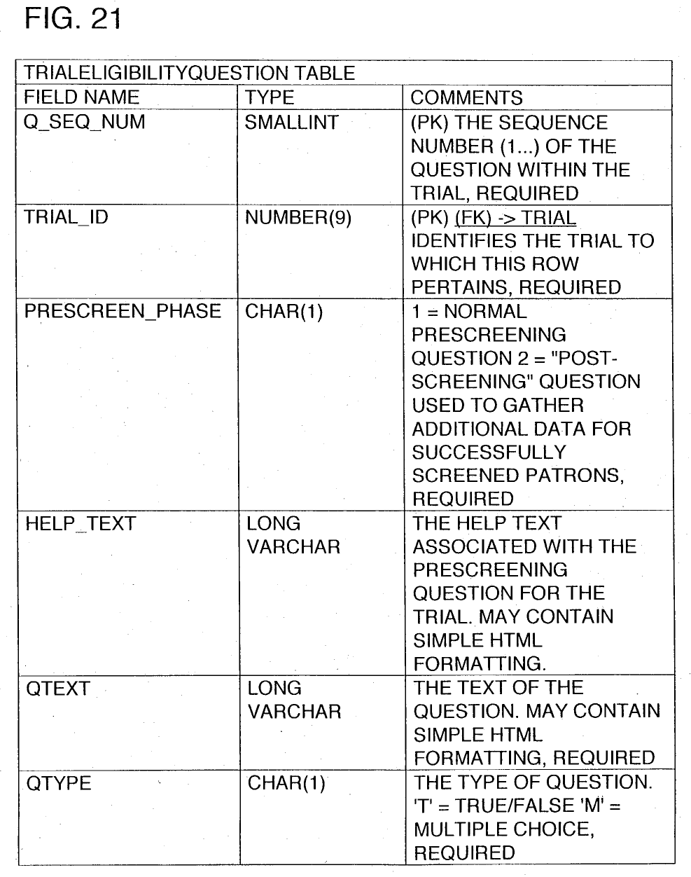

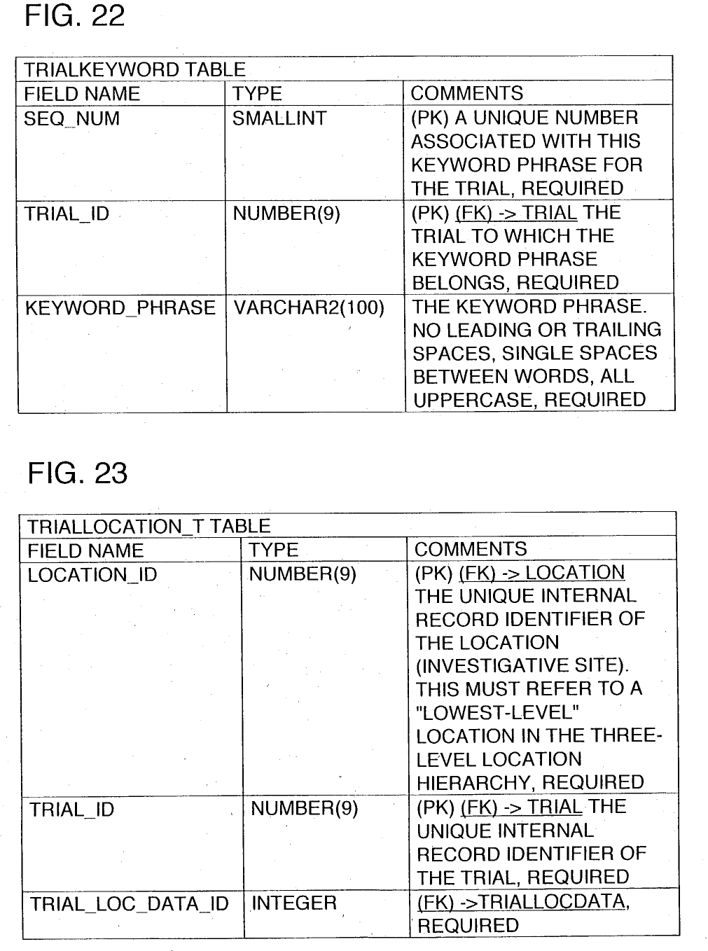

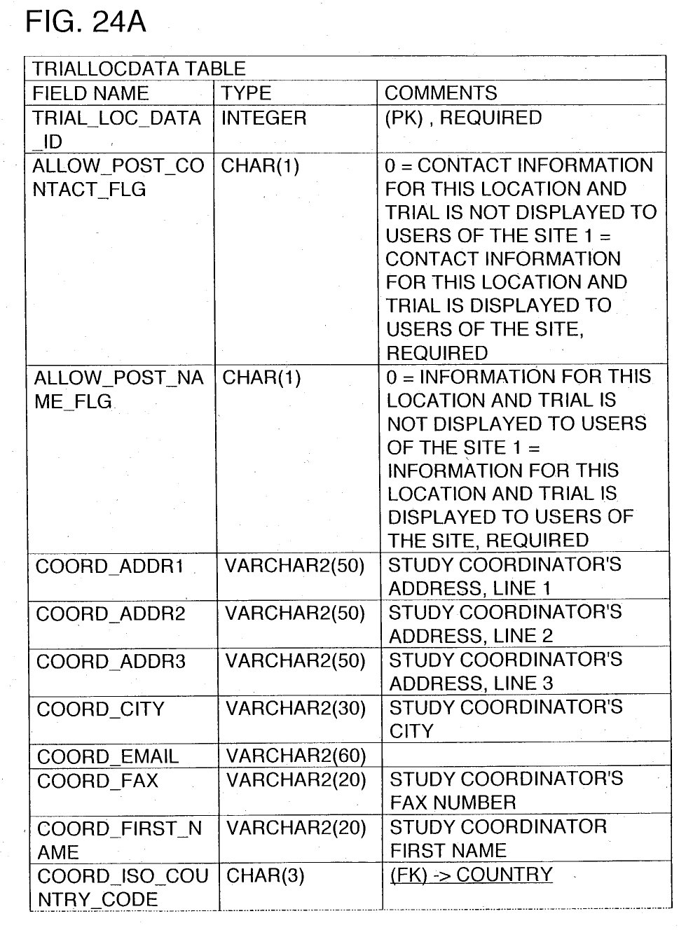

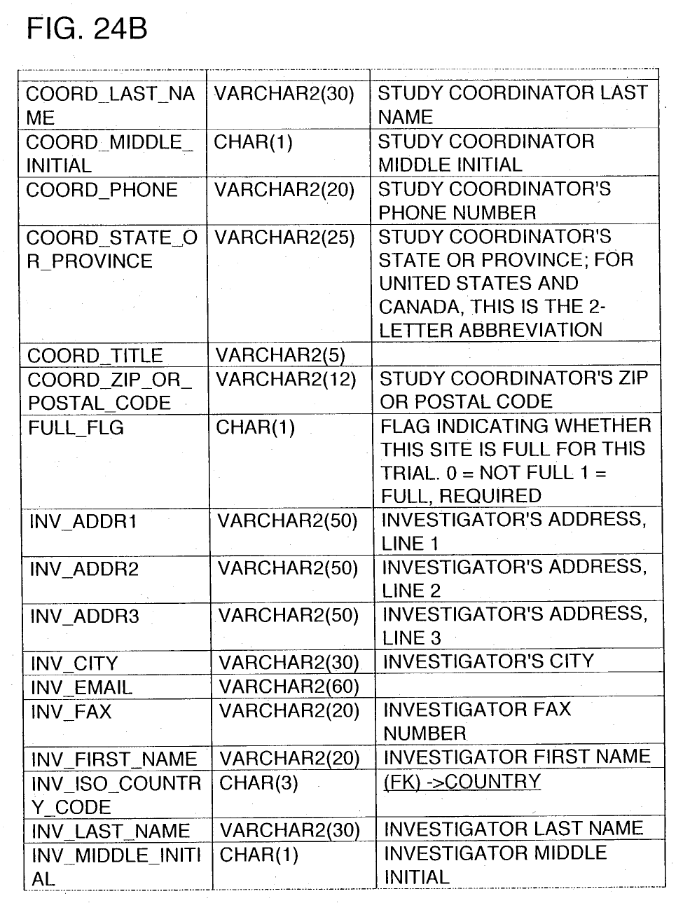

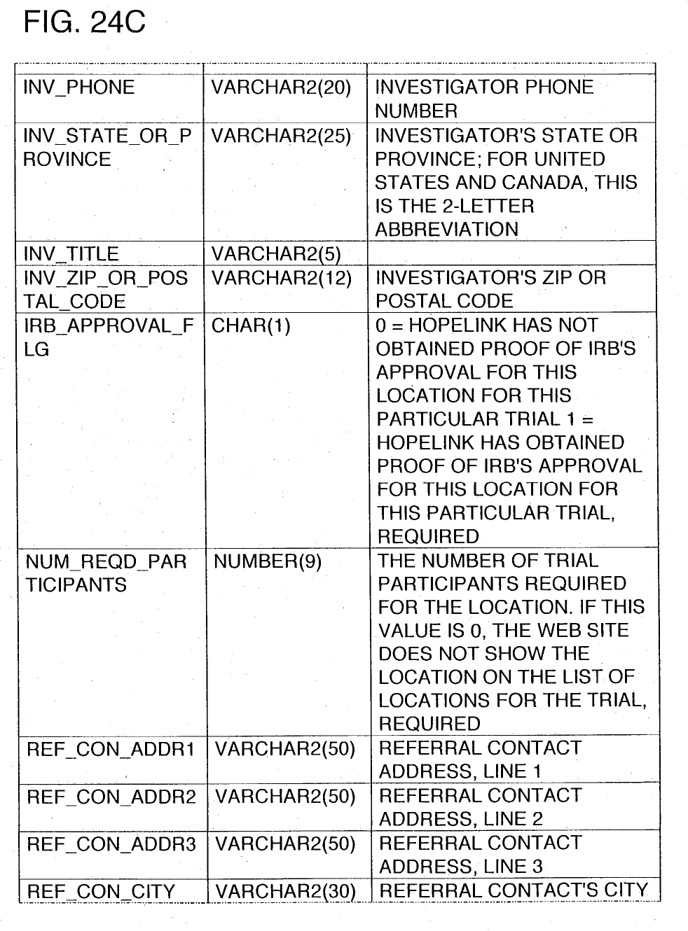

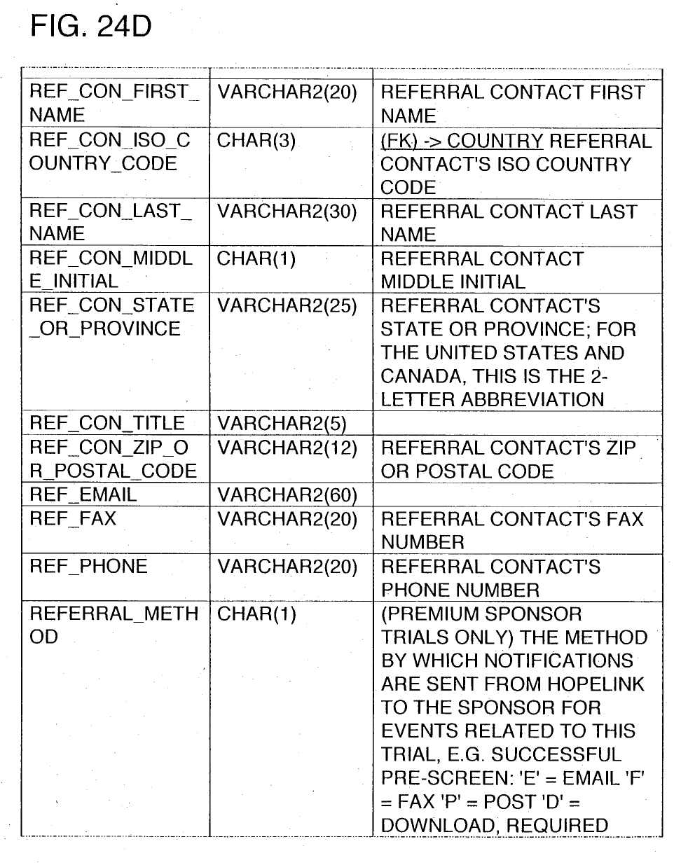

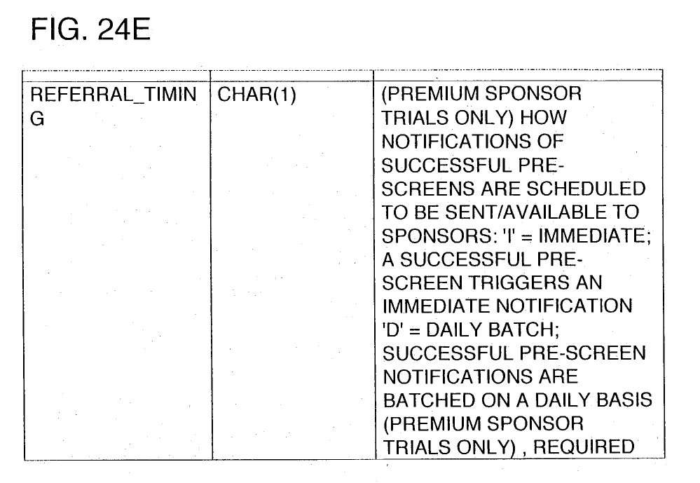

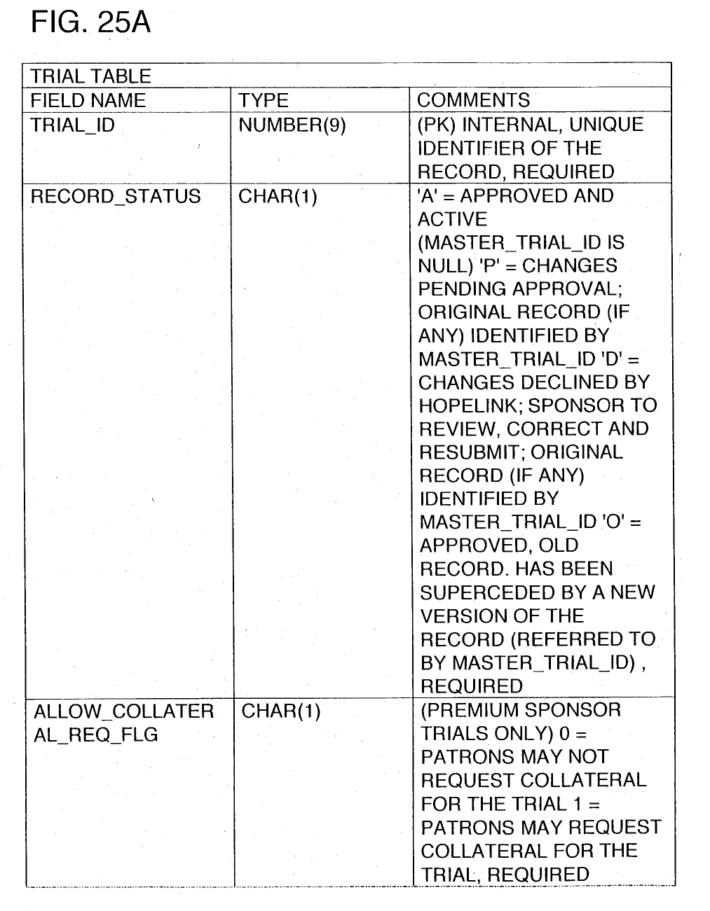

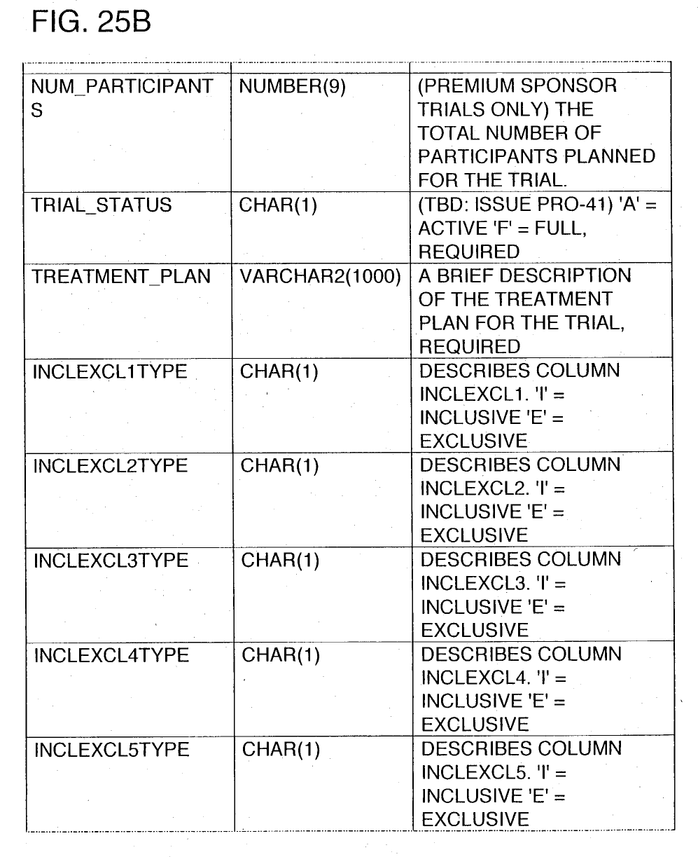

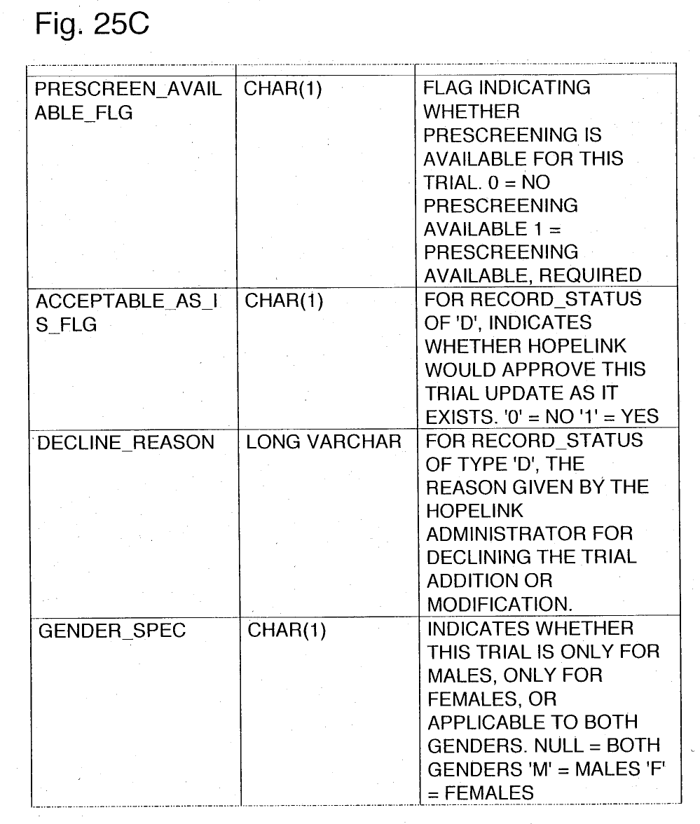

FIGS. 6 through 25 illustrate the database tables for one embodiment of a document repository 46 of the present invention.

One embodiment of a medical information sharing system includes permission-based data sharing and access of medical and clinical trial information among users. Information shared between users can include, but is not limited to, clinical trial descriptions, clinical trial protocols, clinical trial process documents, medical records, medical test results, medical research data, HCP records, medical billing records, medical payment records, and medical insurance records. For example, a user may choose to share all of their personal medical information with their physician, but may choose to share only a portion of their information with a medical insurer who is calculating coverage. In this example, both physician and insurer are granted access to data that is directly associated with and identifies a specific person. In another example a patient participating in a clinical trial may share a portion of their personal medical information with the trial investigator, but may share only data that does not provide an identification of the patient with the trial sponsor. In this example, the trial investigator is granted access to identifying data, but the clinical trial sponsor receives data that cannot be linked to a specific person.

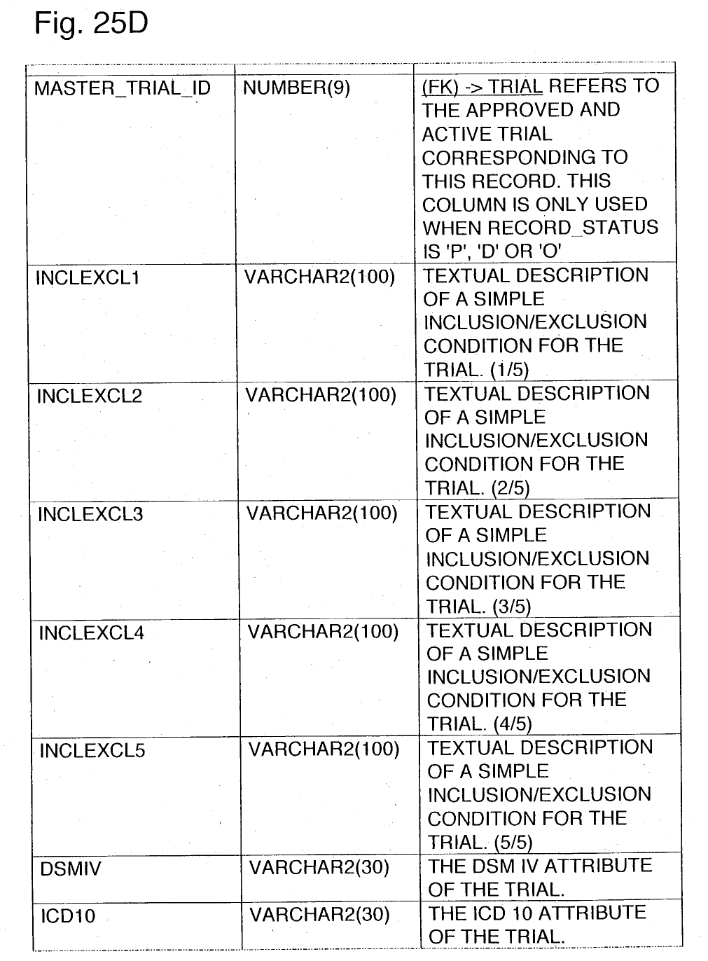

Referring now to FIG. 26, one embodiment of a medical information sharing system 10 of the present invention includes software and hardware 58 that provides authentication of a user. The system 10 may further include software and hardware 60 that stores, verifies, and communicates user privileges and permissions to share and access information. Further still, the system 10 may include software and hardware 62 that provides exchange of medical information between users. The embodiment of the system 10 may also include software and hardware 64 that provides anonymous message routing between users. Additionally, the system 10 may include software and hardware 66 that provides an audit history of the sharing, access, and exchange of information within the system 10 and among users of the system 10. The system 10 may also include a document repository 46 containing clinical trial information for at least one clinical trial.

In one embodiment, an information sharing and access client provides a user or third-party system with access to the medical information sharing system of the present invention. Referring again to FIG. 26, a client 68 within a medical information sharing system 10 and coupled to a UI 16 provided by the system 10, can provide users with sharing and access of information via a third-party website or access device 26 via a network 42.

In this embodiment, a client 70 may also be incorporated as a component part of a third-party information system 72 to provide sharing and access to a user mediated by the software, hardware, and UI components 74 of a third-party information system 72.

Further, a client 76 may also be implemented as software residing in an computer device 78. Computer devices include but are not limited to desktop computer, portable computer device, portable display device, portable communication device, personal digital assistant, information access appliance, networked kiosk, and stand-alone kiosk. In these embodiments, the client 76 may also provide the UI 80 for sharing and access to the medical information sharing system 10 of the present invention.

Clients communicate with other clients and functions of the medical information sharing system of the present invention by a network 42. Suitable networks 42 include but are not limited to internet, local area network, wide area network, broadband network, and wireless network.

In other embodiments, a client 82 may be incorporated as a component part of a third-party medical database 84 to provide user with sharing and access of medical data contained in the database 84.

In other embodiments, communication between clients may be encrypted for privacy and security. Suitable encryption mechanisms include but are not limited to PKI, WTLS, SSL, S/MIME, VPN, and IPSec.

In one embodiment of the present invention, clients share and access information directly with other clients by a peer to peer networking system and protocols. Peer to peer communication among clients provides significant advantages in the ease in which a client can be deployed and avoids centralized bottlenecks to communication between clients. However, peer to peer communication inefficiently uses communication bandwidth to discover and identify other clients that can provide access or sharing of information. Because of this limitation, peer to peer communication does not scale well to large numbers of clients. Embodiments providing one or more support servers to facilitate access or sharing of information and also peer to peer communication among clients provide better performance and use of communication bandwidth than those that do not.

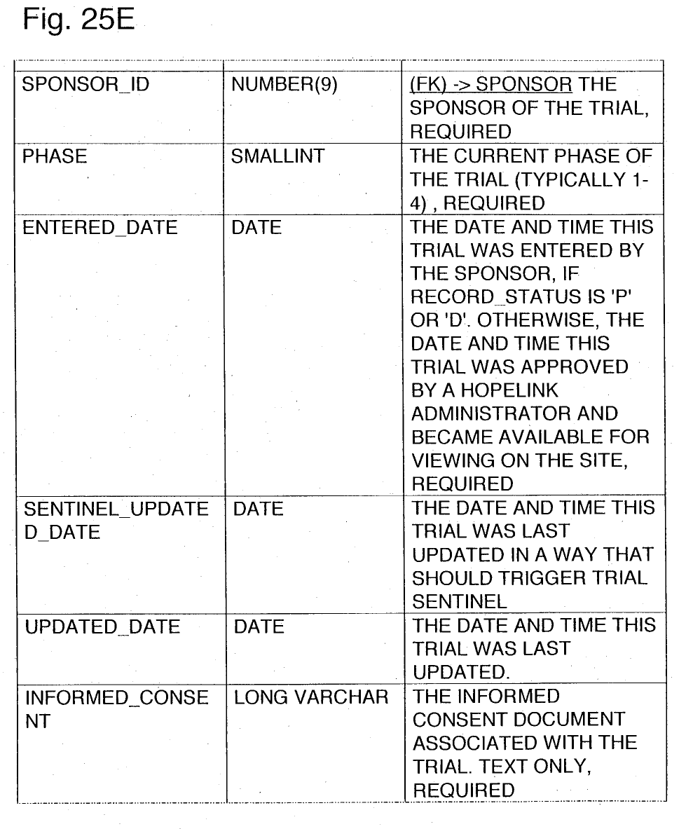

Referring now to FIG. 27, one embodiment of a medical information sharing system 10 of the present invention at least two clients 68, 70, and 82 coupled by a network 42 and peer to peer communication protocols. Network based peer to peer communication and protocol is well known in those skilled in the art.

The system 10 includes an authentication server 84 that provides authentication of the validity and identity of users and clients sharing and accessing medical information.

In various embodiments, a permissions server 86 stores, verify, and communicate user privileges and permissions to share and access information. In these embodiments, a document server 88 may provide exchange of medical information between peer to peer clients 68, 70, and 82. Further, a routing server 90 may provide anonymous message routing between clients.

Additionally, the system 10 may include an audit server 92 that maintains an audit history of the sharing, access, and exchange of information within the system 10 and among users and clients of the system 10 of the present invention.

In another embodiment of the present invention, a client may maintain an audit history of information shared and accessed by the client. A client's audit information may be maintained locally by the client, or by an audit server 92 that provides logging and history services for multiple clients and servers within the system.

In various embodiments of the present invention, the system can provide secure authentication of users compliant with HIPAA, CFR part 11, and ICH from any UI. A user provides authentication information to the system that uniquely identifies the user. Multiple authentication mechanisms may be used including user ID and password combination, as well as various means of electronic authentication including digital certificate, digitally encoded smart card, digitally encoded browser cookie, and digitally encoded dongle. In embodiments of the methods and systems of the present invention where user ID and password authentication is provided, passwords are at least 6 characters in length and contain at least one alphabetic character and at least one non-alphabetic character. In these embodiments, password information may be encrypted within the medical information system.

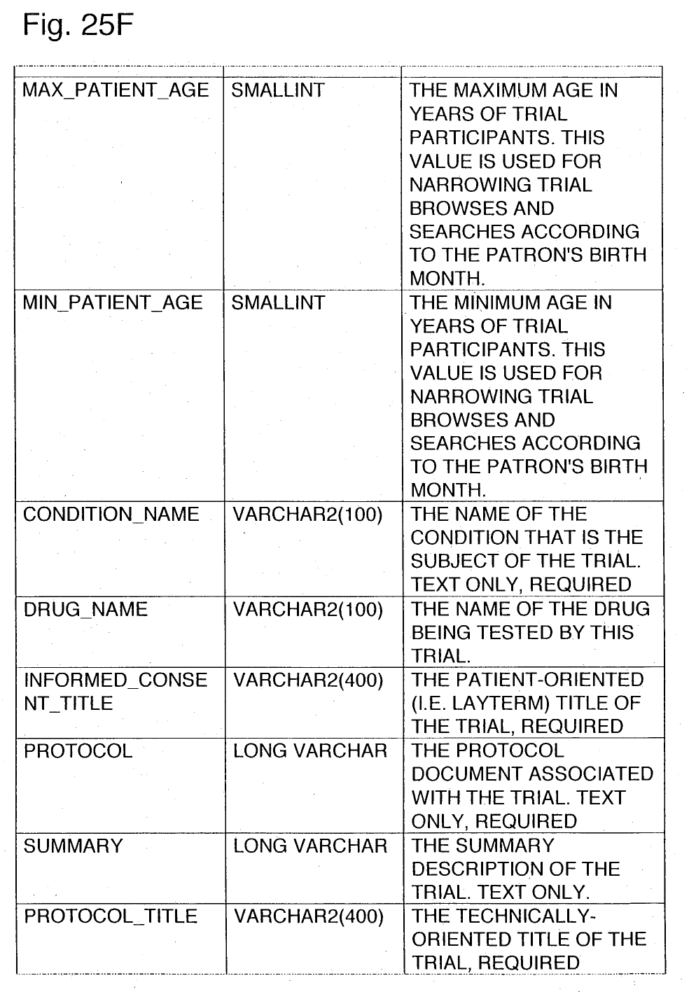

Referring now to FIG. 28, the methods and systems of the present invention include at least one authentication server 84 to provide validation of the identity of a user based on authentication information supplied to the system by a user through a client and coupled to a network 42. Clients, document servers, and other servers in the system 94 query an authentication server 84 with a user's authentication information to verify the identity of the user.

In other embodiments, an authentication server 84 may provide identifying information about the user including name, contact information, and social security number to clients and servers in the system.

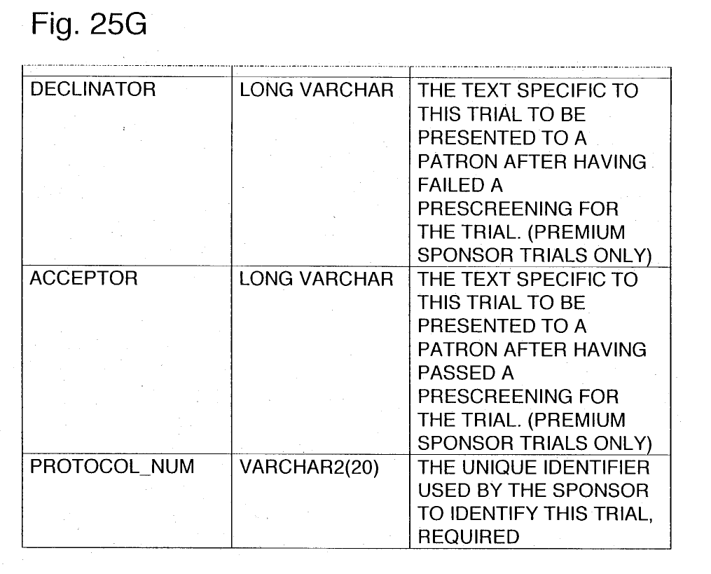

Referring now to FIG. 29, an authentication server 84 may be combined with at least one other system server 96 in the same physical hardware. An authentication 84 server may be implemented by multiple clustered or distributed servers, each providing a portion of the authentication function. An authentication server 84 can maintain an audit history of transactions that the authentication server processes. The audit information may be maintained locally by the server, or by an audit server (FIG. 27, 92) that provides logging and history services for the authentication server 84.

In certain embodiments, the portion of information that a user can share with other users is restricted by the user's permissions. Similarly, the portion of user information that a user can access is restricted by the user's privileges. The scope of permissions and privileges available to a user is defined and constrained by the user's role of the present invention.

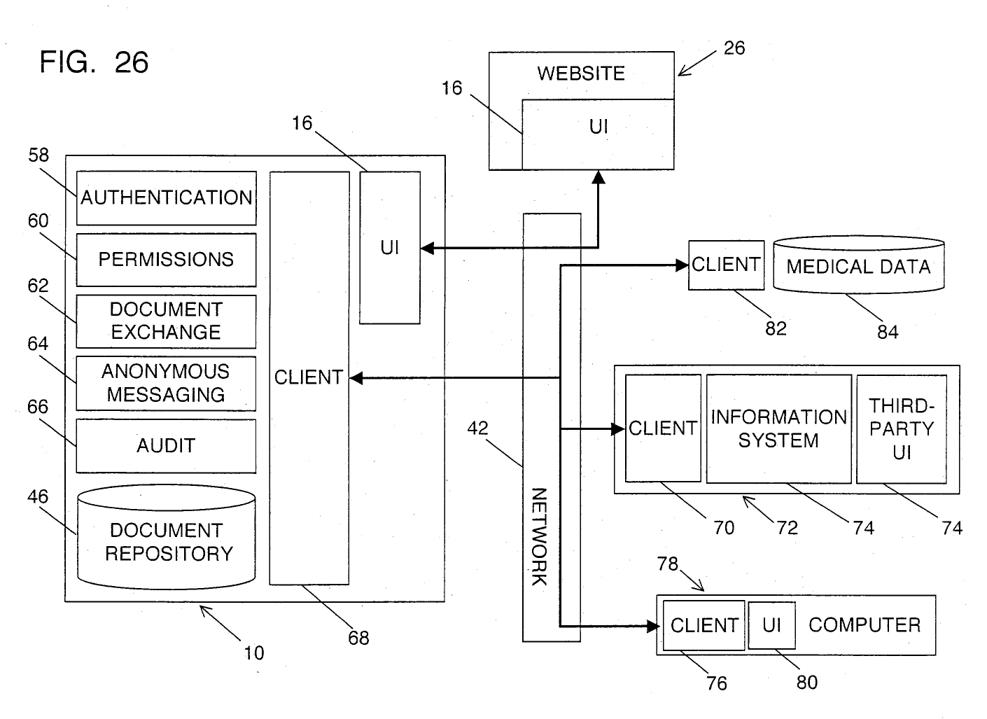

Referring now to FIG. 30, one embodiment of the present invention includes at least one permissions server 86 coupled to a network 42. Permission server 86 includes a database 98 of permission and privilege information. Information sharing permissions include permission to create a data entity, to view a data entity, to modify a data entity, to delete a data entity, and modify the role permissions of a data entity. Information access privileges include privilege to create a data entity, to view a data entity, to modify a data entity, to delete a data entity, to modify the role permissions of a data entity, and the like.

In other embodiments the permissions and privileges specify a user's ability to share information accessed from system users with at least one third-party user. The permissions and privileges also specify a length of time information accessed from system users is retained by a user.

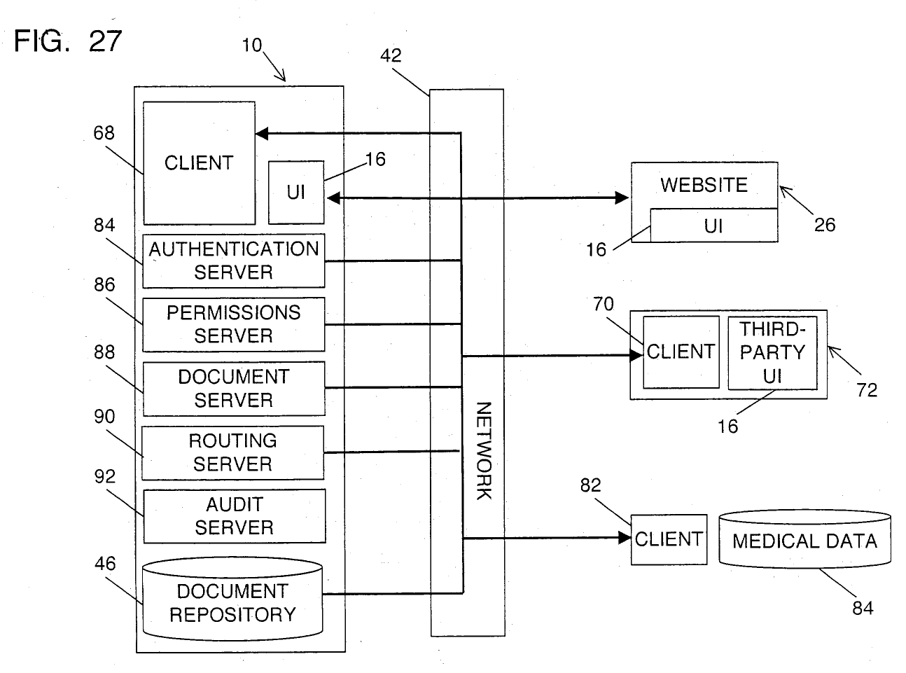

Referring now to FIG. 31, in other embodiments a permissions server 86 is combined with at least one other system server 96 in the same physical hardware.

In various embodiments of the present invention, a permissions server 86 is implemented by multiple clustered or distributed servers each providing a portion of the permissions function. A permissions server 86 may also be implemented by a proprietary permissions standard, and standards including the X.500 directory standard, Directory Access Protocol (DAP), and Lightweight Directory Access Protocol (LDAP) standard.

In other embodiments, communication between a permission server 86, a client and other servers 94 within the system is encrypted. Suitable encryption mechanisms include but are not limited to PKI, WTLS, SSL, S/MIME, VPN, and IPSec.

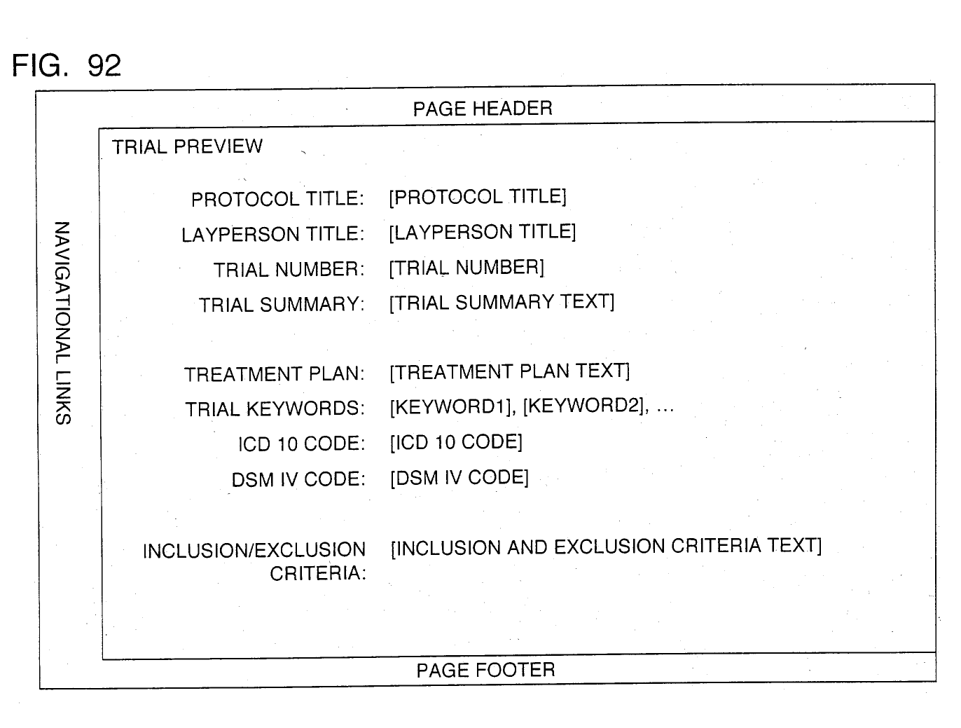

In other embodiments, a permissions server 86 maintains an audit history of transactions that the permissions server 86 processes. The audit information may be maintained locally by the permissions server 86, or by an audit server (FIGS. 27, 92) that provides logging and history services for the permissions server 86.

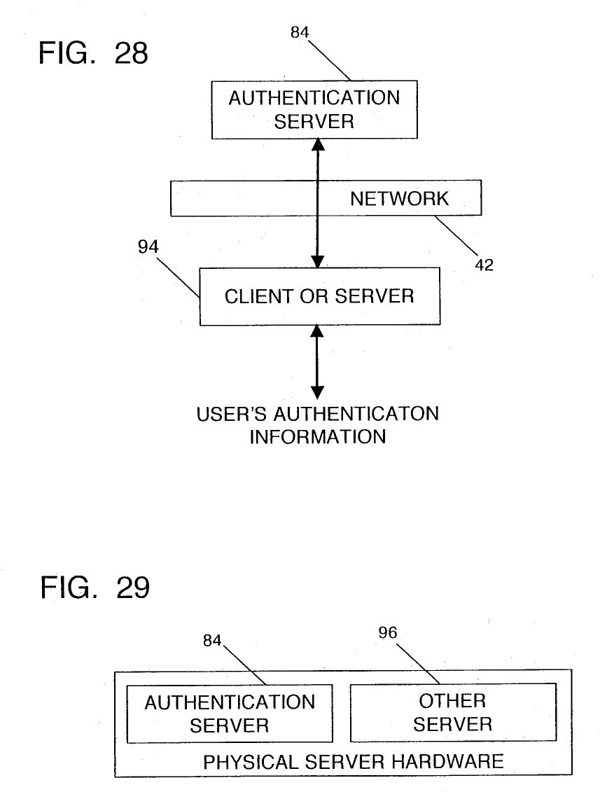

Referring now to FIG. 32, one embodiment of the present invention includes at least one routing server 90 to provide anonymous exchange of information between users and coupled to a network 42. A routing server 90 accepts information addressed to at least one third-party user from a user via a client 70. The routing server 90 removes the user's identifying information and replaces the user's information with information identifying the routing server 90 as the sender, and a unique transfer identifier. With the user's identifying information removed, the information transfer is be completed with the third-party user anonymously with respect to the user. The routing server 90 retains a record of the transfer 100, including information identifying the user and the unique transfer identifier. This log information can be maintained indefinitely or for a defined length of time.

The routing server 90 then completes the information transfer with one or more third-party users. A third-party user receives the information with no knowledge of the user initiating the exchange. To reply to the user, a third-party user responds to the routing server 90, including the unique transfer identifier in the information transfer. The routing server 90 matches the unique transfer identifier with it's record of previous transfers 100 to recover the user's identification information. The routing server 90 then forwards the reply to the user.

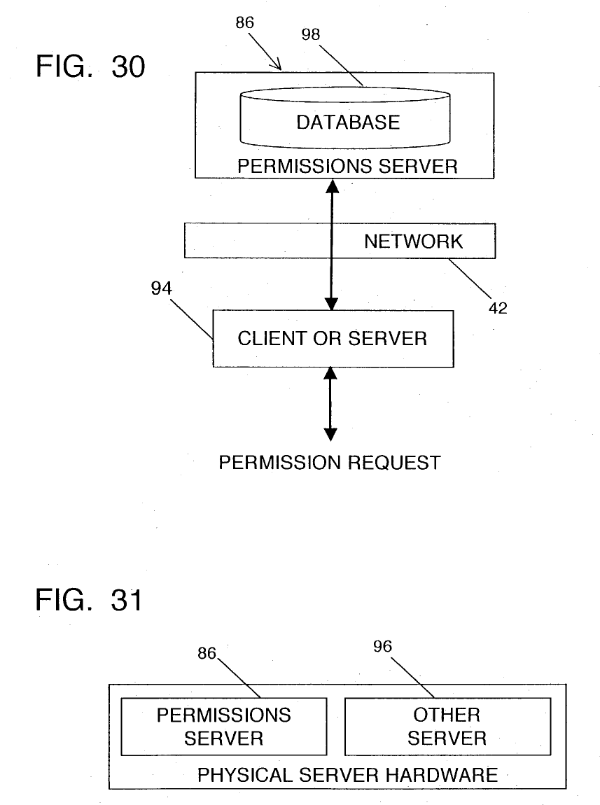

Referring now to FIG. 33, in other embodiments a user provides authentication information to a routing server 90. In these embodiments, a routing server 90 then verifies the identity of the user by an authentication server 84. A routing server 90 may also verify the permissions of the user by a permissions server 86.

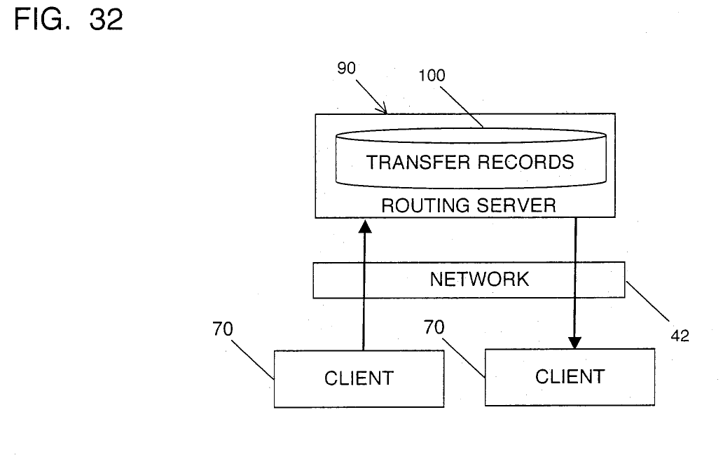

Referring now to FIG. 34, in other embodiments a routing server 90 is combined with at least one other system server 96 in the same physical hardware.

In various embodiments, a routing server 90 is implemented by multiple clustered or distributed servers, each providing a portion of the routing function. A routing server 90 can may be implemented by a server employing standard messaging protocols including but not limited to Simple Mail Transfer Protocol (SMP), Post Office Protocol (POP), Internet Message Access Protocol (IMAP).

In other embodiments of the present invention, communication between a routing server 90, a client, and other servers 94 is encrypted. Suitable encryption mechanisms include but are not limited to PKI, WTLS, SSL, S/MIME, VPN, and IPSec.

In other embodiments, a routing server 90 maintains an audit history of transactions that the routing server 90 processes. The audit information may be maintained locally by the routing server 90, or by an audit server 92 that provides logging and history services for the routing server 90.

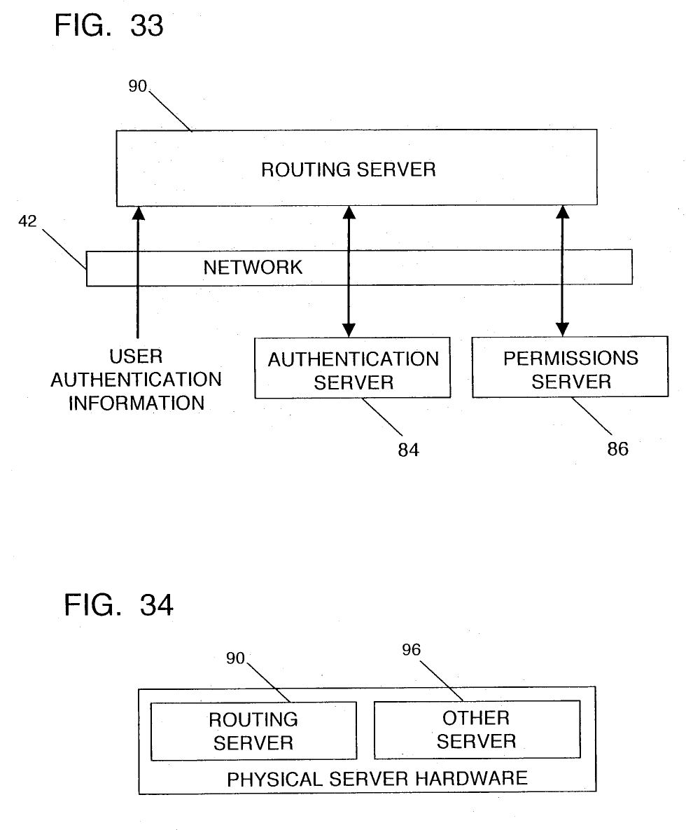

Referring now to FIG. 35, various embodiments of the present invention include at least one audit server 92. In these embodiments, an audit server 92 provide a logging and history services for multiple clients and servers. A database 102 coupled to the audit server 92 records an audit history of accesses by users via clients to medical information.

Information recorded includes but is not limited to the date and time of a user's access to medical information and the user's identity.

In other embodiments, an audit server 92 provides an audit history of accesses a user's shared information by third-party users. Information recorded includes but is not limited to the date and time of the access, the identity of the third-party user accessing the information, and information identifying the accessed information. A user's access to the audit history maintained by an audit server 92 may be constrained by the user's privileges to access the history information. In these embodiments, a permissions server (FIG. 27, 86) may provide the user's privileges to an audit 92 server.

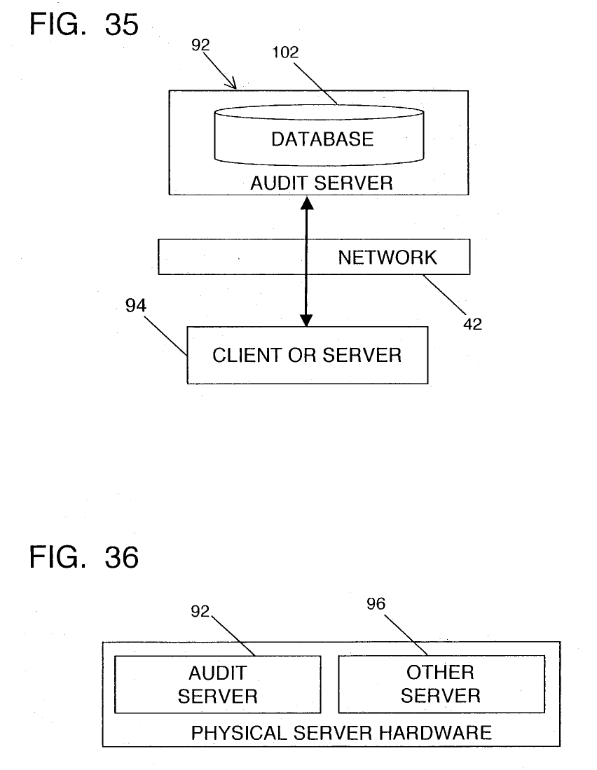

Referring now to FIG. 36, in various embodiments an audit server 92 is be combined with at least one other system server 94. An audit server 92 may also be implemented by multiple clustered or distributed servers, each providing a portion of the audit function.

In other embodiments of the present invention, communication between an audit server 92, and a client and other servers 94 is encrypted. Suitable encryption mechanisms include but are not limited to PKI, WTLS, SSL, S/MIME, VPN, and IPSec.

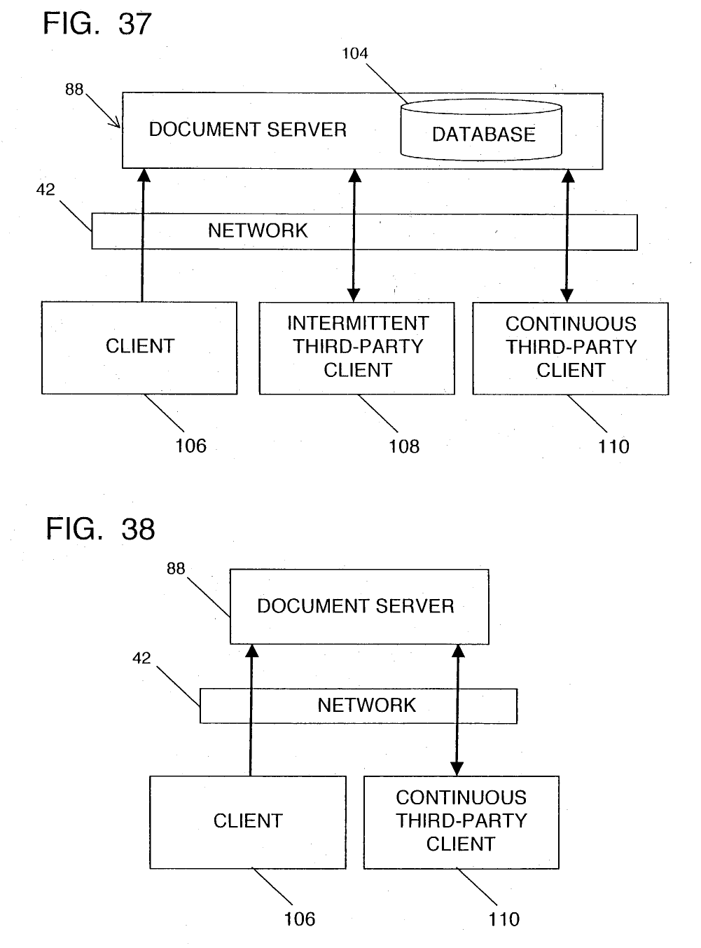

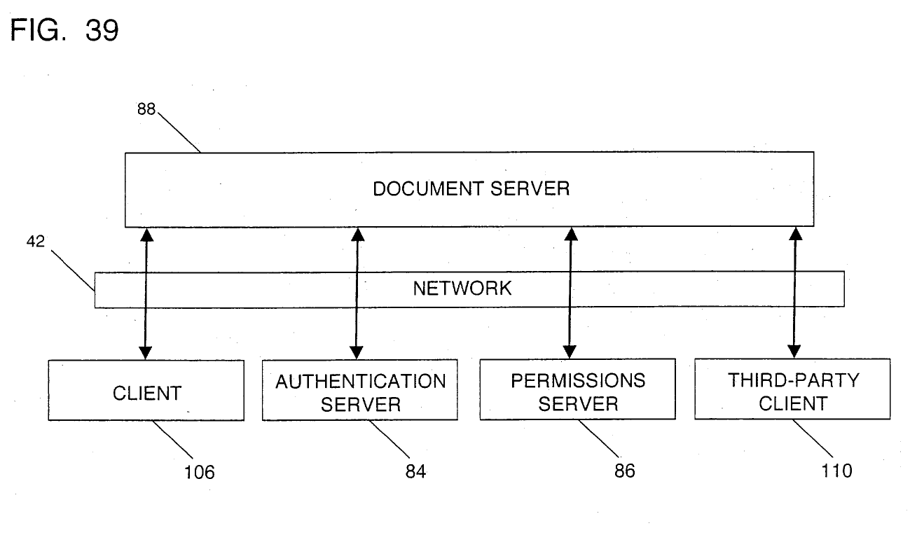

Referring now to FIG. 37, one embodiment of the present invention includes at least one document server 88 to provide an efficient means of exchanging information among users or clients. A document server 88 includes at least one database 104 and is coupled to a network 42. A client 106 periodically registers client and user identifying information with the document server 88. The identifying information is retained for a defined time period in a database104. The identifying information includes but is not limited to a unique identifier identifying a user, a network address of a client, and a date and time of a client's last transaction with the document server. Information present in the document server 88 database 104 older than the defined time period is removed from the database104.

A client 106 accesses a document server 88 to determine the network address and other identifying information of a third-party client 108.

The document server provides the requested information from the database 104 if it is available. If the third-party client 108 information is available in the database 104, the client 106 attempts to establish communication with the third-party client 108 using the information provided by the document server 88. If communication can not be established, or if the document server 88 has no information in the database 104 for the third-party client 108, the client 106 may exchange information with the document server 88 to be retained in the database 104 and to be delivered to a third-party client 108 at a later time. If at some time in the future the third-party client 108 communicates with the document server 88, the document server 88 delivers the retained message and removes it from the database104. If the document server does not deliver the information in within a defined time period, the document server removes the information from the database 104.

A third party client 108 may be intermittently connected to the network 42 or a third party client 110 may be continuously connected to the network 42.

Referring again to FIG. 37, in one embodiment, a user or client specifies the recipient of an information exchange by the identity of a third-party user.

In one embodiment, a document server 88 is be used to store and forward the same information from a sending client 106 to multiple third-party clients108. The document server 88 receives the information to be exchanged, and a list of third-parties to receive the information. Over time, the document server 88 delivers the information to the third-parties when each third-party communicates with the document server 88. Store and forward information exchange is well known in those skilled in the art.

Referring now to FIG. 3 8, in one embodiment, a client 106 transfers information to a document server 88 for delivery to at least one third-party client 110. A third-party client 110 is specified by criteria matching at least one characteristic of a third-party user or a client 110. Matching criteria can include but are not limited to at least one of a document title, if the document is new, date of document updated, a date the document was added in the clinical trial information system, a date the document was updated in the clinical trial information system, document language, medical or lay intended audience of document, if a pre-screen questionnaire is associated with a document, a document source, an International Classification of Disease number, Diagnostic and Statistical Manual of Mental Disorders classification, histopathological disease classification, a disease condition, a location of a clinical trial, a medical organizational affiliation of a clinical trial investigative site, a hospital affiliation of a clinical trial investigative site, a clinical trial enrollment contact information, a clinical trial investigator name, a clinical trial investigator specialty, a clinical trial protocol ID, a therapeutic drug, a gene expression, and an insurance company covering clinical trial treatment.

To receive information based on matching criteria, a third-party client 110 periodically polls a document server 88 for information to receive for a third-party user by criteria associated with the information and matching the third-party client or user. A client polls the document server 88 periodically either at a predetermined interval, or at the time of a third-party user's request to the client to poll the document server 88.

In other embodiments, a third-party client 110 provides matching information to a document server 88. In these embodiments, the document server 88 determines whether an information exchange match exists between a client 106 and a third-party client 110.

In other embodiments, a document server 88 may provide clients with the network address of additional document servers in the medical information sharing system 10.

In other embodiments, a user or client may specify the recipient of an information exchange by a unique identifier of a third-party client.

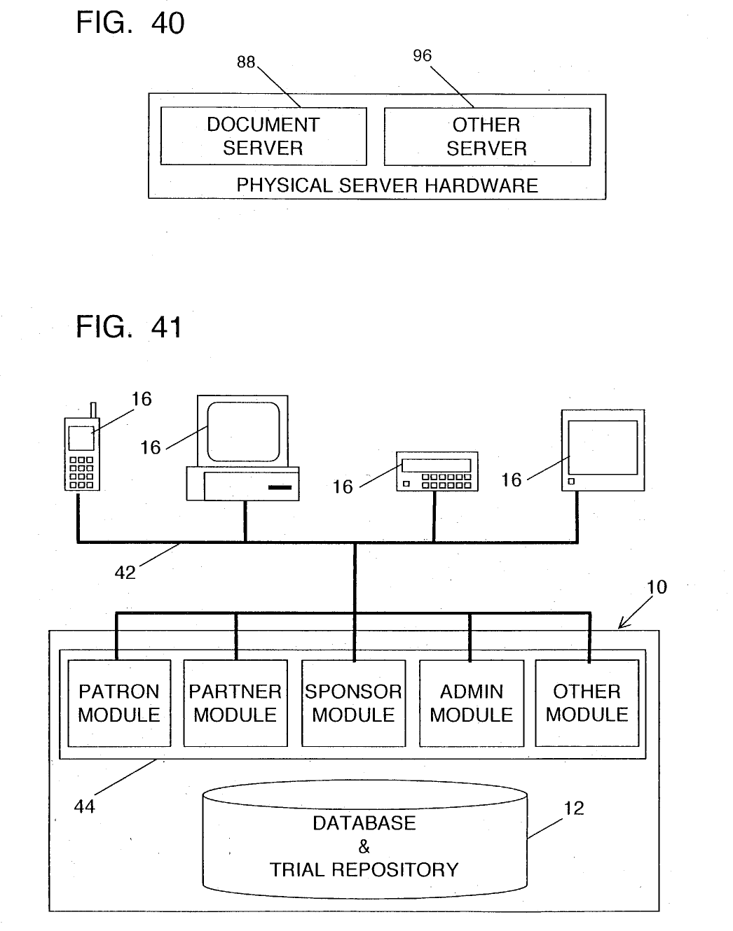

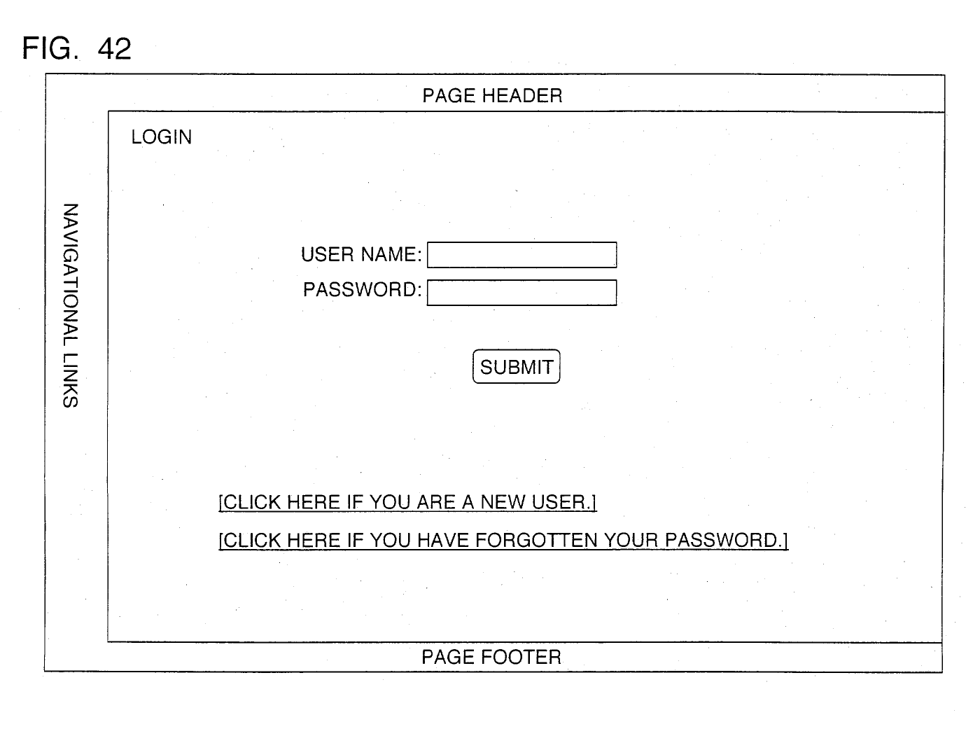

Referring now to FIG. 39, in one embodiment of the present invention, the sending client 106 provides authentication information to a document server 88. The document server 88 verifies the identity of the sending user by an authentication server 84. A document server 88 may also verify the permissions of the sending client 106 and of one or more receiving third-party clients 110 by a permissions server 86.

In other embodiments, a client 106 transfers information to a document server 88 through a routing server 90 to provide an anonymous information exchange between users.

Referring now to FIG. 39, in other embodiments, a document server 88 is be combined with at least one other system server 96. A document server 88 may be implemented by multiple clustered or distributed servers, each providing a portion of the document server function.

In other embodiments of the present invention, communication between a document server 88, a client 106 and other servers may be encrypted. Suitable encryption mechanisms include but are not limited to PKI, WTLS, SSL, S/MIME, VPN, and IPSec.

In other embodiments of present invention, a document server 88 may maintain an audit history of transactions that the document server processes. The audit information may be maintained locally by the document server 88, or by an audit server (FIG. 27, 92) that provides logging and history services for the document server 88.

In one embodiment, the methods and systems of the present invention do not depend on the computing platform employed to implement the methods and systems. In addition, the various components of the system including document repository 46, clients 68, 70, and 82, authentication server 84,permissions server 86, document server 88, routing server 90, and audit server 92, can be implemented in software, software and electronic hardware, or electronic hardware alone.

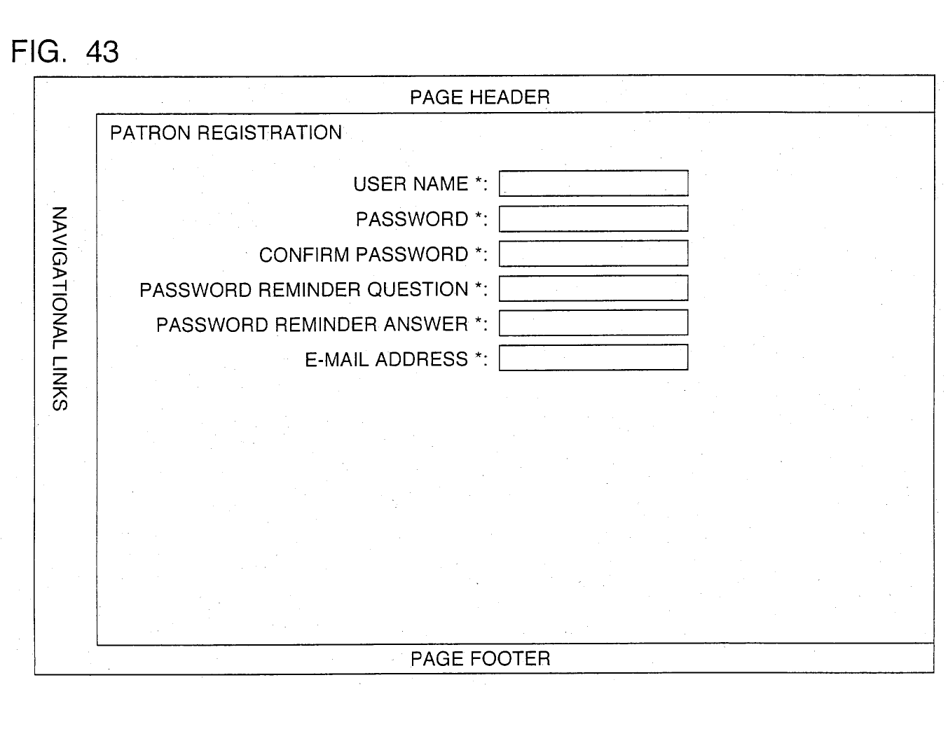

Referring now to FIG. 41, one embodiment of a medical information sharing system 10, provides UI 16 organized into modules where each module provides functions suitable to a user's medical role. Roles include but are not limited to patient, advocate, primary care physician, primary care physician staff, associate physician, associate physician staff, medical agency, medical third-party, clinical trial sponsor, clinical trial investigator, and system administrator. The system 10 includes a database 12 and is coupled to a network 42. The database 12 includes a clinical trial repository containing at least one oncology clinical trial document.

Other embodiments of the present invention may incorporate medical conditions in the clinical trial repository in addition to or in replacement of oncology. Other embodiments may also provide software modules suitable to additional medical conditions. Additional medical conditions include but are not limited to cardiology, pulmonary disease, renal disease, endocrine disease, gastrointestinal disease, rheumatology, hematology, infectious disease, neurology, and psychosocial conditions.

The methods and systems of the present invention 10 include a patron module suitable for patients and patient advocates. The system 10 also includes a sponsor module suitable for clinical trial sponsors and clinical trial investigators. The system 10 also includes a partner module suitable for patient advocates. The system 10 also includes a administrator module suitable for use by administrators of the system.

Other embodiments of the present invention may include modules suitable for roles including but not limited to primary care physician, primary care physician staff, associate physician, associate physician staff, insurance staff, medical agency, and medical third-party.

In one embodiment, the patron module provides patrons with the ability to search for clinical trials, view detailed clinical trial information, create and manage an account with patron and subject information, save trial information for future, pre-screen for trial participation, and authorize an administrator to submit information to a sponsor. The information submitted can both personally identify a patron, and be information that does not provide a personal identification of the patron.

Other embodiments of the present invention may provide patrons with the ability to customize content (e.g., healthcare information, trial tracker information) of a page on the partner's site.

Other embodiments of the present invention may provide a patron with information in their customized page that is based on past searches, their profile, and their trial sentinel selections.

Other embodiments of the present invention may provide patrons who are also advocates with the ability to get permission from a patron so submit a patron's information to an investigative site for purposes of trial enrollment.

In one embodiment, several activities in the patron module require a patron to identify themselves. When a patron calls one of these activities, the module can verify the patron's identity through an electronic authentication mechanism (e.g., digital certificate, digitally encoded smart card, digitally encoded browser cookie, or digitally encoded dongle). If the patron authenticated their identity with the system by logging in or has not saved their login information within the service at a prior time, the patron is directed to the patron login page.

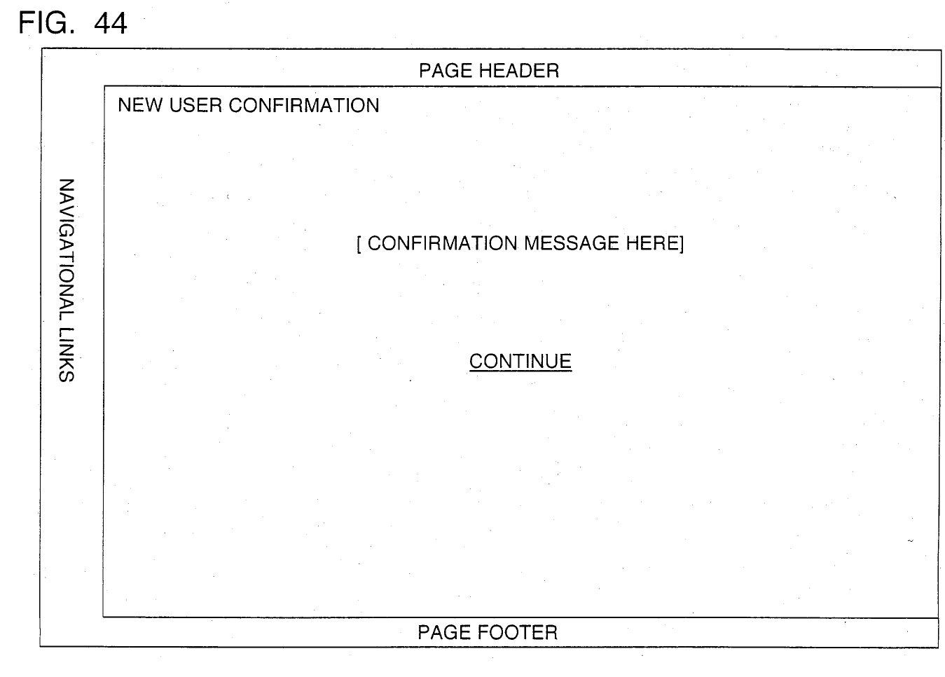

One embodiment of the patron login page for logging into the module is illustrated in FIG. 42. In the login area, there are fields in which a patron can enter a username and password. In the links area, there can be links that direct a patron to the patron registration page to register and create an account and direct a patron to the find accounts page if the patron has forgotten their password.

In one embodiment, if the patron does not have an account and they click on the “New User” link, then the patron login page directs the patron to one embodiment of the patron registration page. If the patron forgets their password, they can click on the “Forget Your Password?” link, which directs the patron to one embodiment of the find account page. If the patron creates an account and elects to store their login information on a module access device, the patron's username, password, and login time are stored.

In one embodiment, if the patron choose or is prompted to log into the patron module, the module verifies that the patron has entered a username and password. The module then verifies that the username exists in the account record in the database. Once the account record is located, the password in the database associated with the username is verified against the password typed by the patron. Once all the validation rules have been passed, the system saves the username as the login handle for the duration of the user's session and returns the patron to their activity prior to reaching the patron login page. If the validation fails, then an informative error message is displayed on the patron login page with instructions for the patron.

Other embodiments of the present invention may allow a patron to authenticate their identity and log into the patron module through an electronic authentication mechanism (e.g., digital certificate, digitally encoded smart card, digitally encoded browser cookie, or digitally encoded dongle).

Other embodiments may verify a user's electronic authentication by an authentication server (FIG. 27).

Other embodiments of the present invention may allow a patron to indicate their permission for other users in the clinical trial ecosystem to access all or portions of their information, where a portion of the information may personally identify the patron, and a portion may not personally identify the patron.

Other embodiments of the present invention may allow a patron to indicate their preference to receive medical content of a newsletter type delivered to him/herself by email, fax, web page, postal mail, voice message, wireless page, or wireless message.

Other embodiments of the present invention may include one or more of the following in a newsletter delivered at a person's request: medical and disease information, notification of new clinical trial documents, notification of changed clinical trial documents, notification of removed clinical trial documents, medically-related news, or medically related editorial content of potential interest.

Other embodiments of the current invention may request a patron's preferred form of communication-by email, fax, web page, postal mail, voice message, wireless page, or wireless message.

In one embodiment, patrons use most features of the module without registering and creating an account; only if a patron must be identified in some way in order to save information for the patron can any level of authentication or registration be necessary. For examples, if a patron would like to save specific trial information, a completed or incomplete pre-screen for a trial, or a list of trials for a particular type of cancer, then the patron can be required to register for an account.

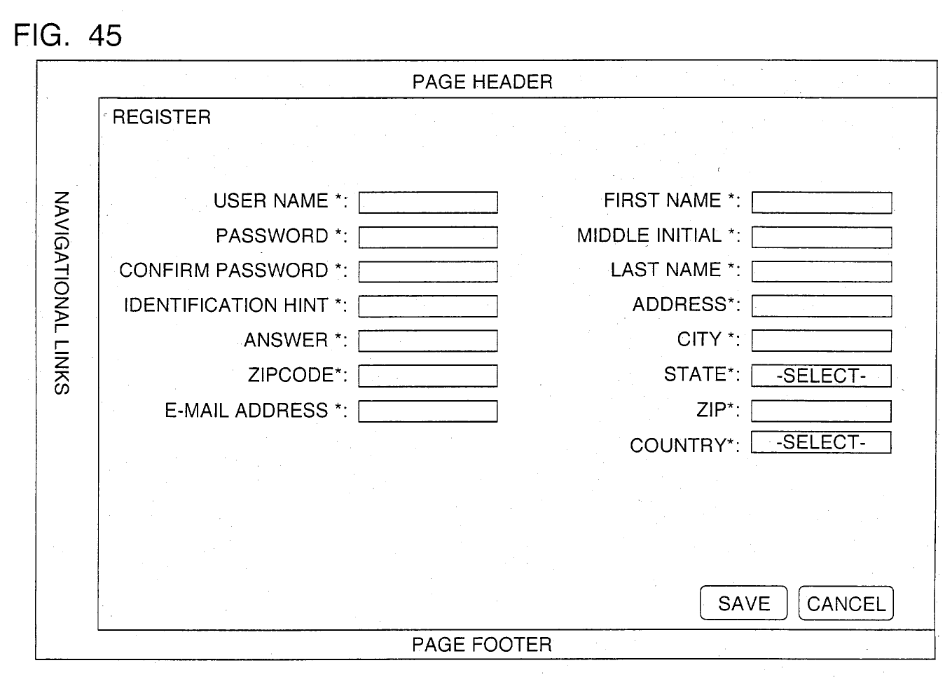

In one embodiment, when an action requiring authentication is initiated by a patron one embodiment of the registration page appears, as illustrated in FIG. 43. In the email/password area, a patron can enter a username, password, password confirmation, password question, password answer, email address. In the action area can be a submit button and a cancel button. If a patron clicks the cancel button, they are returned to the page from which they called the registration page. If a patron clicks the submit button, the account information is saved by the module and the patron is taken to one embodiment of the new patron confirmation page. The benefits of registering can be provided, so that a patron is aware of the features available to him/her as a result of registering.

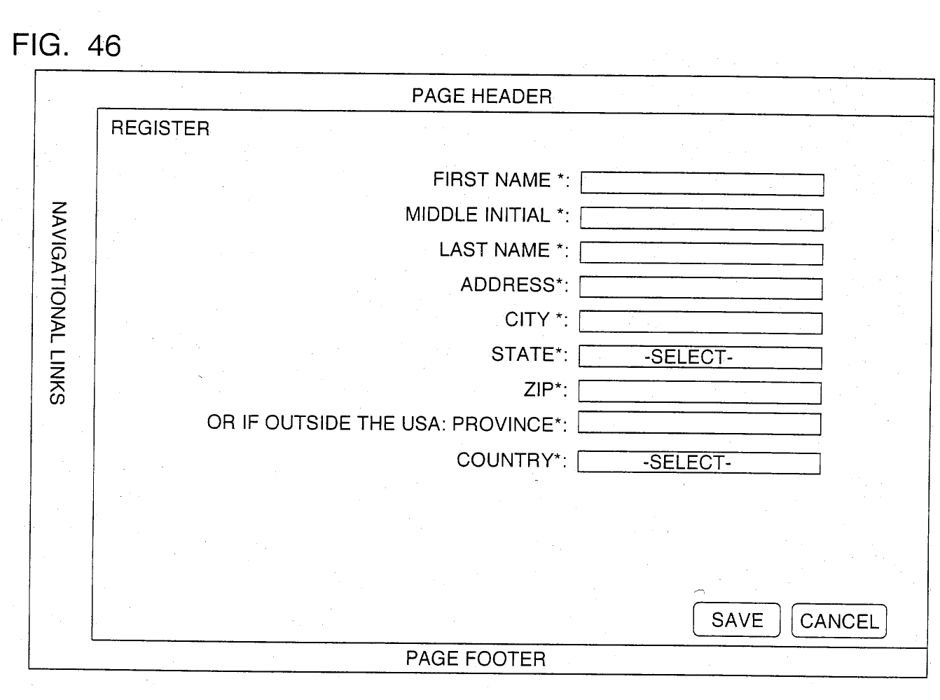

If a patron completes the registration and clicks the submit button, one embodiment of the new patron confirmation page appears, as illustrated in FIG. 44, and informs the patron that the first part of their registration has been successfully completed. In the main text area, a confirmation message can appear with a link that takes the patron back to where they initiated the registration process.

In one embodiment, once a patron registers and creates an account, the system verifies the patron intends to do so by contacting the patron with instructions on how they should complete the registration process. A link is provided in the email that when clicked, takes a patron to the email address confirmation page to confirm that patron's intention to register for the module.

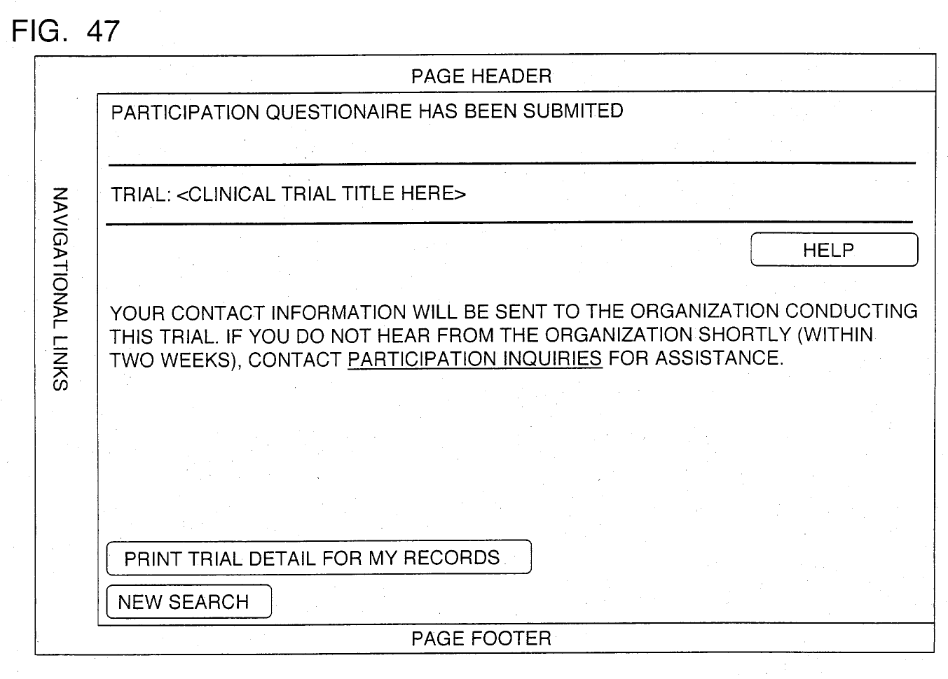

In one embodiment, only if a patron passes a prescreen and wants the administrator to forward their information to the trial investigator/sponsor, are they required to provide contact information during registration. If a patron has not registered for the service before, one embodiment of the registration page appears, as illustrated in FIG. 45. Again, in the email/password area, a patron enters a username, password, password confirmation, password question, password answer, email address. In the contact information area, a patron enters their title, first name, middle initial, last name, address, city, state, zip/postal code, country, primary and secondary phone numbers and types, and fax number. In the action area can be a submit button and a cancel button. If a patron clicks the cancel button, they are returned to the page from which they initiated the registration process. If a patron clicks the submit button, the account information is saved by the module and the patron is taken to one embodiment of the new patron confirmation page. The benefits of registering are provided, so that a patron is aware of the features available to him/her as a result of registering.

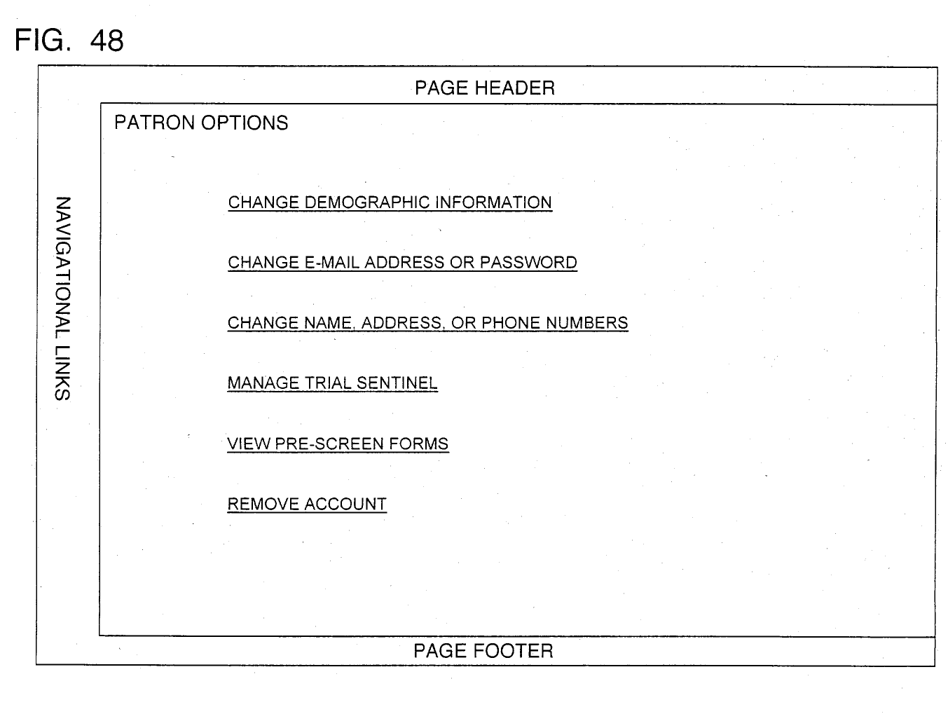

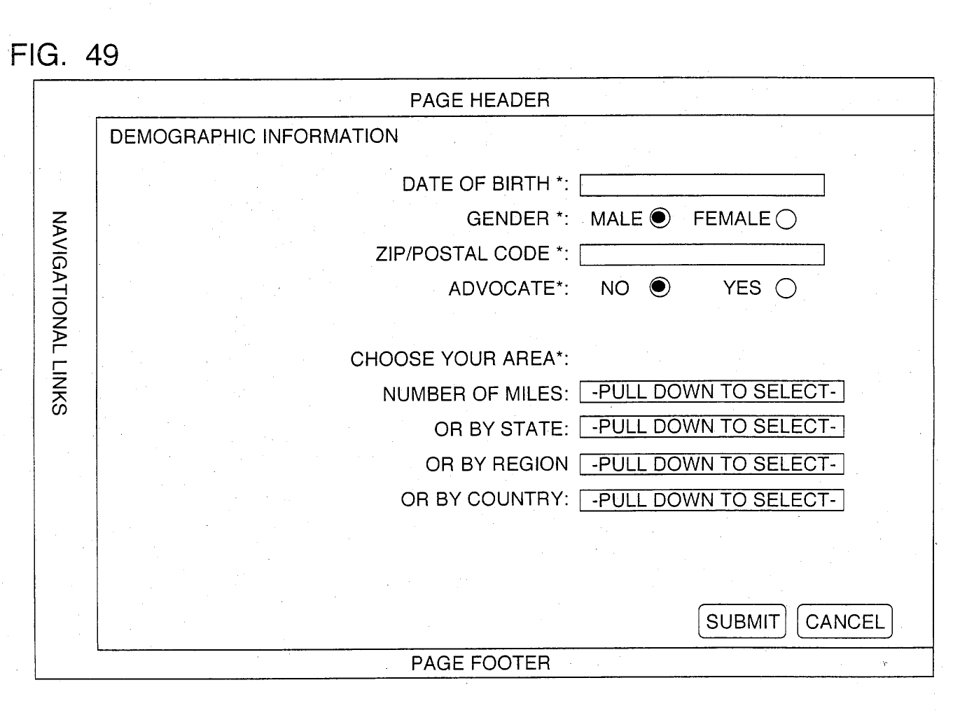

In one embodiment, if a patron passes a prescreen, wants the administer to forward their information to the trial investigator/sponsor, and does have an account, one embodiment of the verify/update contact information page appears, as illustrated in FIG. 46. In the contact information area, a patron can enter/update their title, first name, middle initial, last name, address, city, state, zip/postal code, country, primary and secondary phone numbers and types, and fax number. In the action area can be a submit button and a cancel button. If a patron clicks the cancel button, they are returned to the page from which they initiated the registration process. If a patron clicks the submit button, the account information is saved by the module and the patron is taken to one embodiment of the submit confirmation page, as illustrated in FIG. 47, that informs a patron that their identifying information and passed prescreen will be sent to the trial sponsor/investigator.

Other embodiments of the present invention may forward a patron's information to the trial investigator/sponsor automatically without administrator intervention.

Other embodiments of the present invention may require a patron to enter demographic information, such as date of birth, gender, zip/postal code, and the patron's role as an advocate or patient during registration.

Other embodiments of the present invention may require travel preference (to participate in trials) to be entered in order to register with the module; specifically, patrons may have to choose a geographic area, the number of miles from the patron's zip code, the state, region, or country to which a patron is willing to travel to participate in a trial.

Other embodiments of the present invention may include areas to enter other patron-specific information including, but not limited to, genetic information, medical history, details of a patron's current medical care, primary care physician, primary care physician contact information, primary care physician unique identifier and primary care medical credentials.

Other embodiments of the present invention may allow a patron to collect electronic records from medical databases, medical information databases, medical insurance databases, proteomic information databases and genetic information databases.

Other embodiments of the present invention may vary in the number of pages required to enter this data or the amount of data that is required to create and account.

Other embodiments of this invention may require a patron to select areas of interest about which a patron would like to receive information. Further, other embodiments may include granting permission to allow a user to contact a patron with information.

Other embodiments of the present invention may provide functionality that allows advocates to choose to receive electronic newsletters from partners or updates about trials/categories of interest to them as part of registration. The advocates may choose to submit these newsletters to their subjects.

Other embodiments of the present invention may include functionality that queries public or authorized records for more information about a patron who has completed the registration process.

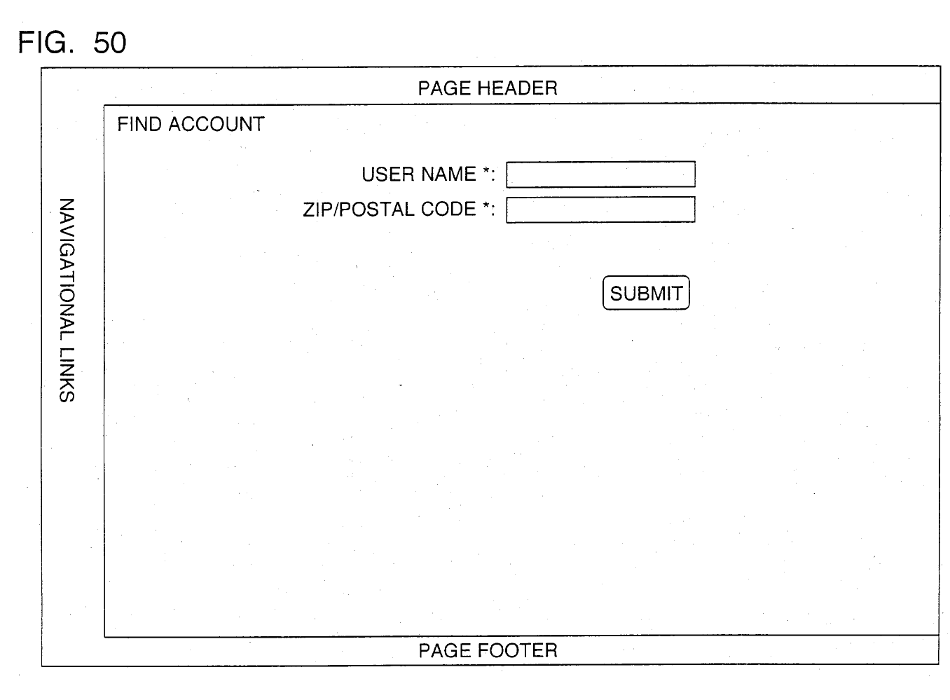

As illustrated in FIG. 48, one embodiment of the patron account options page presents the secure, account-related actions that a patron can take while using the module. A patron can reach this page by clicking a link in the navigation bar on each module page. Activities available to the patron from the patron account page can include reviewing and changing password, email address, contact information, and trial sentinel selections. These options can be displayed as links on the patron account options page.

Other embodiments of the present invention may remove this step from the workflow, so that a patron can access and edit all information collected by the module.

Other embodiments of the present invention may include other account options specific to the type of patron using the module: demographic information, travel restrictions, medical history, current medical care, medical conditions/diseases of interest to a patron.

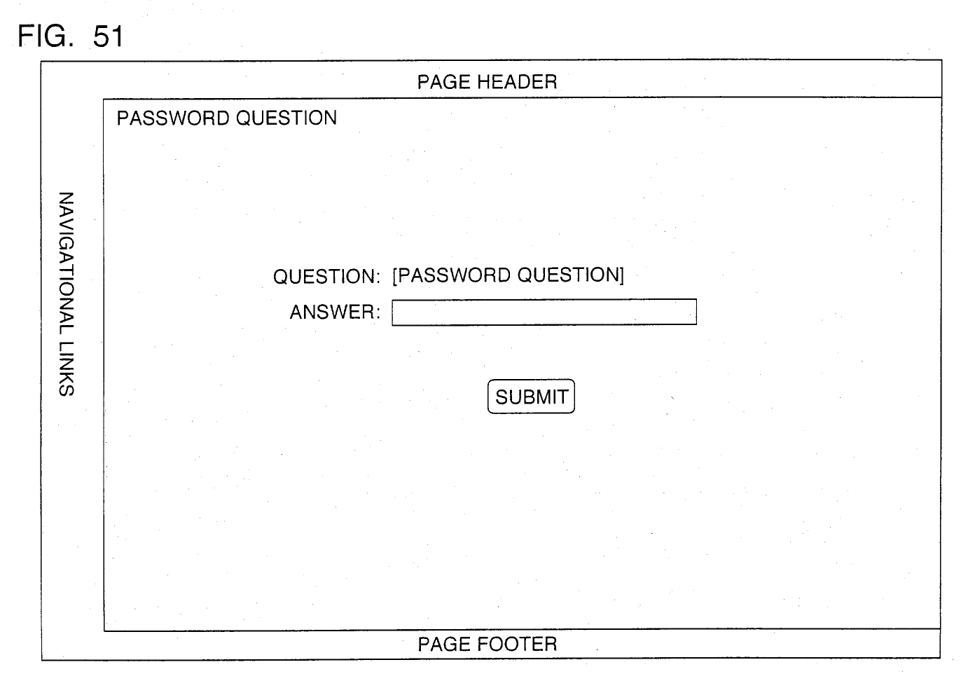

One embodiment of the patron demographics page, as illustrated in FIG. 49, allows a patron to modify the demographic information used in searches for specific trials. In the demographic information area, a patron can enter a date of birth, gender, zip/postal code, and an indication of the patron's reason for using the module including as an advocate of a third-party, or directly for the user. In the geographic delimiter area, a patron can choose an area, a distance from the zip/postal code, the state, region, or country to which the patron is willing to travel to participate in a trial. The patron can also choose “no limit”.

Other embodiments may not include this page as part of the module if, for example, a patron's demographic information or travel preferences are not required by the module.

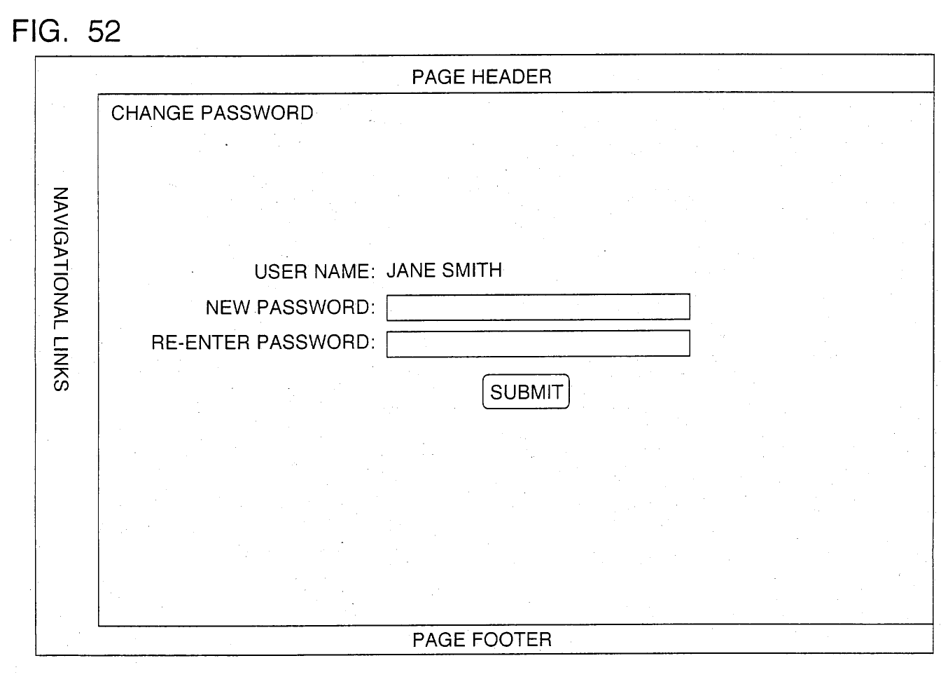

In one embodiment, the first step to retrieving a patron's forgotten password is to confirm that an account does in fact exist with the module. One embodiment of the find account page, as illustrated in FIG. 50, asks a patron for their username and zip code and can be displayed to a patron if they click the “Forget Your Password?” link on the patron login page. In the account information area, a patron can enter their username and zip code. The module verifies that an account exists. If no account is found in the database, one embodiment of the find account page appears with an error message. If an account is found, the patron is directed to one embodiment of the password question page.

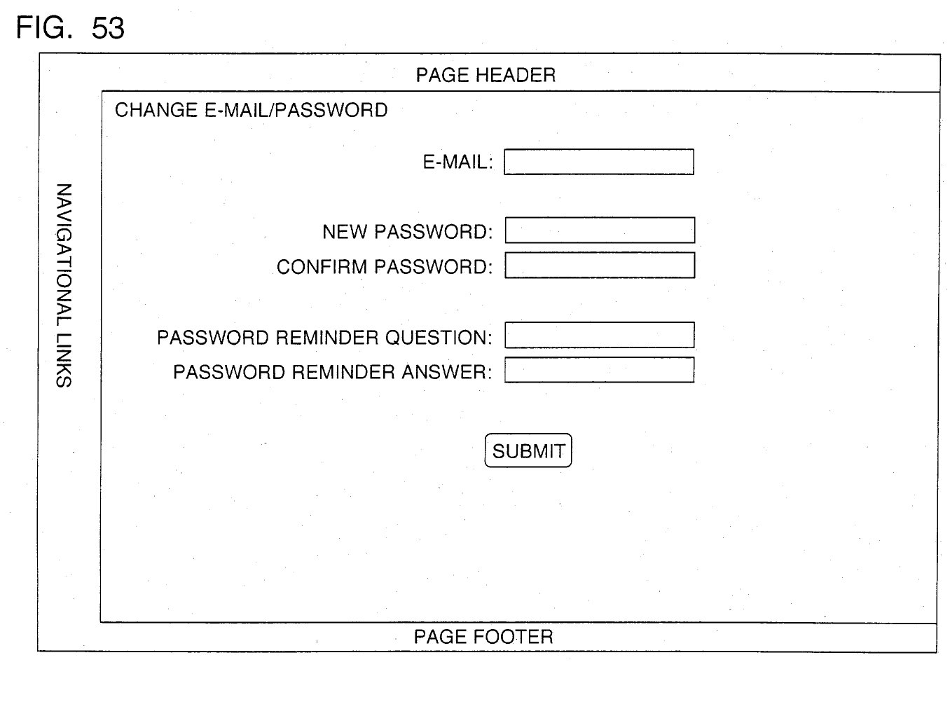

In one embodiment, once an account is found in the module, a patron reaches the password question page, as illustrated in FIG. 51. In the password question area, a patron's password question can appear above a textbox for the answer. A patron can enter the answer to that question and then can submit it by clicking the submit button. The module verifies that the answer to the password question is the same as that stored by a patron during registration. If the answer given matches the answer in the selected account record, a patron can be directed to one embodiment of the password modification page. If the answer given does not match, one embodiment of the password question page can be presented to the patron with an error message.

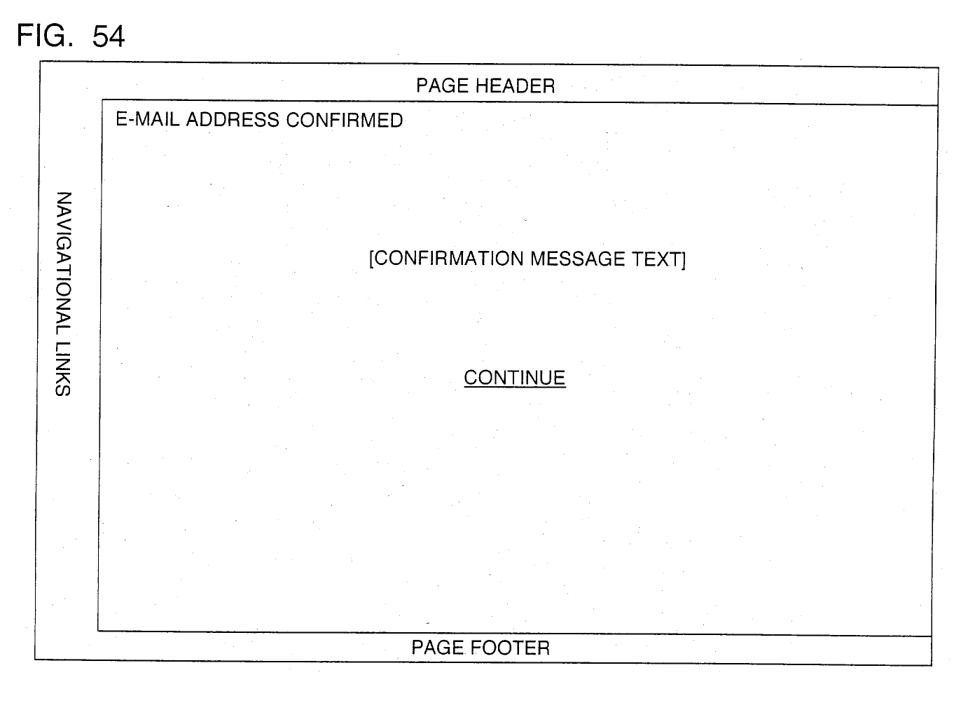

In one embodiment, the password modification page, as illustrated in FIG. 52, enables a patron to change their password. In the password modification area, a patron username can be displayed along with a password textbox, and a password verification textbox. A patron can enter his or her new password into the password textbox, re-enter it into the password validation textbox, and then click the submit button. The module can verify that the two password entries are identical and valid. If the entries are valid, the password can be saved to the database as part of the patron's account record. If the entries are not valid, one embodiment of the password modification page is presented with an error message to a patron, who can be required to reenter the aforementioned information.

Other embodiments of the present invention may redirect a patron directly to the patron registration page if the password answer does not match. Other embodiments of the present invention may combine the functionality of the find account, password question, and password modification pages.

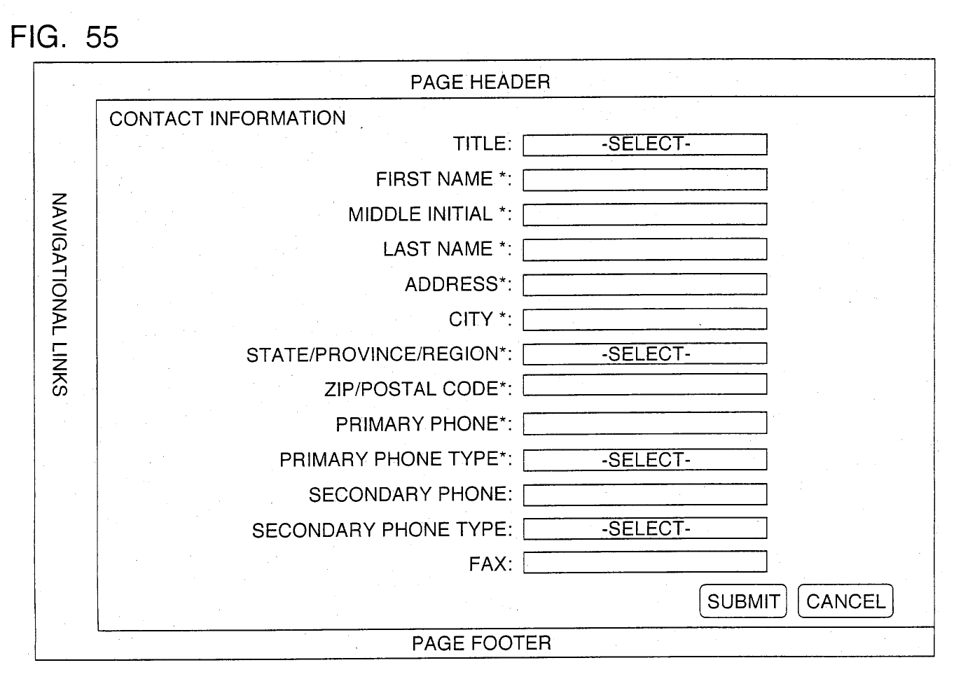

In one embodiment, if a patron wishes to change their email address or account password, a patron accesses the change email/password page, as illustrated in FIG. 53, from the patron account options page. In the email area, the field can be populated with the patron's current email address associated with their account. The patron can change the contents of this field. In the password area, the Patron can enter a changed password twice to confirm that it is entered correctly. In the password reminder area, the password question and answer fields can be populated with the password question and answer associated with the account. A patron can update this information if desired. After updating the desired fields on this page, a patron can click the submit button to send this information to the database.

In one embodiment, whenever the email address is changed, it may not used by the module to send notifications (e.g. for Trial Sentinel) until the change has been confirmed. Confirmation can occur as follows: (a) user modifies email address, (b) modification triggers the sending of a test email message to that address, containing a confirmation link, (c) the user receives the email test message and navigates to the enclosed link to the email address confirmation page, (d) the module “confirms” the email address and flags it as being eligible to receive notifications.

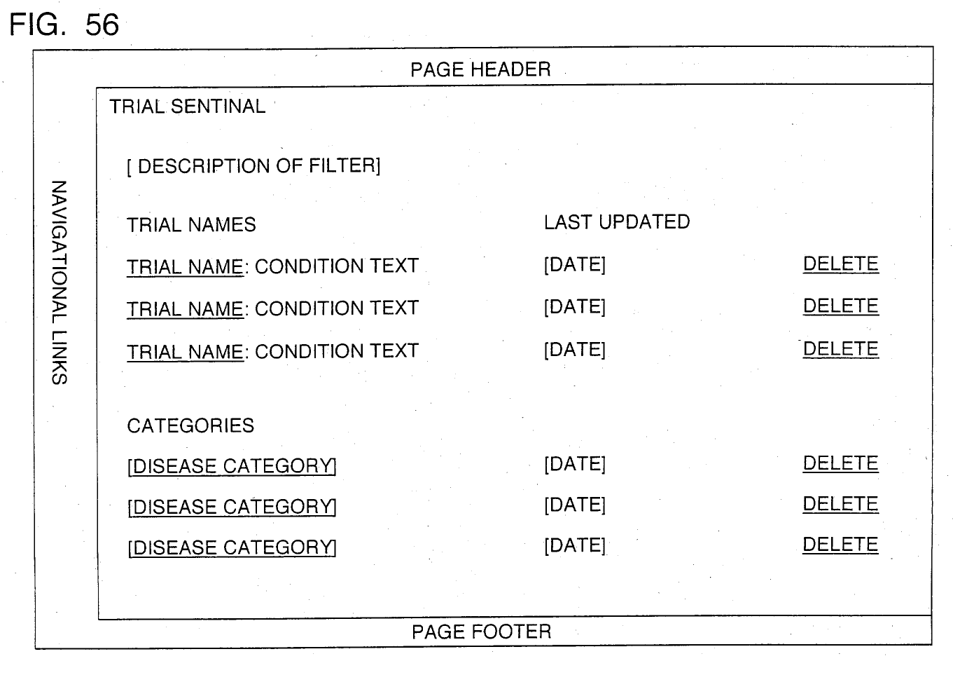

In one embodiment, after a patron registers with the module or updates their email address, an email that contains a confirmation link is sent to the patron. By clicking on the link, a patron can be taken to one embodiment of the email address confirmation page, as illustrated in FIG. 54, where a patron can complete the registration process. In the confirmation area, a message explaining the confirmation can appear. When a patron clicks the continue button, the email in their profile can be flagged to indicate that the address and registration are valid and that the address is eligible to receive notifications from the module.

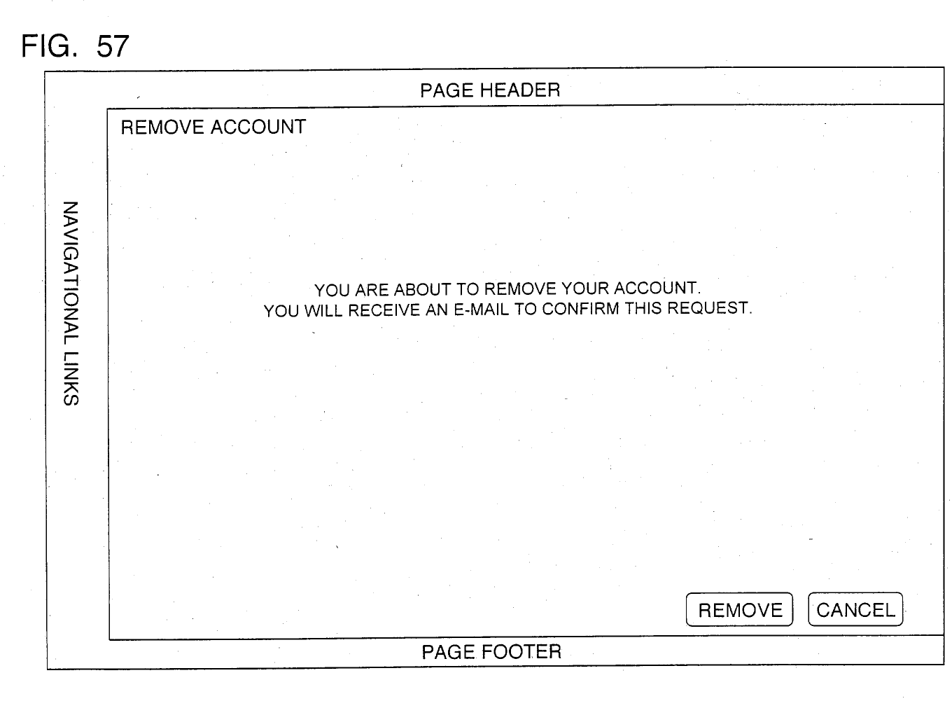

In one embodiment, a patron can choose to update their contact information if they has previously entered it into the module from the patron account options page and the trial detail page. In one embodiment of the contact information page, as illustrated in FIG. 55, a patron can update his her title, first name, middle initial, last name, address, city, state, zip/postal code, country, primary and secondary phone numbers and types, and fax number.

Other embodiments of the present invention may include variations of the above information including website, cell phone, business address, and personal medical information. Personal medical information can include medical records associated with the user, medical test results associated with the user, medical research associated with the user, healthcare provider records associated with the user, healthcare billing records associated with the user, healthcare payment records associated with the user, and healthcare insurance records associated with the user.

Other embodiments may permit the patron to share their medical information with third-parties in response to the user giving permission.

Other embodiments may permit the patron to access their medical information from other sources, including hospital records, physician records, insurance records, and testing service records.

In one embodiment a trial sentinel is presented in the patron module that permits the storage and organization of various data and whose functionality is based on the type of person using the module. A link to manage trial sentinel selections can be accessible from all pages within the module. In addition, a patron can be taken to the trial sentinel management page after performing an action in the module that saves/updates information to a patron's trial sentinel. The following describes the audience-specific functionality of the trial sentinel:

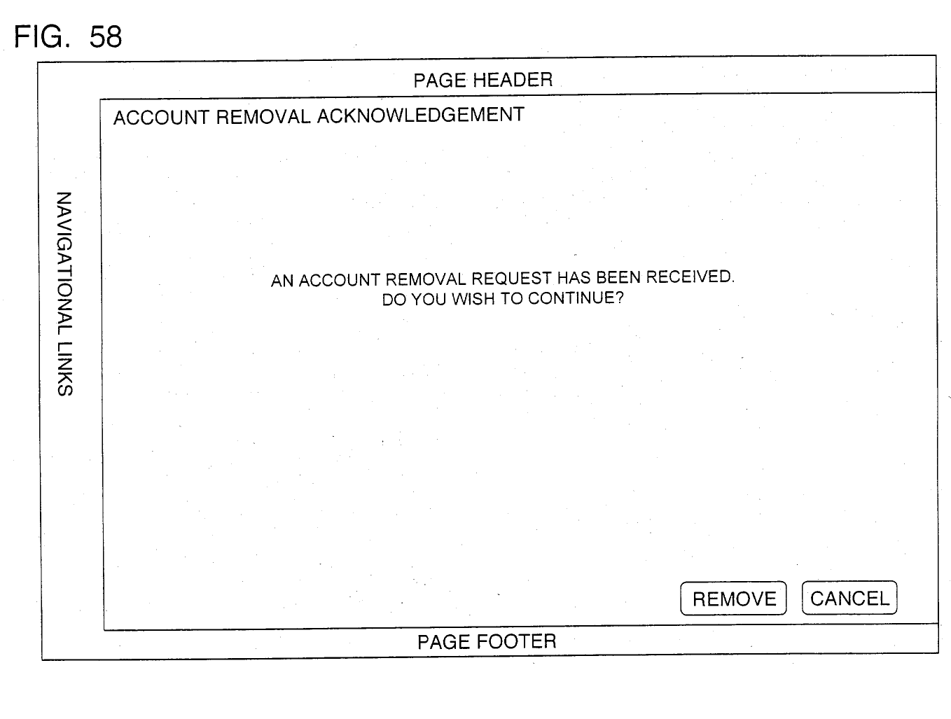

For a patron who is also a patient, the trial sentinel allows a patron to save trial information and condition categories of interest to him/her. In addition, by saving a condition category, the module is configured to generate email notifications to the patron when new or updated trials exist in the condition category. Patrons who are also patients can also remove the trials or condition categories from the trial sentinel if desired. FIG. 56 illustrates an embodiment of a trial sentinel management page for patrons who are patients. In the trial information area, a list of the trials saved to the patron's trial sentinel appears. In the category information area, a list of condition categories saved to the patron's trial sentinel appears. Hyperlinks to remove an item appear to the right of each trial and condition category listing.

Other embodiments of the present invention may include the inclusion of a list of new and updated trials within the condition category previously saved by a patron if the page is accessed from a URL contained in a trial sentinel notification email.

Other embodiments of the present invention may include an indication of a completed or partially completed pre-screen form for a trial.

Other embodiments of the present invention may allow a patron to save a search, so that they can return to the results in the future.

Other embodiments of the current invention include the ability for a patron who is also an advocate to save trial information and condition categories to the trial sentinel for particular subjects.

Other embodiments of the current invention may permit a patron to also store annotations about other saved items in the trial sentinel.

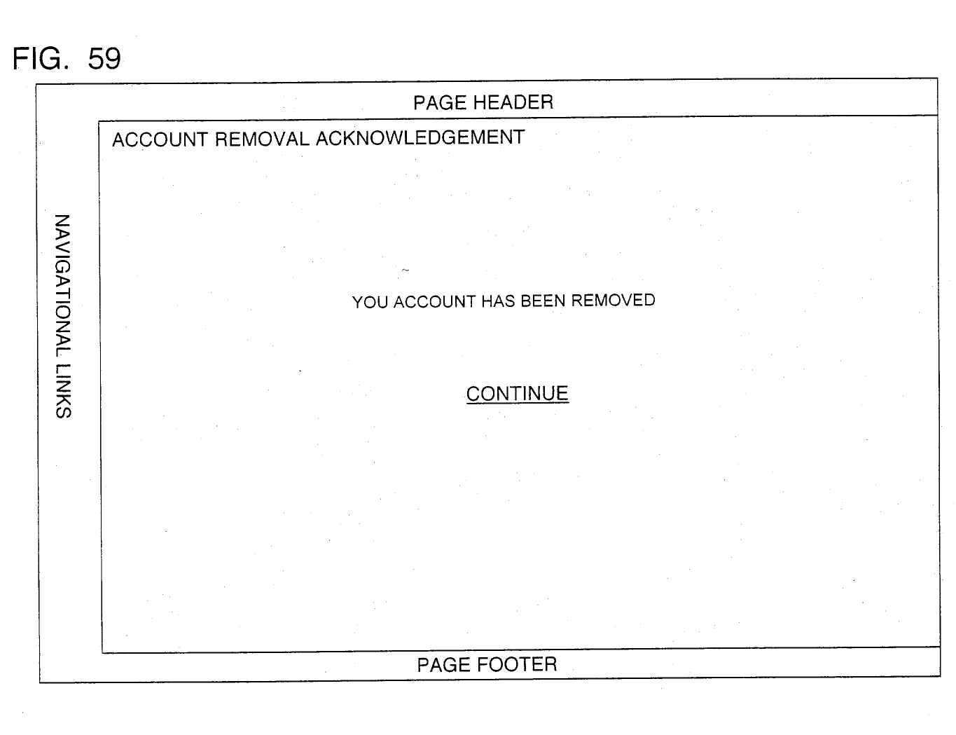

Patrons may wish to remove their account and in one embodiment can do so from the remove account page, as illustrated in FIG. 57. In this embodiment, the page can allow a patron to begin the account removal process. In the message area, the patron is provided with a question about their intent to remove their account as well as a remove account and a cancel button. After the patron clicks the remove account button, the module sends an email to the patron requesting that the patron confirm the account removal by clicking a link in the email, which subsequently takes the patron to one embodiment of the patron remove account verification page.

In one embodiment of the patron remove account verification page, a patron is asked to confirm their intention to remove their account. In the message area, a patron is prompted with confirmation text as well as a remove account button and a cancel button. If the patron clicks the cancel button, their account is retained and they are redirected to the patron account options page. If the patron clicks the remove button, their account is deleted and the user is directed to one embodiment of the patron account removed confirmation page.

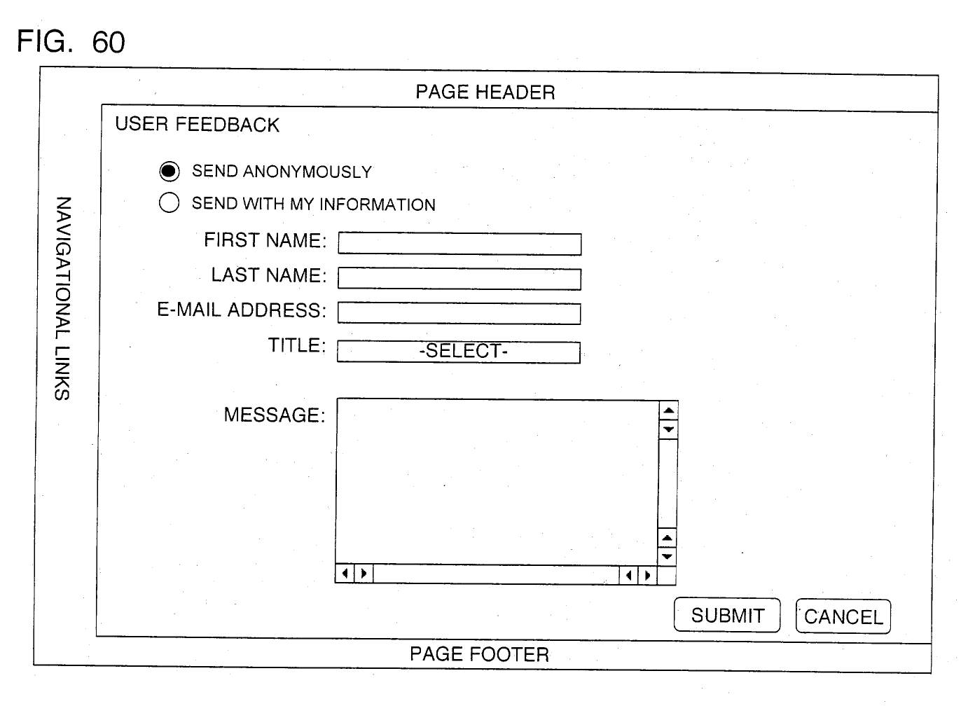

In one embodiment, a patron who does wish to remove their account is directed to the patron account removed confirmation page, as illustrated in FIG. 58. In the message area, a patron is informed that their account has successfully been deleted from the module. At this point, the patron's username can be available to other patrons wishing to become registered. The demographic data associated with the account, and any pre-screening forms completed, can remain in the database but can be disassociated from the patron's identifying information.

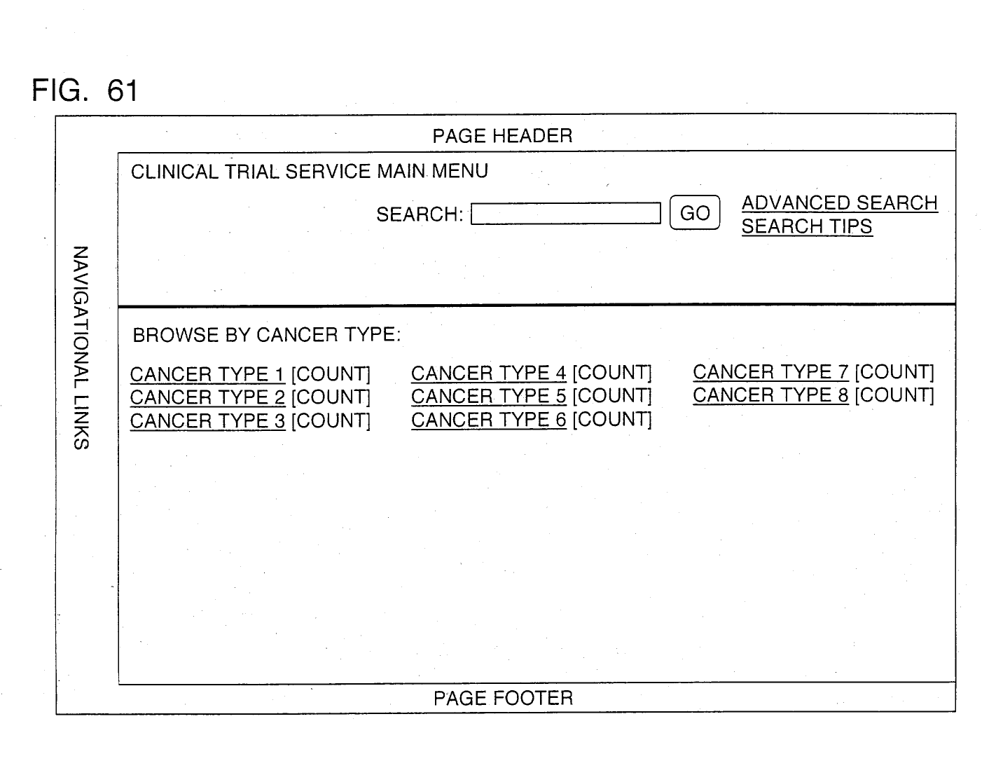

In one embodiment, a patron reachs the patron account update confirmation page, as illustrated in FIG. 59, after updating their email address, contact information, or password. In the main text area, a message indicating that a patron's account information has been successfully updated can appear. In addition, a continue button can be available. By clicking on the continue button, a patron can be returned to the point at which they initiated the update.

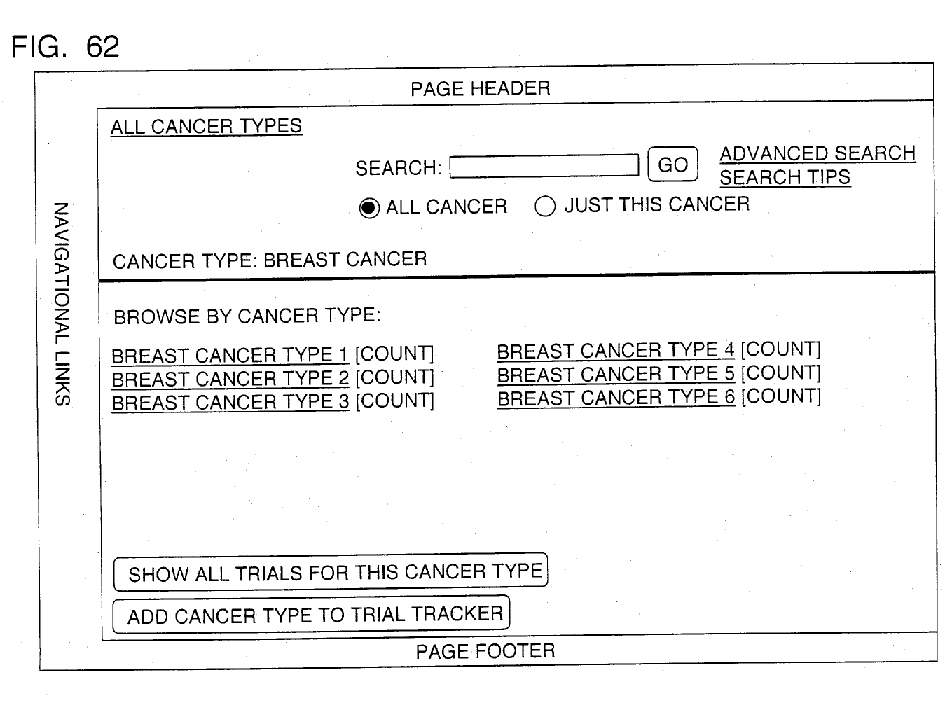

In one embodiment a patron is presented with a feedback pop-up window when the patron attempts to leave the module to provide an administrator with input and opinions about the modules for improvement purposes, as illustrated in FIG. 60. In the optional contact information area, a patron can choose to send their feedback anonymously, or can choose to enter their first name, last name, or email address. If a patron is logged in prior to clicking the feedback link, these fields can be pre-populated with the patron's account information; however, a patron can still choose to send the feedback anonymously. In the feedback information area, a patron can be required to select a title from the drop-down list to indicate the type of feedback the patron is sending. A patron can type a message in the message field and then click the submit or cancel buttons also in that area. If the patron clicks the cancel button, they are directed to the page to which they navigated from the patron module. If the patron clicks the submit button, the administrator receives an email with the feedback message and contact information provided by the patron.

In one embodiment, a patron finds clinical trials of interest by searching or browsing the trial repository via the patron module. A patron navigates the condition category tree to locate a specific medical condition, or performs a keyword search to find trials.

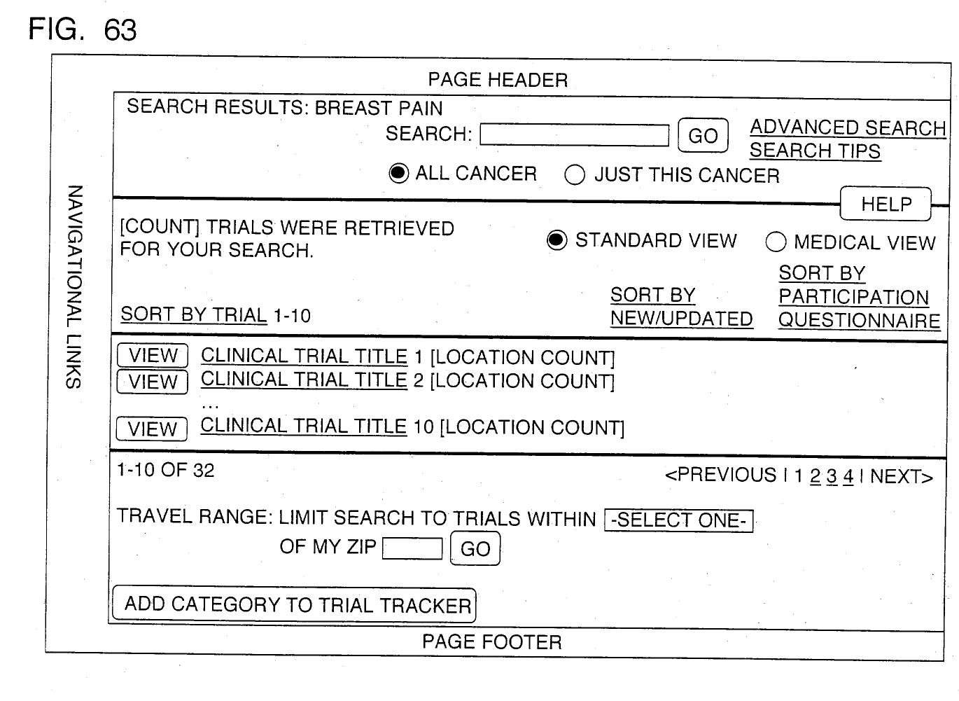

A patron browses or searchs from the main menu page of the module, or perform an advanced search. On the main menu page, as illustrated in FIG. 61, in the search area, the patron can enter keywords relating to trials in which they are interested, click the search tips link to view tips on searching, or click the advanced link to navigate to the advanced search page. When a patron enters keywords in the search field and clicks the go button, the module performs a search of the trial database and returns a list of trials on the search result page that contain the keywords in their records.

In one embodiment, the search engine supports uppercase and lowercase, misspelled, synonyms of words as well as Boolean searches.

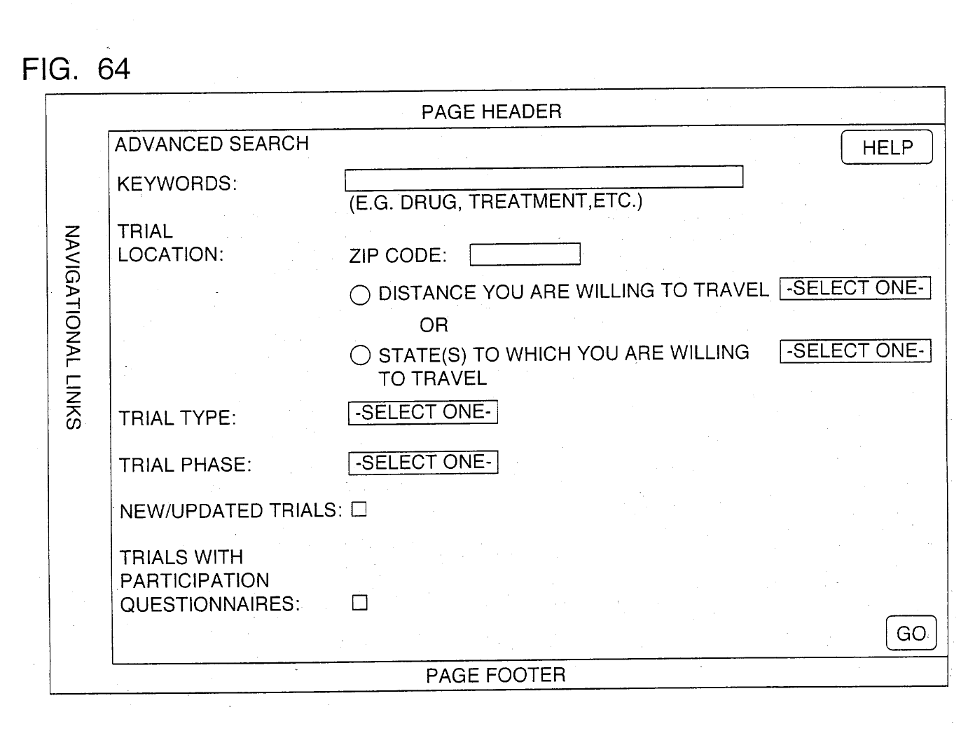

Alternatively, in the browse area, a patron can click on the linked condition categories to reach the next level in the condition category tree, or the category browse page, as illustrated in FIG. 62. In the search area on this page, patrons can perform a keyword search within the subcategory. On the main menu page and on all browsing pages, categories and subcategories can be listed alphabetically, less general condition categories, which can appear at the bottom of the browse area. The number of trials in each category can appear next to the associated category.

Other embodiments of the present invention may order the condition categories differently than described here.

Other embodiments of the present invention may allow patrons to browse by location of clinical trial, document language, document lay or medical intended audience, hospital affiliation of investigative site, availability of prescreen questionnaire, clinical trial contact method, availability of clinical trial help, therapeutic drug, International Classification of Disease Number, Diagnostic and Statistical Manual of Mental Disorders classification, histopathological disease classification, gene, expression, user-specific laboratory results, user medical history information, medical center at which trials are conducted, investigator name, investigator specialty, investigator location, or insurance company covering trial treatment.

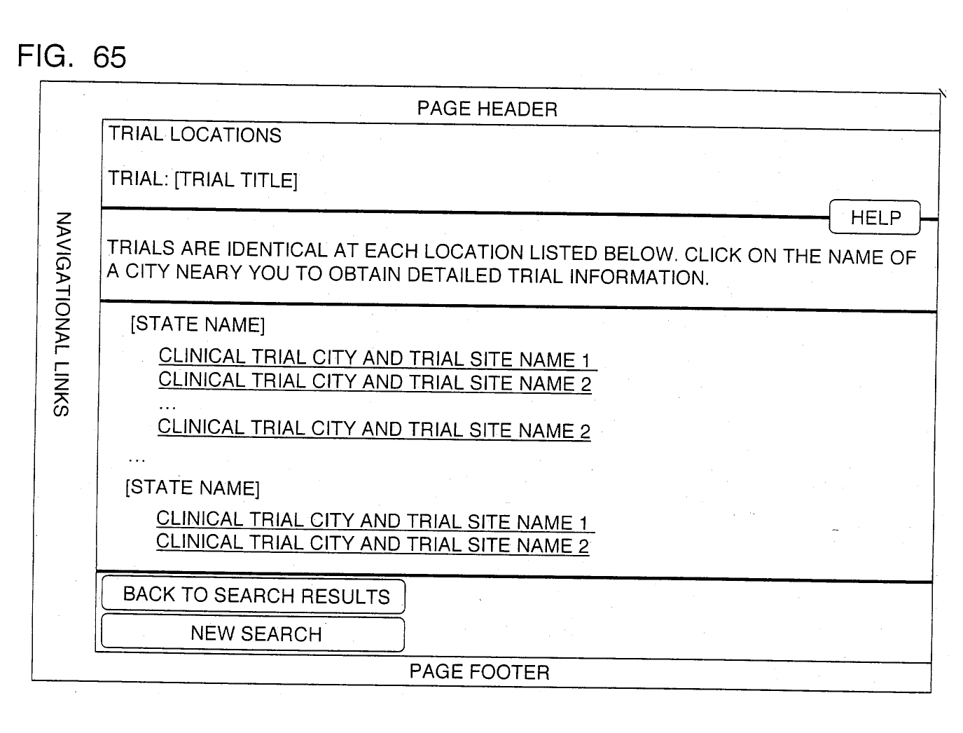

In one embodiment, when a patron reaches the search/browse results page, either by browsing to the lowest level in the condition category tree, or by performing a keyword search, they are presented with summary information about the trials retrieved from the database, as illustrated in FIG. 63. In the breadcrumb area, the path a patron has taken through the condition category tree can be displayed. The title of the page can indicate the condition category to which a patron browses or the search term(s) they entered in the search field. In the results summary area, a description of the search/browse (e.g., keywords, geographic refinement, advanced search criteria) and the number of trials retrieved can be presented. If no trials were retrieved from the database, a text message can appear with suggestions to improve a patron's search/browse that are customized by the search/browse methods used by a patron. In addition, the patron can be provided with a reference to the search tips link in the search area of the page. In the results area is the list of trials retrieved from the database including trial title, an indication if the trial is new or updated since the last database refresh, and if a prescreen is available for the trial. Next to each listing in this embodiment is a view button, which when clicked, will take the patron to the trial locations page, if multiple locations exist for a trial, or to the trial detail page. Also in this embodiment is a button to add the condition category to the trial sentinel for instances where a patron browses to the list of trials or performs a search within a condition category.

In this embodiment, the trials are initially sorted by those with prescreens, then those that are new/updated, then alphabetically by title. Functionality exists for a patron to sort by any of the headings in the results area, title, new/update, prescreen available.

Other embodiments of the present invention may provide patron's with the ability to sort by one or more of the following: investigative site location, the date that the document entered the system, the date the document was updated on the system, document language, document's intended audience, investigative site hospital affiliation, investigative site organizational affiliation, prescreen questionnaire, information contact method, therapeutic drug, number of investigative sites, phase of the clinical trial, or name of the clinical trial investigator.

Other embodiments of the present invention may display search results using a file manager format.

In one embodiment, a refinement area of the search/browse results page is available in which is functionality to further reduce the list of trials according to the willingness of a patron to travel. A patron enters their zip code and use the pull-down menu to select the distance from that zip/postal code they are willing to travel.

Other embodiments of the present invention, provide a patron who is also an advocate with the ability to apply a profile of one of their subjects to further refine the results of the search/browse.

Other embodiments of the present invention may permit a patron to apply their demographic profile to further refine the results.

Other embodiments of the present invention may permit a patron to apply information collected from the patron and information accessed from electronic records on behalf of the patron to further refine the results.

Other embodiments of the present invention may include limiting or sorting search results by disease state, by viewing location, by language preference, by investigative site, by hospital affiliation of the investigative site, by customer service method (online, phone, etc.), by availability of information-line (phone), by therapeutic drug, by results of a previously taken prescreen questionnaire.

Other embodiments of the present invention may not provide a patron with null search results; that is, some method of useful information or personal contact would be made to further assist a patron with their search.

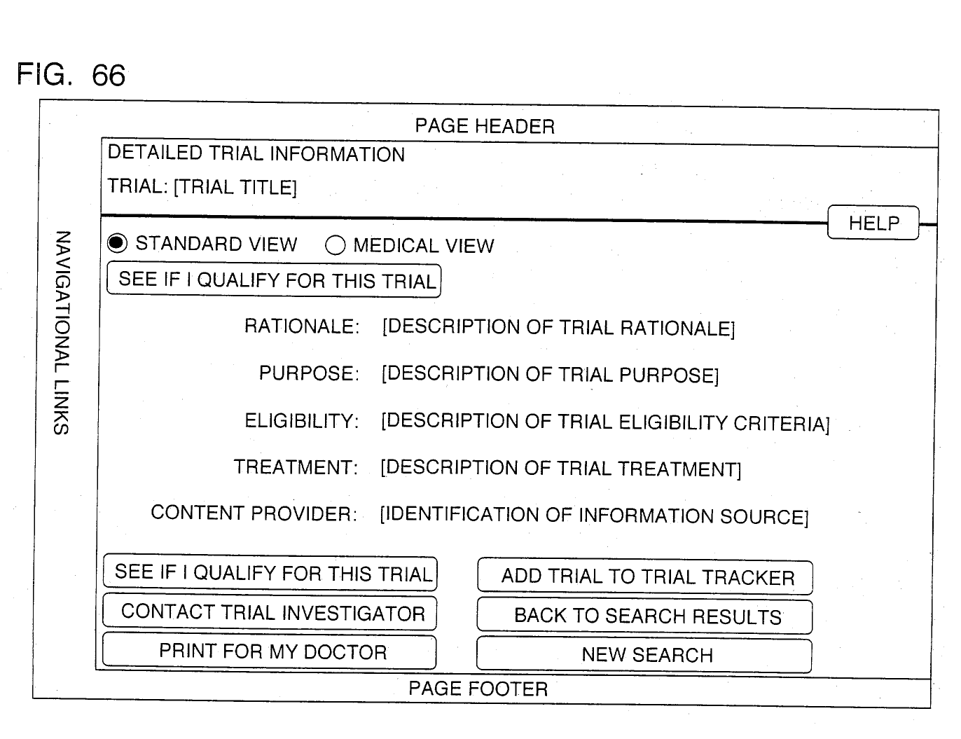

In one embodiment, when a patron clicks the advanced search link in the search area of most module pages, they are taken to the advanced search page, as illustrated in FIG. 64. In the search criteria area, a patron can enter keywords and trial location delimiters. In addition, a patron can select the type of trials of interest to him/her: treatment, screening, prevention, supportive care, generic, diagnostic. A patron can also select the stage of the trials of interest to him/her: Phase I, II, II/III, III, and IV. Finally, a patron can choose to view only those trials that are new/updated since the last database refresh or only those trials that have prescreens available. A patron clicks the go button to retrieve trials from the database that match their search criteria in the search/browse results page, discussed previously.

Other embodiments of the present invention may include the ability for a patron to search by trial number, drug name, sponsor, investigator, pharmaceutical organization, date last updated, the date added to the database, disease condition, other medical terminology, hospital affiliations of the investigative site, clinical trial contact method, International Classification of Disease number, availability of clinical trial help, Diagnostic and Statistical Manual of Mental Disorders classification, histopathological disease classification, gene expression, user specific laboratory results, user medical history information, medical center at which trials are conducted, investigator name, investigator specialty, investigator location, or insurance company covering trial treatment In one embodiment, after a patron clicks a view button on the search/browse results page, they are taken to the trial detail page for trials with only one administering location, or to the trial location page for trials with multiple locations.

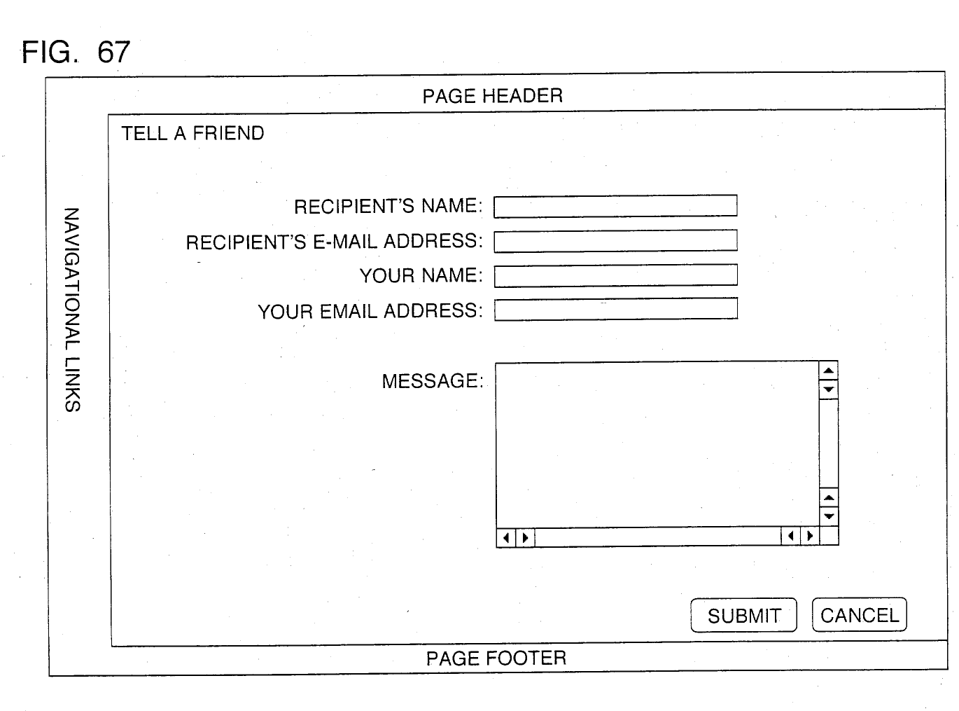

The trial locations page can provide a patron with a list of locations at which the trial is being administered, as illustrated in FIG. 65. In the title area, the name of the trial can appear. In the locations area, the city, state, zip code and facility name where the trial is being held are listed. The list is sorted by state, then by city name. A patron can browse the list and click the link of a location of their choice.

Other embodiments of the present invention may include an linked alphanumeric area in which a patron can click on the first letter of a state's name to reach the locations in that state.

Other embodiments of the present invention may use a pull-down menu of states, sponsors, investigators, or institutes that conduct trials in lieu of a list of linked locations.

Other embodiments of the present invention may show the trial detail information prior to trial location information.

Other embodiments of the present invention may show the trial detail information with the trial information on the same page.

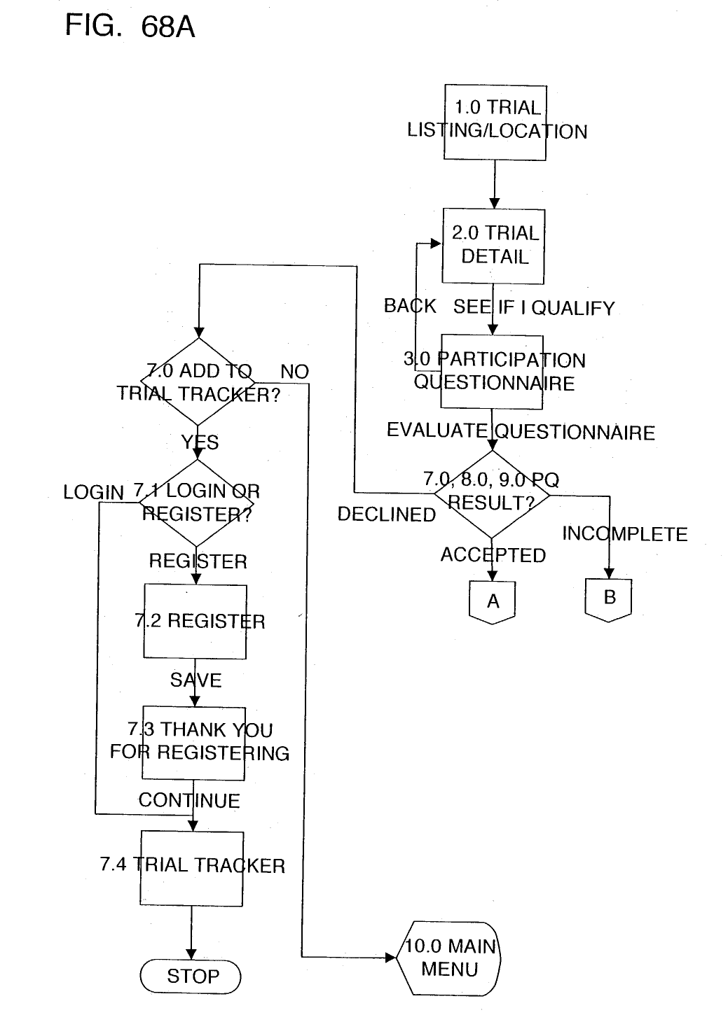

In one embodiment, a patron click a location name (for a trial with only one location), to bring the patron to the trial detail page, as illustrated in FIG. 66. Here the patron is provided with detailed information about the trial in order to assist the patron in determining the relevancy of that trial to him/her or their subject. In the title area, the name of the trial can be presented. In the trial information area, a patron can view the trial location selected by a patron and the rationale, purpose, eligibility, treatment, and sponsor/investigator for the trial. The contents of the page are presented in the lay view by default. However there is an option to toggle to a medical view which contains more technical and more detailed information about the trial. Also in the trial information area, there are buttons to provide a patron with contact information for the trial sponsor/investigator, print the trial information, add the trial information to their trial sentinel, return to their search/browse results, conduct a new search, and in some cases, see if they qualify for the trial. A patron is taken directly to the prescreen if they click on the “see if I qualify” button. If a patron clicks the print the trial information button, a pop-up window can appear with lay and medical views of all of the trial information discusses previously.

Other embodiments of the present invention may vary in the amount of information provided on the trial detail page. Information can include, but is not limited to contact information for the trial investigator, clinical trial drug information, clinical trial enrollment criteria, clinical trial design information, disease information, reports, and/or newsletters.

Other embodiments of the present invention may list the side effects that may be experience if a person participates in a trial and is placed in the test group during the trial.

Other embodiments of the present invention may include a link to customer service, an email, phone, or live chat interface, that a patron may click to reach the administrator or inventor.

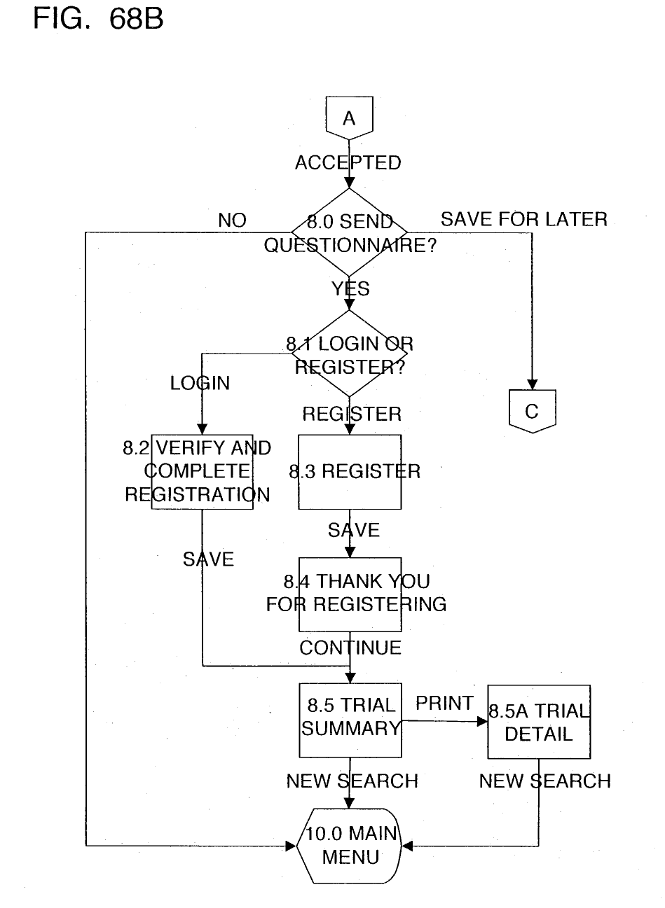

One embodiment includes a “tell a friend” link that can allow a patron to send an email link to a particular page within the module to an email address of their choosing. The tell a friend page, as illustrated in FIG. 67, can allow a user to send this link. In the address area, a patron can enter his her name, email address and the recipient's name and email address. First names and email addresses can be required; last names may not be required. The email sent can include a generic message, to protect the recipient's privacy, informing the recipient that the sender has found information of interest to the recipient. By clicking on the link provided in the email, the recipient can view the trial detail. The transaction can be recorded in the database, so that the administrators can monitor use of the feature and types of information being forwarded, but the identifying information of both the sender and the recipient cannot used for any purposes.

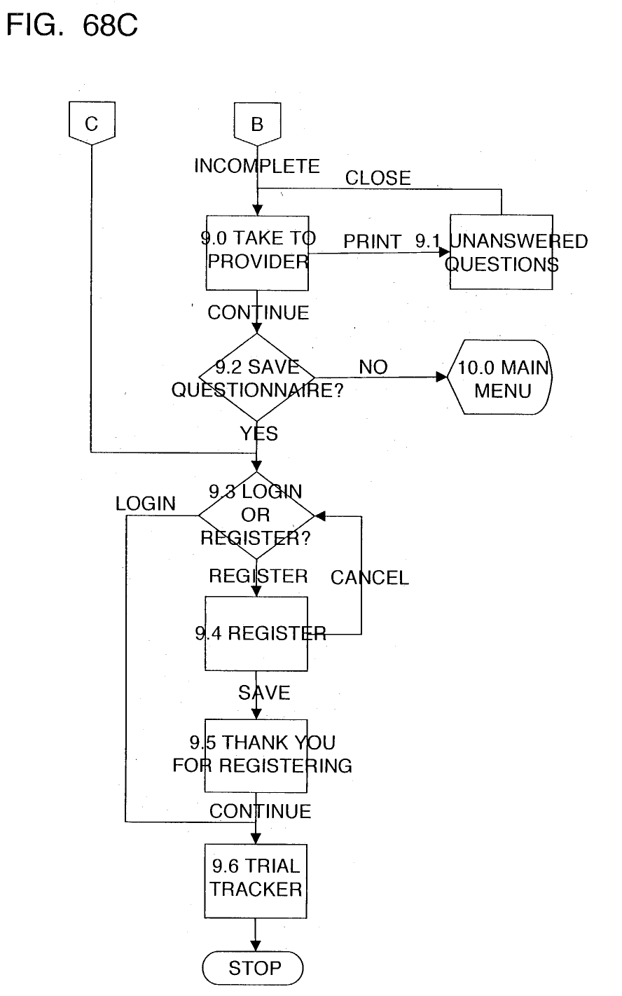

A patron may prescreened for a trial by completing an online, brief questionnaire to determine if they meet the preliminary eligibility requirements for a trial. Unless they have passed and submitted the prescreen, they can take the prescreen as many times as they would like (e.g., if their condition or treatments change). FIG. 68 illustrates the possible scenarios a patron can face with respect to whether or not they are logged in at the time they take a prescreen and to the results of the prescreen.

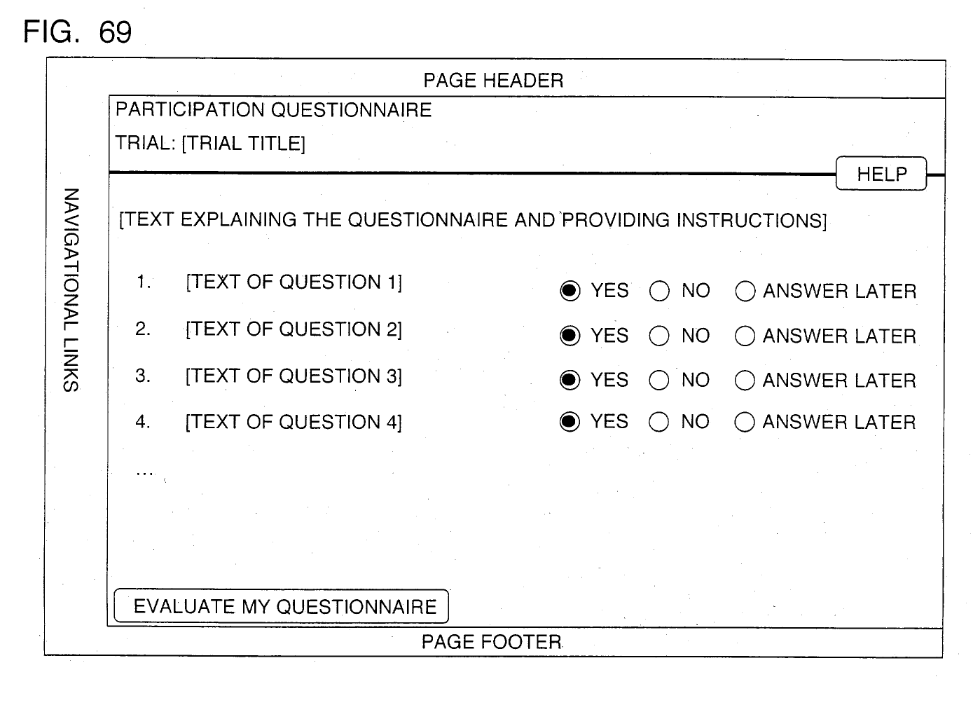

As illustrated in FIG. 69, a patron can answer yes/no/answer later to questions online to determine their preliminary eligibility. In the title area, the name of the trial can appear. In the questions area, a list of about ten yes/no/answer later questions can appear with radio buttons available for a patron to enter their responses. A patron can complete the questionnaire and click the evaluate my questionnaire button to receive the results of their prescreen. The answers entered by a patron can be verified by the module with the “correct” answers in the database (previously provided by the trial sponsor/investigator) and presented to a patron with the prescreen results page.

Other embodiments of the present invention may display the prescreen questionnaire or instructions on multiple pages.

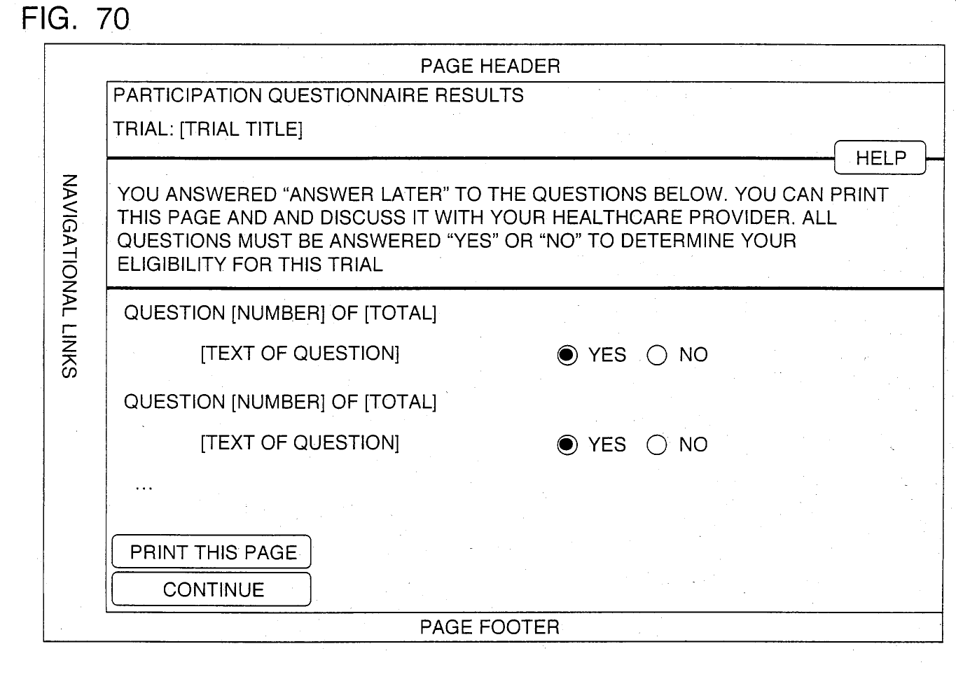

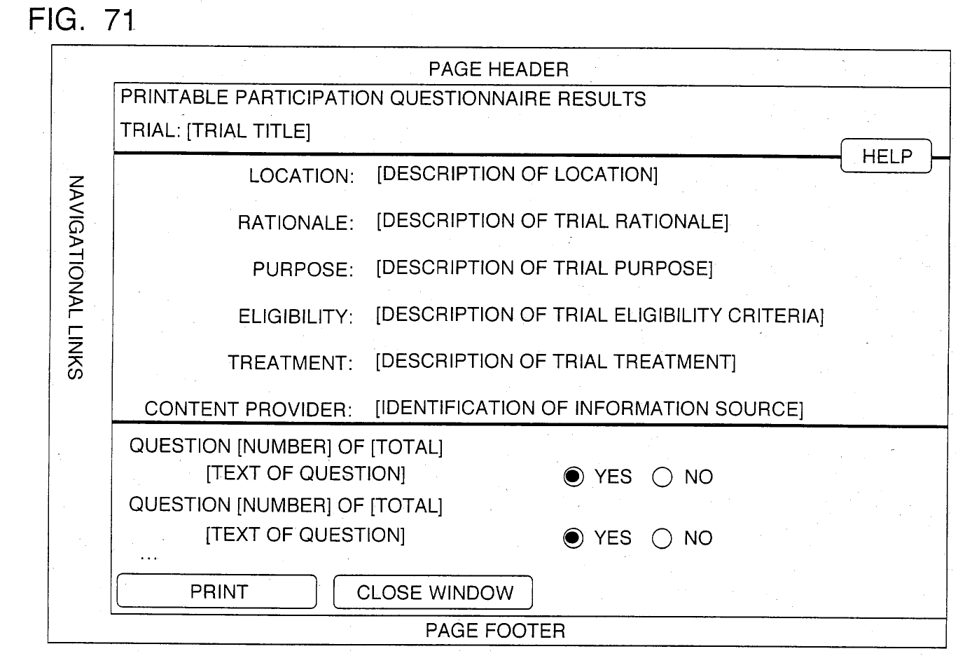

In one embodiment, if any questions are not answered or if a patron responds “answer later”, the prescreen results page can indicate such to the patron and lists these questions. In the prescreen results page for incomplete prescreens, as illustrated in FIG. 70, the information area informs a patron that their prescreen is incomplete and lists the questions to which a patron responded “answer later” and questions not answered by a patron. Also in the information area is a button that allows a patron to print the information in order to take to the doctor page, as illustrated in FIG. 71, and the items left unanswered or with “answer later” responses for a patron's HCP.

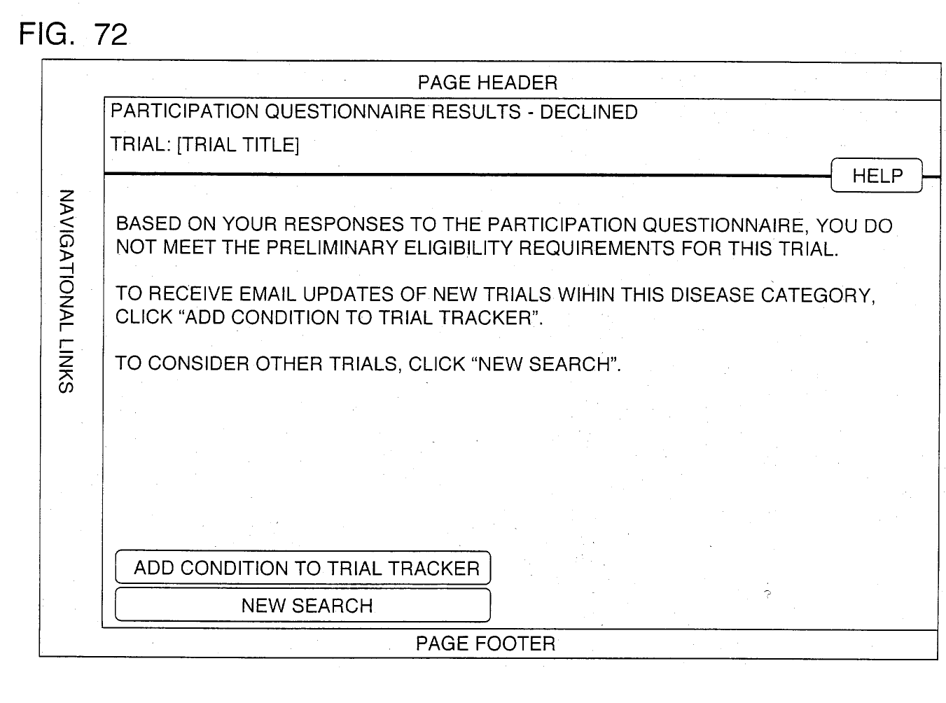

In one embodiment, if a patron's responses to a prescreen are such that they do not meet preliminary eligibility requirements for the trial, the prescreen results page can indicate such, as illustrated in FIG. 72. In the information area, text indicating that a patron does not meet preliminary eligibility requirements exists in addition to buttons to save the trial (and prescreen) to the trial sentinel or begin a new search from the main menu page.

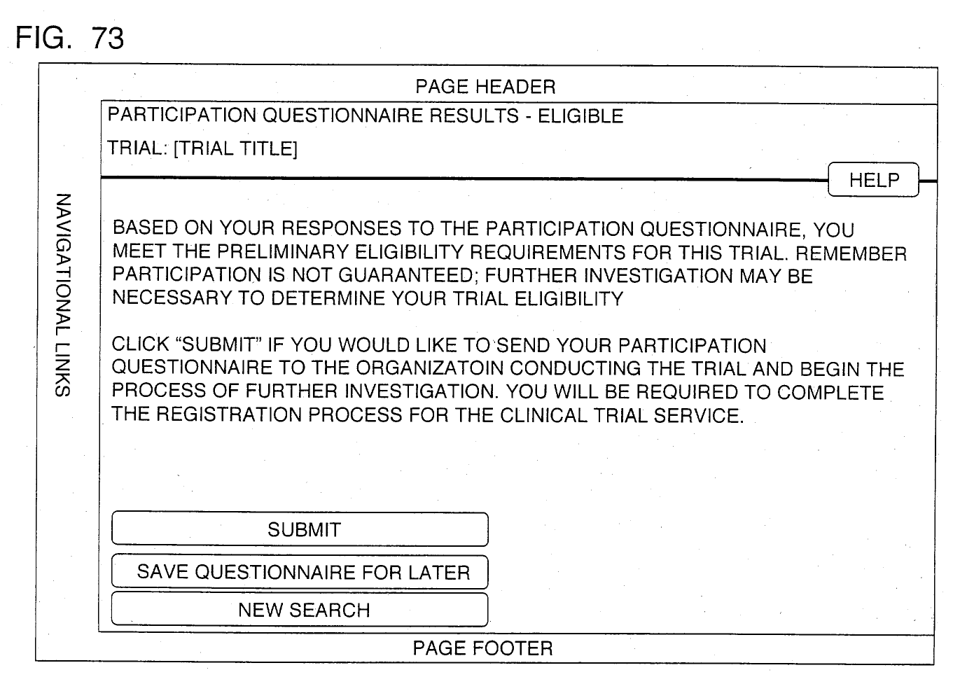

In one embodiment, if a patron's responses to a prescreen are such that they meet preliminary eligibility requirements for the trial, the prescreen results page can indicate such, as illustrated in FIG. 73. In the information area, text indicating that a patron meets preliminary eligibility requirements exists in addition to buttons to save the trial (and prescreen) to the trial sentinel, submit the prescreen to the trial sponsor/investigator, or begin a new search from the main menu page.

In one embodiment, if a patron clicks the submit button and they are not logged in, they can be taken to the login page. A patron can log in and is sent to the edit/update contact information page. If a patron clicks the submit button and they are logged in, the patron is taken directly to the edit/update contact information page. If a patron clicks the submit button and does not have an account with the module, they can be sent to the login page. A patron clicks the register button and is taken to the register page described previously.

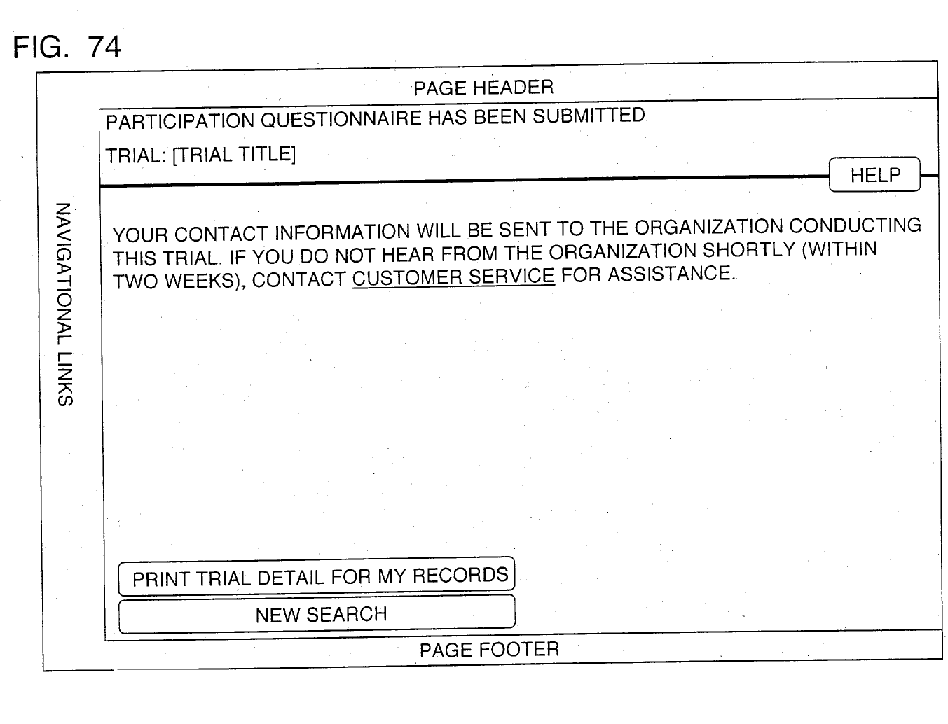

In one embodiment, once a patron clicks the submit button on the edit/update contact information page, they can be presented with the prescreen submitted page. The prescreen submitted page can inform a patron that their contact information and passed prescreen are being submitted to the trial investigator/sponsor, as illustrated in FIG. 74. In the information area, a patron can view a message regarding the submission of their information to the trial investigator/sponsor. Also in the information area are buttons to allow a patron to print the detailed information about the trial as well as the questionnaire with their responses or begin a new search from the main menu page.

Other embodiments of the present invention give a patron, acting as an advocate, the ability to save the prescreen to a particular subject profile in the trial sentinel.

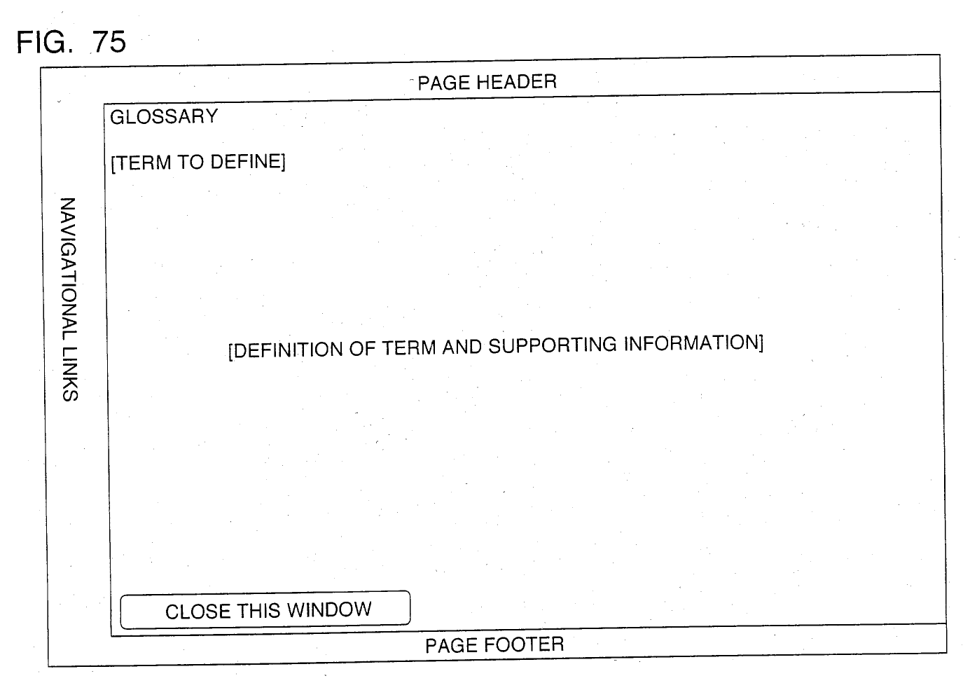

In one embodiment, the glossary can provide a patron with definitions of unfamiliar or complex medical terms. A patron can click on words within the module for which there are glossary entries. Words with glossary entries are denoted with a different font color and size than the text on each page. A patron can click on the linked glossary item and a popup window appears containing the glossary item and its definition, as illustrated in FIG. 75.

Another embodiment of the present invention is the sponsor module, which provides sponsors with the ability to manage their account, submitting a new trial to be presented in other service modules, modify trial information, and view reports on pre-screened patrons.

Other embodiments of the present invention may include the creation of a website for a sponsor.

Other embodiments of the present invention may include customizing the clinical trial service for the sponsor; that is, allowing sponsor users to view only the sponsor's trials and information appropriate for the sponsor.

In one embodiment, methods and systems are provided that improve the clinical trial process through a module for clinical trial sponsors and investigators. Upon entering the sponsor module, a sponsor/investigator is directed to the sponsor login page, similar to the patron login page, as illustrated in FIG. 4. In the login area, the sponsor/investigator can be prompted for their username and password. A sponsor/investigator can enter this information, click the submit button. If their username and password are validated through a secure electronic authentication mechanism (e.g., digital certificate, digitally encoded smart card, digitally encoded browser cookie, or digitally encoded dongle), then the sponsor can be directed to the sponsor options page. If an investigator successfully completes the login process, they can be directed to the trial administrator options page. If their username is incorrect, a sponsor/investigator can be returned to the login page and an instructional error message can appear at the top. If the sponsor/investigator has forgotten their password, they can access the password modification process, specifically, the find accounts page, and enter a new password after some identity verification by clicking the forgot your password? link in the links area. Also in the links area can be a new user link that, when clicked by a sponsor, directs the sponsor to the sponsor pre-registration page. If the sponsor/investigator has created an account and elected to store their login information on their module access device, the sponsor's username and password can be encrypted and stored in a file on the sponsor's/investigator's module access device.

In one embodiment, the first step to retrieving a sponsor's/investigator's forgotten password is to confirm that an account does in fact exist with the module. The find account page, as illustrated in FIG. 50, asks a sponsor/investigator for their username and zip code and is displayed to a sponsor/investigator if they click the forget your password link on the sponsor login page. In the account information area, a sponsor/investigator can enter their username and zip code. The module verifies that an account exists. If no account is found in the database, the find account page can appear with an error message. If an account is found, the sponsor/investigator can be directed to the password question page.

In one embodiment, a sponsor/investigator can reach the password question page, as illustrated in FIG. 51, if an account is found in the database that matches the information a sponsor/investigator enters on the find accounts page. In the password question area, a sponsor's/investigator's password question can appear above a textbox for the answer. A sponsor/investigator can enter the answer to that question and then submits it by clicking the submit button. The module verifies that the answer to the password question is the same as that stored by a sponsor/investigator during registration. If the answer given matches the answer in the selected account record, a sponsor/investigator is directed to the password modification. If the answer given does not match, the password question page appears to the sponsor/investigator with an error message.

In one embodiment, the password modification page, as illustrated in FIG. 52, enables a sponsor/investigator to change their password. In the password modification area, a sponsor' username is displayed along with a password textbox, and a password verification textbox. A sponsor/investigator can enter his or her new password into the password textbox, re-enter it into the password validation textbox, and then click the submit button. The module can verify that the two password entries are identical and valid. If the entries are valid, the password can be saved to the database as part of the sponsor's/investigator's account record and the sponsor/investigator can be directed to the account update confirmation page. If the entries are not valid, the password modification page can appear with an error message and a sponsor/investigator can be required to reenter the aforementioned information.

In one embodiment, the account update confirmation page, as illustrated in FIG. 59, informs the sponsor/investigator that they have successfully changed the password for their account via text in the password modification confirmation area. Also in the password modification confirmation area is a link to the sponsor options page.

Other embodiments of the present invention may redirect a sponsor/investigator directly to the sponsor pre-registration page to create a new account if the password answer does not match. Other embodiments of the present invention may combine the functionality of the find account, password question, and password modification pages.

In one embodiment, registration for the sponsor module involves pre-registration, review and approval, and complete registration processes. Potential sponsors are required to first submit pre-registration information, a sponsorship proposal, to the administrator. The potential sponsor is either approved or not approved by the administrator. (Information about the criteria can be found in the explanation of the Admin Module.) An email is sent by the administrator to the potential sponsor indicating their approval or disapproval. If the sponsor is approved, the email contains a link back to the sponsor module, so that the sponsor can login and complete the registration process, which includes detailed profile and page layout information and preferences, although once a sponsor completes their pre-registration, they can begin the process of completing the detailed profile and page layout information. If the sponsor is not approved, the administrator can provide an explanation describing their reasons for declining the sponsorship proposal.

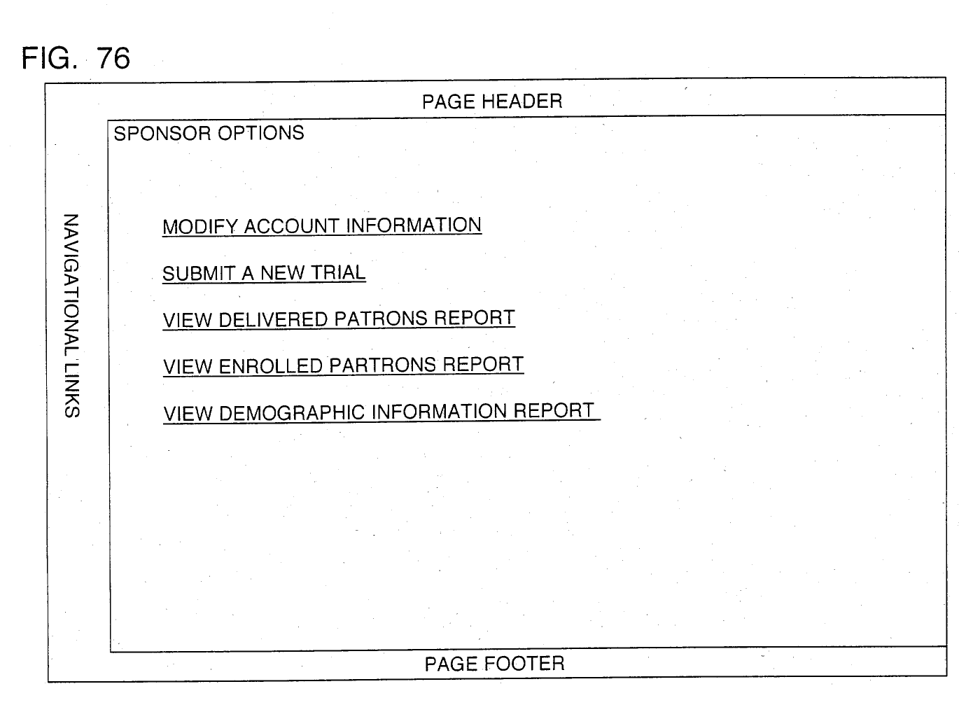

From the sponsor login page, in one embodiment, a sponsor is presented with the sponsor options page, as illustrated in FIG. 76, in which a sponsor can add/update the sponsor profile, submit a new trial for use in other service modules, modify an existing trial as well as view the delivered patrons, enrolled patrons, or demographic information reports. All links can be available to the sponsor in the options area of the sponsor options page. Details of the functionality of each option are discussed in the following sections.

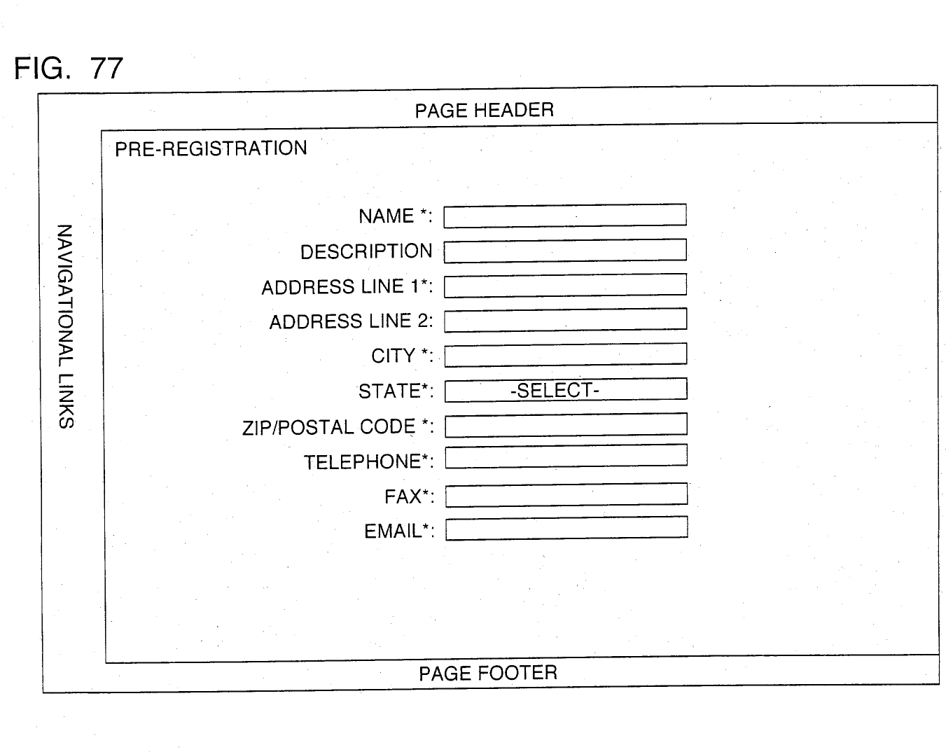

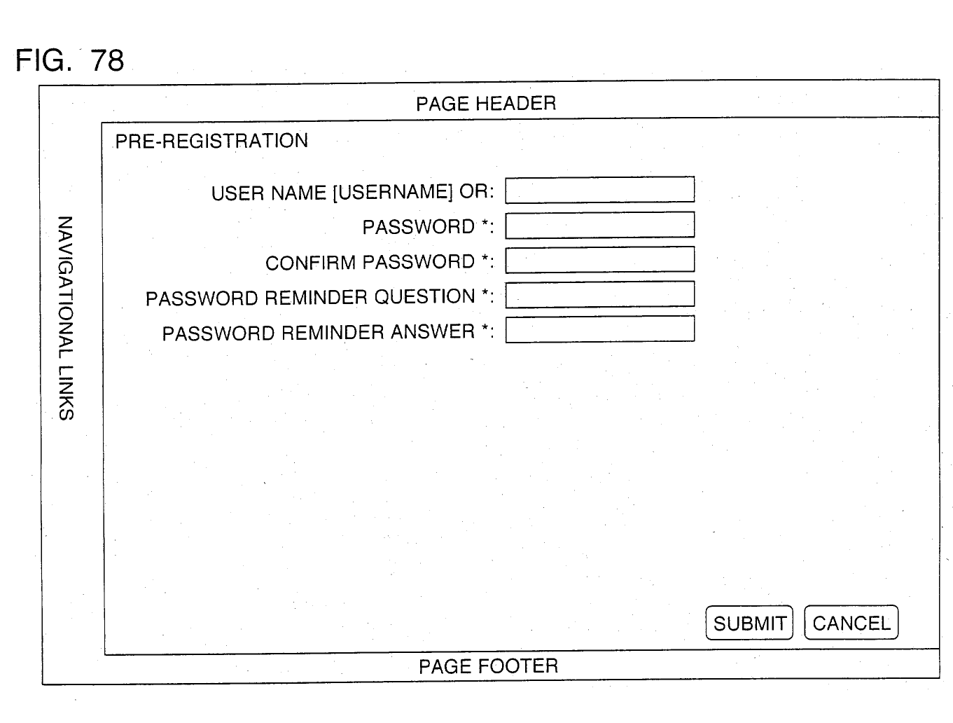

In one embodiment, a sponsor accesses the sponsor pre-registration page from the new user link on the sponsor login page or from the link on the sponsor options page. The sponsor pre-registration page, as illustrated in FIG. 77 and FIG. 78, allows a potential sponsor to create a temporary account with the module; temporary, because the potential sponsor must be reviewed and approved by the administrator/inventor. In the general sponsor information area, a sponsor enters the name of the sponsor organization and its description. In the sponsor business contact information area, the sponsor enters their first name, last name, address, city, state/province, region, zip/postal code, country, telephone and fax numbers and email address. In the login information area, the sponsor enters their preferred username, password, password again for verification of entry, and a password question and answer in case a sponsor forgets their password in the future. If the sponsor has completed this page previously, their username appears as static text. Also in the login information area is submit button and a cancel button. If a sponsor clicks the cancel button, the information entered/updated in the sponsor pre-registration page is not saved and the sponsor can be returned to the page they were viewing prior to reaching the sponsor pre-registration page. If, after entering/updating information in the sponsor pre-registration page, the partner clicks the submit button, the information is saved to the database, the administrator is notified of the new/updated pre-registration application via an email, and the sponsor is directed to the sponsor options page if this is not the first submission of pre-registration information. If this is the first time a sponsor completes pre-registration, they are directed to a sponsor marketing page, on which are the benefits of becoming a sponsor and information about the review and approval process for sponsorship.

In one embodiment, the information on this page is pre-populated if the partner is currently logged in and has entered information in the partner pre-registration page. If the user has accessed this page by clicking the new partner link on the partner login page, all of the page elements described previously are blank.

When new/updated information is submitted to the administrator, it is be reviewed and approved by the administrator before the changes are implemented in the modules.

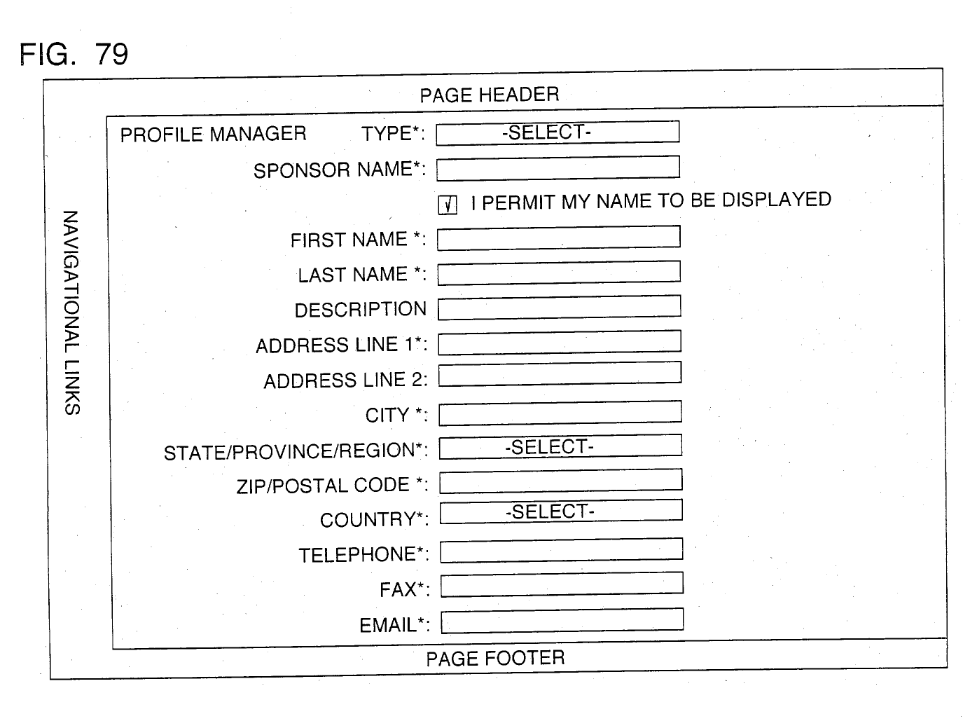

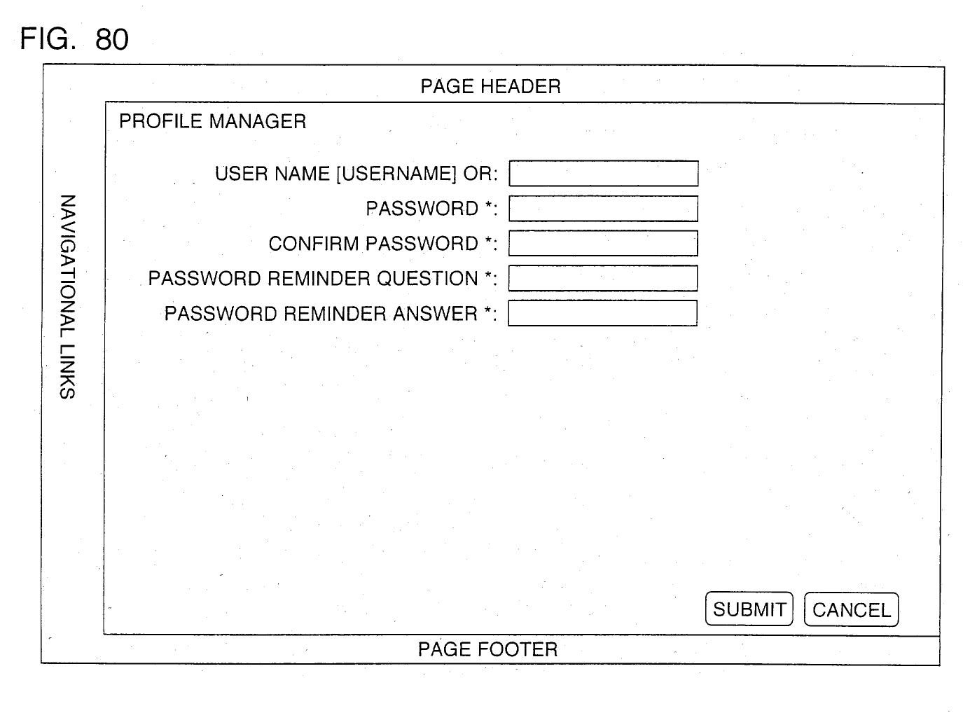

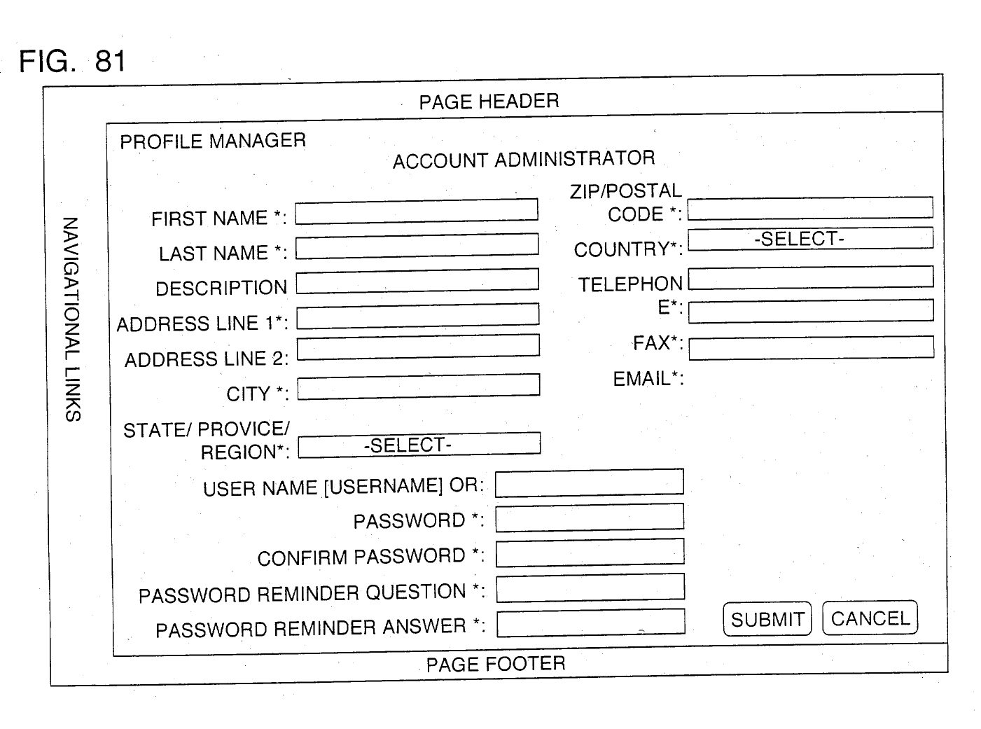

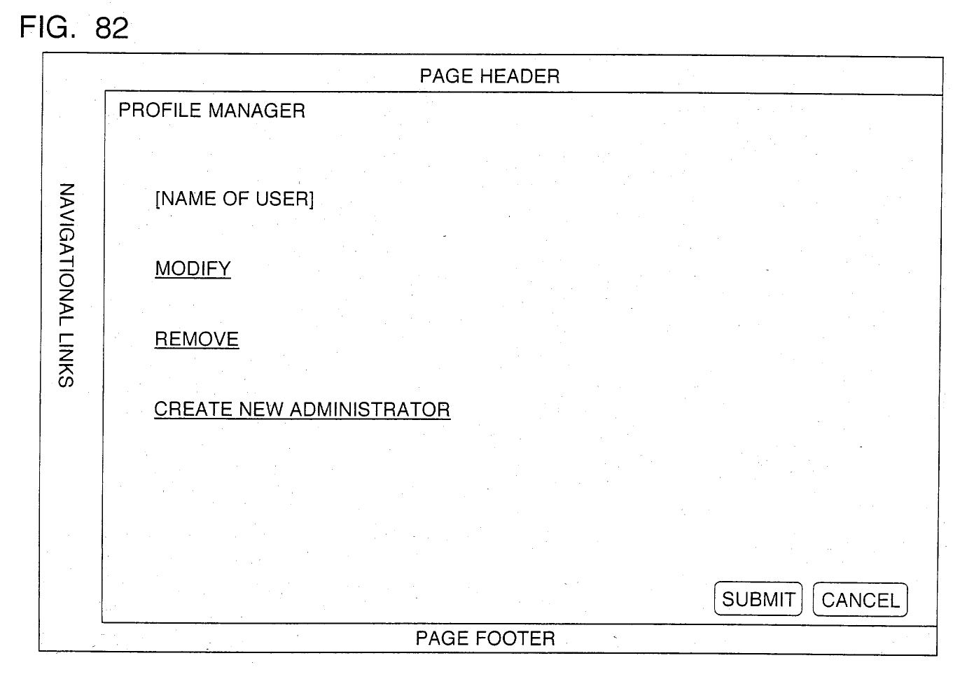

In one embodiment, from the sponsor profile management page, as illustrated in FIGS. 79, 80, 81 and 82, a sponsor can add or modify their sponsor profile. Availability of information in the sponsor profile management page can be determined by the permissions associated with the various sponsor actors. The permission scheme can be hierarchical with the business contact at the top followed by the account administrator, and the trial administrator. If the logged in person does not have modification access to certain information on the page, the information still can appear, but simply as static text.

In the general sponsor information area on the sponsor profile management page, a patron can enter/edit the type of patron module presentation (basic or premium), sponsor name, indication that the sponsor would like the sponsor name to appear to patrons, and description of the sponsor. In the sponsor business contact area, a sponsor enters/edits their first name, last name, address, city, state/province/region, country, phone number, fax number, and email address. Also in the business contact information area, a sponsor can enter the business contact's username (text display if updating sponsor profile), password, password again for verification as well as a password question and answer. In the account administrator information area, the sponsor can enter the sponsor administrator's first name, last name, address city, state/province/region, zip/postal code, country, phone number, fax number, and email address. Also in the account administrator information area, a sponsor can enter the administrator's username (text display if updating sponsor profile), password, password again for verification as well as a password question and answer. The fields related to the administrator and business contact and their usernames and passwords can only visible to the administrator or business contact, respectively, if they are viewing this page. In the trial administrator managed list area, the sponsor views the list of trial administrators added to the module. Here, the sponsor can remove trial administrators from the list or can click a link to create a new administrator, where they can be directed to the trial administrator management page. Also in the trial administrator managed list area can be a submit button and a cancel button. If the sponsor clicks the cancel button, no information is saved to the database and the sponsor can be directed the sponsor options page. If the sponsor clicks the submit button, the sponsor can be directed to sponsor profile preview page.

In one embodiment, the information on this page is pre-populated if the sponsor is currently logged in and information has already been saved to the database. Any additions or modifications submitted via this page may reviewed and approved by the administrator before they are used in the service module. If the user is an approved sponsor, the entry point URL may be displayed.

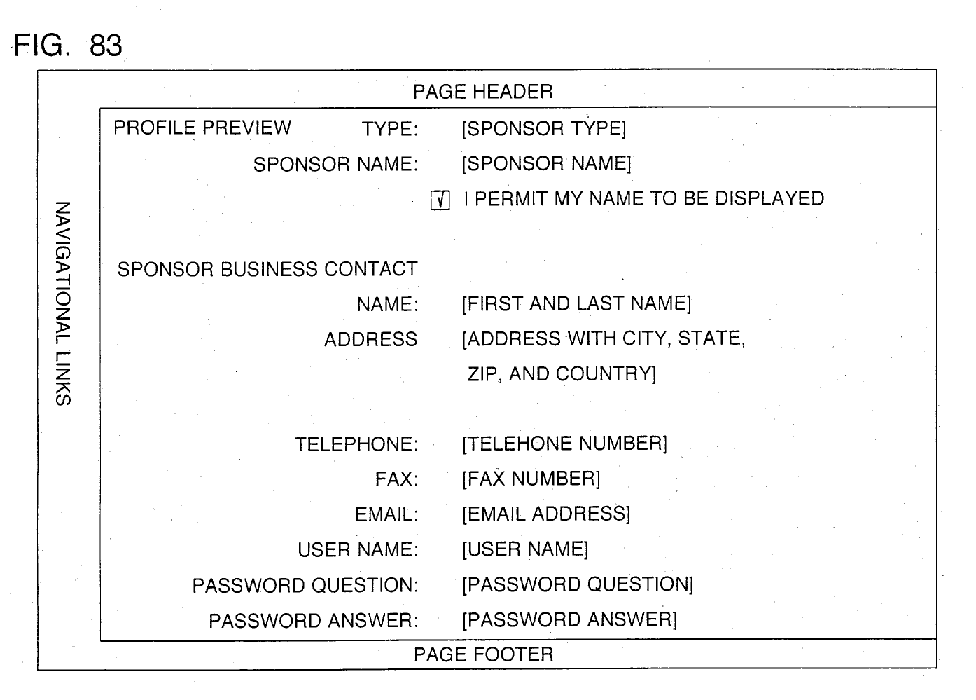

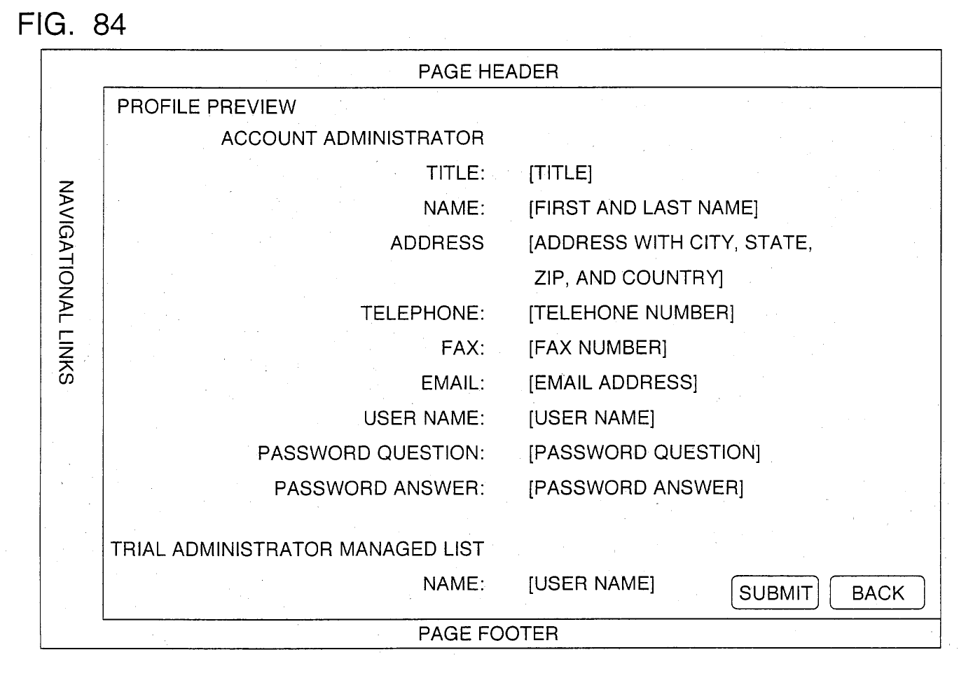

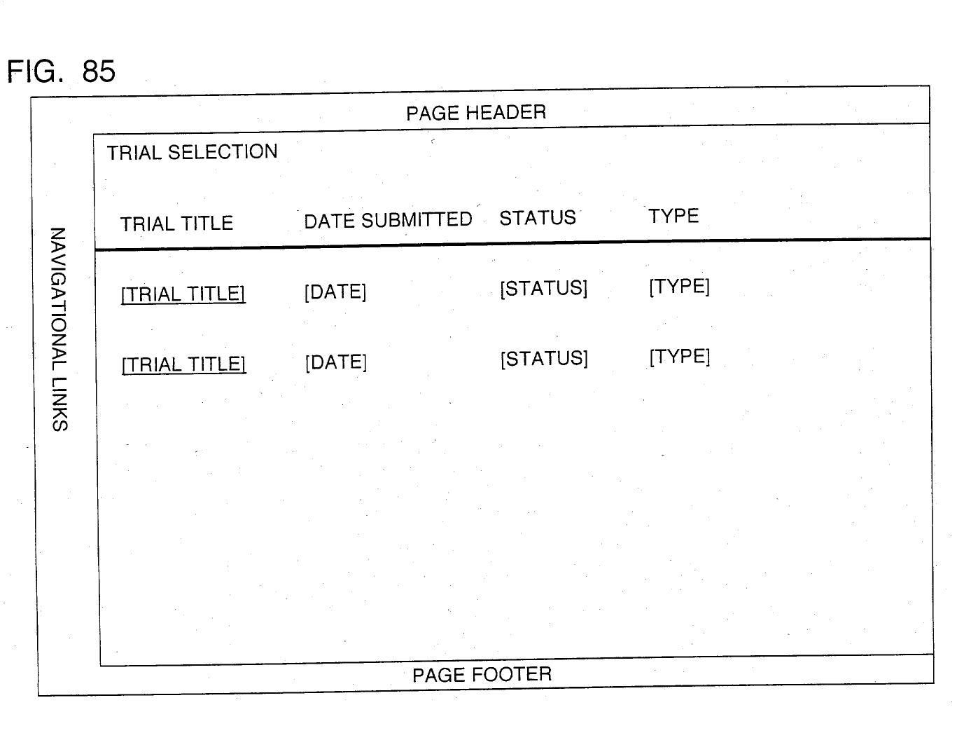

In one embodiment, before the new/updated information is saved to the database, the sponsor actor reviews their entries in the sponsor profile preview page, as illustrated in FIGS. 83 and 84. Here, the sponsor business contact, account administrator, or the trial administrator can preview their additions or changes. All information can be displayed statically according to the hierarchy of sponsor actors. In the trial administrator managed list can be a submit button and a back button. If the sponsor actor clicks the submit button, the information entered/updated in the sponsor profile management page is saved to the database, the administrator is alerted to the updates via email, and the sponsor actor can be redirected to the sponsor options page. If the back button is clicked, the sponsor actor is directed to the sponsor profile management page, where they can edit the information entered there.

Other embodiments of the present invention may require different combinations of information about the sponsor; fax number, for example, may be optional.

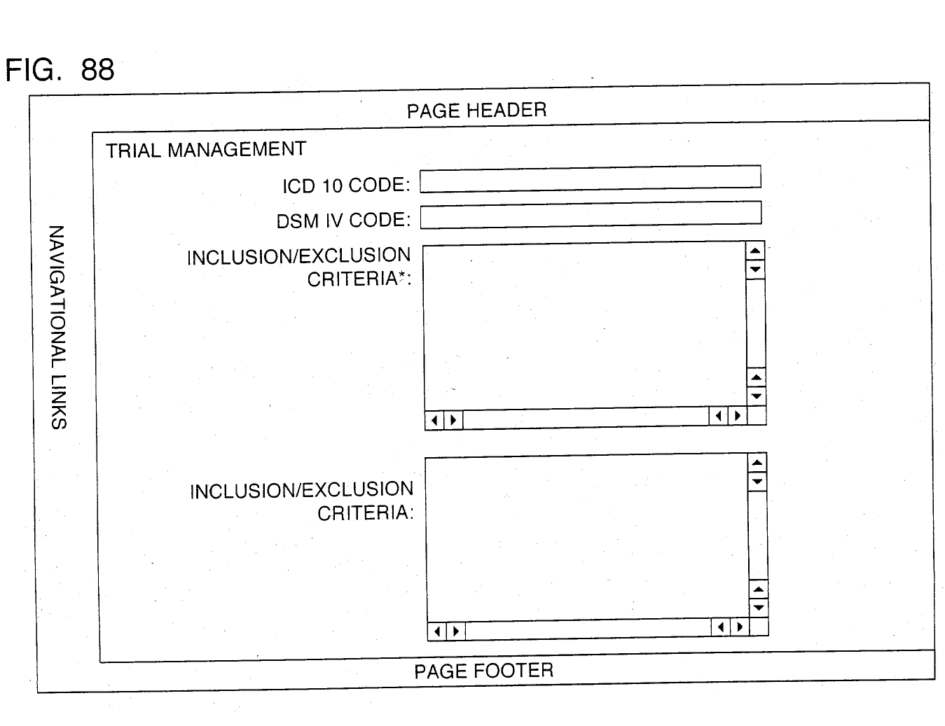

In one embodiment, to update a trial, a sponsor can click the modify a trial link on the sponsor options page and can be directed to the trial selection page, as illustrated in FIG. 88. In the trial selection area, a linked and comprehensive list of trials for that sponsor can be presented to a sponsor. The list of trial can be displayed dynamically and ordered by the sponsor's trial numbers. A sponsor can click the linked trial name of interest to him/her and can be directed to the trial management page for that trial. Also in the trial selection area can be the date the trial was last submitted, the status of the trial (pending/rejected), and the type of the last submission (add/change).

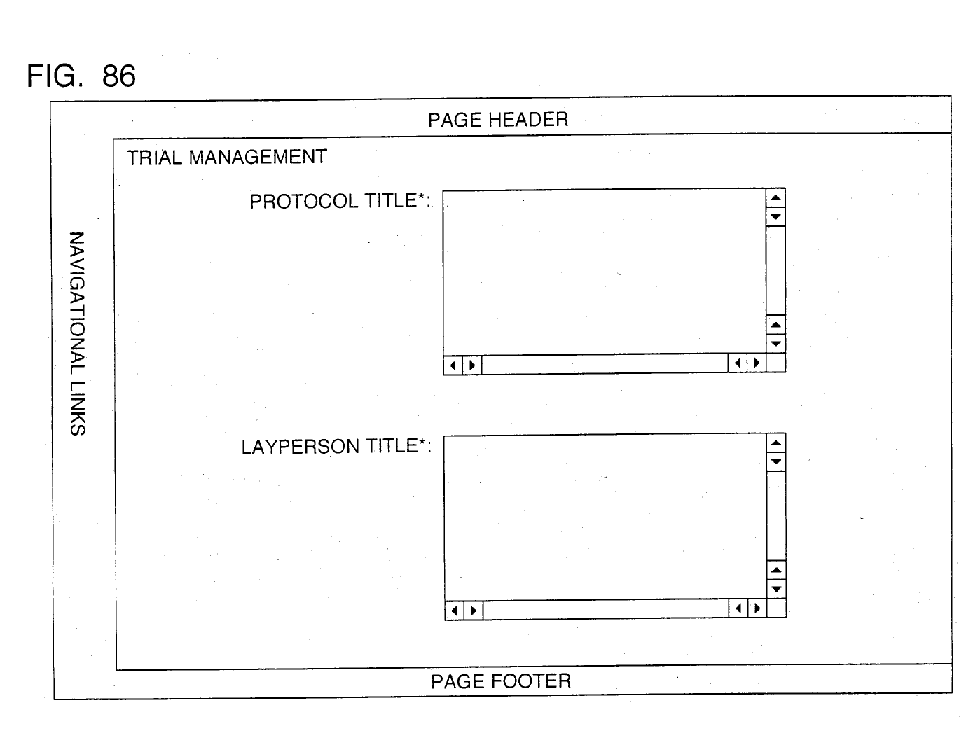

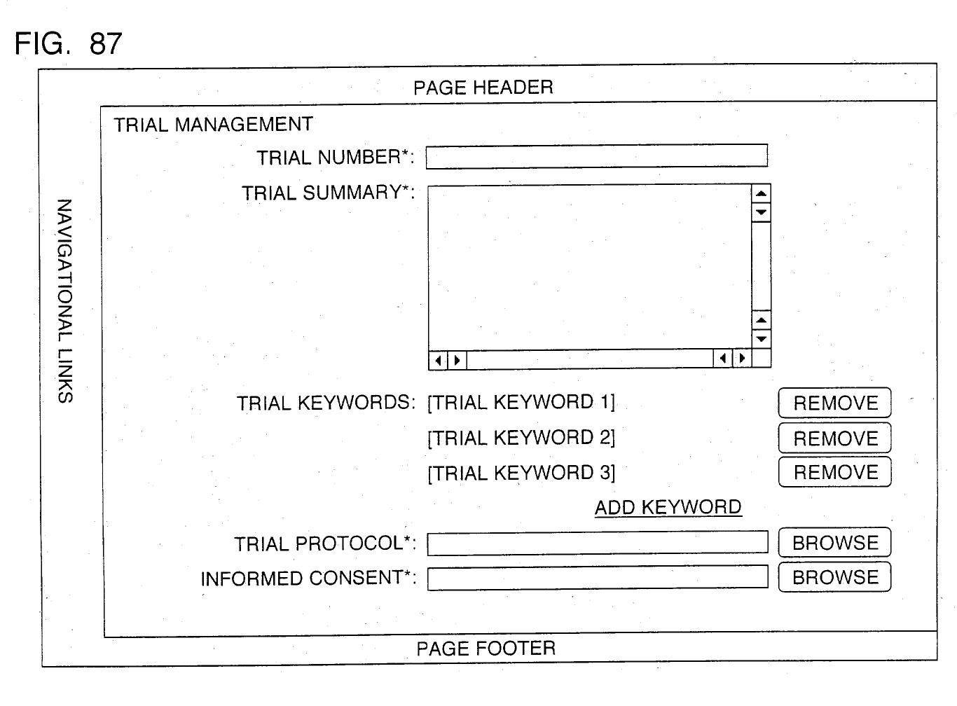

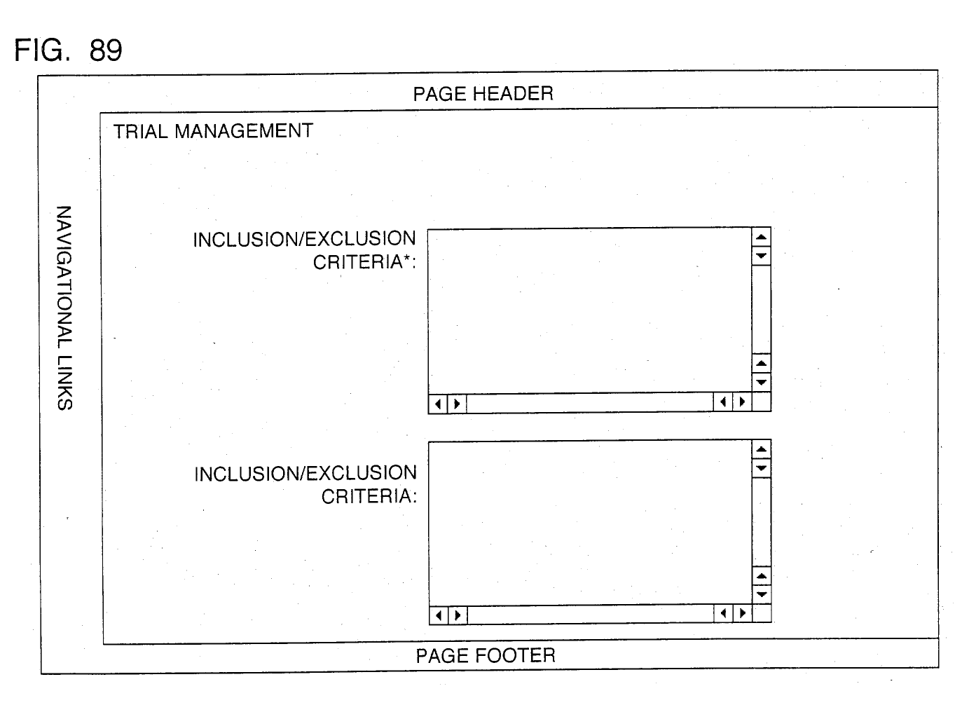

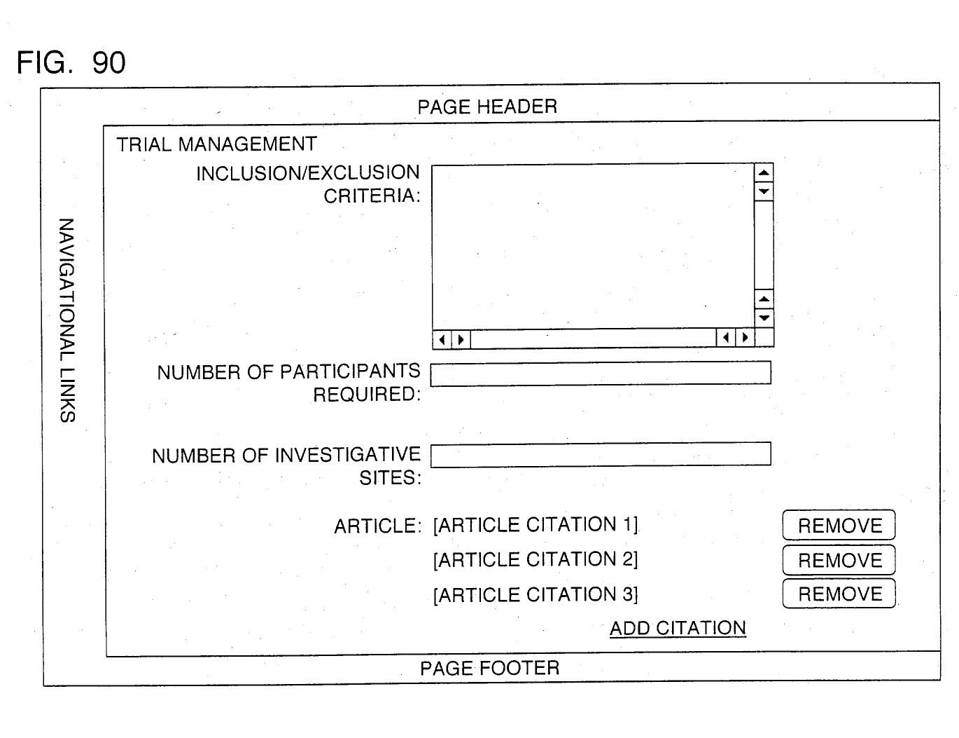

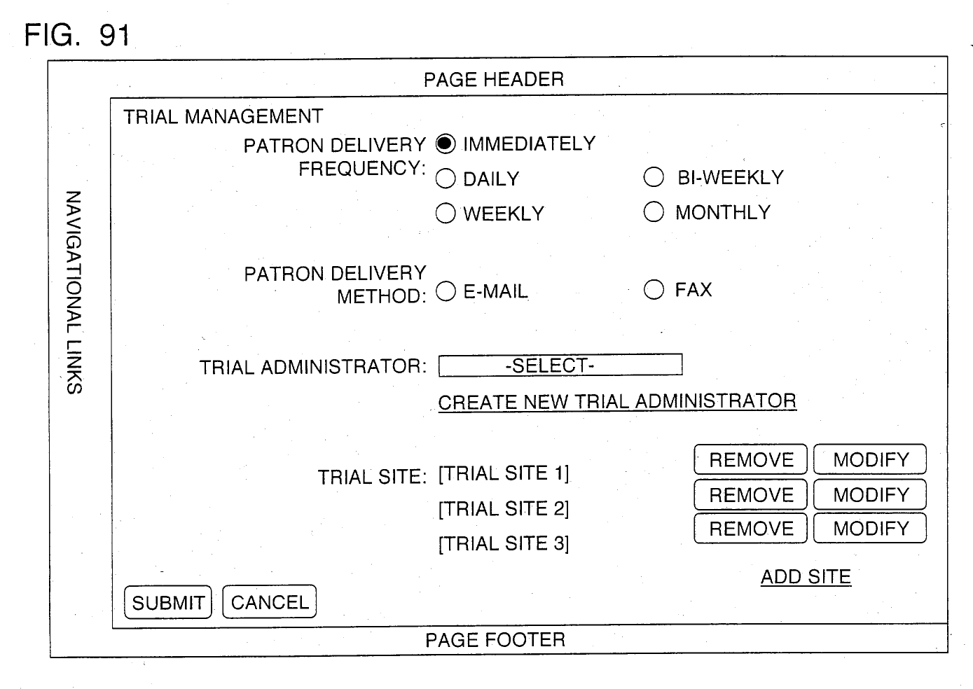

In one embodiment, in the trial management page for a trial, a sponsor can add or modify the information about a particular trial, as illustrated in FIGS. 86, 87, 88, 89, 90, and 91. In the trial information area, a sponsor can enter/update the protocol title, layperson title, trial number, trial summary, and treatment plan. Trial keywords can also be presented in this area as a managed list. Each keyword can be viewable as plain text and next to each keyword can be a remove button. If the sponsor clicks the remove button, the corresponding keyword can be removed from the trial profile and the sponsor can be returned to the trial management page. The sponsor can add a keyword to the Trial by clicking the add keyword link, which can direct him/her to the add keyword page. In the trial information, a sponsor can also enter the trial protocol filename, informed consent filename, ICD 10 Code, DSM IV code, inclusion/exclusion criteria, number of participants required for the trial, and the number of investigative sites. The informed consent and trial protocol files can be prepared for upload by entering their file paths in their respective file textboxes. The actual upload can occur after a sponsor clicks the submit button. Citations associated with a trial can also be presented as a managed list. Each citation title can be viewable as plain text and next to each citation title can be a remove button. If the sponsor clicks the remove button, the corresponding citation can be removed from the trial profile and the sponsor can be returned to the trial management page. The sponsor can add a citation to the Trial by clicking the add citation link, which can direct him/her to the add article citation page. In the premium sponsor area of the trial management page, a sponsor can add or modify patron delivery mechanism and frequency of patron referral to the trial. From radio buttons, a sponsor can select the frequency (immediately, daily, weekly, biweekly, or monthly) and method (email, or fax) of patron referral. In the trial administrator area, a drop-down list of trial administrators can be available to the sponsor. The sponsor can select a trial administrator from the list or, if the list does not include the administrator the sponsor needs, the sponsor can create a new trial administrator by clicking on a create a new administrator link, also in the trial administrator area, and being directed to trial administrator management page. Once the creation is complete, the sponsor can be redirected back to the trial management page to continue with entering/updating trial information. In the trial site area, trial site information can be presented as a managed list. Next to each plain text trial site can be two buttons—a modify button and a remove button. If the sponsor clicks the modify button, they can be directed to the trial site management page. If the sponsor clicks the remove button, the corresponding investigative site can be removed from the trial profile. The sponsor can add a site to the trial by clicking the add site link, which can direct him/her to the investigative site selection page. In the prescreen area (not pictured), a text link indicating that prescreen information has/has not been entered can appear. The sponsor can update/enter prescreen questions in the trial prescreen entry page. Once the update/entry is complete, the sponsor can be redirected back to the trial management page to continue entering/updating trial information. Finally, in the controls area, a sponsor can click the submit button to be redirected to the trial preview page. If the sponsor clicks the cancel button, the sponsor can be redirected to the sponsor options page.

In one embodiment, if the sponsor accesses the trial management page via the trial selection page, the trial information is be pre-populated; otherwise, the fields in this page can be blank. Also, only sponsors that are premium may be able to indicate the total number of participants for a trial, article links and citations, and the frequency and method of patron referral.

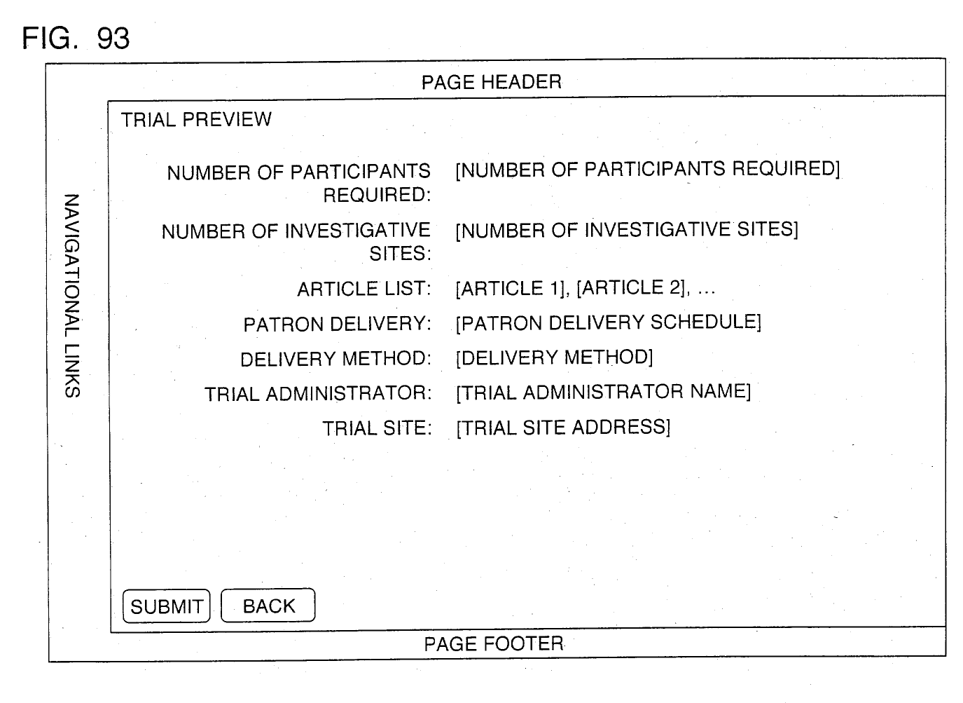

In one embodiment, before the data entered in the trial management page are saved to the database, the sponsor can preview all the information about the trial in the trial preview page, as illustrated in FIG. 92 and FIG. 93. Once the sponsor is satisfied with the added/modified trial information, they can submit the information to the administrator/inventor for review by clicking the submit button. This can trigger an email notification to be sent to the administrator. If the sponsor clicks the back button, they can be taken back to the trial management page where they can edit the information about the trial.

Other embodiments of the present invention may include the ability to integrate a sponsor's system, such that trial information could be electronically loaded to the database.

Other embodiments of the present invention may capture information about a particular trial from other sources.

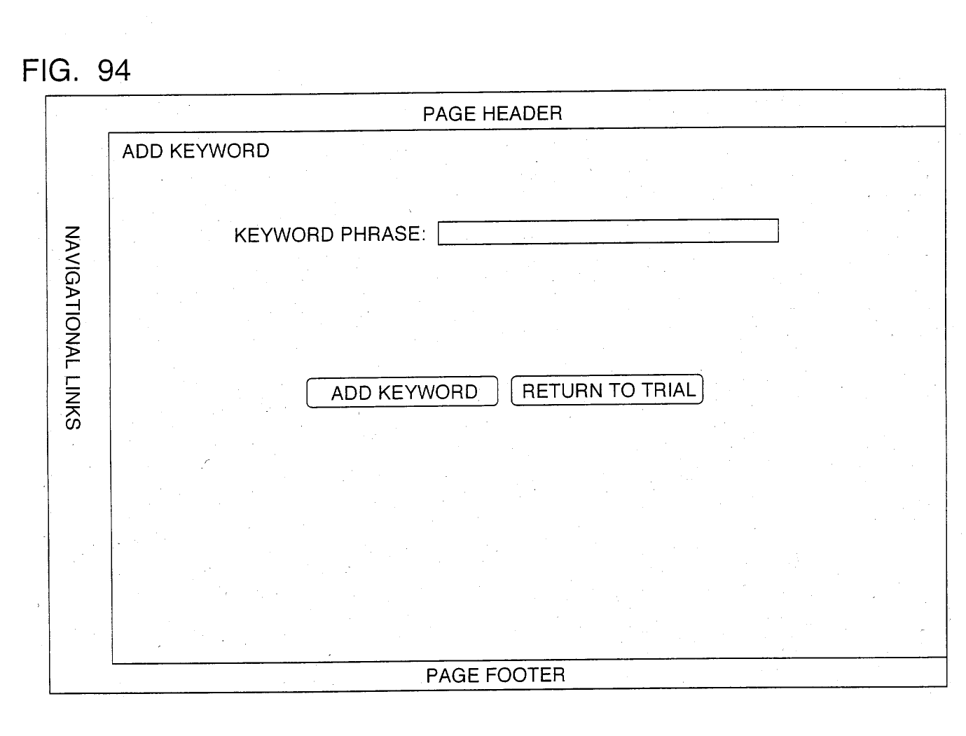

In one embodiment, sponsors choose to associate keywords with a trial to improve the “hits” on the trial. These keywords are used in the patron and physician modules when persons perform keyword searches. Sponsors add keywords to a trial in the add keyword page, as illustrated in FIG. 94. A sponsor can add keywords one at a time in a textbox in the add keyword phrase area of the page. The sponsor can click the add keyword button to add the phrase they entered in the keyword phrase textbox to the trial. If a valid keyword phrase is entered by a sponsor, it can be added to the trial profile and the module can redirect the sponsor to the add keyword page with the keyword phrase textbox cleared.

In one embodiment, when the sponsor wishes to return to the trial management page, they can click the return to trial button. If the keyword phrase textbox is not blank, the sponsor can be redirected to the add keyword page where the textbox is filled with the previous value and a message that can indicate that a keyword phrase will be lost unless they click the add keyword button. If the sponsor clicks the return to trial button again, they can be redirected to the trial management page. If the keyword phrase textbox is blank when the sponsor clicks the return to trial button, they can be redirected to the trial management page.

Other embodiments of the present invention may be such that a sponsor can import a file that contains keywords for a particular trial or can enter all keywords at once, separated by a comma.

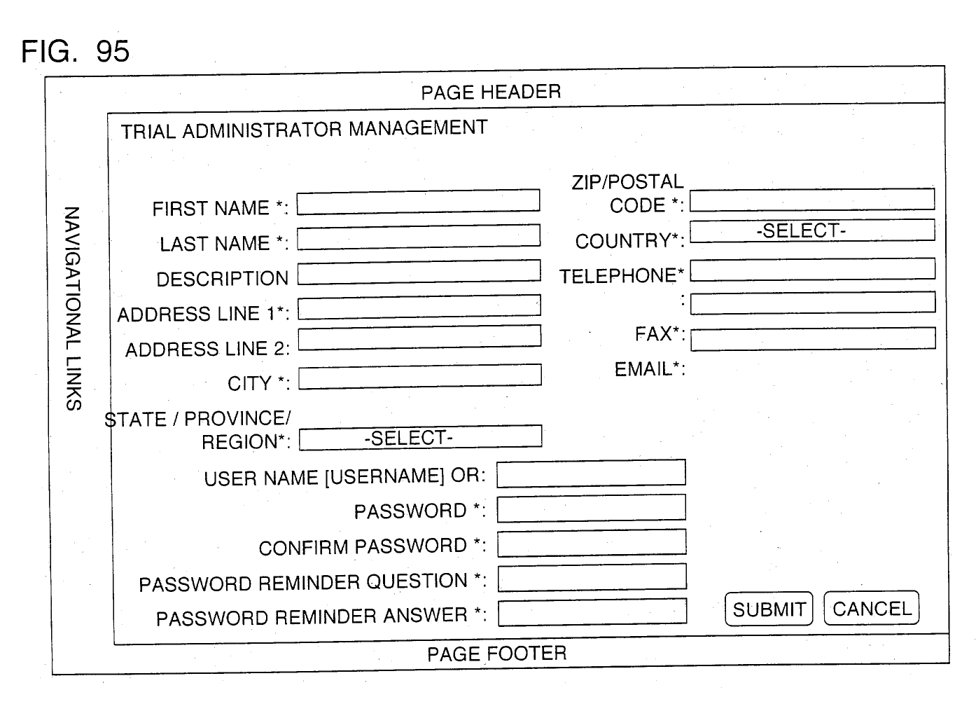

In one embodiment, the trial administrator management page, as illustrated in FIG. 95 is accessed from either the trial management page or the sponsor profile management. The page allows sponsor account administrators to create and modify trial administrator profiles. In the trial administrator contact information area, an account administrator can enter the trial administrators first name, last name, address, city, state/province/region, zip/postal code, country, phone number, fax number, and email address. In the username and password area, the account administrator can enter a username, password, password again for entry verification as well as a password question and answer in the event the password is forgotten in the future. Once a trial administrator has been created, their name can appear in the list of available trial administrators on all trial management for that sponsor. Trial administrators can also have the ability to modify their own information once they have been created in the module by the sponsor account administrator. Thus, the latter fields, password question and answer, cannot appear if the account administrator accesses this page. In the event the account administrator or trial administrator is logged in, the username can appear as static text.

In one embodiment the data are pre-populated if the account administrator chooses to modify a current trial administrator. All fields can appear blank if the account administrator chooses to create a new trial administrator.

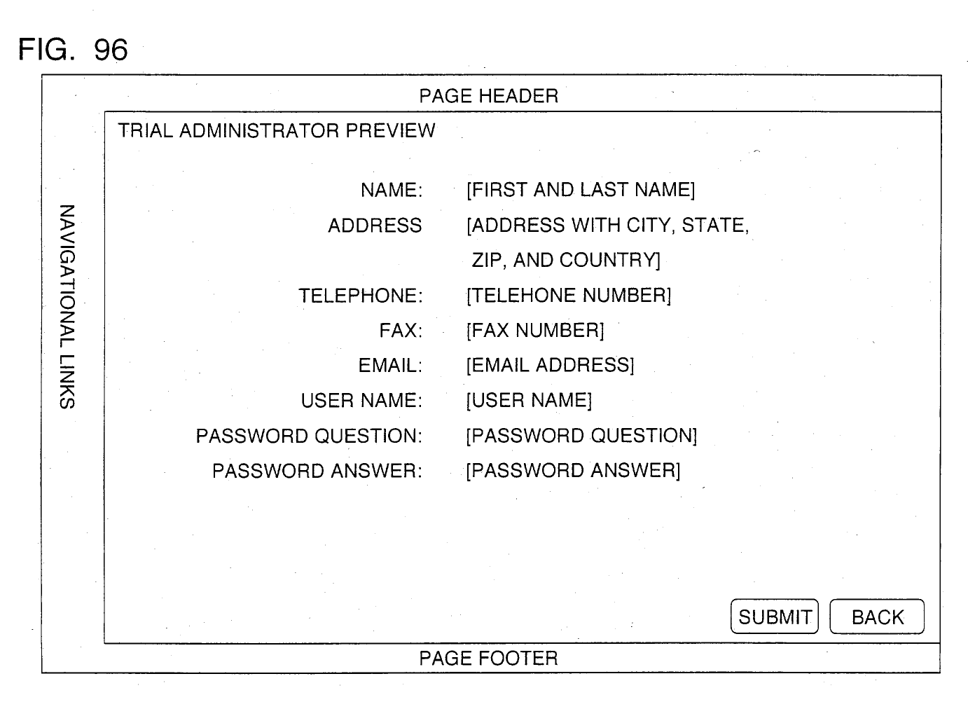

In one embodiment, by clicking the submit button in the trial administrator management page, the account/trial administrator is directed to the trial administrator preview page, as illustrated in FIG. 96. If the account/trial administrator clicks the cancel button, they are returned to either the trial administrator options page or the trial management page. Information entered/updated in the trial administrator management page can appear in static form on this trial administrator preview page. By clicking the submit button, the trial administrator information is saved to the database and can direct the account or trial administrator to the trial management page or sponsor profile page. If the back button is clicked, the account or trial administrator is directed back to the trial administrator management page, where they can further update the trial administrator data.

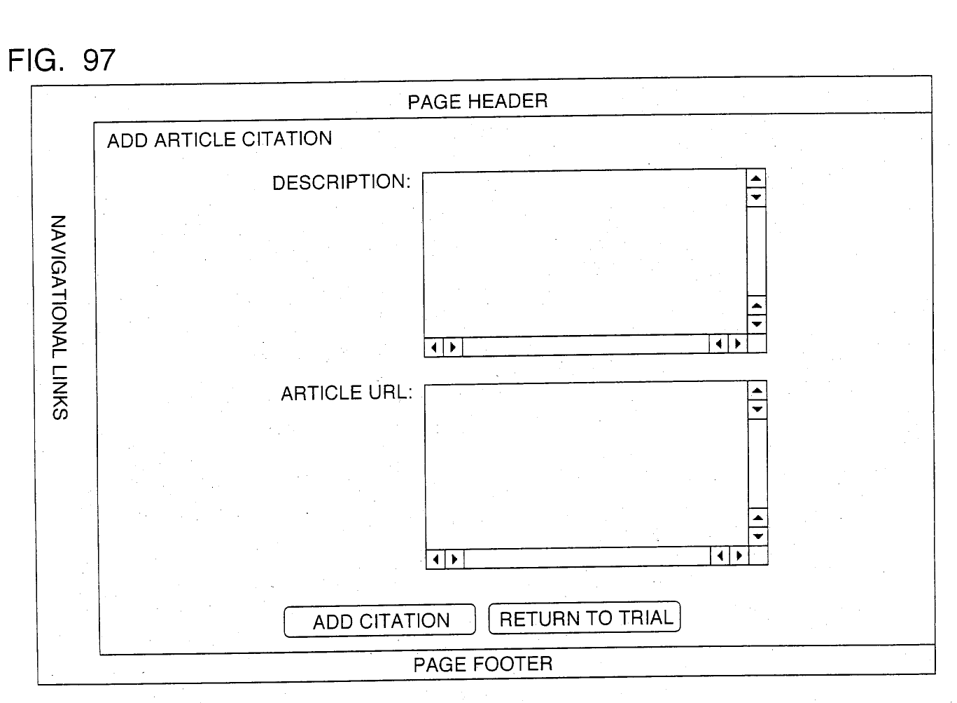

In one embodiment, the add article citation page allows a sponsor to add an article citation link to a trial listing. The sponsor can add an article citation by entering values into the description and URL textboxes and then clicking the add citation button in the add article area of the add article citation page, as illustrated in FIG. 97. If the sponsor clicks the add citation button without entering a valid description and URL, the sponsor can be directed back to the add article citation page where an error message can be displayed. If valid values are entered, the article citation can be added to the trial profile and the module can direct the sponsor back to the add article citation page with both textboxes cleared.

In one embodiment, when the sponsor wishes to return to the trial management page, they can click the return to trial button. If either textbox is not blank, the sponsor can be redirected to the add article citation page where the textbox is filled with the previous value and a message can inform the sponsor that the citation will be lost unless they click the add citation button. If the sponsor clicks the return to trial button again, they can be redirected to the trial management page. If the textboxes are blank when the sponsor clicks the return to trial button, they can be redirected to the trial management page.

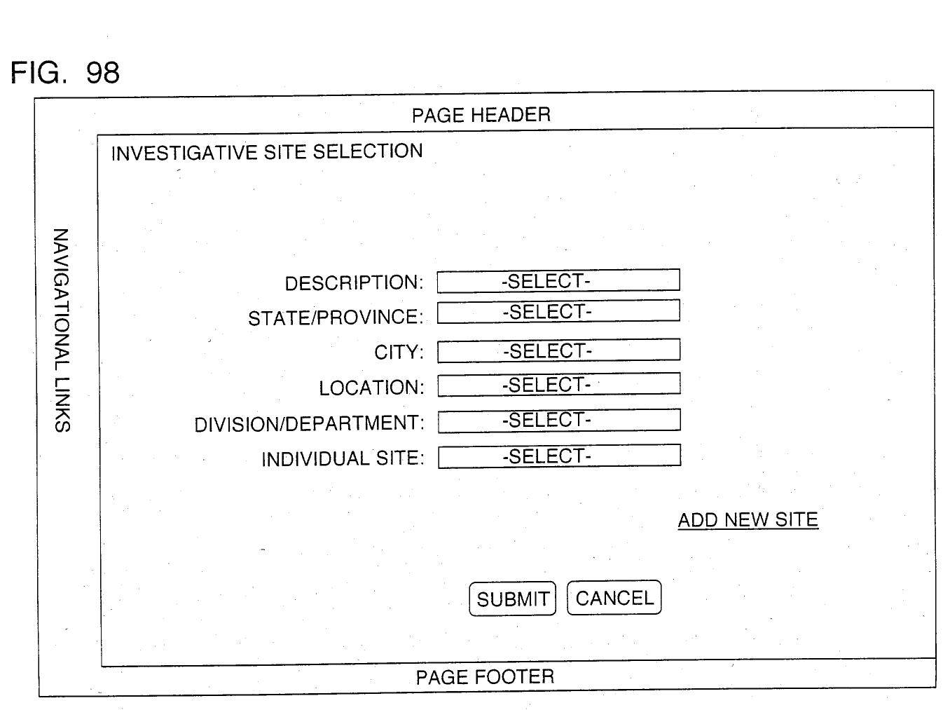

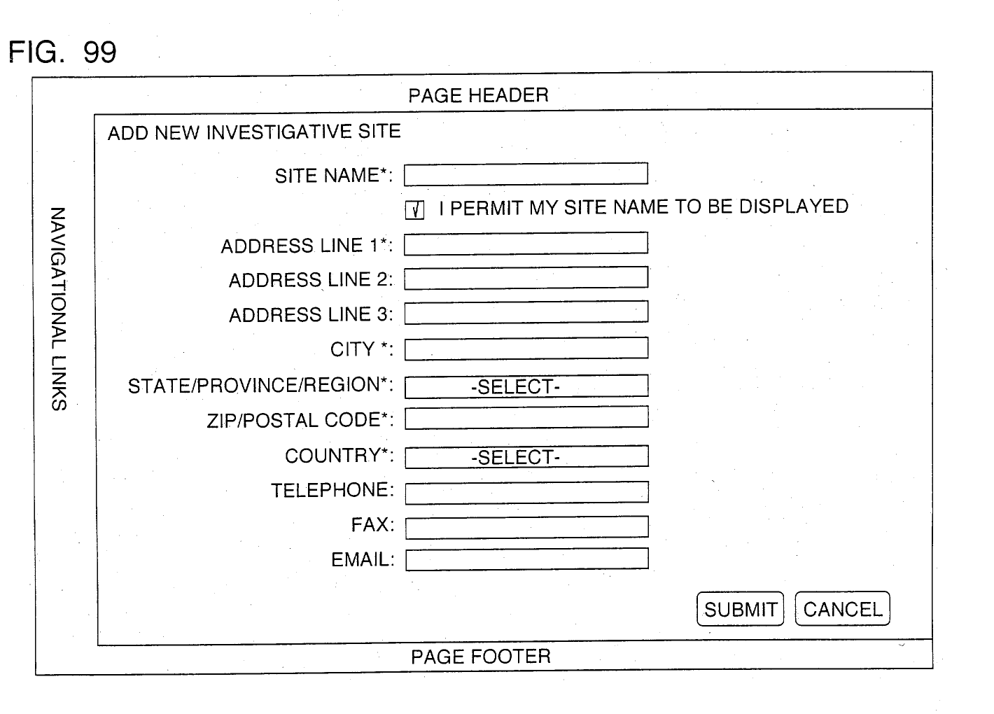

Initiated when a sponsor clicks add site link in the trial management page in one embodiment, the investigative site selection page, as illustrated in FIG. 98, allows a sponsor to select an investigative site that they would like to add to a trial. This page can be repeatedly submitted and reloaded as the sponsor works down the address hierarchy until the lowest level is reached. For example, a sponsor begins in the trial site area and starts by choosing the investigative site's country from a drop-down list and then clicking the continue button. The page would then display the country in plain text and the states/provinces for that country in a drop-down list. The sponsor then chooses a state/province and clicks the continue button. The process continues with the Sponsor selecting and submitting the city, then the site location, then the site division/department, and finally the individual site from a series of drop-down lists. When the sponsor completes the process by selecting a specific investigative site, they can add that investigative site to the current trial by clicking the submit button, which directs the sponsor to the trial site management page where they enter information specific to that site for that trial. The sponsor can return to the trial management page without selecting a site at any time by clicking the cancel button

In one embodiment, if the sponsor can't find the investigative site at which the trial is being conducted, they can click add new site link at any point in the process. This directs the sponsor to the add new investigative site page, as illustrated in FIG. 61. In the trial site area, the sponsor can enter the site name, indicating that posting this site to the database is okay, site address, city, state/province/region, zip/postal code, and country. Next, the sponsor can click the submit button and they can be directed to the trial site management page to enter complete information on the particular trial site. If any data errors are detected when the sponsor submits the page, they can be redirected to the add new investigative site page and an error message is displayed. If the sponsor would like to exit the page without adding a trial site, they can click the cancel button.

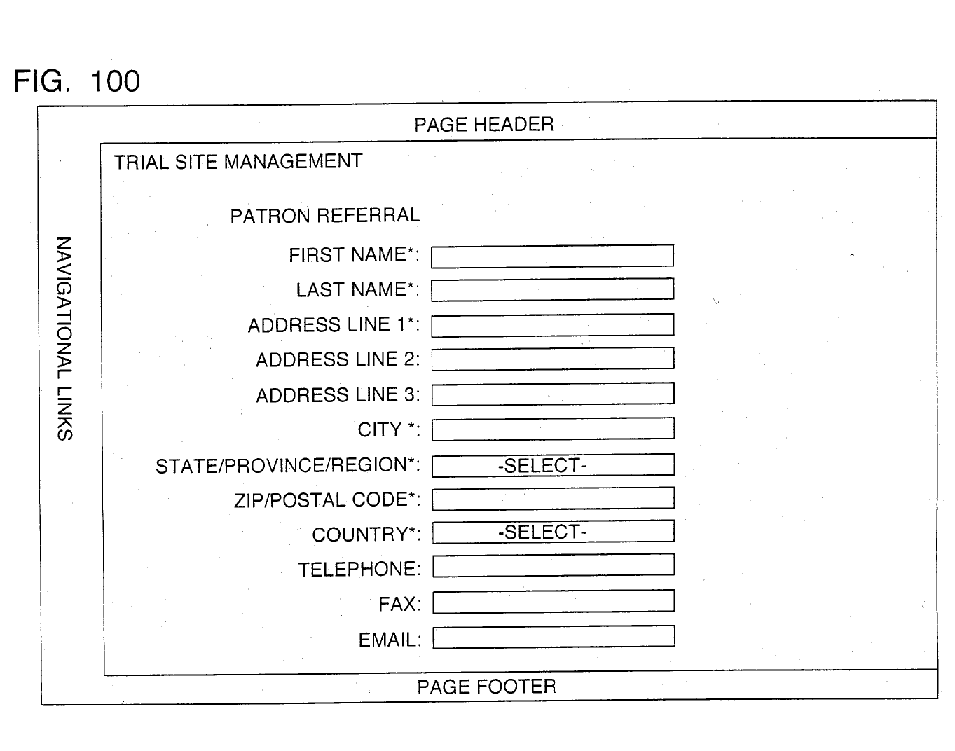

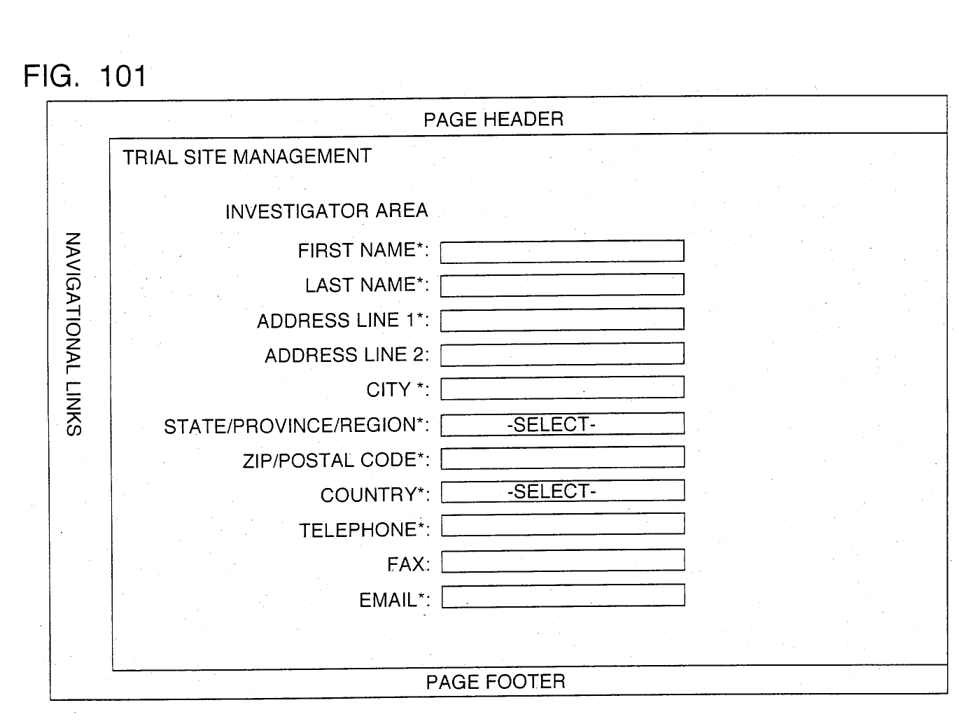

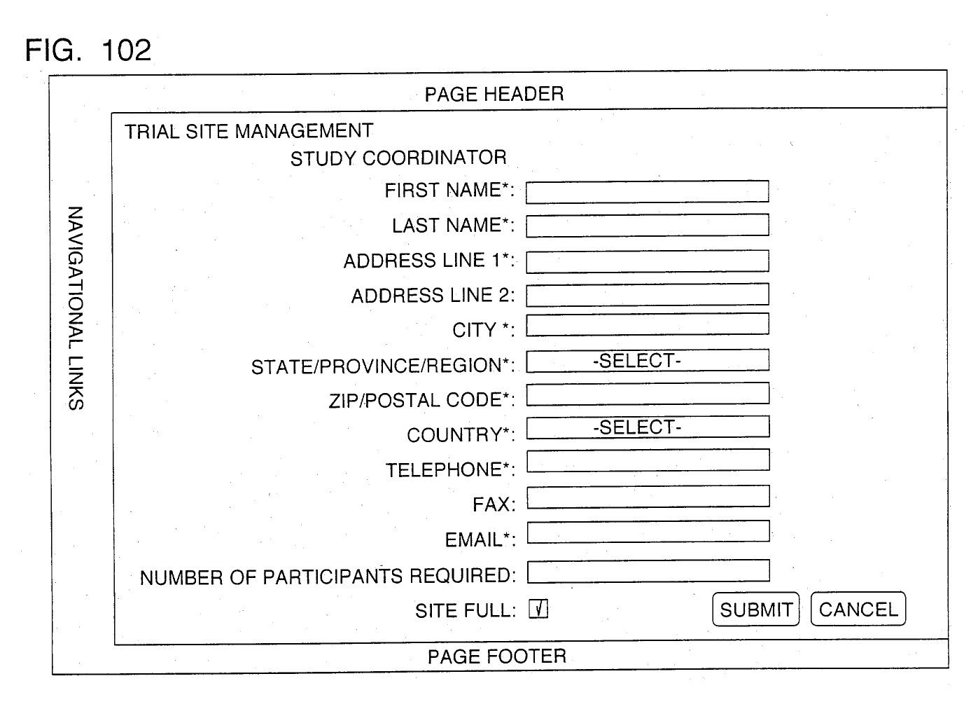

In one embodiment, in the trial site management page, as illustrated in FIGS. 100, 101, and 102, a sponsor submits and modifies information specific to an investigative site for a specific trial. In the patron referral information area, the sponsor can enter the referral contact's first name, last name, address, city, state/province/region, zip/postal code, country, phone number, fax number, and email address. In the investigator area, available only for premium sponsors, a sponsor can enter the investigator's first name, last name, address, city, state/province/region, zip/postal code, country, phone number, fax number, and email address. In the study coordinator area, available only for premium sponsors, a sponsor can enter the trial coordinator's first name, last name, address, city, state/province/region, zip/postal code, country, phone number, fax number, and email address. In the trial site information area, available only to premium sponsors, a sponsor can enter the number of participants required for the trial and an indication if the site is currently full and if the trial has the approval of the Institutional Review Board (IRB). When the sponsor completes all of the required information and clicks the submit button, they can be redirected to the trial management page. If the sponsor clicks the cancel button, they can be redirected to the previous page (trial management page, investigative site selection page, or add new site page).

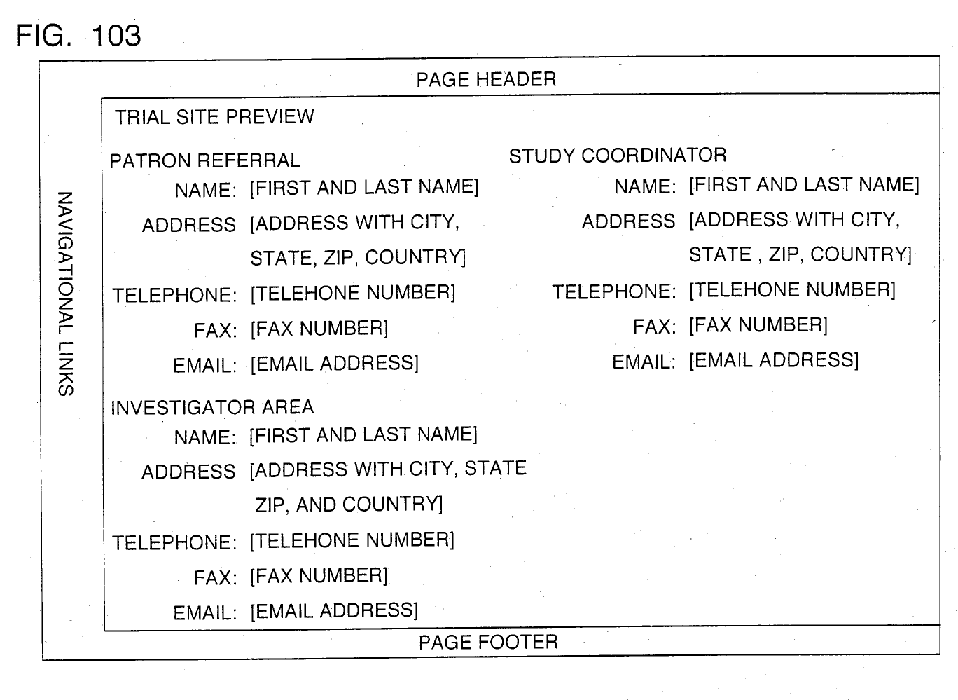

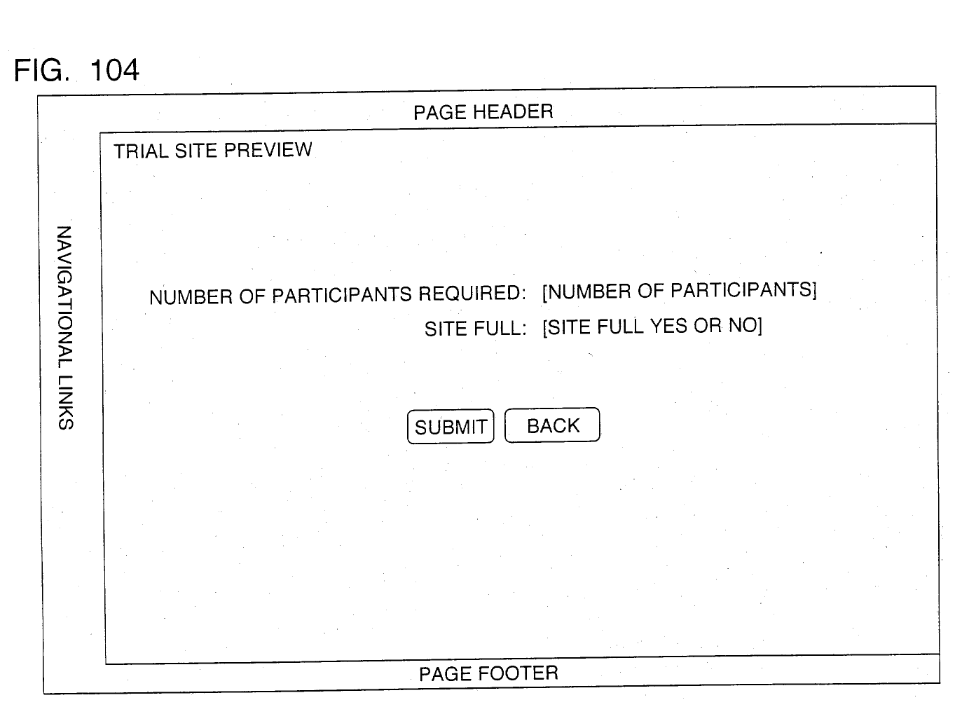

In one embodiment, before submitting the information about a trial site to the database, the sponsor can preview all information entered for a trial site in the trial site preview page, as illustrated in FIG. 103 and FIG. 104. The sponsor can click on the submit button and the trial site information can be saved to the database and the sponsor can be directed to the trial management page. If the sponsor wishes to edit the trial site information, they can click the back button and be directed to the trial site management page.

In one embodiment, to enter questions in order to prescreen patrons for a trial, the sponsor completes the sponsor prescreen entry page. In the questions area, the sponsor enters questions and responses that would qualify a patron for the trial. The sponsor can click the next button and the question they entered can appear in static text with remove and edit buttons adjacent to it. The sponsor can continue entering questions or can click the back to trial information to be directed to the trial site management page.

Other embodiments of the current invention may allow sponsors to enter relevance criteria; that is, weight each question in the prescreen for a trial.

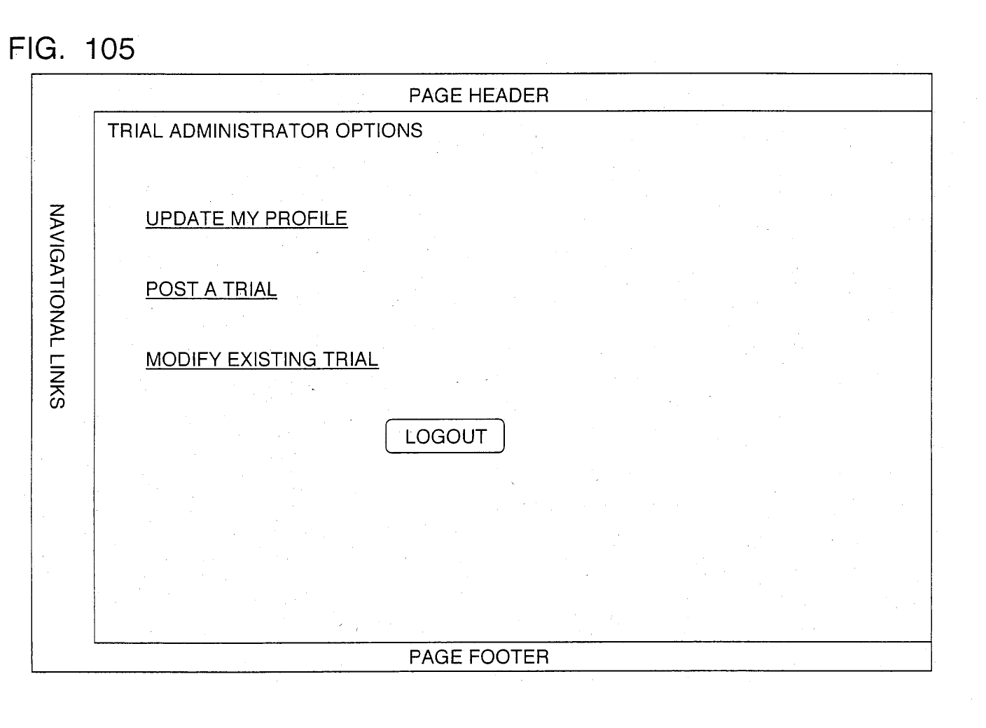

In one embodiment, when a sponsor trial administrator logs into the module, they are directed to the trial administrator options page, as illustrated in FIG. 105, where they can be presented with a list of functions available to him/her. A trial administrator can click links to update their profile where they are directed to the trial administrator management page; post a trial, where they are directed to the trial management page; modify existing trials, where they are directed to the trial management page; or logout, where they are logged out of the module and directed to the sponsor login page.

In one embodiment of the present invention, the following reports can be accessed from the sponsor options page:

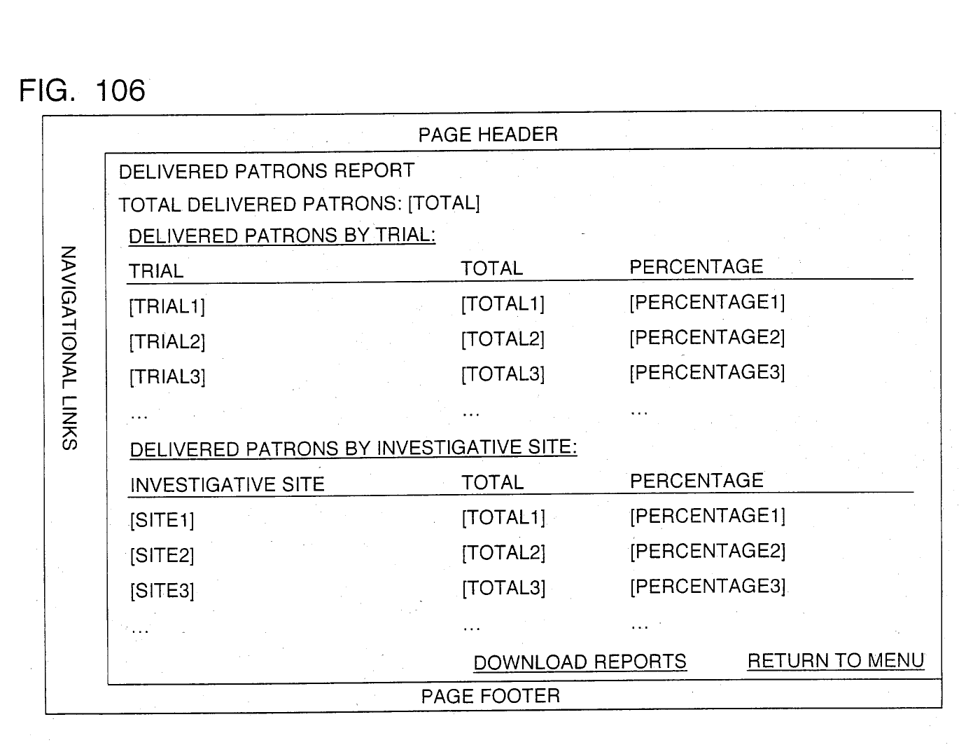

The delivered patrons report are presented in static format and as defined by the administrator in the delivered patrons report page, as illustrated in FIG. 106. In the report area of the page, the number of prescreened patrons who are delivered to the sponsor can be displayed. This data can be displayed as a total, in a table by trial, and in a second table by investigative site. The sponsor can return to the sponsor options page by clicking the return to menu link below the reports.

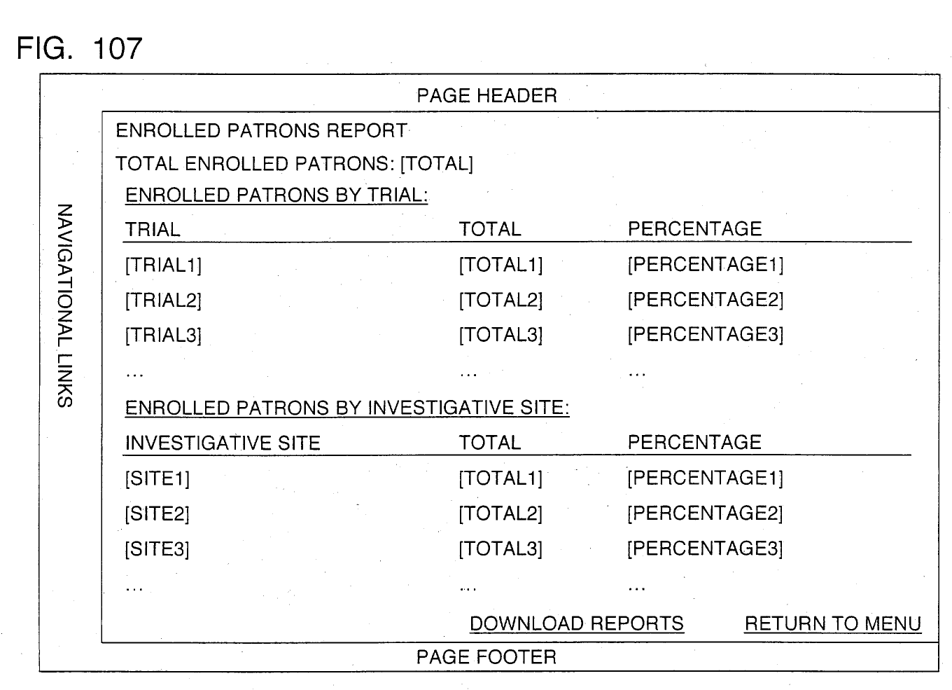

The enrolled patrons report can be presented in static format and as defined by the administrator in the enrolled patrons report page, as illustrated in FIG. 107. In the report area of the page, the percentage of prescreened patrons who were actually enrolled in trials can be displayed. This data is displayed as an aggregate percentage (total number enrolled/total number successfully pre-screened), in a table by trial, and in a second table by investigative site. The sponsor can return to the sponsor options page by clicking the return to menu link below the reports.

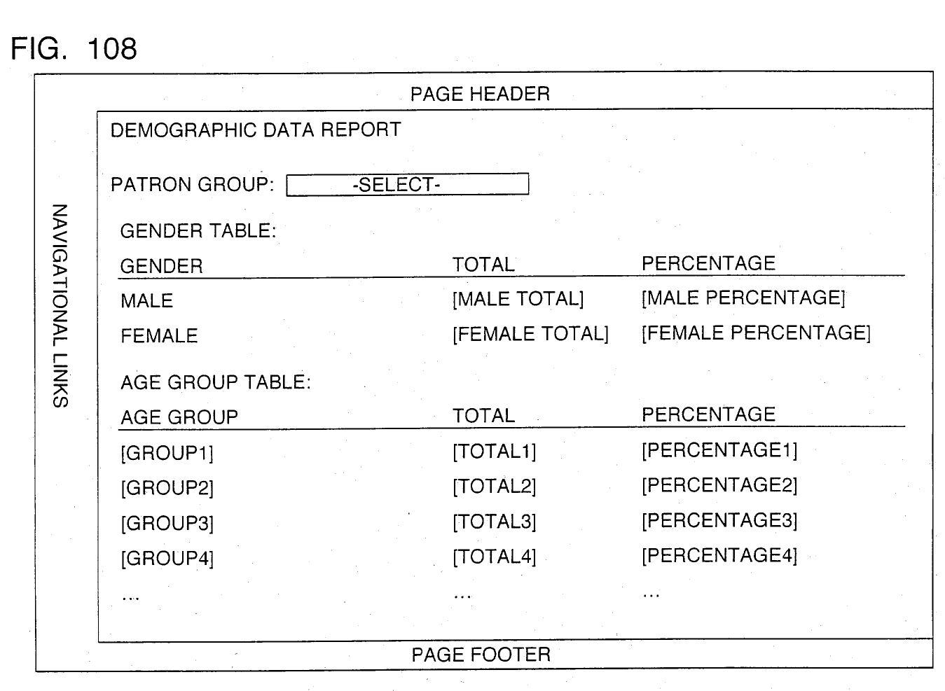

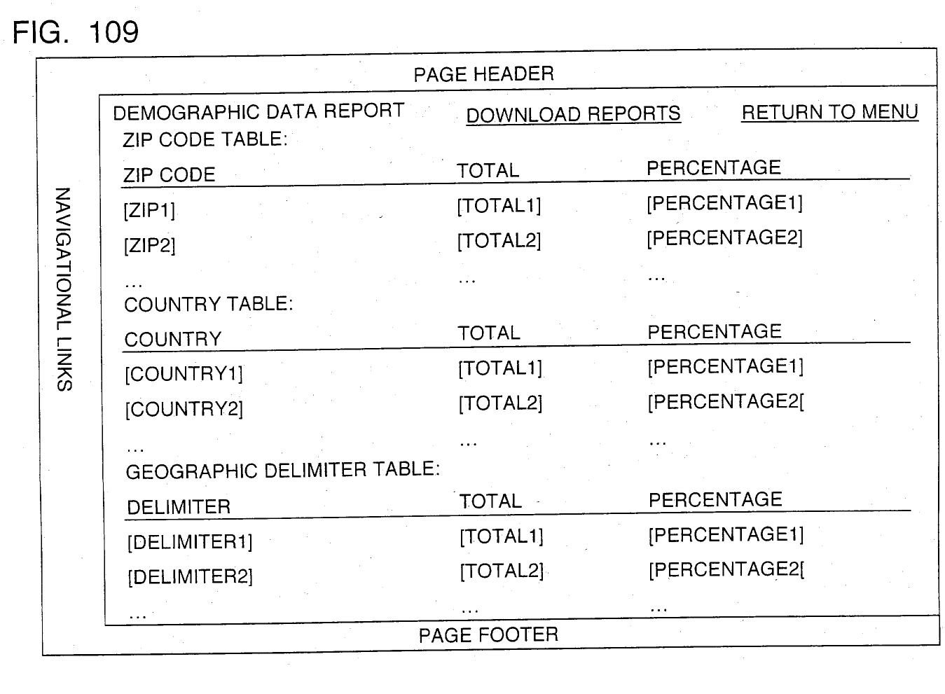

The demographic data report are presented in static format and as defined by the administrator in the demographic data report page, as illustrated in FIG. 108 and FIG. 109. In the report area of the page, demographic information describing patrons who have gone through a sponsor's pre-screen process are described. The demographic data are displayed in the following tables: gender with totals and percentages, age groups with totals and percentages, top ten ZIP codes with totals and percentages, top five countries with totals and percentages, and geographic delimiter groups with totals and percentages. The sponsor also haves the option of displaying this data only for the patrons that passed pre-screens, failed pre-screens, or for all of the sponsor's patrons. The sponsor makes their selection from a drop-down list at the top of the report area of the page. The default option is to display the demographic data for all of the sponsor's patrons. With this data, the sponsor can predict desirable locations for investigative sites. The sponsor can return to the sponsor options page by clicking the return to menu link below the reports.

In one embodiment, methods and systems are provided that improve the clinical trial process through a module for clinical trial partners. In the partner module, a partner can apply for a partnership online, manage their account information, and manage the layout by which the patron module will be presented. A pre-registration process and review and approval by the administrator is required before the latter two functions are accessible. Finally, the patron module is presented as a standalone site; that is, it is not embedded in another website.

In one embodiment, partners can be nonprofit patient advocacy groups (e.g., health organizations, foundations, societies and associations) with online presences. They tend to focus on either a specific medical condition or a community of patients. Examples of such groups include the Leukemia and Lymphoma Society, the National Prostate Cancer Coalition, and the International Myeloma Foundation. Partners can also be disease-specific websites that give users access to information on a specific medical condition. Examples of such sites are the Oncology Nursing Society and OncologyChannel.com. Further, partners can also be healthcare portals, medical websites that give users access to large quantities of information on general health. There are many medical portals on the web. Examples of such portals are HealthFrontier.com and HealthLinks.net. Also, partners can be HCP resource websites, medical websites specifically designed for healthcare professionals. An example of such a website is the American Medical Association.

Other embodiments of the present invention may include other types of partnerships including organizations in other categories, including regional and academic research centers, individual physicians and other investigators with patient-recruitment websites, physician practice management software vendors who deploy tools that assist individual providers as well as groups of practitioners, sponsor websites, payers, general web portals and search engines, and corporate intranets.

In one embodiment, upon entering the partner module, the partner is directed to the partner login page, similar to the patron login page as illustrated in FIG. 42. In the login area, the partner is prompted for their username and password. A partner can enter this information, click the submit button, and if their username and password are validated through a secure electronic authentication mechanism (e.g., digital certificate, digitally encoded smart card, digitally encoded browser cookie, or digitally encoded dongle), can be directed to the partner options page. If their username is incorrect, a partner is returned to the login page and an instructional error message can appear at the top. If the partner has forgotten their password, they can access the password modification process, specifically, the find accounts page, and enter a new password after some identity verification by clicking the forgot your password? link in the links area. Also in the links area is a new user link that, when clicked by a partner, directs the partner to the partner pre-registration page.

In one embodiment, if a partner forgets their password, they can follow a similar series of steps to those of the sponsor module to verify their account and retrieve their password.

In one embodiment, registration for the partner module involves pre-registration, review and approval, and complete registration processes. Potential partners can first be required to submit pre-registration information, a partnership proposal, to the administrator. Using a number of criteria, the potential partner is either approved or not approved by the administrator. An email is sent by the administrator to the potential partner indicating their approval or disapproval. If the partner is approved, the email contains a link back to the partner module, so that the partner can login and complete the registration process, including detailed profile and page layout information and preferences. Once a partner completes their pre-registration, they can begin the process of completing the detailed profile and page layout information. If the partner is not approved, the administrator can provide an explanation describing their reasons for declining the partnership proposal.

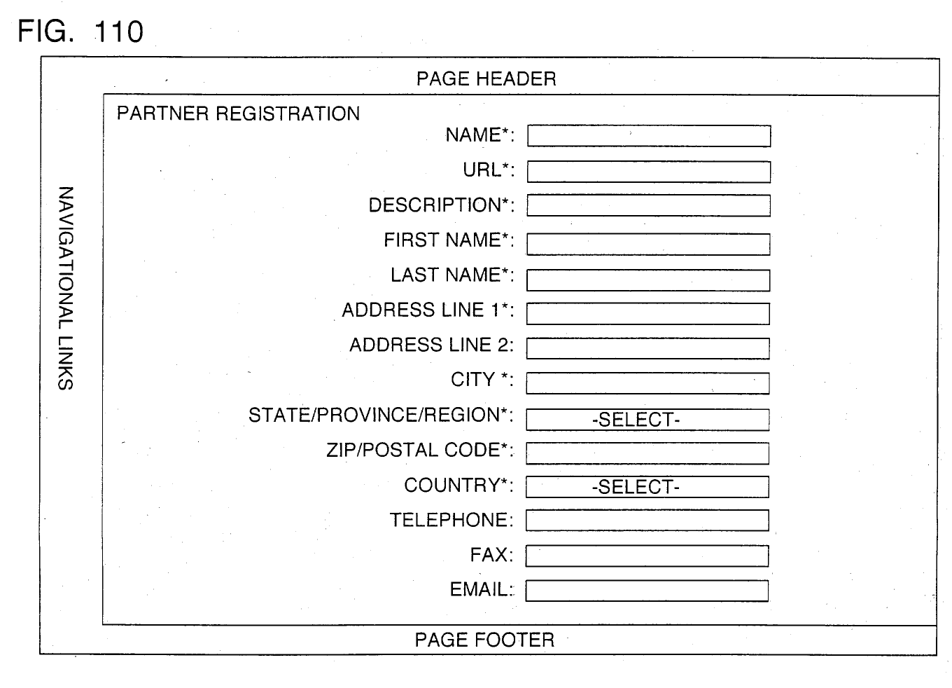

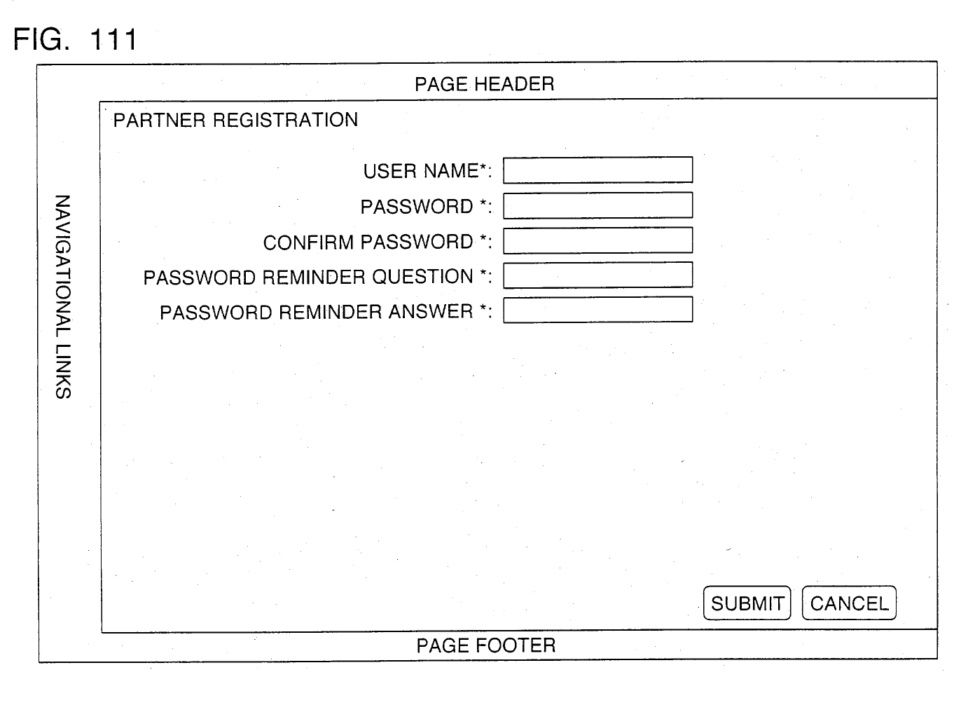

In one embodiment, a partner accesss the partner pre-registration page from the new user link on the partner login page or from the link on the partner options page. The partner pre-registration page, as illustrated in FIG. 110 and FIG. 111, allows a potential partner to create a temporary account with the module; temporary, because the potential partner must be reviewed and approved using various criteria by the administrator/inventor. In the general partner information area, a partner can enter the name, the URL, and the description of the partner organization. In the business contact information area, the partner can enter their first name, last name, address, city, state/province/region, zip/postal code, country, phone number, fax number, and email address. The fax number and email address fields can be optional. In the login information area, the partner can enter a username, password, password again for verification of entry, password question and answer in case a partner forgets their password in the future. If the partner has completed this page previously, their username appears as static text. Also in the login information area is a submit button and a cancel button. If a partner clicks the cancel button, the information entered/updated in the partner preregistration page is not saved and the partner is returned to the page they were viewing prior to reaching the partner preregistration page. If, after entering/updating information in the partner preregistration page, the partner clicks the submit button, the information is saved to the database, the administrator is made aware of the new/updated pre-registration application via an email, and the partner can be directed to a page with benefits of partnering with the administrator/inventor and information about the review and approval process.

In one embodiment, the information on this page is be pre-populated if the partner is currently logged in and has entered information in the partner pre-registration page. If the user has accessed this page by clicking the new partner link on the partner login page, all of the page elements described previously are be blank.

When new/updated information is submitted to the administrator, in one embodiment, it is be reviewed and approved by the administrator before the changes are implemented in the modules.

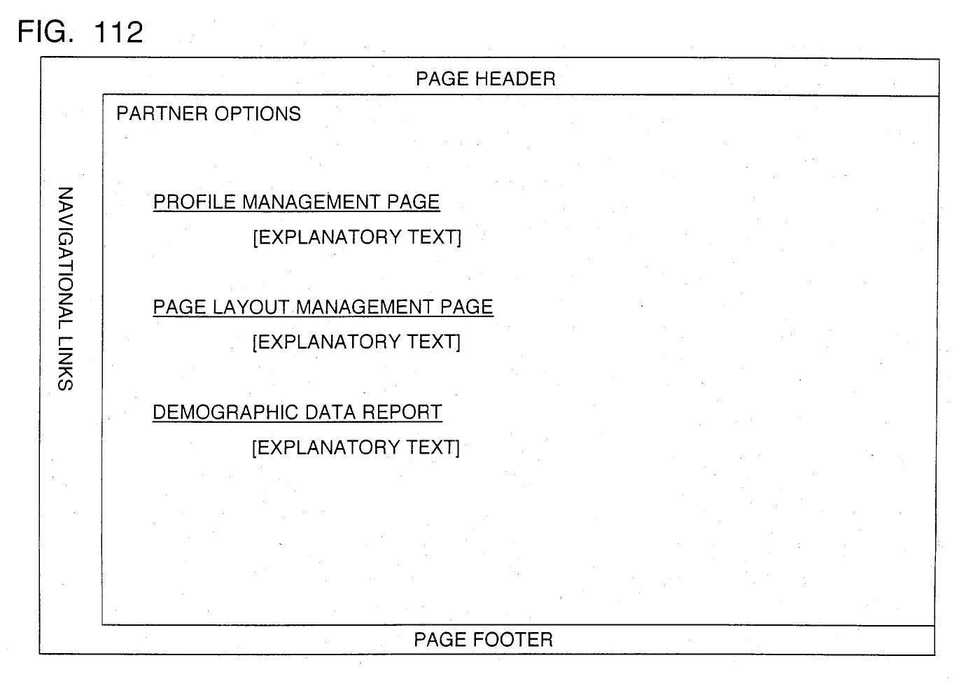

In one embodiment, after successfully completing pre-registration, a partner may update their options from the partner options page, as illustrated in FIG. 112. In the options area, a partner is provided with links to modify their partner profile, modify their page layout for presenting the patron module, view demographic data reports, and view partner traffic analysis reports.

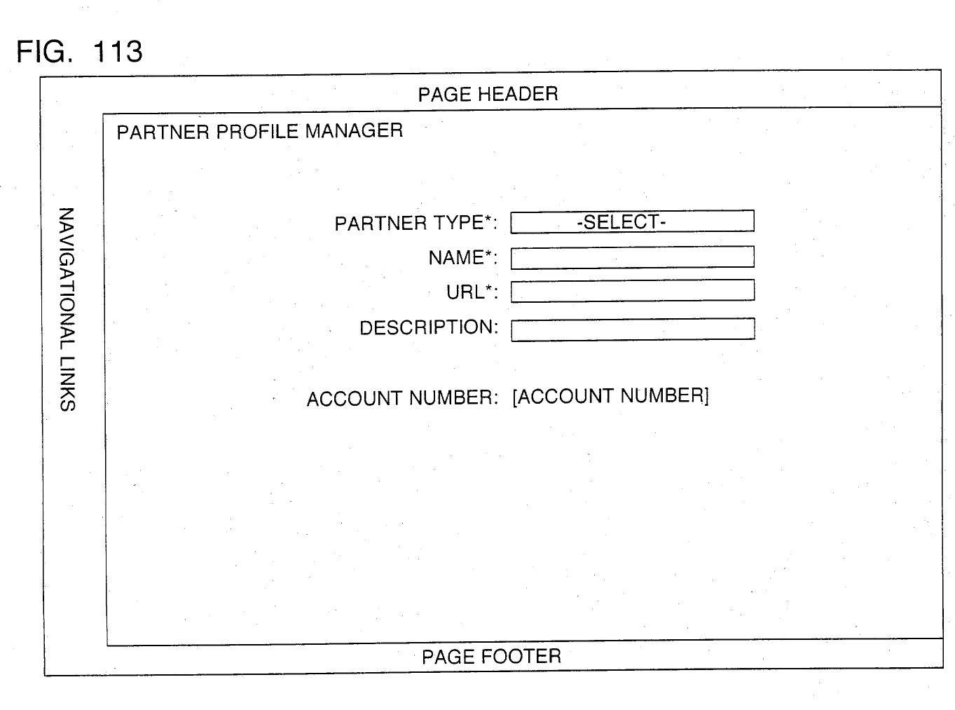

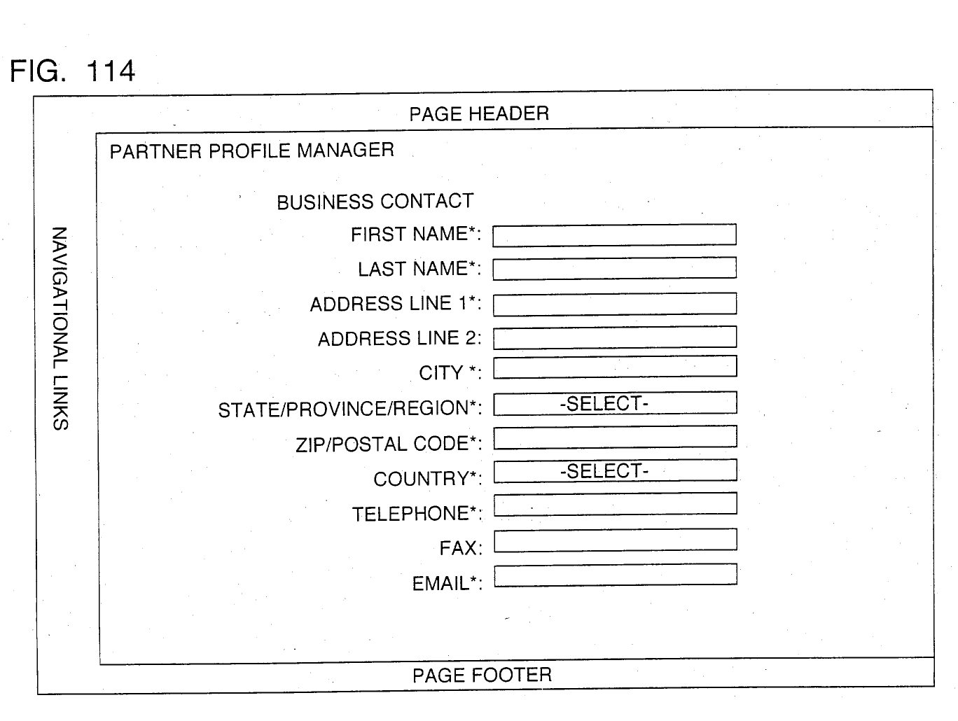

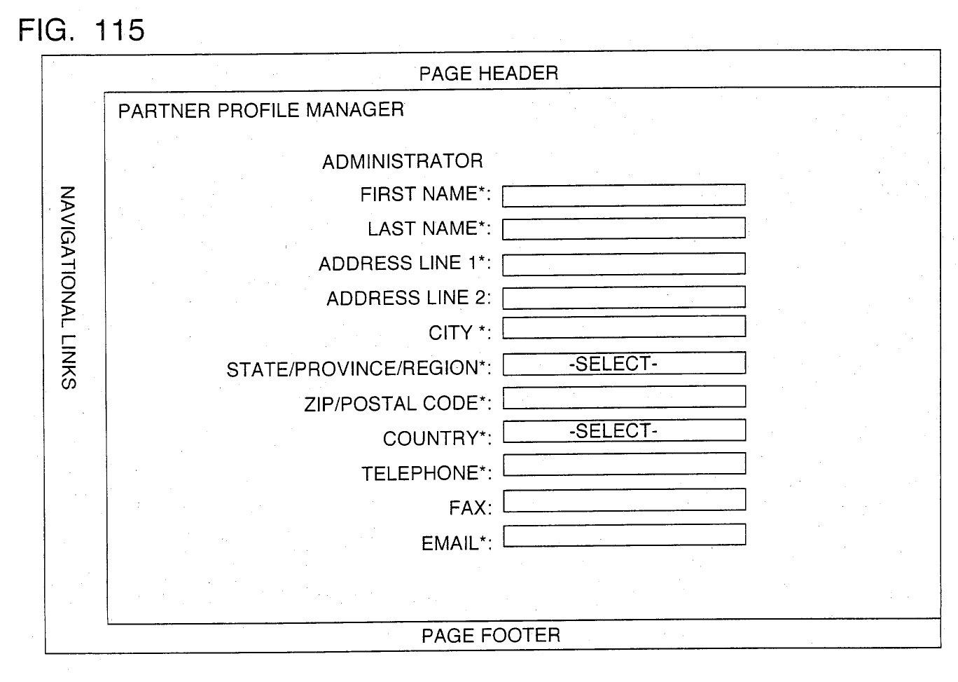

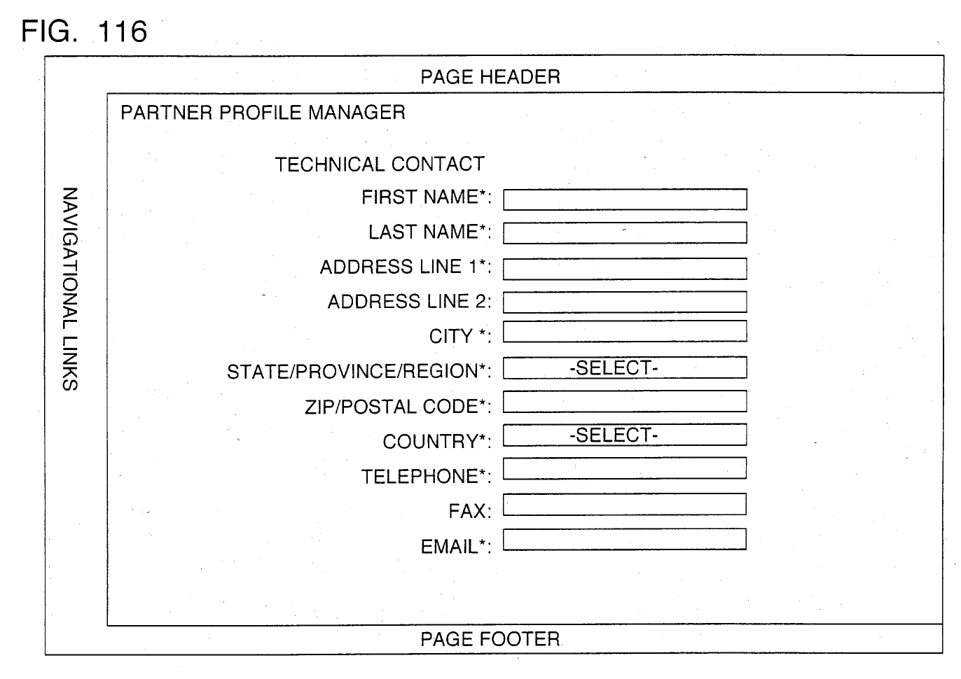

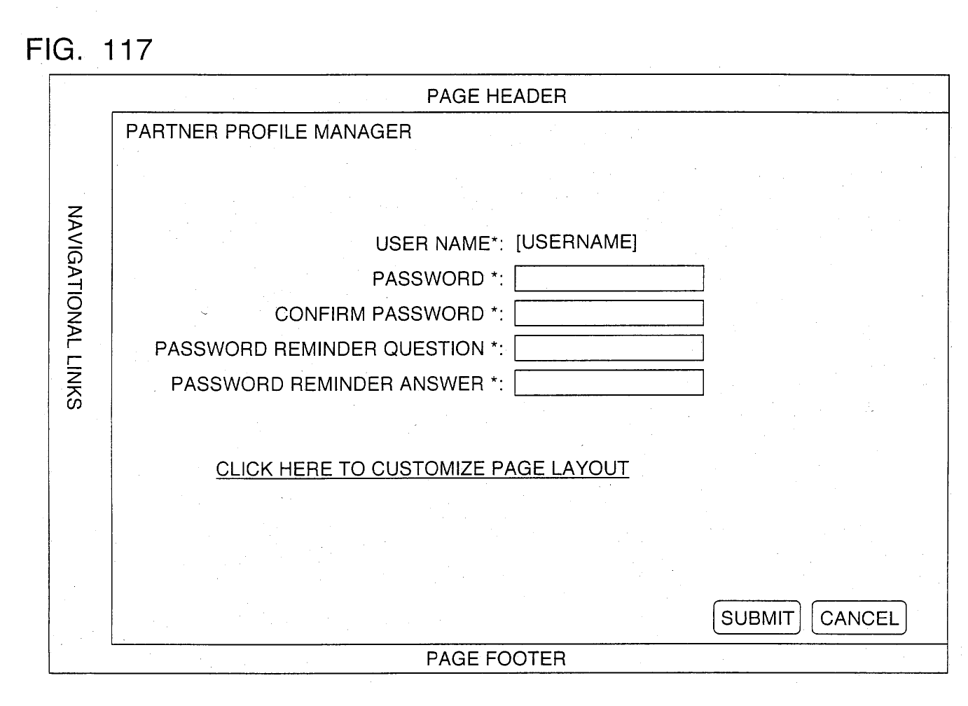

In one embodiment, from the partner profile management page, as illustrated in FIGS. 113, 114, 115, 116, and 117, a partner can add or modify their partner profile. In the general partner information area, a patron can enter/edit the type of patron module presentation (co-branded or customized), partner name, partner's URL, description of the partner, and the partner's account number (not editable). In the business contact area, a patron can enter/edit their first name, last name, address, city, state/province/region, country, phone number, fax number, and email address. In the administrator information area, the partner can enter the partner administrator's first name, last name, address city, state/province/region, zip/postal code, country, phone number, fax number, and email address. In the technical contact area, the partner can enter their technical contact's first name, last name, address, city, state/province/region, zip/postal code, country, phone number, fax number, and email address. In the login information area, a patron can enter/update their password, password verification, and password question and answer. For partners who have not yet completed the partner page layout management page, by clicking the next button in the login area, the data entered in the partner profile management page is saved to the database and the partner us presented with the partner page layout management page. For partners who have already completed the partner page layout management page, by clicking the finish button in the login area, the data entered/edited in the partner profile management page is saved to the database and the partner is presented with the partner options page. Also in the login area are links to the partner page layout for partners who have entered page layout preferences and to the partner page layout management page and buttons to finish or cancel. If the partner clicks the cancel button, none of the information edited/entered on the partner profile management page is saved and the patron is returned to the page from which they initiated the partner profile management page.

In one embodiment, the information on this page is be pre-populated if the partner is currently logged in and information has already been saved to the database. Any additions or modifications submitted via this page can be reviewed and approved by the administrator before they are used in the service module. If the user is an approved partner, the entry point URL can be displayed.

Other embodiments of the present invention may require different combinations of information about the partner; fax number, for example, may be optional.

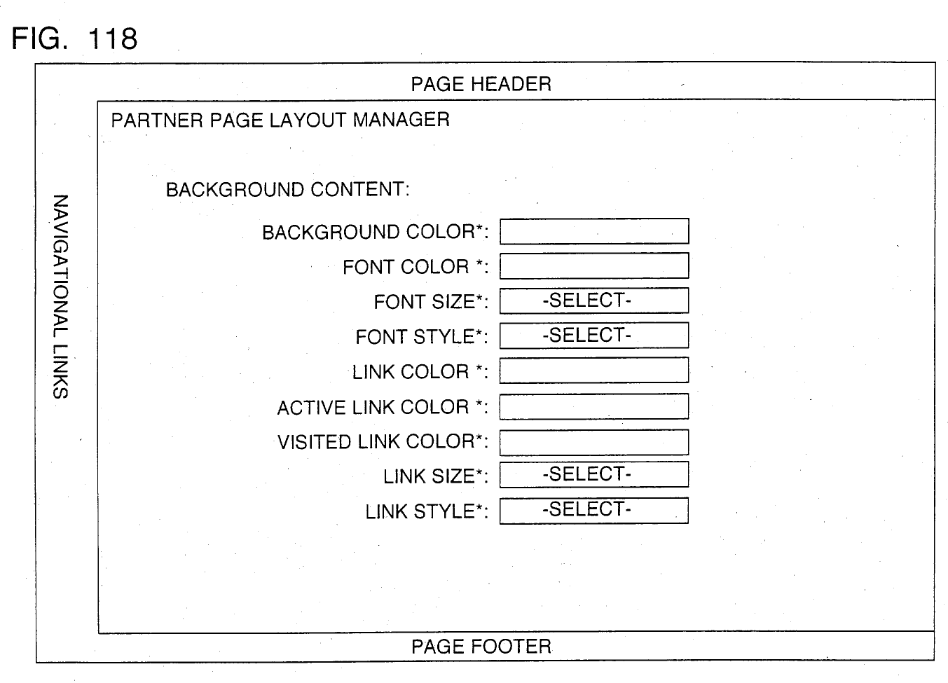

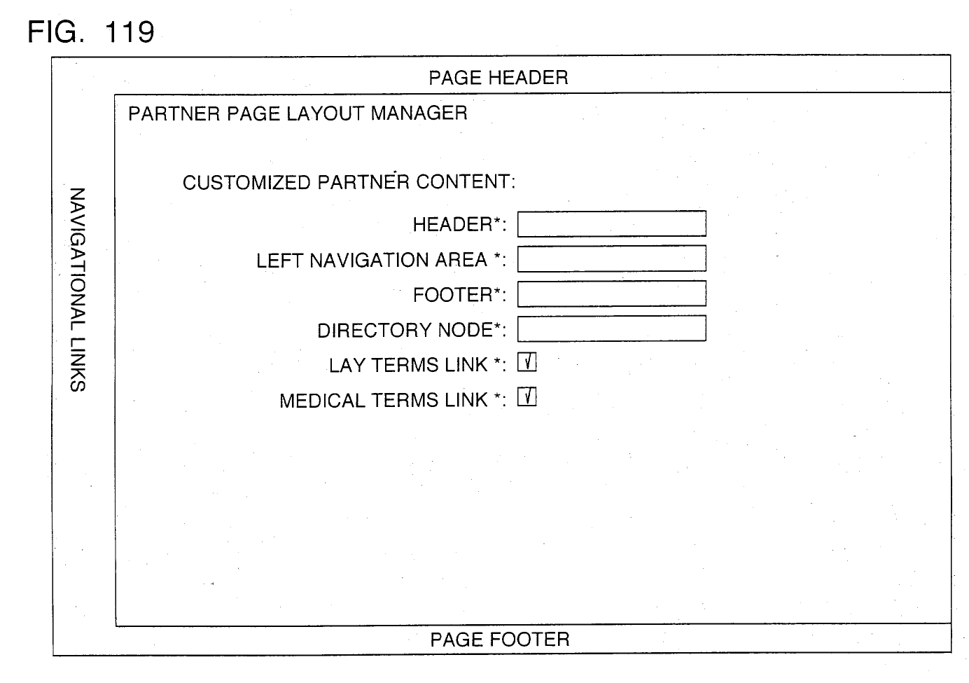

In one embodiment, the partner page layout management page, as illustrated in FIG. 118 and 119, is accessed from the partner options page or from the partner profile management page. Here, a partner can add or modify their partner page layout profile, the layout preferences for presenting the patron module via the partner's website. In the content information area, the partner can specify their preferred page background color, font color, font size, font style, link color, active link color, visited link color, link size, and link style. In the customized partner content information area, a partner can enter static HTML for their page header, left navigation, and footer areas surrounding the embedded patron module application provided by the inventor. Also in the customized partner content information area, the patron can select the condition category level they want to appear on the main menu page of the patron module. In addition, the patron can select the lay terms link checkbox to indicate the default view to a patron using the patron module. If this checkbox is not selected, the medical view will be the default. Finally, the patron can select the medical terms link checkbox to indicate their preference to permit glossary function in the patron module. In this area can be submit and cancel buttons. If the partner clicks the cancel button, no edits to the partner page layout management page are saved to the database and the partner is returned to the page prior to initiating the partner page layout management page. If the partner clicks the submit button, the edits to the partner page layout management page are saved to the database and the partner is presented with the partner profile and page layout preview page.

In one embodiment, the information on this page is be pre-populated if the partner is currently logged in and has previously saved page layout preference information. Any additions or modifications submitted via this page are reviewed and approved by the administrator before they are implemented in the module.

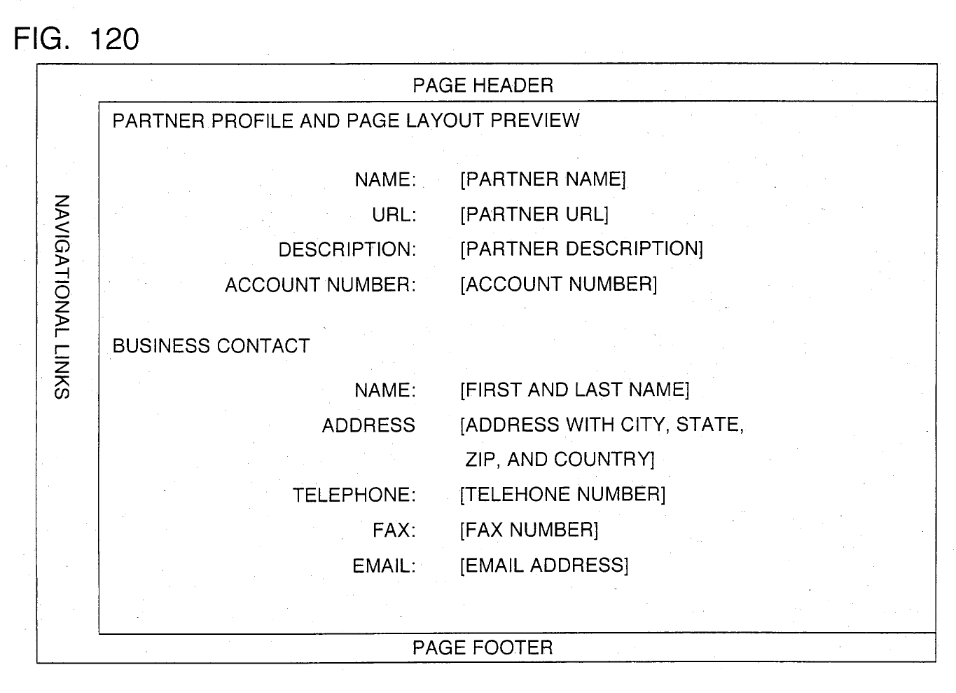

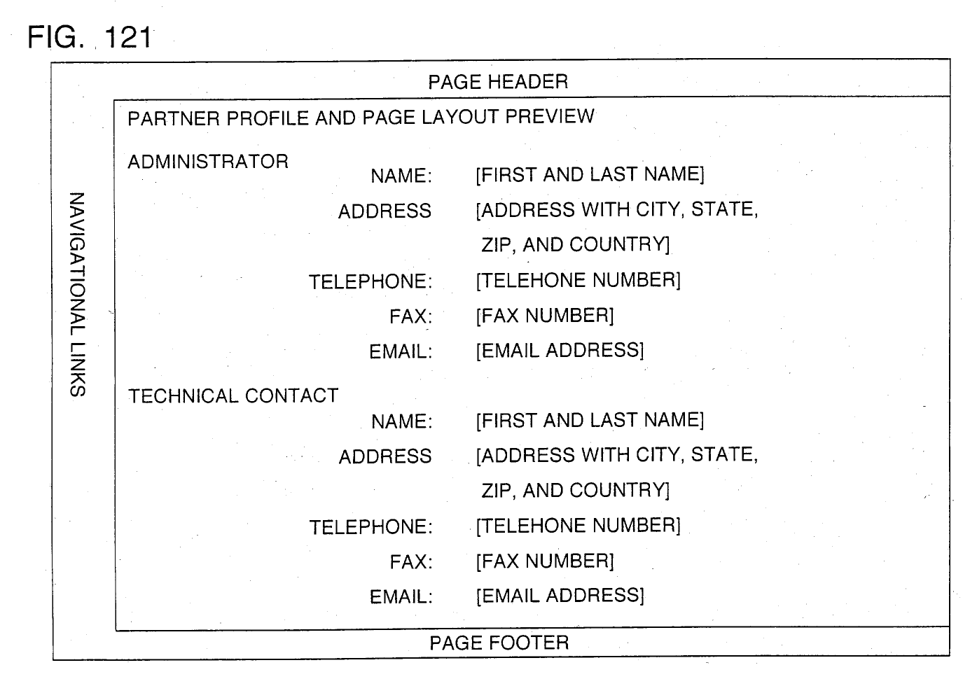

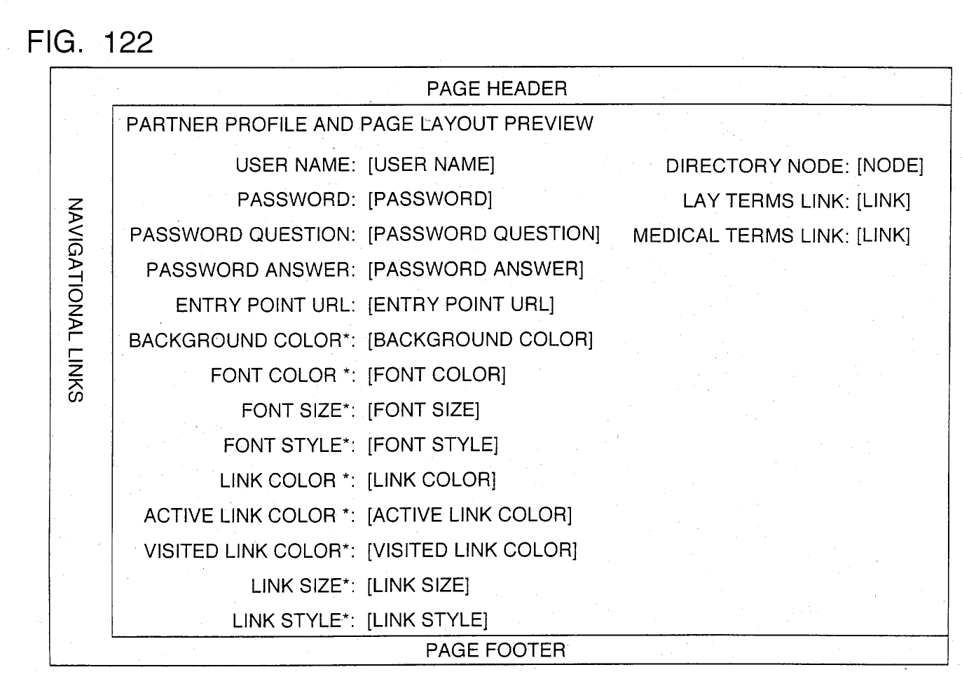

In one embodiment, a partner is presented with the partner profile and page layout preview page so that the partner can make a final review of his submissions to the administrator as illustrated in FIGS. 120, 121, and 122. Here, the partner reviews all entries made in the partner profile management and partner page layout management pages. If a partner wishes to change/edit any information, they can do so from this page. If the patron clicks the submit button, the information is saved to the database and the administrator is notified of the updated information via an email alert. If the partner clicks the cancel button, the information is not saved to the database and the partner is returned to the page where they initiated the partner profile and page layout preview page.

Other embodiments of the present invention may include allowing partners to make further customizations around the presentation of the service not limited to language, disease focus, disease content, search capabilities, navigational scheme, and medical or lay terminology.

In one embodiment, after a the patron module is launched within a partner's website, the partner can view reports to view the demographic information about its patrons and traffic reports for the patron module presented in the partner's website.

From the partner options page, a partner reachs the demographic data report page. In the report area of the page, as illustrated in FIG. 108 and FIG. 109, a patron can select the patron group (e.g., all, those who have passed a prescreen, those who have failed a prescreen) of interest. The demographic data is displayed in the following tables according to the patron group selected by the partner: gender with totals and percentages, age groups with totals and percentages, top ten ZIP codes with totals and percentages, top five countries with totals and percentages, and geographic delimiter groups with totals and percentages. The default option is to display the demographic data for all of the partner's patrons. The partner is returned to the partner options page by clicking the return to menu link located below the reports.

From the partner options page, a partner reachs the partner traffic analysis report page, where a partner can view information about the number of page hits, sessions, unique and otherwise, a patron module has received.

In one embodiment, methods and systems are provided that improve the clinical trial process through a module for healthcare providers. The HCP module provides HCPs with the functionality of the patron module except where detailed in the following sections.

Other embodiments of the current invention may include limiting and sorting search results by international classification of disease number, by diagnostic and statistical manual of mental disorders (DSM) classification (psychiatric diseases), by histopathological classification of disease, by gene expression, by laboratory data, by gene expression (e.g., HER 2 (human epidermal growth factor receptor 2), BRCA 1 (breast cancer 1)), PSA (prostate specific antigen), by histopathology (from what cells/tissue a tumor is derived), hematological indices (e.g., hemoglobin, white cell count, platelet count), by liver function tests, by diabetes indices (e.g., blood glucose level, HbA1c, Glycosylated hemoglobin), by specific drug in development, by medical center, by physician, by insurance company for which trials are covered.

Other embodiments of the present invention may include capabilities for physicians to create patient accounts and save trial, medical, and other disease-related resource information to those accounts.

In one embodiment, the default view for HCPs is medical view. HCPs can toggle to the lay view.

In one embodiment, trial detail information includes a schematic representation of the clinical trial design, and investigator biographies.

Other embodiments of the present invention may provide an HCP with direct access to a call center to assist in the prescreen of their subject.

Other embodiments of the present invention may allow an HCP to denote their role: primary care physician staff, associate physician, primary care physician, associate physician staff.

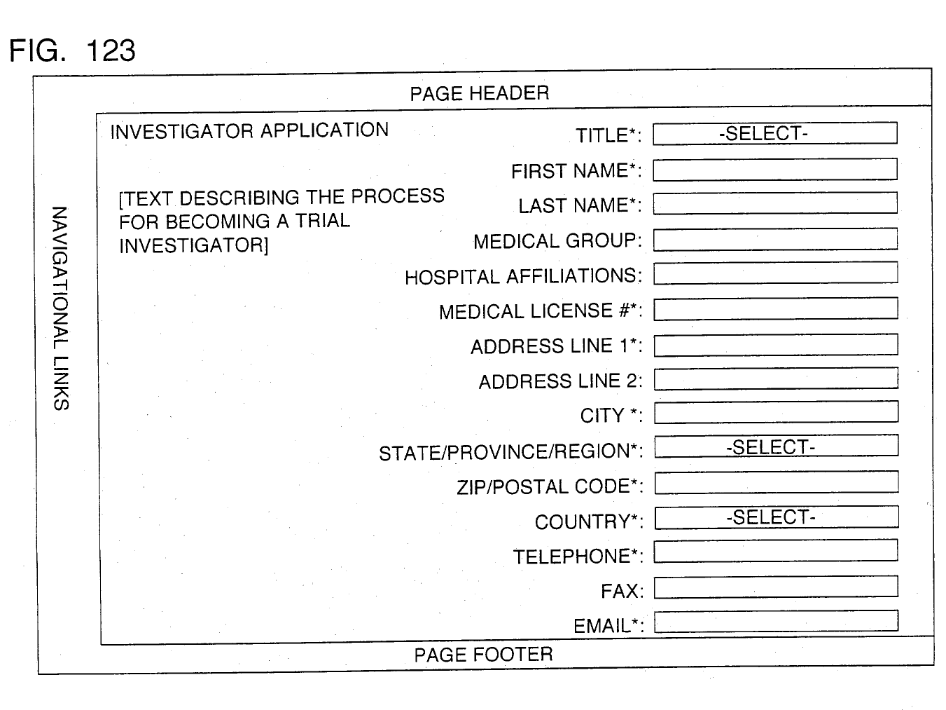

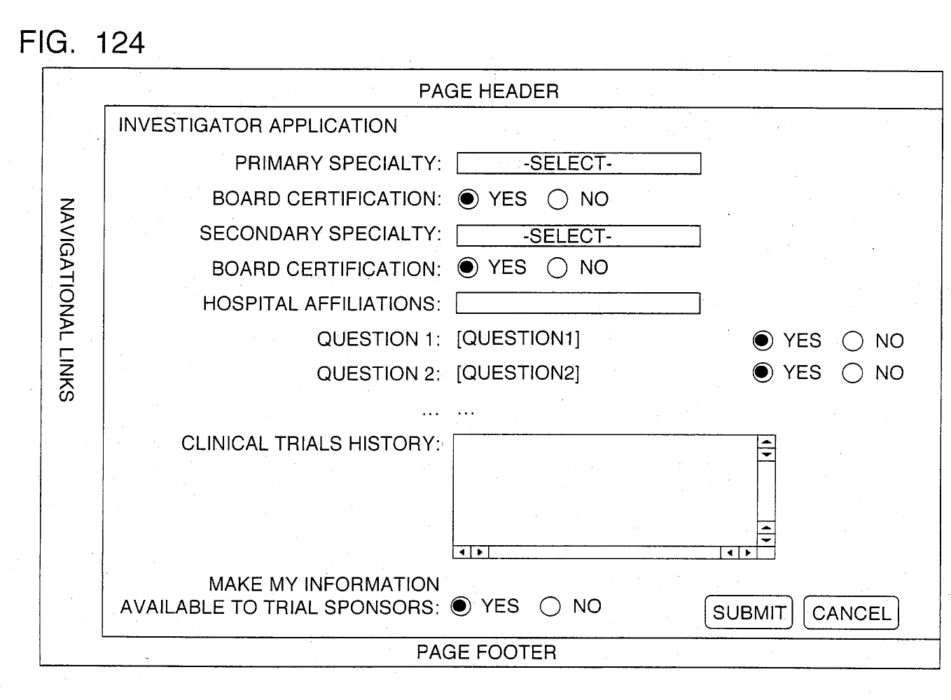

In one embodiment, the investigator application page is accessed from a link on the main menu page. The page gives interested physicians the opportunity to apply to become trial investigators in their area of medical interest or specialty. The investigator application page, as illustrated in FIG. 123 and FIG. 124, provides the functionality for physicians to enter their contact information as well as some information regarding their background and their area of interest or specialty. In the basic information area, a physician can enter their title, first name, last name, medical group name, hospital affiliations, and medical license number. In the contact information area, the physician can enter their address, city, state/province/region, country, phone number, fax number, and email address. In the medical information area, the physician can enter their primary specialty, an indication of their board certification in their primary specialty, secondary specialty, an indication of their board certification in their secondary specialty, responses to a brief screening questionnaire, information about their past experience with clinical trials, an indication that they would like their information made available to trial sponsors. By clicking the submit button, the information entered in the investigator application page is saved to the database and available to the administrator for review and approval in the admin module.

Other embodiments of the present invention may include module functionality to interface a patron's primary care physician with a trial investigator and with the medical records of a patron.

Other embodiments of the present invention may include confidential links for primary care physicians (e.g., inclusion/exclusion criteria), so that patients could be screened by their primary care physician.

Other embodiments may require a physician to enter their credentials in the trial investigator application page.

In one embodiment, methods and systems are provided that improve the clinical trial process through a module for the inventor's system administrators. The admin module allows the inventor's administrators to review and accept, reject, or modify sponsor registrations, partner registrations, and trial submittals. It can also provide the administrator with the ability to generate and manage reports that track all the patron activity on all modules and react accordingly to improve the methods and systems of the present invention. The general statistics are indications of overall scalability issues, and the specific reports can highlight accounting and site design issues.

In one embodiment, there are no links to the admin module on the Internet; the module can resides on the inventor's intranet. In order to access the module, the administrator can type a URL into their browser's address bar from an authorized access device.

Other embodiments may permit an administrator access to the admin module from a secure connection to a URL.

In one embodiment, upon starting a new session in the admin module, the administrator is immediately directed to the admin login page, similar to that of the patron login page as illustrated in FIG. 42. The login page allows the administrator to login with their username and password and then access the administrator functionality. In the login area, the administrator can enter their username, password and click the submit button. The module can first checks that the administrator enters a username and password. It then can validate that the username exists in the database. Once locating the account record in the database that maps to the username, the module can check that the entered password matches the password in the database. Once all the validation rules have been passed, the module can direct the administrator to the administrator options page. If the validation fails, then an informative error message can be displayed on the login page.

In one embodiment, a set of administrator permission levels can restrict the sponsor applications, partner applications, and trial submittals that an administrator can review. An administrator is given permission to review new sponsor applications, updated sponsor applications, new partner applications, updated partner applications, new trial submittals, and/or updated trial submittals. Permissions for each of these actions are independent of any of the other actions.

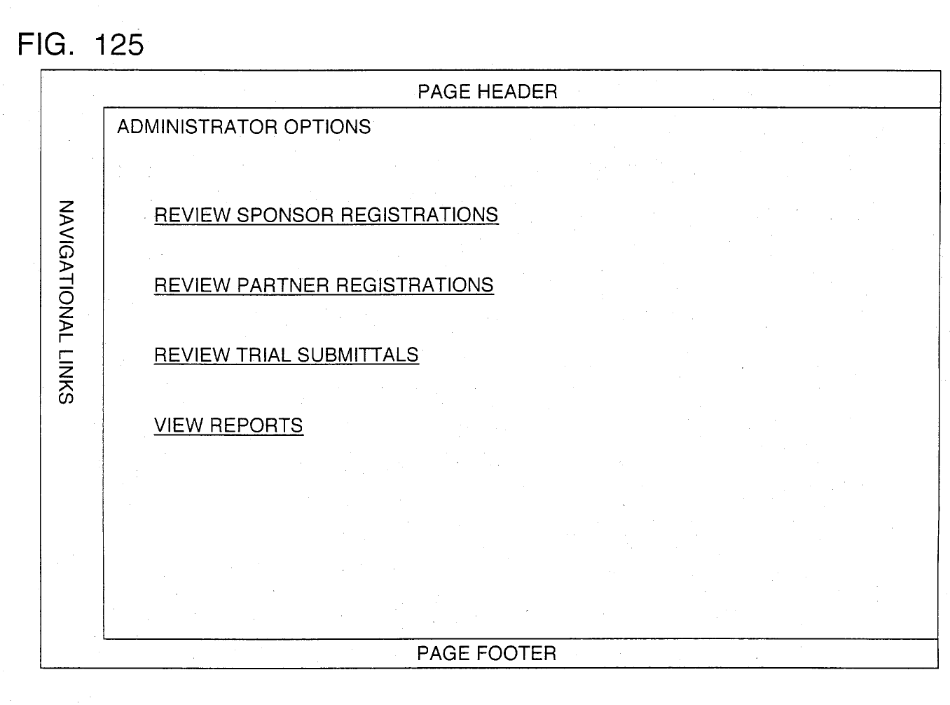

In one embodiment, after the administrator successfully completes the login procedures, they are directed to the admin options page, as illustrated in FIG. 125. The admin options area of the page can present links to the five basic actions that an administrator can take: (1)review and accept/reject sponsor applications; (2)review and accept/reject trial investigator applications; (3)review and accept/reject partner applications, review and accept/reject trial submittals; and (4)view admin and web traffic reports. The following sections describe the results of clicking these links.

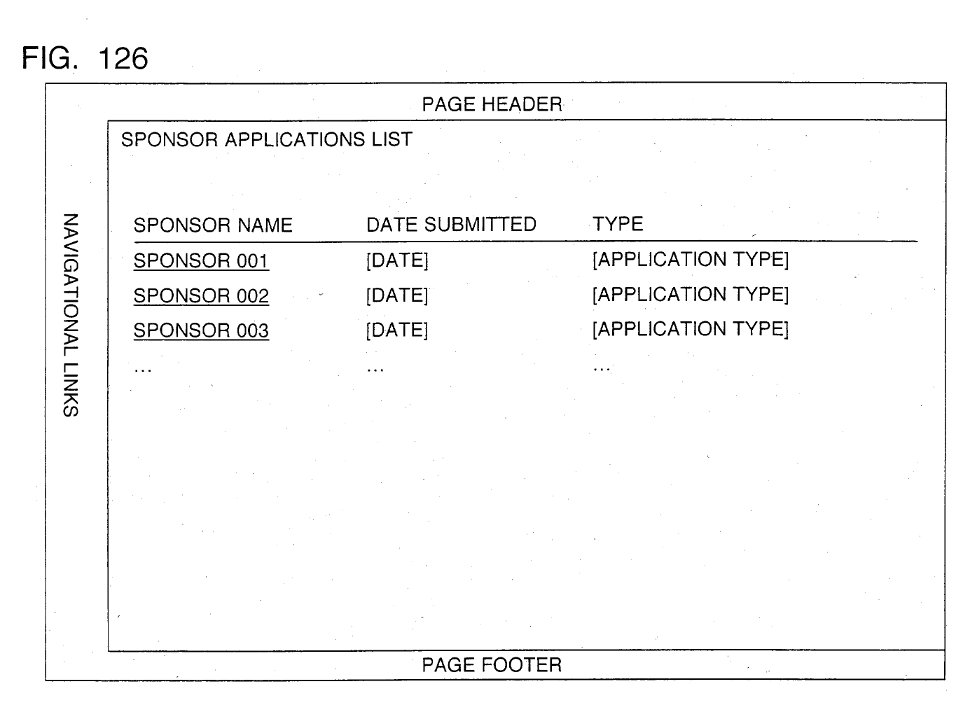

By clicking on the review sponsor registrations link in the admin options page, in one embodiment the administrator reaches the sponsor applications list page, as illustrated in FIG. 126, that lists all of the outstanding sponsor applications. In the application list area of the page, the sponsor's name, date of submittal and registration type (change, pre-registration, or final registration) can be displayed. If the administrator has been given permissions to only review new sponsor applications or only review updated sponsor applications, only the corresponding type of applications can be displayed on this page. If the administrator has permissions to review both new and updated sponsor applications, all outstanding applications can be displayed on this page. The administrator can view the registrations by clicking on the name of the sponsor, which can be linked to its corresponding application review page. The sponsor names can be sorted in chronological order with the oldest application appearing at the top of the list.

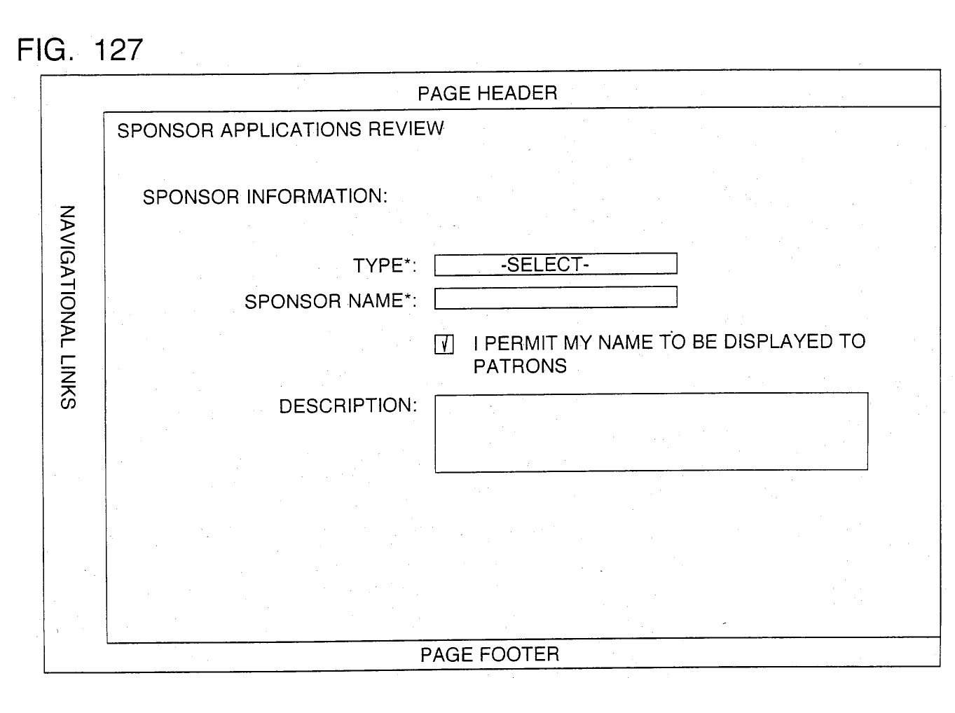

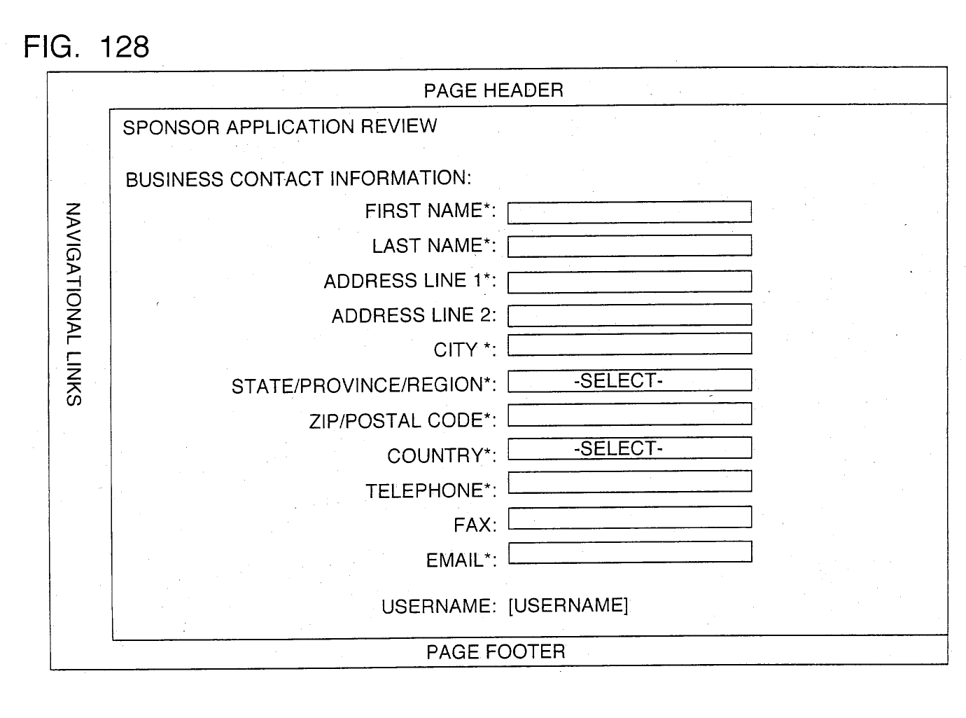

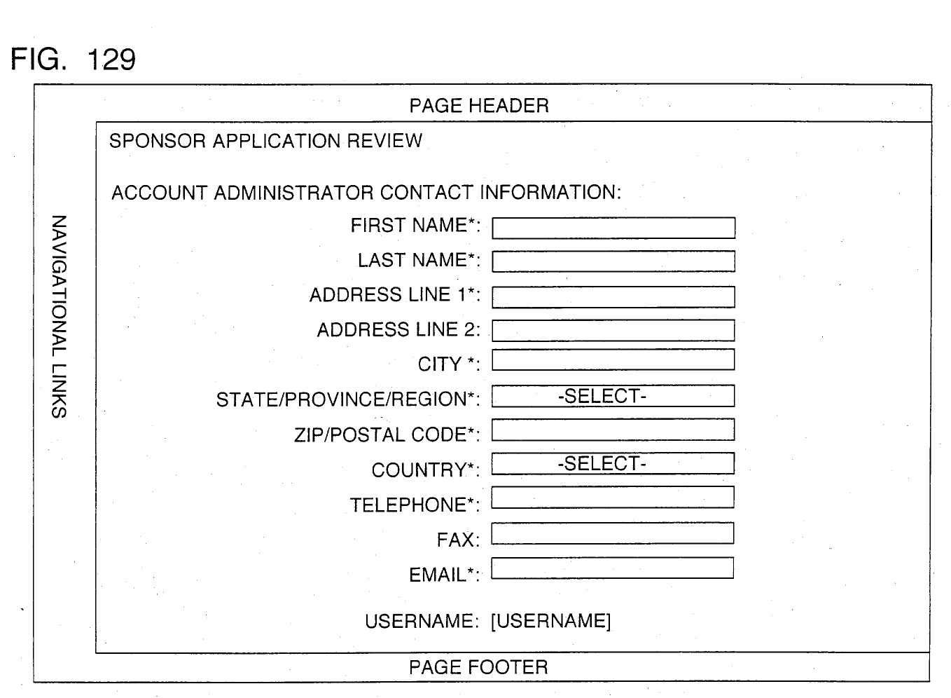

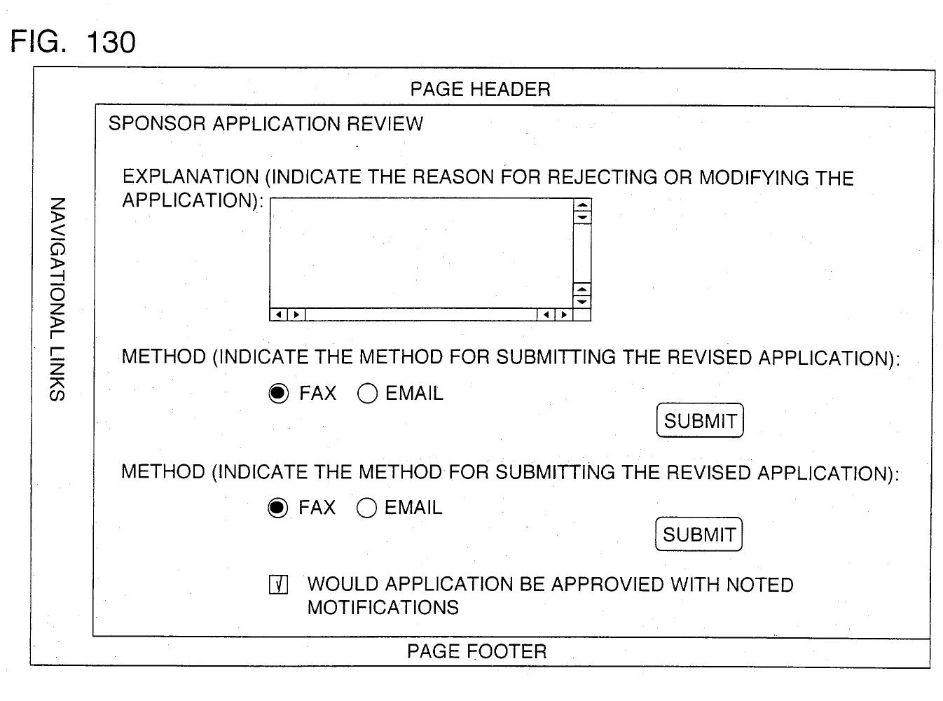

In one embodiment, when the administrator reaches the sponsor application review page for a particular sponsor, the administrator can preview all the content associated with the sponsor account application. All of the information entered by the sponsor can be pre-filled in the form elements on the page. The sponsor application review page, as illustrated in FIGS. 127, 128, 129 and 130, provides the administrator with the tools to accept, reject, or modify the application. The administrator can review and modify any sponsor account information. Next, in the rejection/modification explanation area of the page, they can enter their explanation for rejection/modification and indicates the method by which the message will be sent to the sponsor. In the accept/reject controls area, the administrator clicks the accept button or the reject button and can provide further explanation if their decision. The administrator can indicate that if certain changes are made to the application, that they would approve the application. If the application was rejected or modified by the administrator, the sponsor can approve the modification or edit the application and resubmit it for approval. Criteria for approving a sponsor includes but is not limited to drug presence in the pipeline in Phase II or III and the information provided in the sponsor's pre-registration.

Other embodiments of the present invention may include providing sponsors with specific prescreen criteria that are most often excluding persons from the sponsor's trial.

In one embodiment, by clicking on the review trial investigator applications link in the admin options page, the administrator reaches the trial investigators applications list page, similar to the sponsor applications list page as illustrated in FIG. 126, that lists all of the outstanding trial investigator applications. In the application list area of the page, the physician's name, date of submittal and registration type (change or new) are displayed. If the administrator has been given permissions to only review new trial investigator applications or only review updated trial investigator applications, only the corresponding type of applications can be displayed on this page. If the administrator has permissions to review both new and updated trial investigator applications, all outstanding applications are displayed on this page. The administrator can view the registrations by clicking on the name of the sponsor, which are linked to its corresponding application review page. The physician names are sorted in chronological order with the oldest application appearing at the top of the list.

In one embodiment, when the administrator reaches the trial investigator application review page for a particular physician, the administrator can preview all the content associated with the trial investigator account application. All of the information entered by the physician is pre-filled in the form elements on the page. The trial investigator application review page, similar to the sponsor application review page, as illustrated in FIGS. 127, 128, 129, and 130, provides the administrator with the tools to accept, reject, or modify the application. The administrator can review and modify any physician account information. Next, in the rejection/modification explanation area of the page, they can enter their explanation for rejection/modification and indicates the method by which the message can be sent to the physician. In the accept/reject controls area, the administrator can click the accept button or the reject button and can provide further explanation if their decision. The administrator can indicate that if certain changes are made to the application, that they would approve the application. If the application was rejected or modified by the administrator, the physician can approve the modification or edit the application and resubmit it for approval.

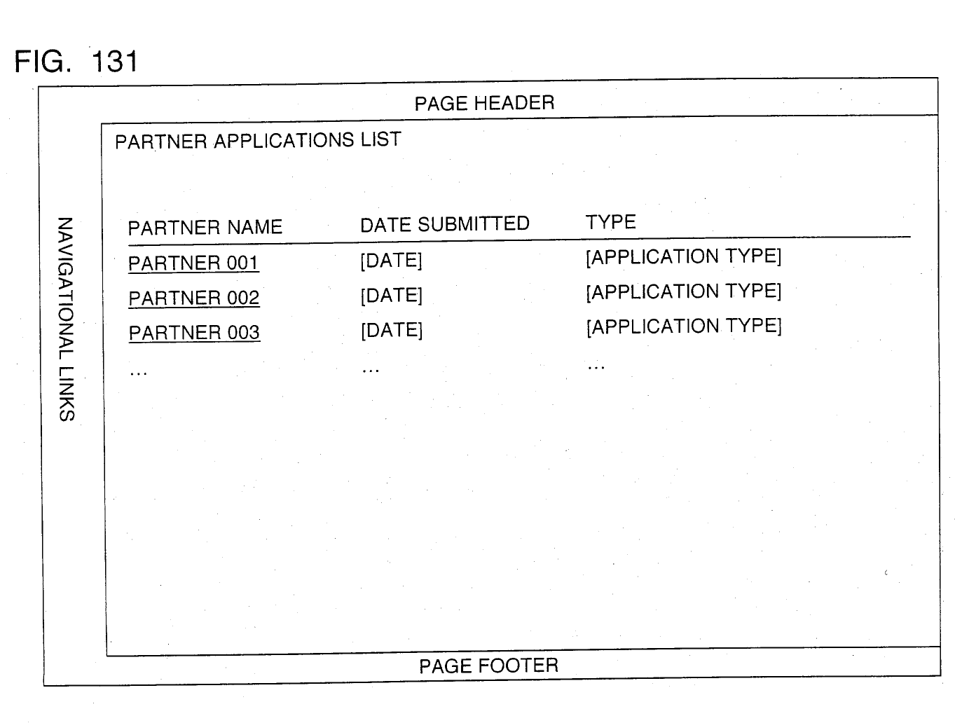

In one embodiment, by clicking on the review partner registrations link in the admin options page, the administrator reaches the partner applications list page, as illustrated in FIG. 131, that lists all of the outstanding partner applications. In the applications list area of the page, the partner's name, date of submittal, and registration type (change, pre-registration, or final registration) are displayed. If the administrator has been given permissions to only review new partner applications or only review updated partner applications, only the corresponding type of applications can be displayed on this page. If the administrator has permissions to review both new and updated partner applications, all outstanding applications can be displayed on this page. The administrator can view the registrations by clicking on the name of the partner, which can be linked to its corresponding application review page. The partner names are sorted in chronological order with the oldest application appearing at the top of the list.

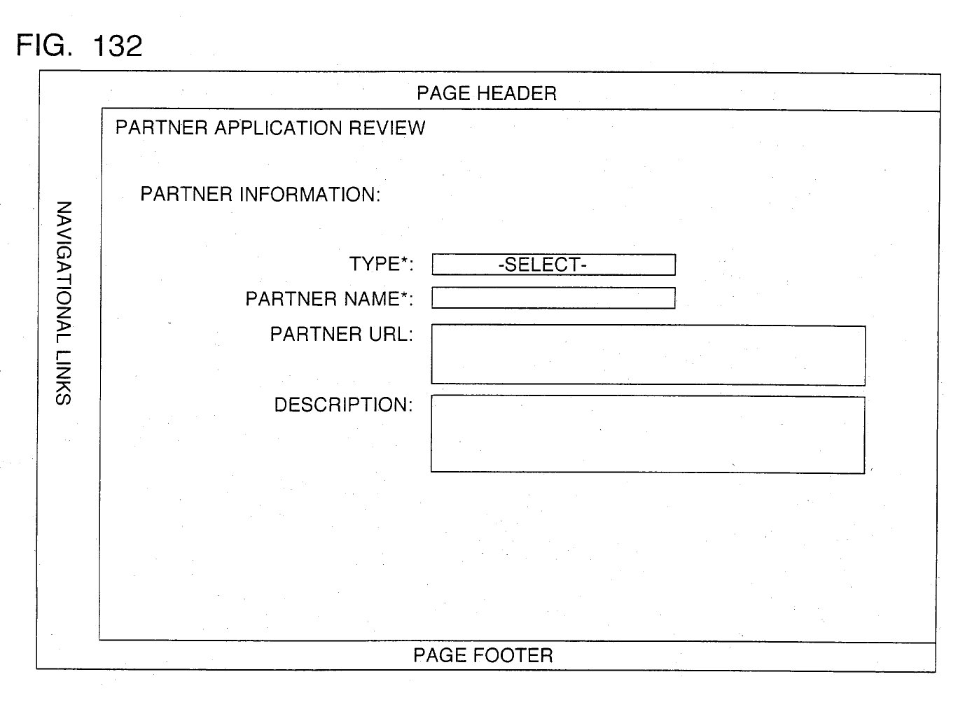

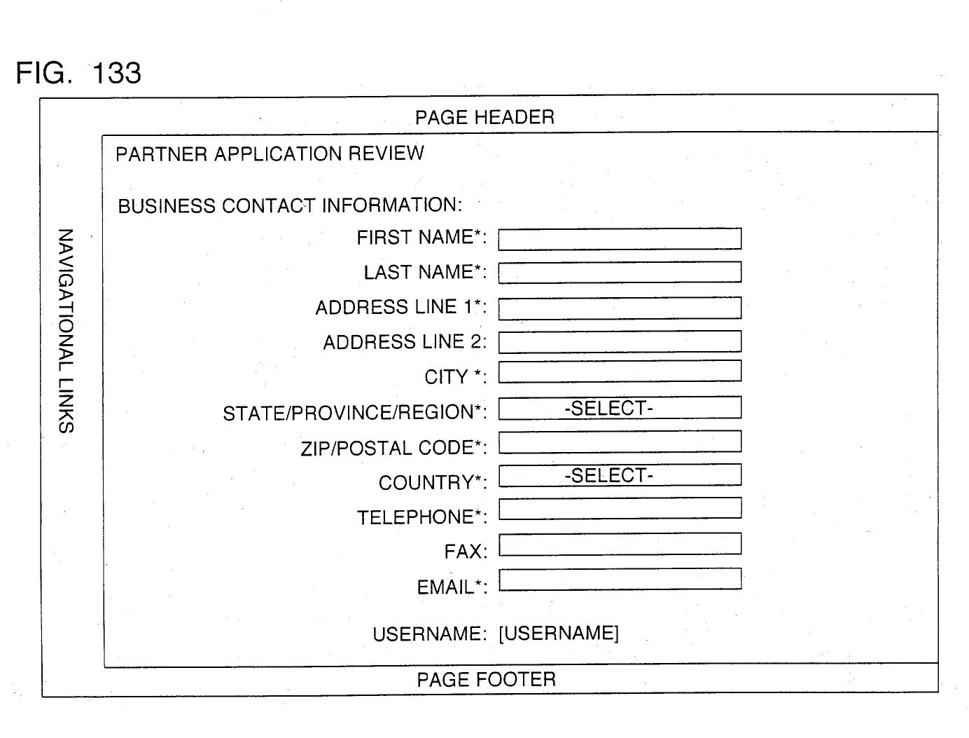

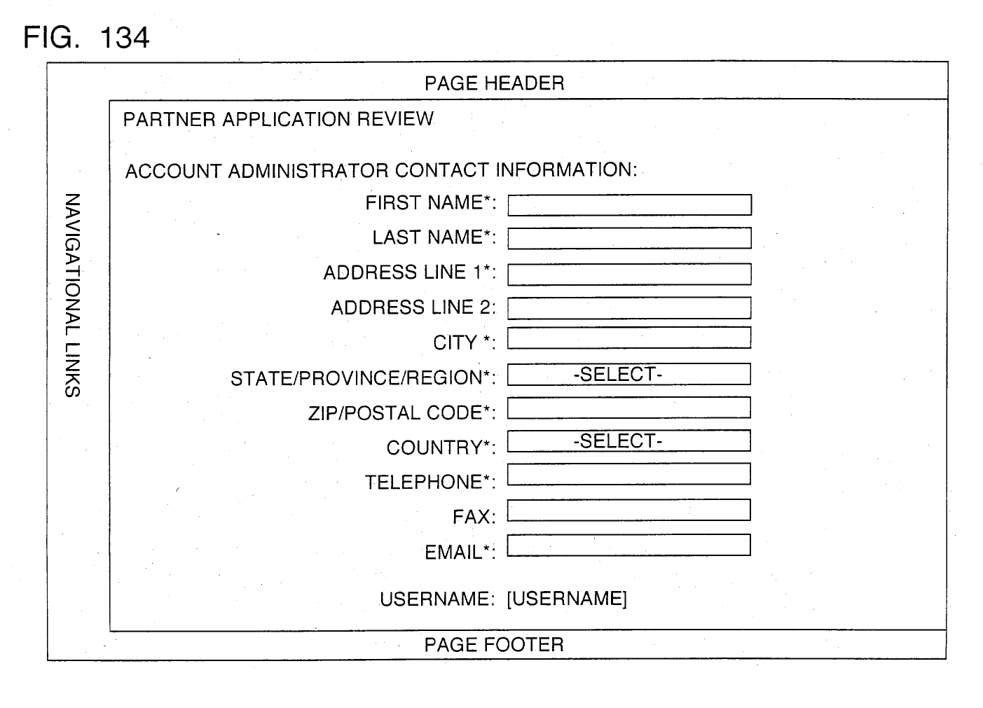

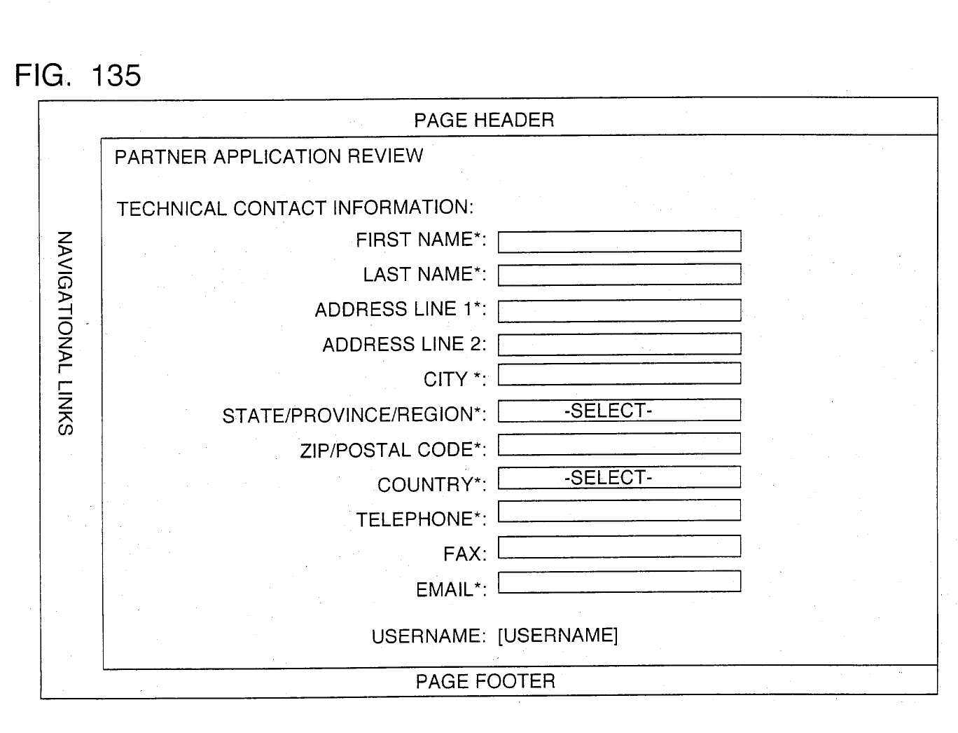

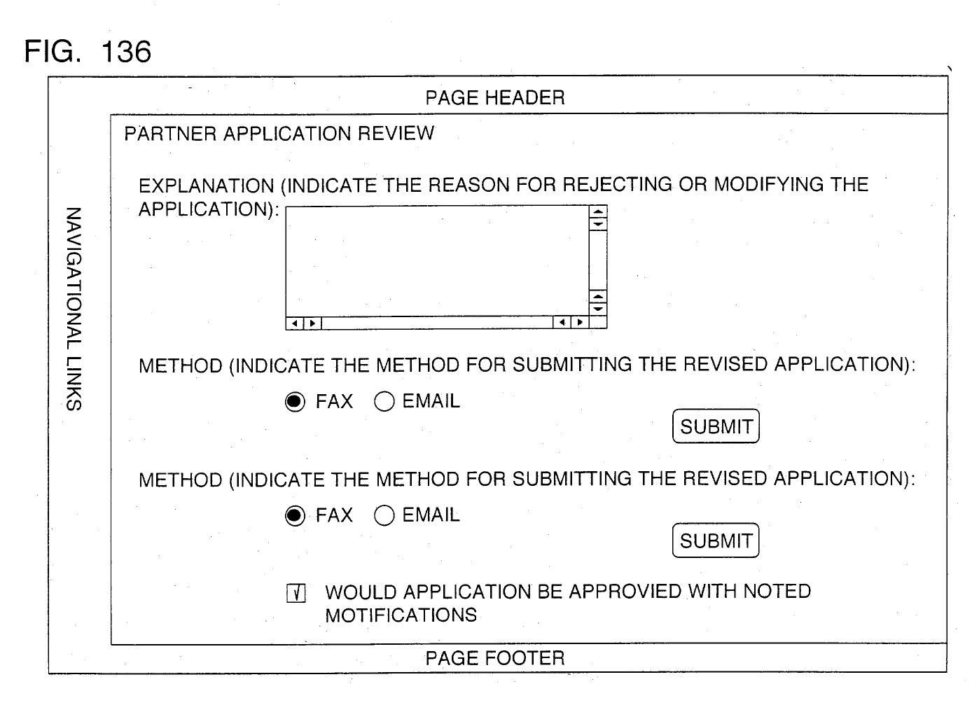

When the administrator reaches the partner application review page for a particular partner, in one embodiment, the administrator can preview all content associated with a partner account application. All of the information entered by the partner can be pre-filled in the form elements on the page. The partner application review page, as illustrated in FIGS. 132, 133, 134, 135, and 136, provides the administrator with the tools to accept, reject, or modify the application. The administrator can review and modify any partner account information. Next, in the rejection/modification explanation area of the page, they can enter their explanation for rejection/modification and indicates the method by which the message can be sent to the partner. In the accept/reject controls area, the administrator can click the accept button or the reject button and can provide further explanation of their decision. The administrator can indicate that if certain changes are made to the application, that they would approve the application. If the application was rejected or modified by the administrator, the partner can approve the modification or edit the application and resubmit it for approval. Explanation of a rejection can be required by the module. Criteria for approval can include, but is not limited to existence of a web site, reach to a population of patients and advocates who are known to be credible, and the contents of the partner's pre-registration.

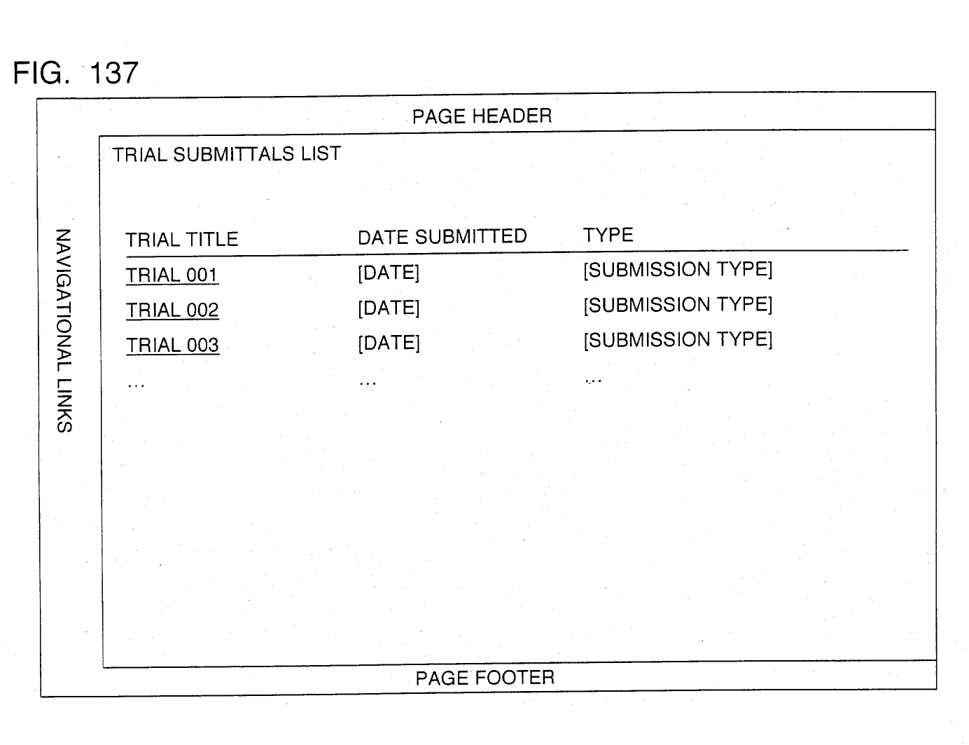

In one embodiment, by clicking on the review trial submittals link in the admin options page, the administrator reaches the trial submittal list page, as illustrated in FIG. 137, that can list all trials that need to be reviewed. In the trial list area of the page, the partner's name, date of submittal, and registration type (change or add) can be displayed. If the administrator has been given permissions to only review updated trial submittals, only the corresponding type of submittals can be displayed on this page. If the administrator has permissions to review both new and updated trial submittals, all outstanding submittals can be displayed on this page. The administrator can view the submittals by clicking on the trial protocol title, which is linked to its corresponding trial review page. The trial protocol titles are sorted in chronological order with the oldest submittal appearing at the top of the list.

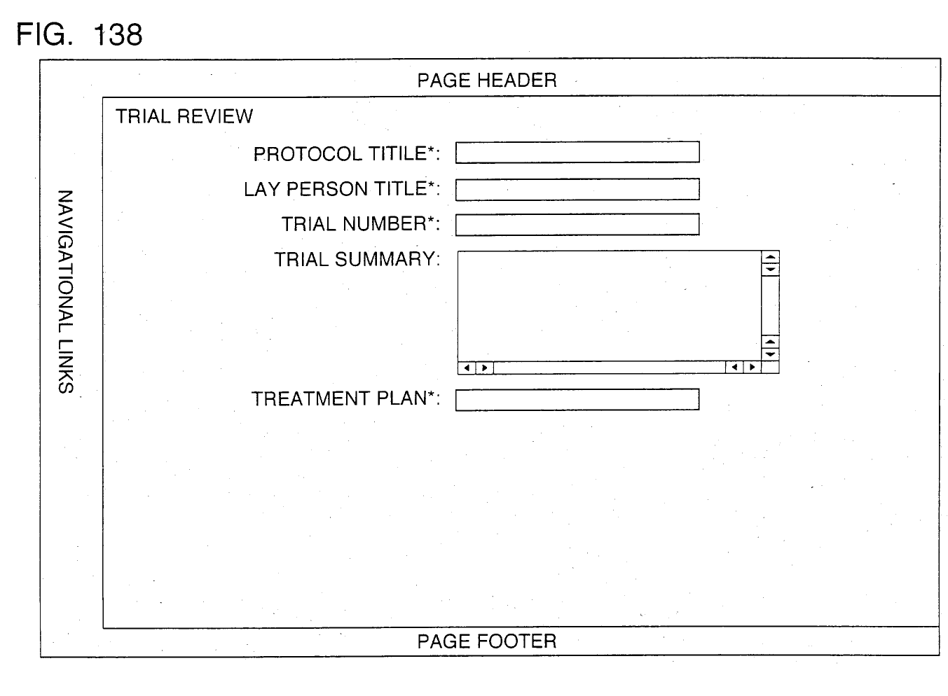

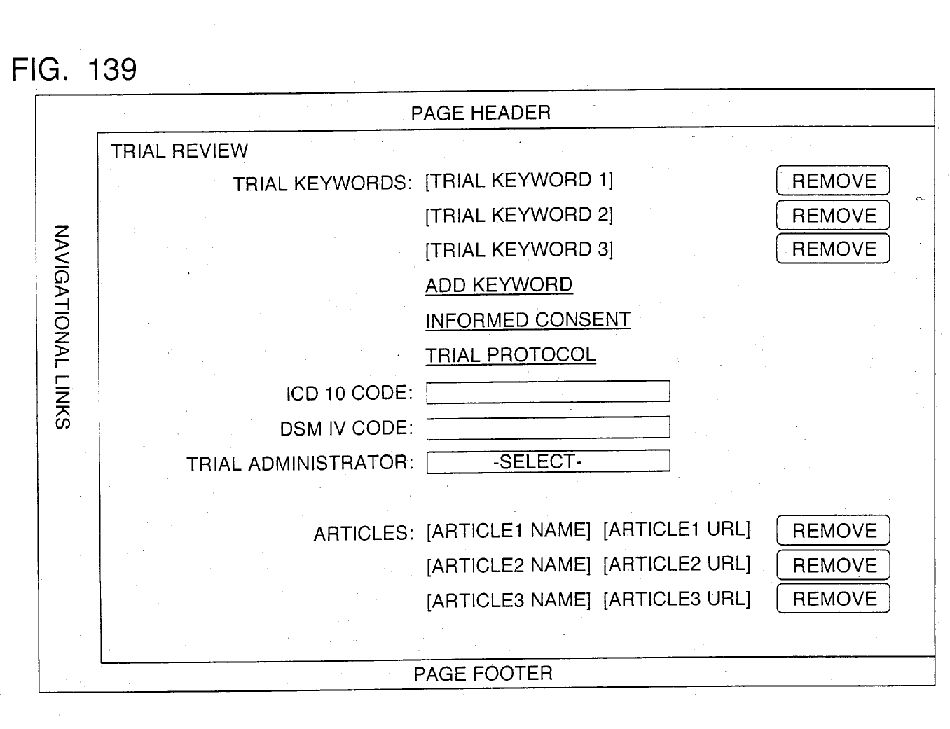

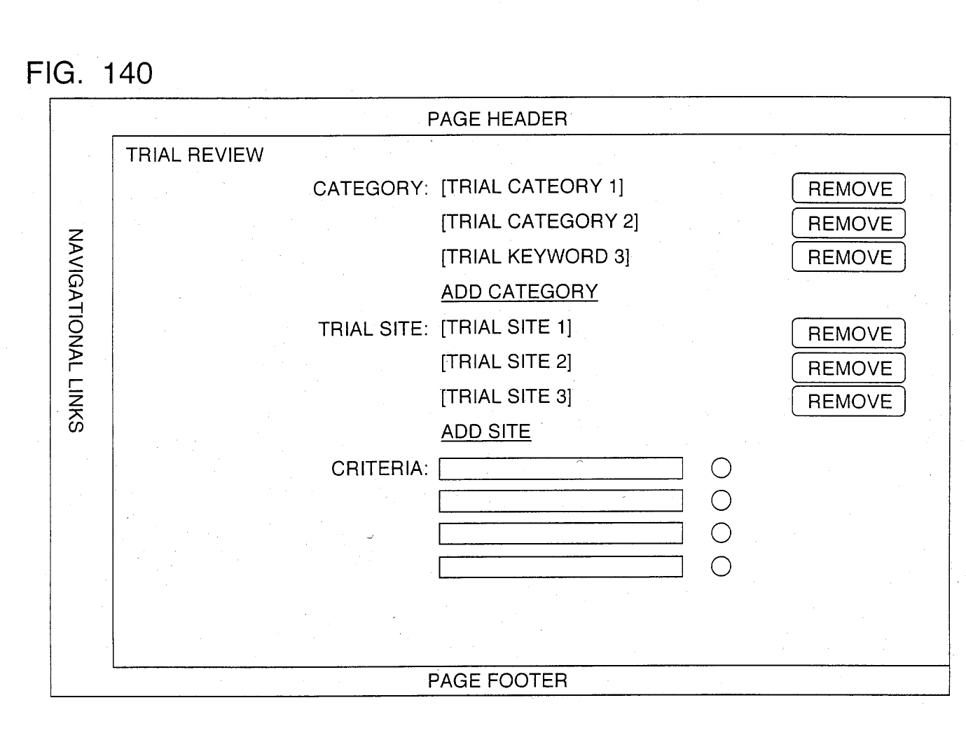

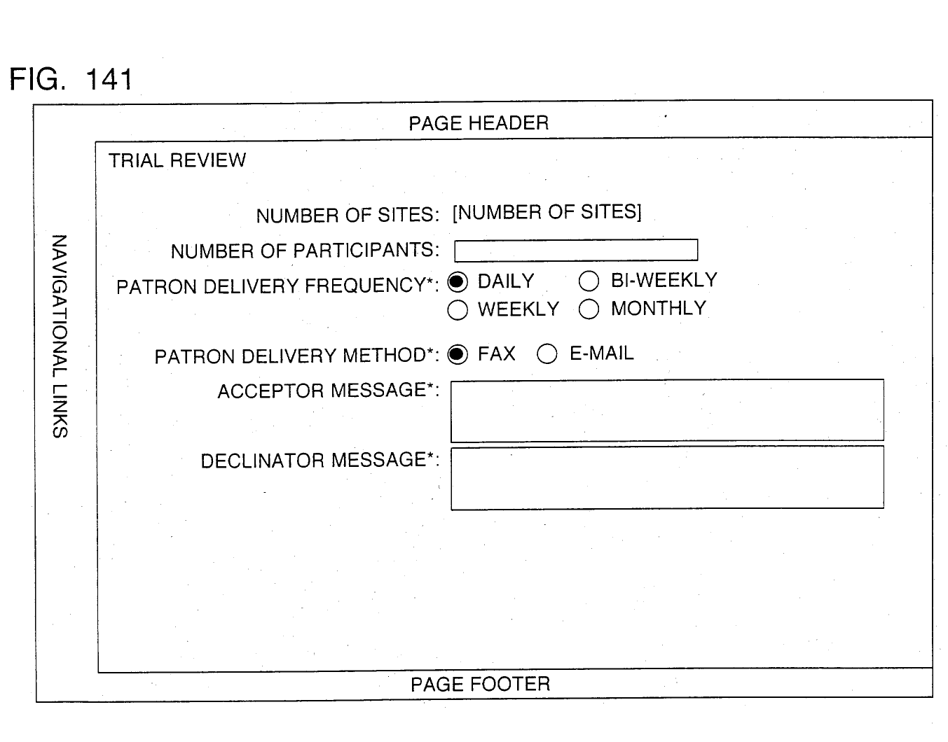

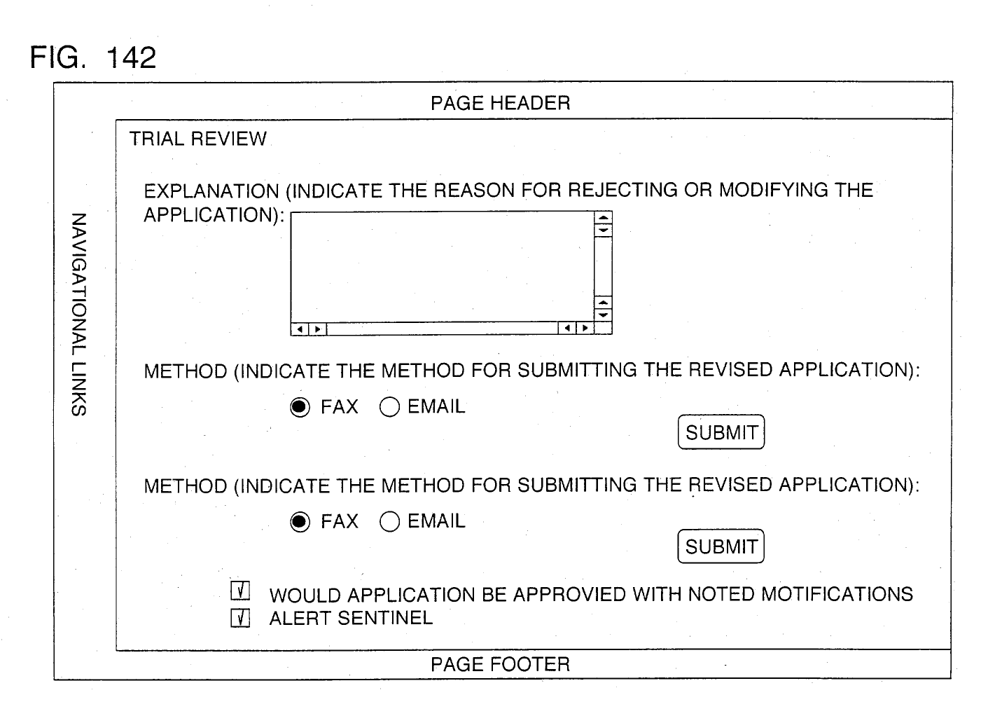

In one embodiment, when the administrator reaches the trial review page for a particular submittal, the administrator can preview all information associated with a trial. All of the information entered about a trial is pre-filled in the form elements on the page. The trial review page, as illustrated in FIGS. 138, 139, 140, 141 and 142, provides the administrator with the tools to accept, reject, or modify the submittal. The administrator can review and modify any trial information. Next, in the accept/reject controls area, the administrator can click the accept button or the reject button and can provide further explanation of their decision. The administrator can indicate that if certain changes are made to the application, that they would approve the application. If the application was rejected or modified by the administrator, the sponsor can approve the modification or edit the application and resubmit it for approval. Also in the accept/reject controls area, an administrator can choose the method of transmission of the approval/rejection of the submittal. Explanation of a rejection is required by the module. If the trial is accepted, the trial sentinel can be notified of a change to the trials database.

In one embodiment and like the sponsor module, the admin module also allows the administrator to add, update, and remove the keywords, citations, investigative sites associated with a trial.

In one embodiment of the present invention, reports are created by the administrator in HTML, PDF, Word, Excel, comma delimited, and ASCII text formats. This flexibility allows for posting reports to web sites, printing pre-formatted reports, manipulating reports for custom display, and uploading reports to a database. The reports are generated in Word, Excel and HTML format.

In one embodiment, data that is captured by the reporting module can include, but is not limited to, the IP address of patrons' module access devices; the number of unique patrons using the modules; the path patrons use to navigate within the modules; time per unique session; number of page visits (by trial and by medical condition); the use of search versus browse; common search fields; the step prior to entering and post exiting a module; and use of technical versus lay views, page view duration, use by self or advocate.

In one embodiment, the administrator uses the reports list page to view the reports available. These reports include reports available to sponsors, web traffic reports, and a trial sentinel demand reports. The web traffic reports are available in comma-delimited format, and the other reports can contain a button to download a file containing the corresponding comma-delimited data.

The delivered patrons report is presented in static format and as defined by the administrator in the delivered patrons report page, as illustrated in FIG. 106. In the report area of the page, the number of prescreened patrons who can be delivered to the sponsor can be displayed. This data is displayed as a total, in a table by trial, and in a second table by investigative site. The administrator returns to the reports list page by clicking the return to menu link below the reports.

The enrolled patrons report is presented in static format and as defined by the administrator in the enrolled patrons report page, as illustrated in FIG. 107. In the report area of the page, the percentage of prescreened patrons who were actually enrolled in trials is displayed. This data is displayed as an aggregate percentage (total number enrolled/total number successfully pre-screened), in a table by trial, and in a second table by investigative site. The administrator can return to the reports list page by clicking the return to menu link below the reports.

The demographic data report is presented in static format and as defined by the administrator in the demographic data report page, as illustrated in FIG. 108. In the report area of the page, demographic information describing patrons who have gone through a sponsor's pre-screen process is described. The demographic data is displayed in the following tables: gender with totals and percentages, age groups with totals and percentages, top ten ZIP codes with totals and percentages, top five countries with totals and percentages, and geographic delimiter groups with totals and percentages. The sponsor also has the option of displaying this data only for the patrons that passed pre-screens, failed pre-screens, or for all of the sponsor's patrons. The sponsor makes their selection from a drop-down list at the top of the report area of the page. The default option is to display the demographic data for all of the sponsor's patrons. The administrator returns to the reports list page by clicking the return to menu link below the reports.

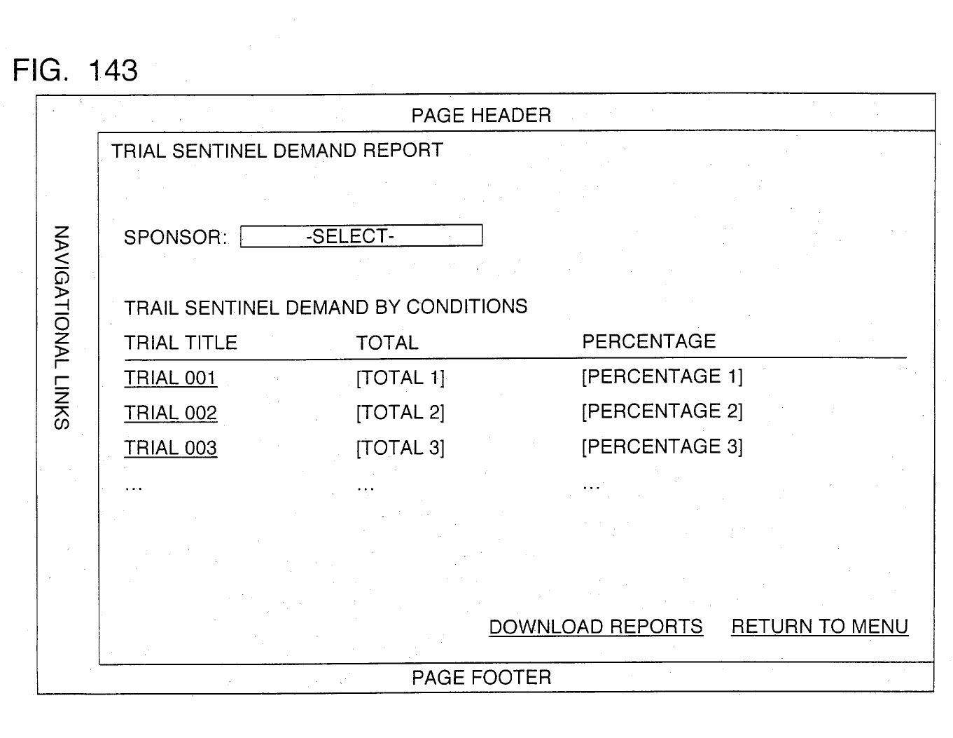

The trial sentinel demand report, as illustrated in FIG. 143, displays the trial sentinel demands listed by condition. The table consists of a list of conditions with at least one trial sentinel request, followed by the actual number trial sentinels requested for each condition. The administrator returns to the reports list page by clicking the return to menu link below the reports.

The general statistics report accounts for the number of unique patrons and the average length of a patron's session. The report also includes site data such as the hits, page views, sessions, and visitors that outline the specific reports to follow. The administrator returns to the reports list page by clicking the return to menu link below the reports.

The most requested pages report accounts for the number of page visits by identifying the most popular web site pages and how often they were accessed. This report determines if patrons easily access content important to the inventor. The average time viewed indicates how well the pages hold the attention of the patrons. The administrator can return to the reports list page by clicking the return to menu link below the reports.

The top entry pages report accounts for the entry pages by identifying the first page viewed when a patron visits the site. The top entry pages are often home pages, and major modules, but could be individual pages of interest. The administrator returns to the reports list page by clicking the return to menu link below the reports.

The top paths report accounts for the navigation through the module by identifying the patrons' sequences of pages. This report helps to determine the usability of the module as well as common practices of the patrons. The administrator returns to the reports list page by clicking the return to menu link below the reports.

The top exit pages report accounts for the exit pages by identifying the pages last viewed when a patron leaves the module. This report helps to determine a patron's level of satisfaction, if they found what they were looking for, and when and if they lost interest. The administrator returns to the reports list page by clicking the return to menu link below the reports.

The top visitors report accounts for where patrons can be coming from by identifying the IP address and/or domain name and their relative activity level on the site. This report helps determine the web site's audience and tailor the module to patrons' preferences. The administrator returns to the reports list page by clicking the return to menu link below the reports.

The custom search vs. browse report accounts for the total number of browse versus search hits. It assumes that the number of browse hits can be naturally higher by design. Simple search sessions usually take one search hit, while simple browse sessions may take up to six clicks if a trial can be deep in the clinical trial directory. The report can be filtered to only include search and browse processing pages. The administrator returns to the reports list page by clicking the return to menu link below the reports.

The URL analysis report can be customized to capture information in dynamic pages that can be not captured in the standard reports. This report does require that information to be tracked be in the query string parameters. The administrator returns to the reports list page by clicking the return to menu link below the reports.

The sponsor by trial visit report accounts for the total number of visits to the trial detail pages and can be sorted by sponsor and by trial. The administrator can return to the reports list page by clicking the return to menu link below the reports.

The trial by investigative site visit report accounts for the total number visits to the trial detail pages and can be sorted by trial and investigative site. The administrator returns to the reports list page by clicking the return to menu link below the reports.

The category visit report accounts for the total number of disease condition page visits sorted by disease condition. The administrator returns to the reports list page by clicking the return to menu link below the reports.

The internal search keywords report accounts for the most common search keywords by the internal search module. The administrator returns to the reports list page by clicking the return to menu link below the reports.

The technical vs. lay medical terms report accounts for the total technical term page views versus total lay term page views. The administrator returns to the reports list page by clicking the return to menu link below the reports.

The advocate vs. self report accounts for the total number of patrons who access the site that can be advocates. The administrator returns to the reports list page by clicking the return to menu link below the reports.

The partner visits report accounts for the total number of patron visits sorted by partner in which module can be displayed. The administrator returns to the reports list page by clicking the return to menu link below the reports.

Other embodiments of the present invention can create reports using any trial, patron, admin, sponsor, HCP, or other data used by the methods and systems of the present invention.

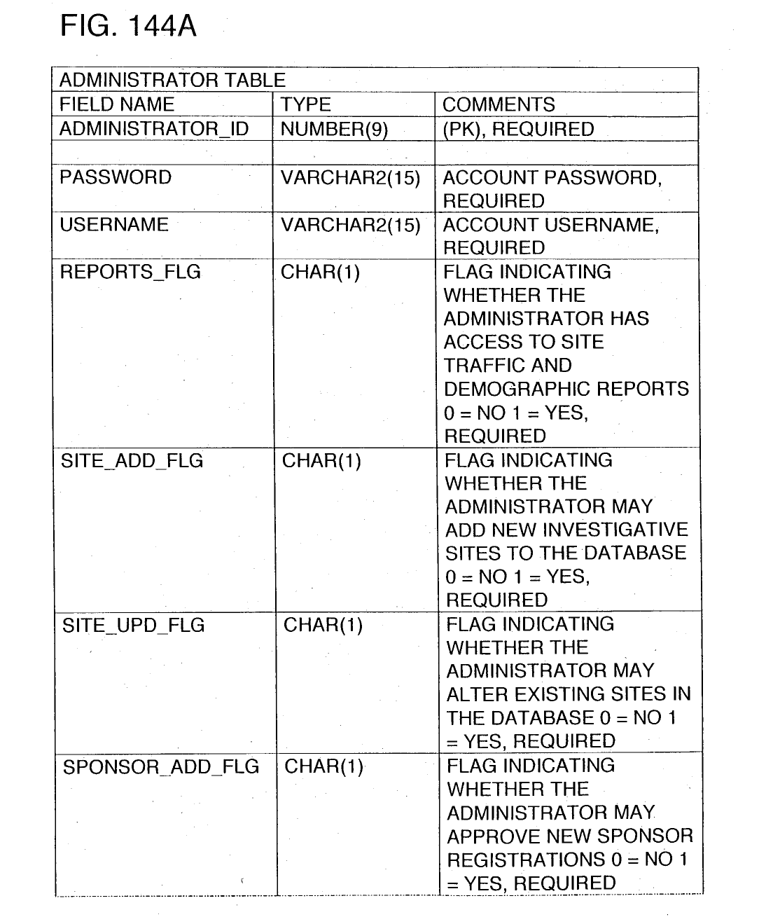

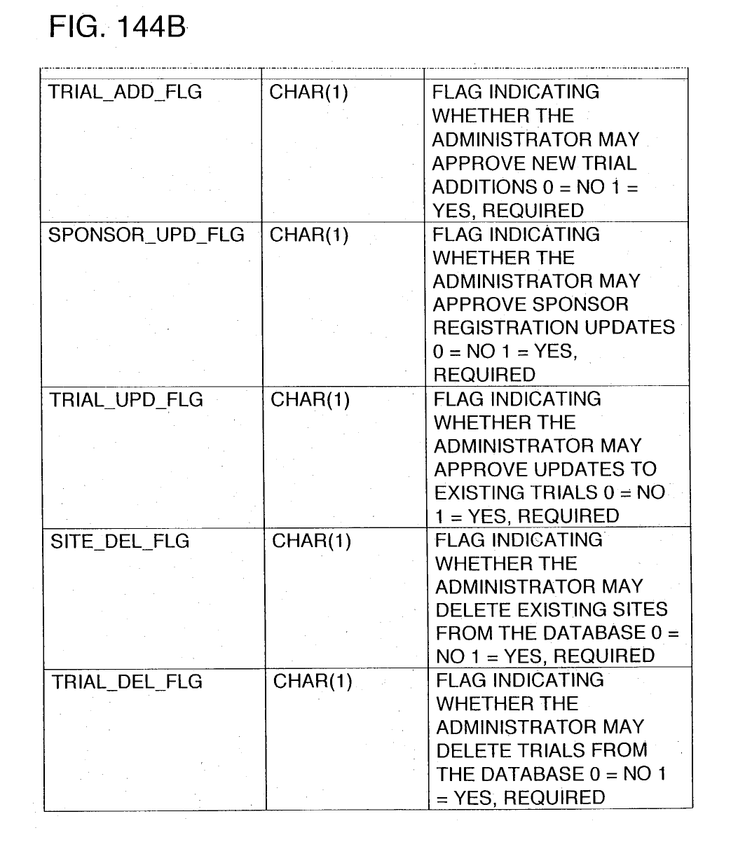

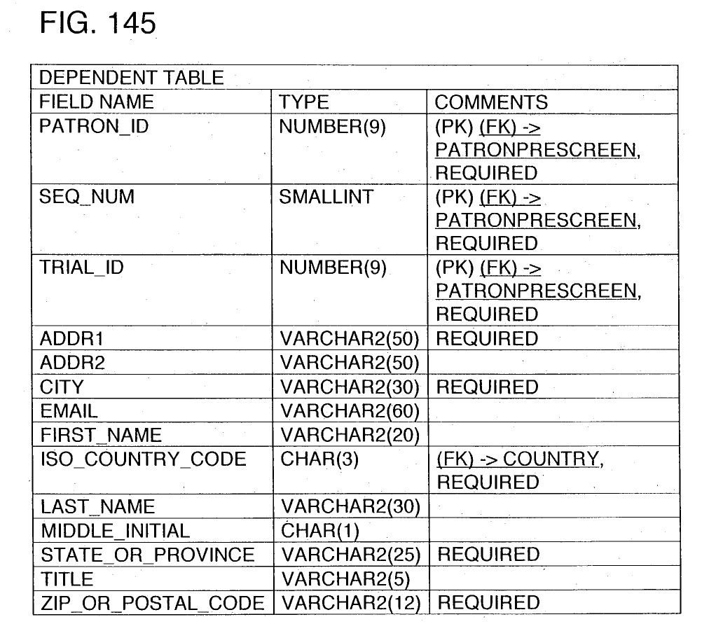

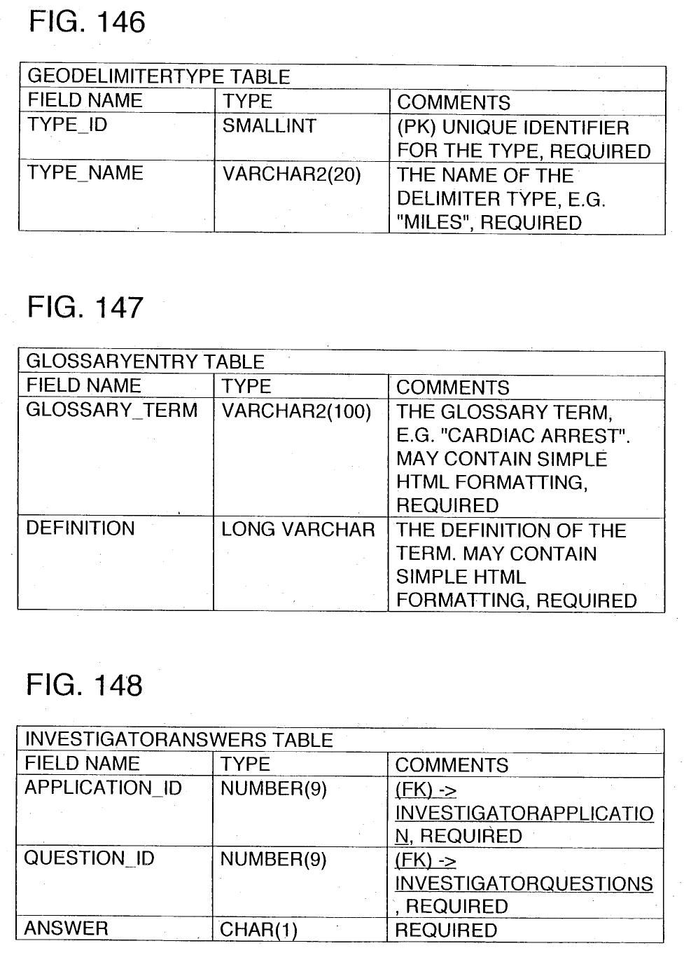

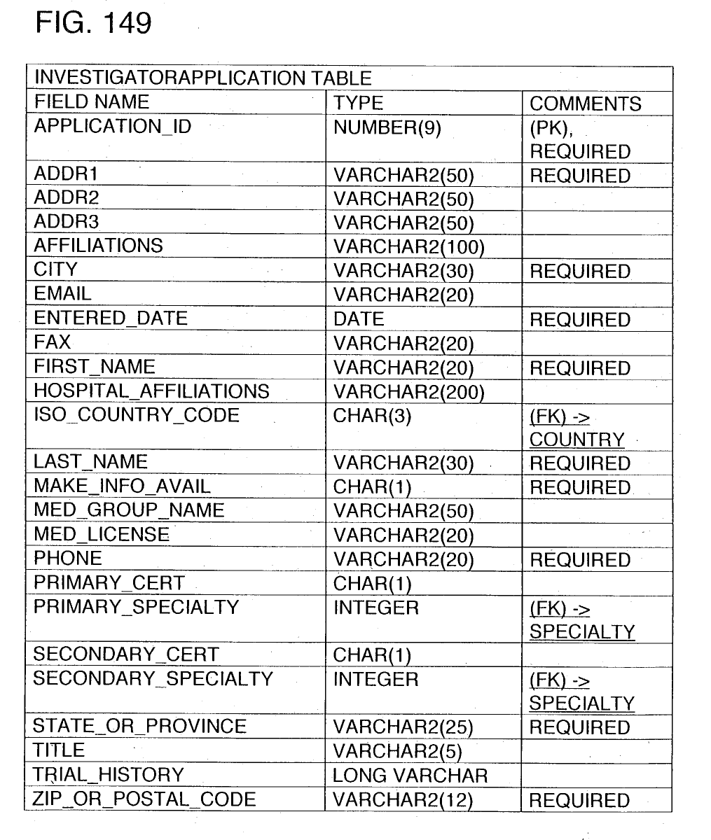

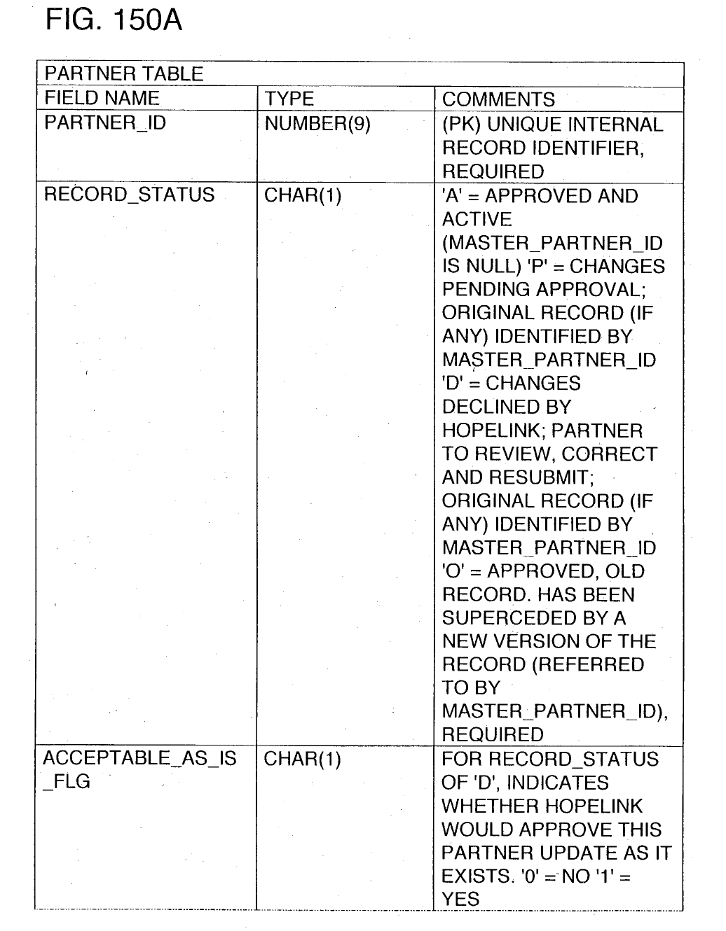

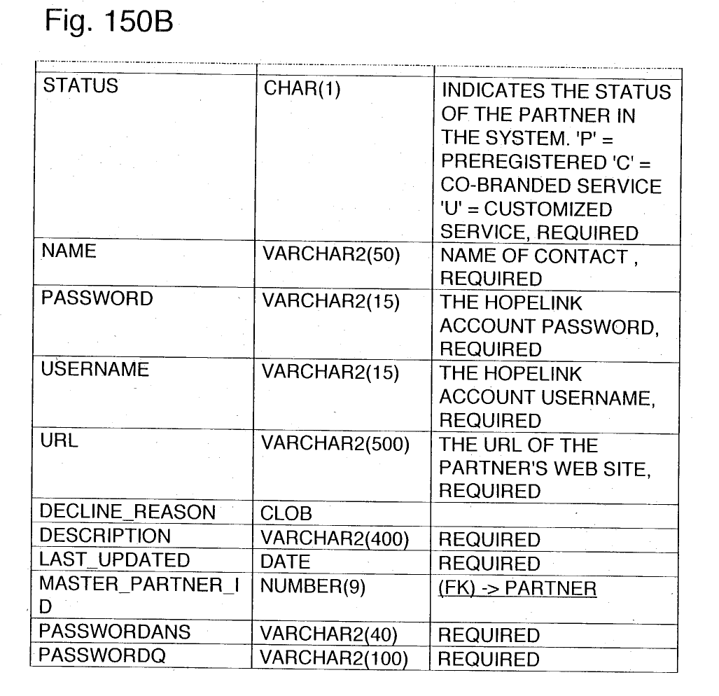

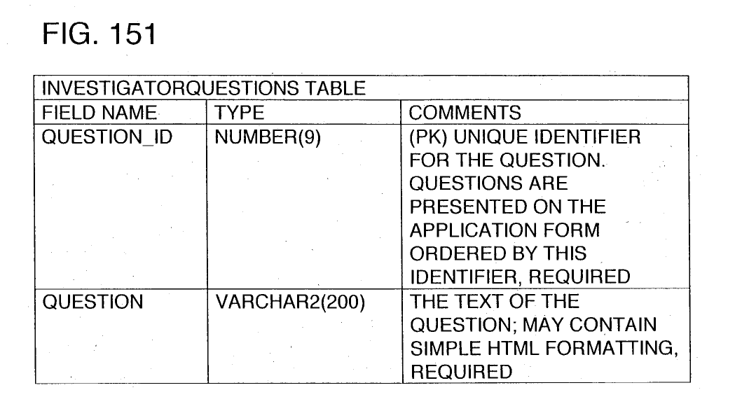

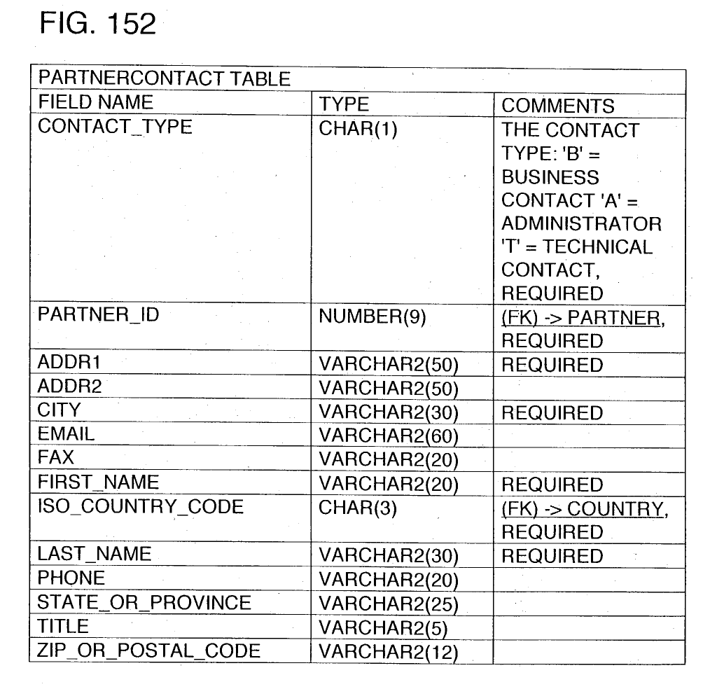

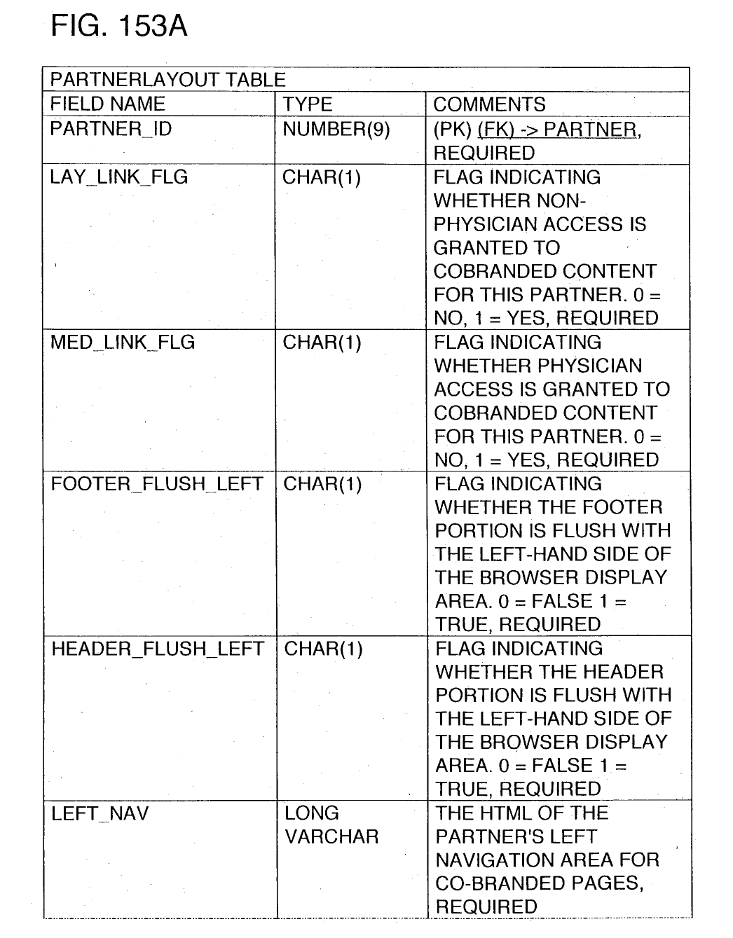

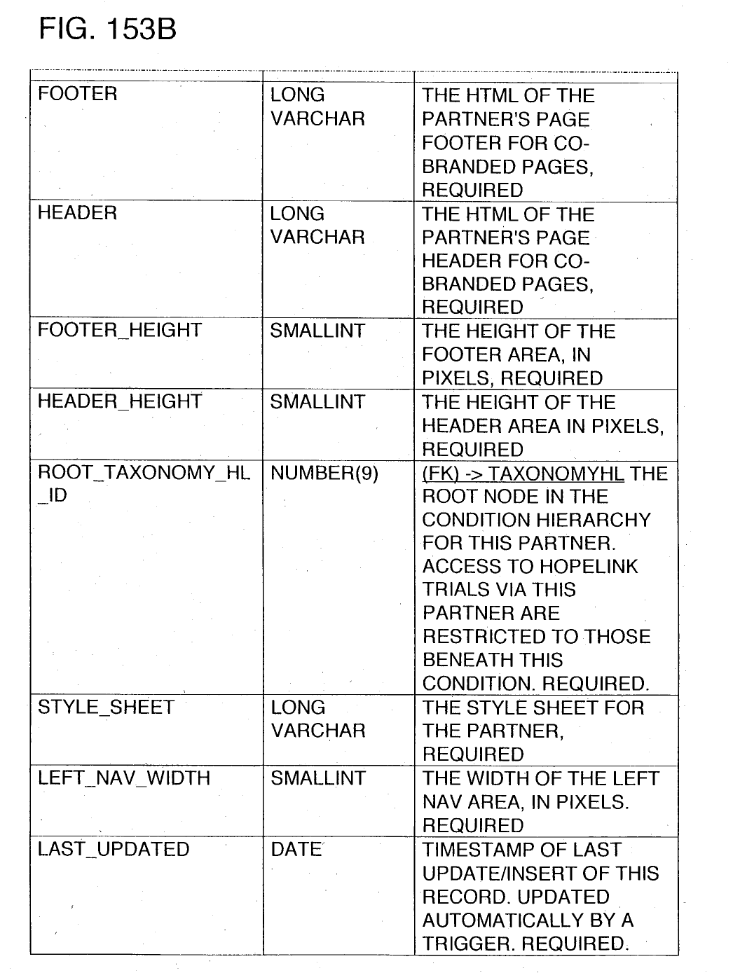

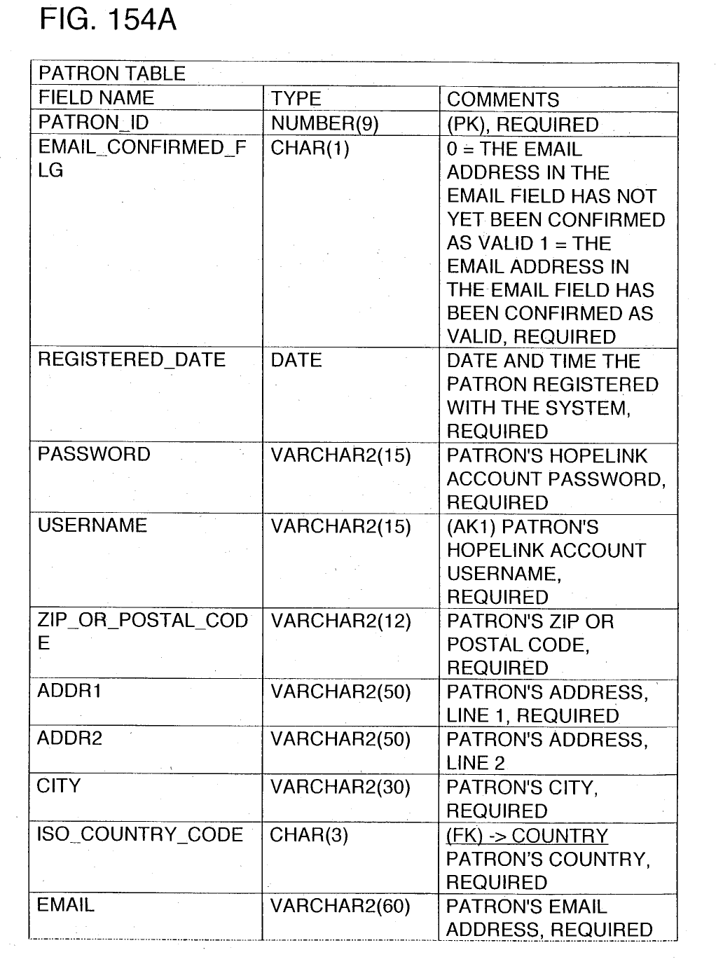

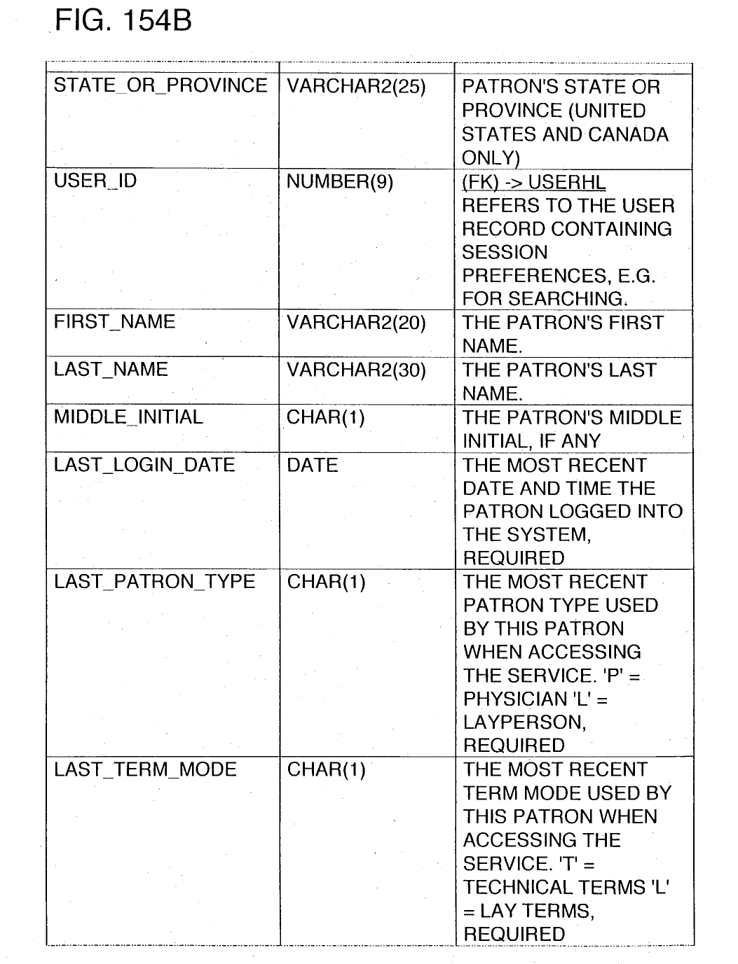

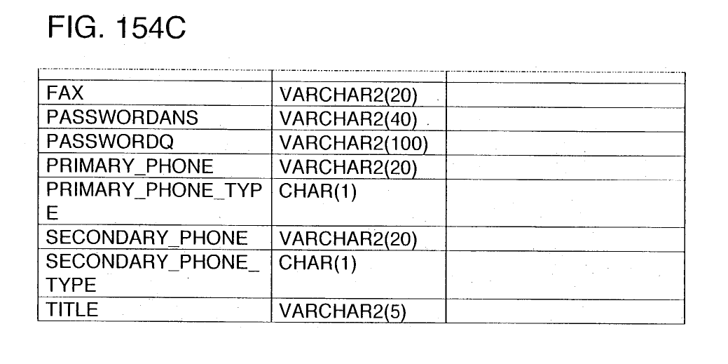

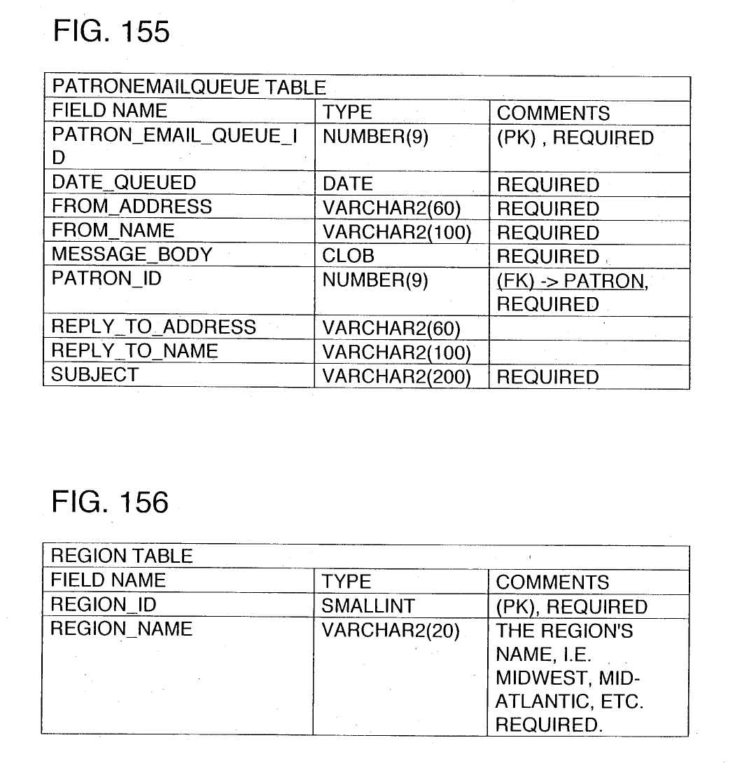

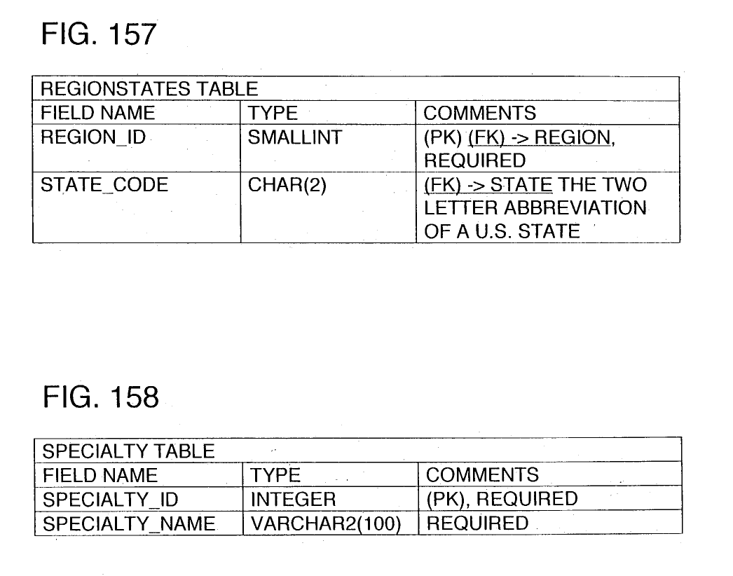

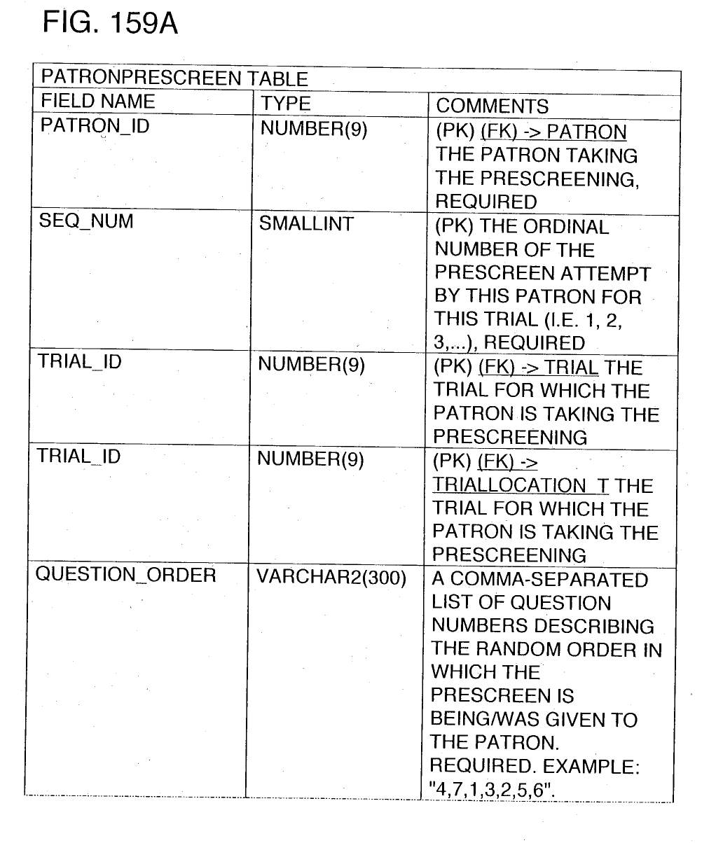

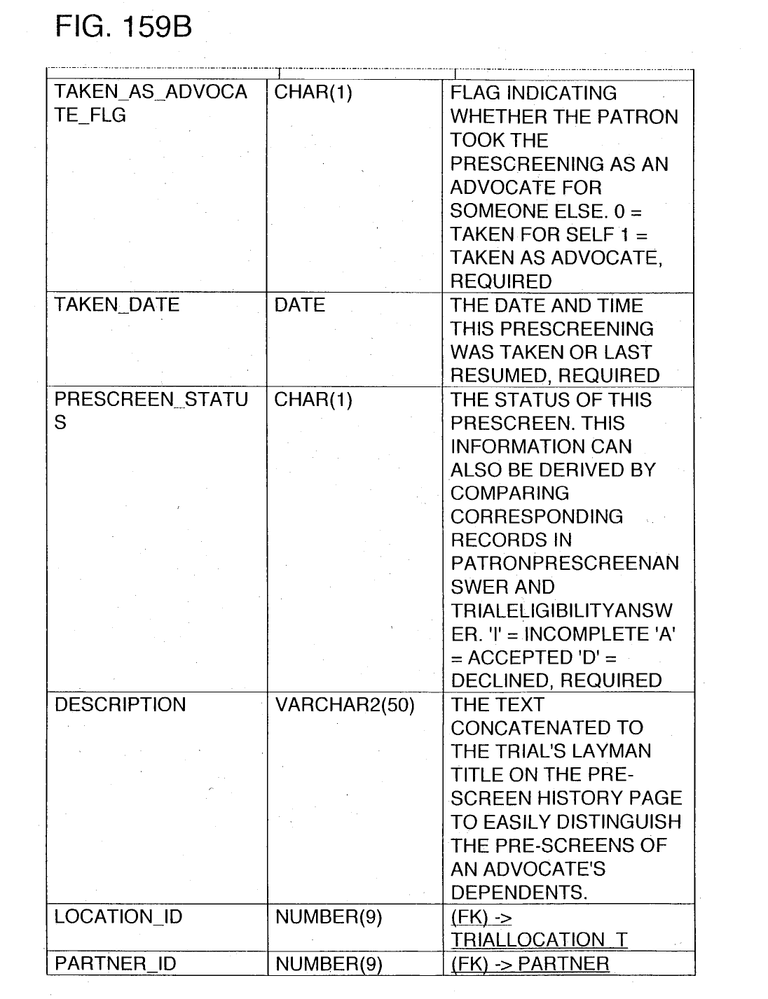

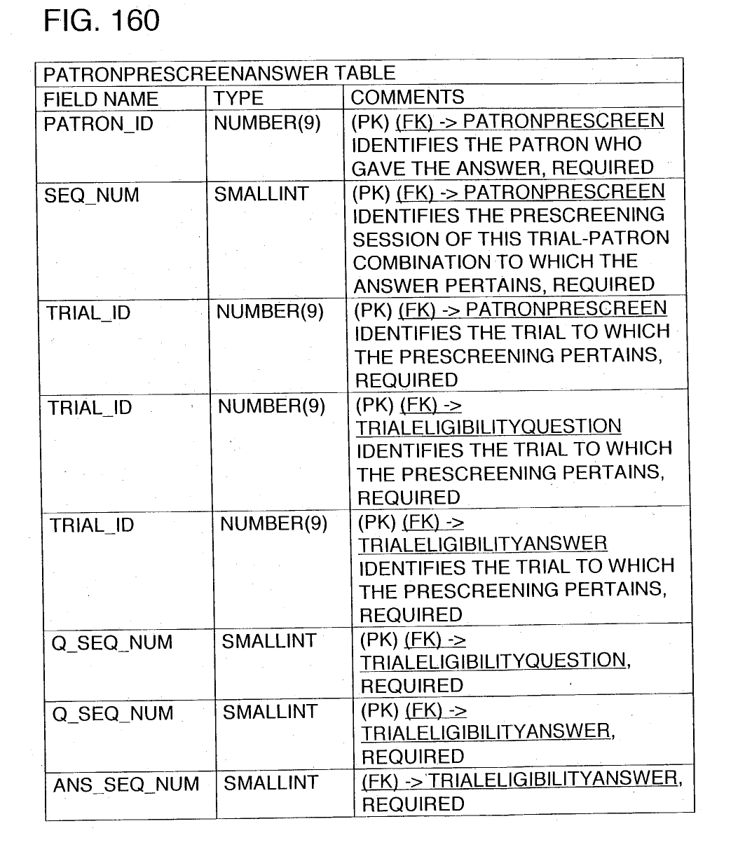

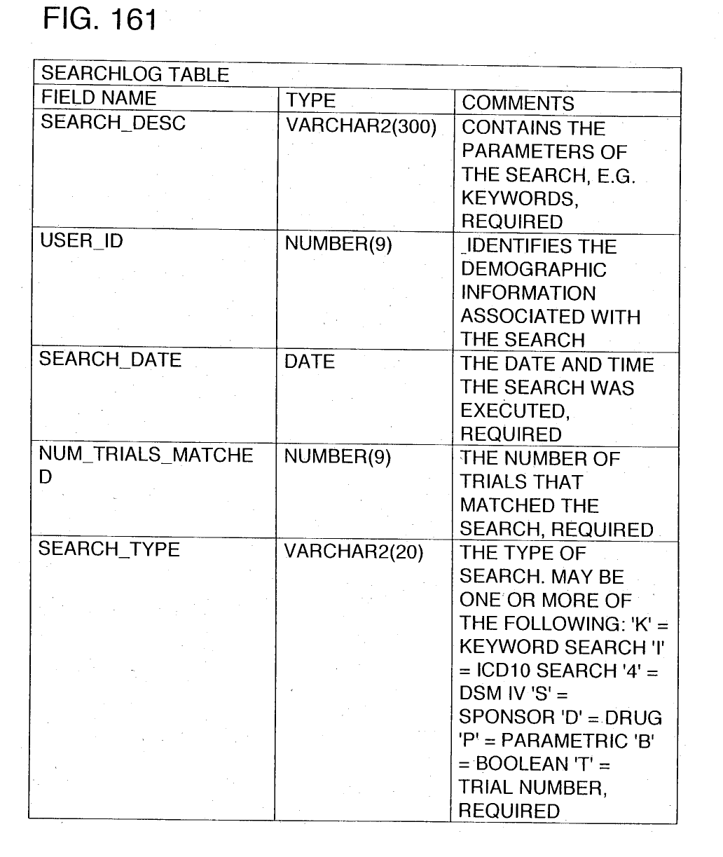

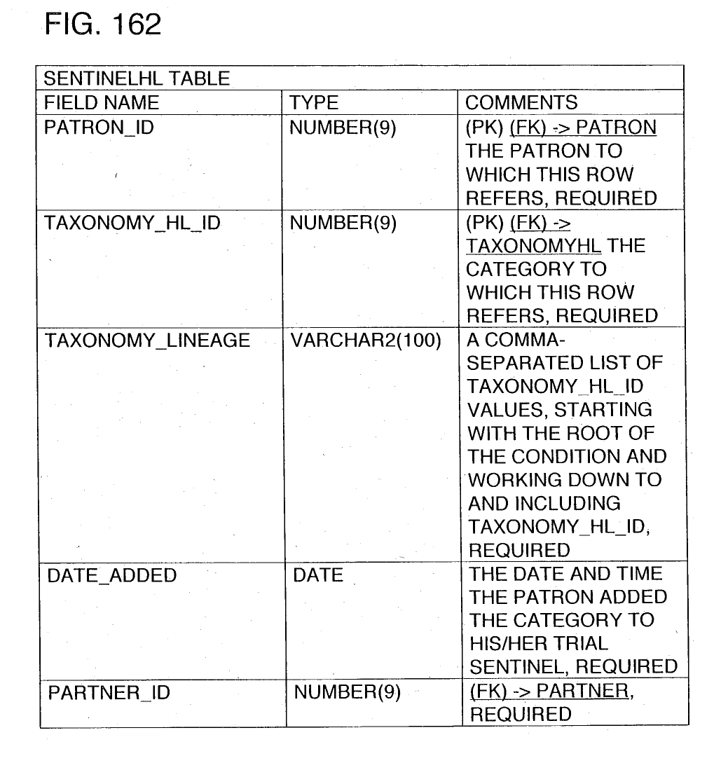

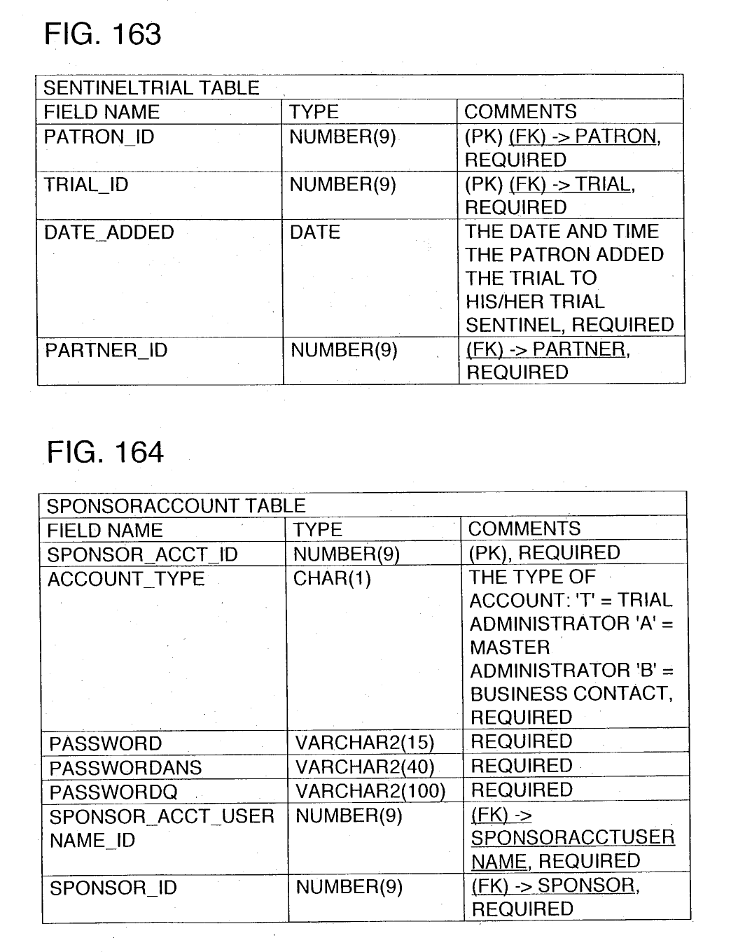

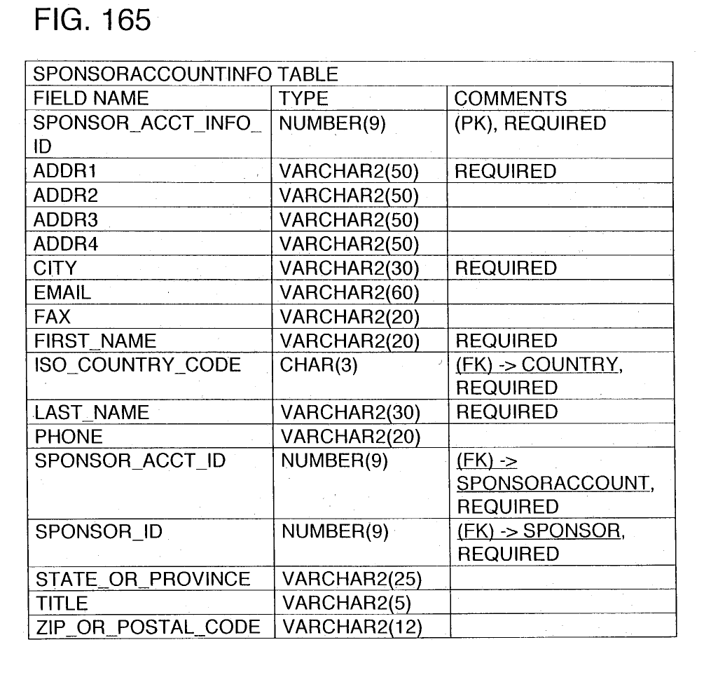

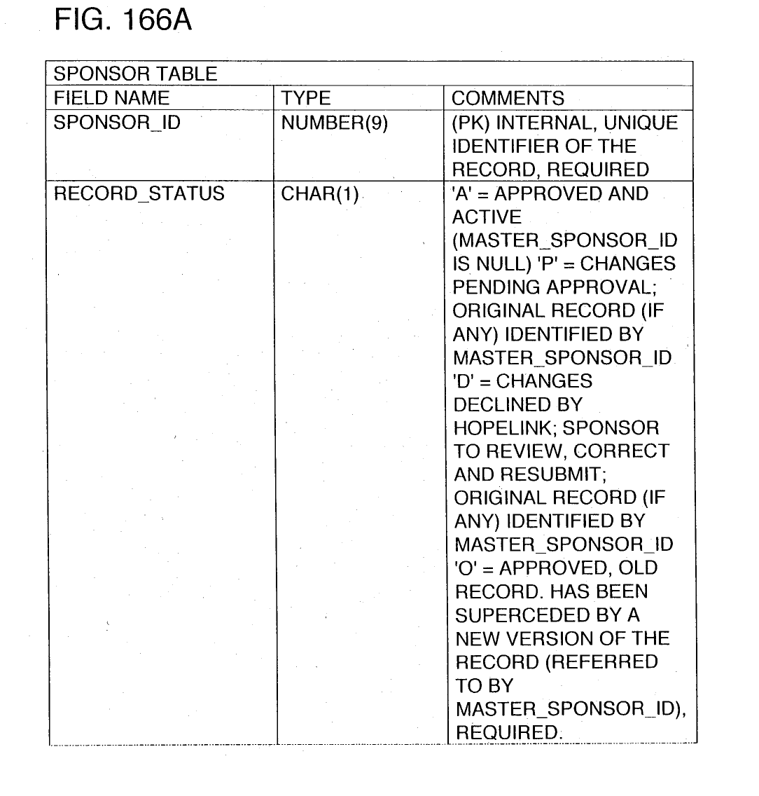

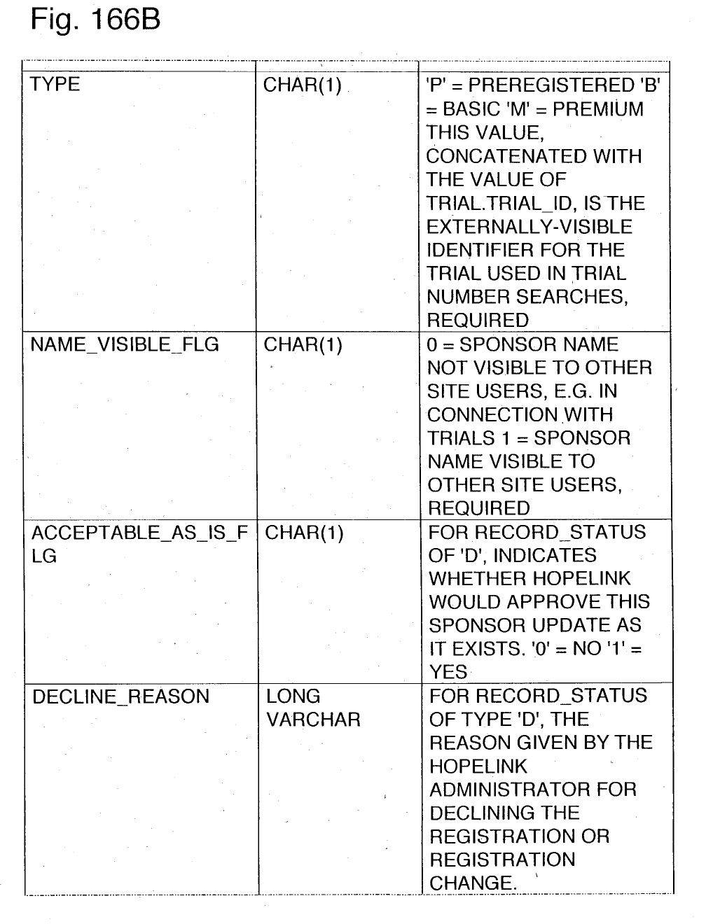

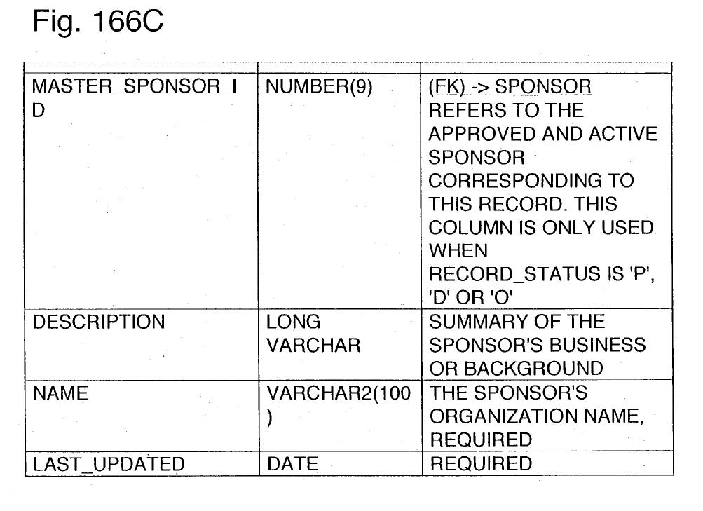

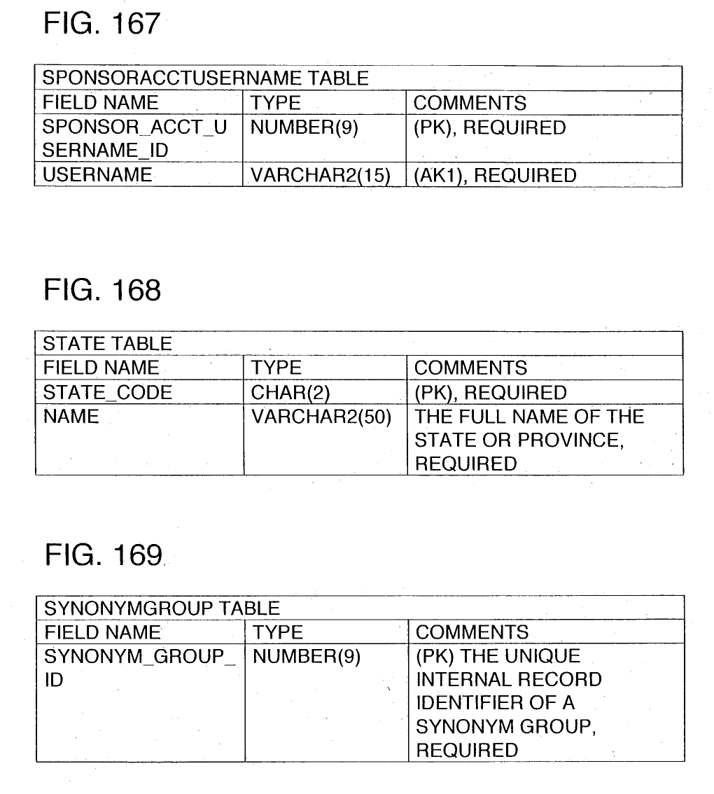

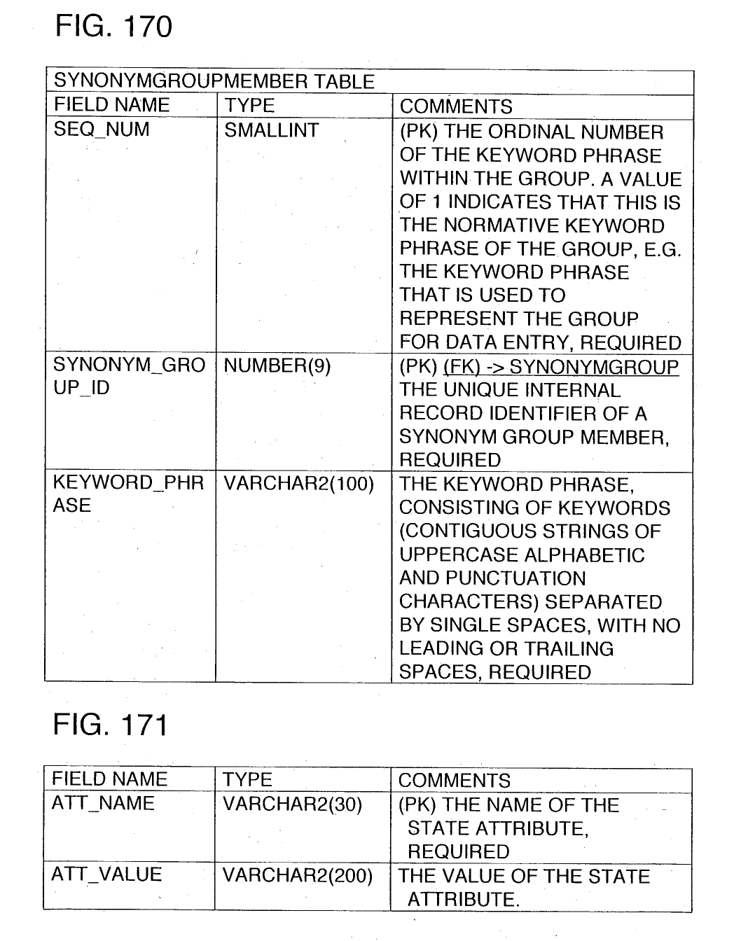

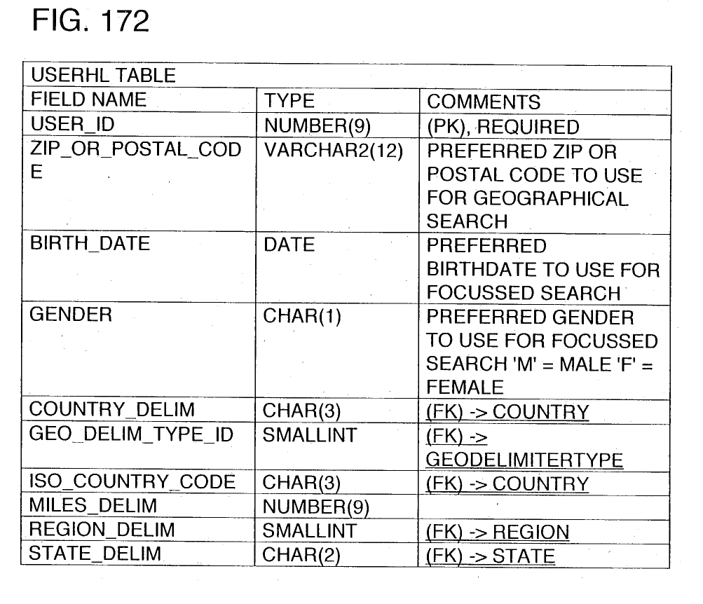

The document repository tables illustrated in FIGS. 6 through 25 combined with the database tables illustrated in FIGS. 144 through 172 illustrate one embodiment of the database including a document repository of the present invention.

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art.

What is claimed is:

1. A clinical trial method, comprising:
providing a repository that includes a plurality of clinical trial documents from one or a plurality of document sources;
comparing at least a portion of the clinical trial documents in the repository with a plurality of clinical trial documents accessed from one or the plurality of document sources;
maintaining a current copy of a clinical trial document in the repository; and
providing a query interface to the repository for access to at least a portion of the clinical trial documents in the repository.

2. The method of claim 1, wherein the document source is selected from a direct clinical trial information database import, an incremental clinical trial information database import, a remote clinical trial information database query, a remote clinical trial information web-site query, and parsing of the content of a clinical trials web site.

3. The method of claim 2, wherein a clinical trials web-site is selected from HTML, XHTML, SGML, XML, WML, WAP, BREW, i-Mode, and plain text encoded clinical trials information accessible by a communication network.

4. The method of claim 3, wherein the communication network is selected from the internet, local area network, wide area network, broadband network, wireless network and telephone system.

5. The method of claim 1, further comprising:
accessing at least a portion of a clinical trial document from the one or the plurality of document sources.

6. The method of claim 1, further comprising:
creating a clinical trial document from different versions of a clinical trial document accessed from the one or the plurality of document sources.

7. The method of claim 6, further comprising:
updating a clinical trial document from different versions of a clinical trial document accessed from the one or the plurality of document sources.

8. The method of claim 1, further comprising:
accessing a document source in response to a ranking score of the one or the plurality of document sources.

9. The method of claim 8, further comprising:
generating a ranking score for each of the one or the plurality of document sources; and
updating a clinical trial document in the repository in response to a ranking score of the clinical trial document.

10. The method of claim 9, wherein the ranking score is determined by at least one of, a document source rating, an age of the repository's clinical trial documents accessed from a document source, a historical frequency that at least a portion of a clinical trial document from a document source is included by the repository in response to a query.

11. The method of claim 9, wherein the document source rating is determined by at least one of, a document source's content update frequency, an age of the document source's content, a document source's content breadth, and a content source's content depth.

12. The method of claim 11, wherein the document source content breadth is determined by a reviewer or assigned by the repository.

13. The method of claim 12, further comprising:
accessing at least a portion of the clinical trial documents accessible from the at least one or the plurality of document sources;
providing a ranking score for the at least one or the plurality of document sources, wherein the ranking is based on a quantity of documents accessible from the at least one or the plurality of document sources; and
assigning a ranking to the at least one or the plurality of document sources.

14. The method of claim 11, wherein the document source content depth is subjectively assigned by a reviewer or assigned by the repository.

15. The method of claim 14, further comprising:
accessing at least a portion of clinical trial documents accessible from the at least one or the plurality of document sources;
providing a ranking score for the at least one or the plurality of document sources, wherein the ranking is based on a length of clinical trial documents accessed from the at least one or the plurality of document sources; and
assigning a ranking to the at least one or the plurality of document sources.

16. The method of claim 1, wherein meta-information associated with a clinical trial document in the repository is maintained in the repository.

17. The method of claim 16, wherein meta-information includes at least one of, a date and time the clinical trial document was added to the repository, a date and time a clinical trial document was accessed from a document source, at least one document source of the clinical trial document, a portion of the clinical trial document accessed from the document source, and the date and time the clinical trial document in the repository was updated from the document source.

18. The method of claim 1, wherein a clinical trial document in the repository is compared with the clinical trial document from at the at least one or the plurality of document sources.

19. The method of claim 18, further comprising:
comparing a clinical trial document in the repository with a clinical trial document from at least one or the plurality of document sources;
determining a clinical trial document from the at least one or the plurality of document sources not included in the repository; and
adding to the repository the clinical trial document not included in the repository.

20. The method of claim 19, wherein each step of claim 19 is repeated for all clinical trial documents in the repository.

21. The method of claim 18, further comprising:
updating at least a portion of the clinical trial documents in the repository of content with content from a newer clinical trial document.

22. The method of claim 21, further comprising:
providing notice to a system administrator of the updating of at least a portion of the clinical trial documents in the repository.

23. The method of claim 21, further comprising:
receiving confirmation from a system administrator to accept a clinical trial document from the at least one or the plurality of document sources.

24. The method of claim 21, further comprising:
repeating steps of claim 21 for all clinical trial documents in the repository.

25. The method of claim 18, further comprising:
determining when a clinical trial document in the repository is no longer accessible from the at least one or the plurality of document sources; and
removing clinical trial documents from the repository that are no longer accessible from the at least one or the plurality of document sources.

26. The method of claim 25, further comprising:
repeating the steps of claim 25 for all clinical trial documents in the repository.

27. The method of claim 25, further comprising:
determining a document source of the at least one or the plurality of document sources that contains an different version of a clinical trial document; and
updating at least part of a clinical trial document in the repository with content a corresponding part of a clinical trial document.

28. The method of claim 1 further comprising:
accessing a document source from the at least one or the plurality of document sources in response to a length of time elapsed since a clinical trial document was added or updated in the repository from the document source.

29. The method of claim 28, further comprising:
determining the length of time elapsed since a clinical trial document was added or updated in the repository;
determining if the length of time elapsed exceeds a threshold value; and
updating at least a portion of the clinical trial documents in the repository when the elapsed time threshold value is exceeded.

30. The method of claim 1, wherein clinical trial documents are organized in a structured relationship in the repository according to a document characteristic, a document classification, and a clinical trial detail.

31. The method of claim 30, wherein the document characteristic includes at least one of, a clinical trial document title, if the clinical trial document is new, date of clinical trial document updated, a date the clinical trial document was added in the system, a date the clinical trial document was updated in the clinical trial information system, clinical trial document language, medical or lay intended audience of a clinical trial document, if a pre-screen questionnaire is associated with a clinical trial document, and clinical trial document source.

32. The method of claim 30, wherein the document classification includes at least one of, International Classification of Disease number, Diagnostic and Statistical Manual of Mental Disorders classification, histopathological disease classification, and a disease condition.

33. The method of claim 30, wherein the clinical trial detail includes at least one a location of a clinical trial, a medical organizational affiliation of a clinical trial investigative site, a hospital affiliation of a clinical trial investigative site, a clinical trial enrollment contact information, a clinical trial investigator name, a clinical trial investigator specialty, a clinical trial protocol ID, a therapeutic drug, a gene expression and an insurance company covering clinical trial treatment.

34. The method of claim 31, wherein the clinical trial document's lay or medical target audience is determined.

35. The method of claim 34, further comprising:
maintaining by the repository a database of medical terms;
generating a ranking score for a clinical trial documentation response to a frequency of occurrence of medical terms in a clinical trial document; and
categorizing a clinical trial document's target audience as lay if the ranking is less than a threshold value and as medical if the ranking is equal or greater than a threshold value.

36. The method of claim 30, wherein the structured relationship between documents of a document source is converted by the repository to the structured relationship of the repository.

37. The method of claim 1, further comprising:
providing a query interface for searching the repository in response to at least one of, a keyword phrase, a document characteristic, a document classification, and a clinical trial detail.

38. The method of claim 37, wherein the document characteristic includes at least one of, a clinical trial document title, if the clinical trial document is new, date of clinical trial document updated, a date the clinical trial document was added in the system, a date the clinical trial document was updated in the clinical trial information system, clinical trial document language, medical or lay intended audience of a clinical trial document, if a pre-screen questionnaire is associated with a clinical trial document, and a clinical trial document source.

39. The method of claim 37, wherein the document classification includes at least one of, International Classification of Disease number, Diagnostic and Statistical Manual of Mental Disorders classification, histopathological disease classification, and a disease condition.

40. The method of claim 37, wherein the clinical trial detail includes at least one a location of a clinical trial, a medical organizational affiliation of a clinical trial investigative site, a hospital affiliation of a clinical trial investigative site, a clinical trial enrollment contact information, a clinical trial investigator name, a clinical trial investigator specialty, a clinical trial protocol ID, a therapeutic drug, a gene expression and an insurance company covering clinical trial treatment.

41. A clinical trial information system, comprising:
at least one database including clinical trial information for a at least one clinical trial;
a user interface including a plurality of selectable user inputs to permit a user to access the at least one database;
at least one document server coupled to the at least one database and configured to provide information exchange between a user and at least one third-party user.

42. The system of claim 41, further comprising:
a client coupled to the database that provides a user with access to medical information in the at least one database.

43. The system of claim 42, wherein the client is selected from software residing in a desktop computer device, software residing in a portable computer device, a communication device, and software residing in a computer information system.

44. The system of claim 41, further comprising:
a network coupled to the at least one database, the network configured to provide communication between clients by peer to peer communication protocols.

45. The system of claim 44, wherein the network is selected from at least one of the internet, local area network, wide area network, broadband network, wireless network, wired network, virtual private network, and telephone system.

46. The system of claim 45, further comprising:
an encryption mechanism coupled to the network configured to provide encryption of communication between a client and the at least one database; and
an encryption mechanism coupled to the network configured to provide encryption of communication between a client and a document server.

47. The system of claim 46, wherein the encryption mechanism is selected from at least one of, PKI, TLS, WTLS, SSL, S/MIME, VPN, and IPSec.

48. The system of claim 41, further comprising:
a at least one authentication server coupled to the document server.

49. The system of claim 4 1, further comprising:
a at least one permissions server coupled to the document server.

50. The system of claim 41, further comprising:
at least one routing server coupled to the document server.

51. The system of claim 4 1, wherein the at least one document server is configured to permit polling by a client.

52. The system of claim 41, wherein the at least one document server is configured to provide selected medical information to a user.

53. The system of claim 41, where in the at least one document server is configured to deliver the selected medical information to the user in response to criteria provided to the document server by a client.

54. The system of claim 41, wherein the at least one document server is configured to deliver the selected medical information to the user in response to the user's identity provided to the document server by a client.

55. The system of claim 41, wherein the at least one document server is configured to authenticate transactions conducted between the document server and at least one of a client, routing server, audit server, and a permissions server.

56. The system of claim 41, wherein the at least one document server is configured to encrypt communication between the document server and at least one of a client, routing server, audit server, and a permissions server.

57. A clinical trial information system, comprising:
at least one database including clinical trial information for a at least one clinical trial;
a user interface including a plurality of selectable user inputs to permit a user to access the at least one database;
at least one routing server coupled to the database and configured to provide anonymous communication between a client and at least one third-party client.

58. The system of claim 57, further comprising:
a client coupled to the database that provides a user with access to medical information in the at least one database.

59. The system of claim 58, wherein the client is selected from software residing in a desktop computer device, software residing in a portable computer device, a communication device, and software residing in a computer information system.

60. The system of claim 57, further comprising:
a network coupled to the at least one database, the network configured to provide communication between clients by peer to peer communication protocols.

61. The system of claim 60, wherein the network is selected from at least one of the internet, local area network, wide area network, broadband network, wireless network, wired network, virtual private network, and telephone system.

62. The system of claim 61, further comprising:
an encryption mechanism coupled to the network configured to provide encryption of communication between a client and the at least one database; and
an encryption mechanism coupled to the network configured to provide encryption of communication between a client and a document server.

63. The system of claim 62, wherein the encryption mechanism is selected from at least one of, PKI, TLS, WTLS, SSL, S/MIME, VPN, and IPSec.

64. The system of claim 57, further comprising:
at least one authentication server coupled to the routing server.

65. The system of claim 57, further comprising:
at least one permissions server coupled to the routing server.

66. The system of claim 57, further comprising:
at least one routing server coupled to the document server.

67. The system of claim 57, wherein the at least one routing server is configured to provide anonymous message exchange between a user and at least one third-party user via a client.

68. The system of claim 67, wherein the at least one routing server is configured to replace a user's identifiable information in a message with an anonymous identifier.

69. The system of claim 67, where in a user's identifiable information and the anonymous identifier are coupled and retained within the routing server for a defined period of time.

70. The system of claim 67, wherein the anonymous identifier and coupled identifiable information are used by the routing server to direct a third-party user's reply to an anonymous message to the user originating the message without revealing a user's identifying information to the third-party user.

71. The system of claim 57, wherein the at least one document server is configured to authenticate transactions conducted between the document server and at least one of a client, routing server, audit server, and a permissions server.

72. The system of claim 57, wherein the at least one routing server is configured to encrypt communication between a client and at least one of a third-party client, document server, audit server, and a permissions server.
